(19) United States
(12) Patent Application Publication
(10) Pub. No.: US 2022/0363378 A1
(43) Pub. Date: Nov. 17, 2022

(54) Electrically Powered VTOL Supersonic Aircraft

(71) Applicant: Daniel Keith Schlak, Alexandria, VA (US)

(72) Inventor: Daniel Keith Schlak, Alexandria, VA (US)

(21) Appl. No.: 17/862,936

(22) Filed: Jul. 12, 2022

(51) Int. Cl. B64C 29/00; B64D 27/24; B64C 30/00

(52) U.S. Cl. CPC B64C 29/0025; B64D 27/24; B64C 30/00

(57) ABSTRACT

A supersonic aircraft comprising longitudinal passenger rows has at its front end a 1^{st} impeller module comprising right and left electrically powered fan sets each comprising two diagonal fans in series, with the respective fan sets spinning in opposite rotational directions around parallel axes. The exhausts from the two fan sets merge to pass conjoined longitudinally along the aircraft to enter a 2^{nd} impeller module comprising electrically powered centrifugal fans rotating in opposite rotational directions around a shared axis. The twin exhausts from the centrifugal fans are collected in specialized volutes that eject the exhausts rearwardly for thrust. All the fans' rotational rates are therefore infinitely variable with thrust always maximized via independent rate modulation of all the fans, few constraints being imposed by airspeed or by prevailing air density. The impeller modules' fans are driven via electrical coils spinning between pairs of stators embedded with Halbach-arrayed or non-Halbach-arrayed magnets.

### TECHNICAL FIELD

The following disclosure relates generally to various fields of mechanical engineering and their application to the electric propulsion of supersonic aircrafts.

### BACKGROUND SUMMARY

### Problems to be Solved, Sidestepped, or Obviated by the Present Invention

There is a need in the aeronautical arts for supersonic passenger aircraft that are simple, consume minimal energy, travel extremely fast, and can take off and land vertically (VTOL). It is proposed herein that if some of these criteria can be met, the others will as a consequence become realizable and also follow logically thereafter. The present application addresses the need with a proposed combination of novel elements that complement each other to concomitantly overcome, with a few exceptions, the regularly recognized primary impediments to supersonic flight, while utilizing electrically powered propulsion to accomplish the supersonic flight and VTOL in a way wherein the supersonic, electric, and VTOL aspects symbiotically compound each other's beneficial effects.

The background summary discussion that follows is principally a list of the well-known primary impediments to supersonic flight, and the background summary consequently includes a respective, parallel summary of each of the most common solutions known by the Applicant to have served to mitigate each of the primary impediments.

In the prior art, the primary impediments have only been addressed via moderate mitigations of said impediments, mainly through aeronautical engineering solutions that incrementally or quantitatively alleviate them.

The primary impediments to supersonic flight are:
I. DRAG
   1. Form drag
   2. Engine drag
   3. Skin drag
   4. Lift-induced drag
   5. Wave drag
II. COMBUSTION
III. TAKEOFF AND LANDING
IV. HEAT
V. ACCESSORIES
   1. A catch-all group for the sundry physical items that weigh down a typical aircraft and whose wholesale elimination (or the eradication of their summed mass and resident volume) would tremendously increase the aircraft's acceleration (via the aircraft's increased thrust-to-weight-ratio) and thus manifest an overall regressive computational feedback loop apropos drag, lift, overall mass, and VTOL capability.
   2. Life support for the passengers.
VI. NOISE AND SHOCK WAVES

The following is a brief discussion of each type of the impediments.

I. Drag (1^{st} Primary Impediment to Supersonic Flight)

The first, most important impediment to supersonic flight, is drag. At high speeds, the drag on an aircraft can be broken down into: 1) form drag, 2) engine drag, 3) skin drag, 4) lift-induced drag, and 5) wave drag.

### 1) Form Drag

Form drag is the most punishing drag at super-high speeds, as it increases parabolically as a function of the aircraft's airspeed with a coefficient vaguely dependent on the aircraft's cross-sectional area as viewed along a longitudinal (flight) direction. The reduction of form drag will be one of the main goals of the present application, so it much discussed. A long tapering nose cone combined with a high length-to-width ratio fuselage have been traditionally used to reduce form drag as much as possible, but for a regular scenario with humans sitting side-by-side in parallel rows, the fuselage can only be narrowed so much.

Often in this technological space (mostly military aircraft) there has been an attempt to put an engine (or more than one engine) within the fuselage, such that the engine's contribution to drag is merely the extra surface area of the fuselage needed to house the engine and its intake. However, this usually requires inlets on the exterior surface of the fuselage to scoop the incoming air toward the innermost area of the fuselage to make the available to the engine, which is usually behind the passengers. The scoops or other analogous ducting systems tend to widen and lengthen the aircraft, increasing aircraft volume, mass, engine drag, and skin drag.

This problem arises from the fact that no one has figured out how, particularly in a passenger aircraft, to intake the air for the engine at/from the nose of the aircraft and directly through the cabin. The passengers have been in the way, apparently for a long time. There were several cold-war-era interceptor and fighter aircraft that took in the engine intake from the front of the aircraft and passed it under a slightly raised cockpit or around the feet of the pilot, thereby obviating the nose cone, but generally, to the Applicant's knowledge, this has not been a useful idea, especially and perhaps never for commercial flight; the raised cockpit increases the air displacement around the aircraft too much, thereby increasing form drag. Twin lateral intakes at the bases of, and forming part of, the wings, ended up being the status quo for military aircraft, because of the requirement that the aircraft contain a cabin. Imagining a USAF F-16 that had, instead of a cabin fused at its front with a nose cone, simply an air intake, is a good way to start imagining the possibilities of the suggestions that will be made herein.

If the normal method (intakes on the lateral sides of the fuselage) were to be used for a supersonic passenger aircraft, the intakes would begin behind the rear-most passengers and there would need to be a lengthy convergence space behind the rear-most passengers and in front of the engine(s). Such a supersonic aircraft's length, already excessive due to the long nose cone, is exacerbated by the rearward extension required for intake convergence/confluence and the engine itself (plus afterburners), as well as the rear exhaust nozzle.

It would be very advantageous to have the intake for the engine in front of the passengers and somehow pass the intake air through the passenger compartment or payload. This would get rid of the nose cone and much of the convergence space, not to mention the outward displacement of air (along the nose cone taper) that, at very high speeds, hinders high-supersonic flight due to its (the outwardly displaced air's) velocity-squared drag contribution. It is believed by the inventor that this would greatly reduce the form drag by narrowing and shortening the overall shape of the aircraft, as well as decrease its mass and skin drag. If the engine intake suction could be made to be extremely high in such a case, form drag would be immensely reduced because the aircraft would be presenting almost no forward surface area to the incoming air. The so-called shock-wave problems associated with the nose cone, well known to all practitioners in the art, and the exotic solutions for nose cones employed to alleviate these problems, would be no longer in effect, if there were no nose cone. An open-mouthed nose will not create shock waves in any direction. A benefit to this is that the aircraft would then be allowed to (by neighborhoods and/or governments) fly out of, into, and over, populated areas. Currently, supersonic aircraft are, even with exorbitantly designed and priced nose cones, not usually permitted to do so, due to the unpleasant noise they generate.

In short, the first problem in high-speed flight is the form drag that is the result of the existence of the (i.e. two rows of) humans or other cargo. The humans (or cargo) are the whole point of the travel to begin with, so the main losses during high-speed flight arise because the engine intake traditionally can't be placed in front of them and the engines can't draw or exhaust air through them.

Imagining a hollow tube flying through the air, open-ended and being nothing but the intake duct and exhaust duct for a single engine, is a convenient way to think about how much form drag would disappear if an inventor could solve this people-engine problem. So much of powered flight is built around the people-engine problem that we have generally taken it for granted and stopped thinking about it, even though most of our work is in dealing with it, instead of getting rid of it.

The applicant herein proposes that if it is possible to make the people-engine problem go away, and an aircraft, if properly designed, could be conceptually represented by an engine with a long hollow intake and a long hollow exhaust, form drag could be reduced to so low that energy consumption would decline to profoundly low levels and speed capabilities would increase to extremely high levels, assuming the other primary impediments to supersonic flight can be solved concurrently.

A lot of the preceding discussion was about prior-art aircraft that had the impeller system inside of them. Many of the supersonic passenger aircraft currently being tested and advertised have a power plant completely external to the fuselage. What this does is add the engine as a standalone extra drag that is combined/summed with the form drag of the aircraft. It does not compound all the drag issues, such as it doesn't mean that engine drag (discussed in the next few paragraphs) gets doubled or anything. It just means that the entities that are choosing this design have decided, for very appealing reasons, to not fold all of the drags up into one package, so they are accepting a certain, quantifiable loss of performance. The invention proposed herein will attempt to fold all of the drags up into one package.

### 2) Engine Drag

Engine drag has been included second because it is a greater impediment to high-supersonic flight than skin drag at very-high altitudes and very-high airspeeds. Engine drag is a term that has been used to describe numerous loss phenomena in the internal combustion engine arts, more in the automotive arts but also in the aeronautical (GTE) arts. This application cannot at this moment fuss about all the different uses of the terminology because they are vast and consequently a distraction at this point. However, there is no term that better fits what the Applicant is trying to describe, and sparsity of mention in the patent and non-patent literatures should not be a deterrent to its use here and thus the term “engine drag” as used herein must be lexicographically circumscribed in the next few paragraphs.

In this application the term “engine drag” is a scalar quantity that represents the sum of all the energy losses experienced by a supersonic aircraft that are contributed by a combustion-based impeller system, said losses due either directly or indirectly to the combustion-based impeller system, said losses further intrinsically being the result of using a combustion-based impeller system instead of an electrically-based impeller system. Myriad of said losses shall be discussed, sometimes only briefly for brevity's sake or peripherally because they are not very important, but we must first focus on the most importunate within this field of endeavor.

Engine drag as expressed herein is in part the result of a supersonic aircraft encountering and utilizing atmospheric air that is unmoving within the relative velocity frame of the earth or the atmosphere while said atmospheric air obviously entails an extremely high negative longitudinal relative velocity across/along the relative frame of the aircraft, but specifically its result as the atmospheric air is captured by the engines (engine intakes, really) and is denied unmolested passage through and out of the impeller system. All supersonic GTEs swallow incoming air and, as is well known, slow it down within the relative velocity frame of the aircraft—especially supersonic GTEs with intake ramps.

However, what is not focused on enough in the known literature is that this air is being accelerated to over 1,000 mph (or much higher for very fast aircraft) in the relative frame of the atmosphere before it is worked on by the impeller system of the aircraft. No matter how it is worked on, a great majority of the previously immobile air (via intake ramps or cones) is caught up within the innards of the aircraft's impeller system and is thereby accelerated (in the relative frame of the atmosphere) to an airspeed several hundred miles-per-hour less than the airspeed of the aircraft or impeller system, which airspeed is still very high. By being captured by the aircraft and conveyed at an airspeed several hundred miles-per-hour less than the aircraft's airspeed, the aircraft in one way or another accelerates all (repeat, ALL) the air encountered by the engine intakes to an extremely high velocity, and this is seen by the Applicant as not only a huge loss, but as one of the hidden intrinsic barriers to high-supersonic flight. The faster the aircraft flies at a specified airspeed, the more air it needs to grab and accelerate (in the relative frame of the earth or atmosphere).

Of course, the paradigm might duly counter-argue, and challenge us with the fact that the air by being slowed down has had its energy transformed from kinetic energy to pressure energy (in the relative frame of the aircraft/impeller system), and yes this pressure energy is rendered by the GTE for expansion thrust later, but it must be emphasized at the time of filing this application that the “expansion thrust later” inherently has subtracted from it the amount of thrust that has been wasted collecting and accelerating all the air that the GTE uses to provide that thrust. It seems to the Applicant that in terms of advertised thrust of engines, the engine-drag subtraction doesn't seem to be as prevalent in the prior-art discussion as it will need to be once the Applicant has made his case here. The Applicant believes that this is because of a calcified paradigm, and that much of the industry has become abjectly reliant on stagnant forms of propulsion technology and ways of thinking.

Why? Well, all of the traditional GTEs (except the useless-for-takeoff-or-landing ramjet and scramjet) suffer at least three incorrigible defects (labeled A-C):
A. Combustion requires that airflow within the combustor be constrained to within 200-800 mph (range probably overly generous) of the aircraft's airspeed in the relative frame of the aircraft;
B. All moving objects within a typical engine must impinge the incoming air at a collision speed less than Mach 1, thus the traditional intake ramps that compress the air to slow it down in the relative velocity frame of the aircraft. Inherently such an intake must accelerate the air in the earth's relative frame, or decelerate the air in the aircraft's relative frame. The latter doesn't seem to be so detrimental, because that's how we have been accustomed to think. But the former, that the air is accelerated in the earth's or atmosphere's relative frame, is an unavoidable (and should-be quintessential) problem. The aircraft must inescapably and constantly catch air, carry it forward, work on it, and then release it, and only by serious energy consumption/creation release it at a useful exhaust velocity. The “carry it forward” is not a small phrase. It means that the engine(s) and/or their intakes must convey air forward for some finite course or finite moment and then re-accelerate it rearward using some finite amount of work for every molecule of air that the engine(s) take in. This surprisingly sums up to be an enormous amount of air, more tons of air than there are tons of aircraft to propel. It is possible that the engine drag is greater on a conventional supersonic aircraft than is the form drag. At least the form drag is somewhat passive.
C. A GTE's innards and bypass flow elements cause substantial drag, for a typical GTE has hundreds of 3D elements that confront the incoming air while working on said air, to pressurize said and slow it down, in the relative frame of the aircraft, to a very low axial velocity. A small but substantial portion of the air is passed laterally/radially through ducts and apertures into the combustor, and by doing so slowing the air down to zero rearward velocity (relative to the aircraft—in reality, the aircraft/engine accelerates this air to its own airspeed, before allowing it to expand to be ejected at a thrust+X velocity), waiting for the instant when it is to be combusted and accelerated again. The engine drag is really a part of the combustion impediment, and will be dealt with more in that discussion, below.

The engine drag comes mainly from ingesting and slowing the incoming air (in the relative velocity frame of the aircraft) down to the combustion-friendly, compressor-friendly, and turbine-friendly airflow velocities required by and experienced inside the GTE, or more importantly the accelerating of the incoming air to an airspeed not very far from the aircraft's airspeed (to an airspeed of 1,600 mph if the aircraft is to travel at 2,300 mph, for instance), and then letting that air passively escape with chemically induced stimulation along the rearward direction, with a nozzle power that is passively dependent upon pressure. The air may thereby subsequently reacquire its previous longitudinal velocity plus a steady additional longitudinal velocity quantity on top of that due to chemical intervention, but only after being caught up and combusted and/or shoveled into a nozzle arrangement that does not much more than “permit” rearward self-acceleration of said energized air from its original near-standstill.

Think about it; a traditional supersonic impeller system that relies on combustion must catch (in a literal sense analogous to a net used for fishing) an enormous amount of air, accelerate it to the aircraft's airspeed, minus a number on average more than the internal GTE air flow velocity of about 700 mph, and use a significant proportion of its energy to re-accelerate this air instead of using said energy to simply propel the aircraft. This possibly explains the upper ceiling on most supersonic passenger aircraft's max airspeed which ceiling is around 1,200-1,600 mph, and for the most advanced military scenarios, around 2,000 mph. Any airspeed over 1,200 mph is a massive liability to overall power output in such prior art systems, because all air in such instances must be caught, accelerated to “airspeed-minus-700 mph” and then worked on for acceleration and turbine losses, such that the effort to make the thrust higher than the airspeed, which is an absolute precondition to generate thrust, is too burdensome to effectuate without an extremely elaborate system that, for obvious reasons, has never been genuinely implemented.

It is believed by the Applicant that it is this forward acceleration by the aircraft of so much incoming air that the prior art supersonic engines (some examples summarized herein) sabotage themselves and that this effect contributes significantly to the established and recognized (in the aeronautical arts) ceilings on maximum airspeed; namely, that it is only the most exotic aircraft that are listed or advertised as functioning at airspeeds higher than M2.

It is becoming increasingly obvious that the real problem is combustion itself. It must be wondered, why don't we just deal with the air at its own speed, and just push it even faster? That is the point of a high-bypass turbofan, but as discussed elsewhere herein, turbofans are no good for supersonic flight. It is also the point of ramjets, but those will be discarded as well (also discussed elsewhere within the application).

Engine drag is ever-present but rears up significantly as a threat to our endeavor to push beyond 1,200 mph airspeed because the air molecules going through a prior-art engine invariably need to be going less than about 700 mph rearwardly in the aircraft's relative velocity frame, while the airspeed of the aircraft is desired to be over 1,200 mph in the earth's relative velocity frame. In this scenario the typical aircraft is collecting tens or hundreds of pounds of incoming air per second, accelerating those pounds to a speed of (relative to their initial unmoving speeds) hundreds or thousands of miles per hour, and relinquishing them, having done work on them without using them for anything other than combustion and expansion potentials, at which stage they have to expand to passively allow the pounds of air to expand over several longitudinal feet to create the longitudinal thrust. This is a huge waste. This paragraph may seem like a lofty, sophisticated assessment, but the Applicant cannot see a way in which said huge waste can be ameliorated or eliminated without the teachings of this application, or at least some of these teachings, although it would be awesome if someone did something just as cool as this but in another way.

So, to be frank, even an acclaimed super-tropospheric high-supersonic vehicle such as the USAF SR-71 with those big engines incorporated into its wings is constantly accelerating standing air (in the Earth's relative frame), via those cool-seeming engines and/or their intakes, to a high velocity (“plus” about 1,200 mph) before accelerating said standing air to the thrust velocity (“minus” about 3,000 mph). That 1,200 mph matters! It is a loss. Why slow the air down in the relative frame of the aircraft, or in another way of looking at this, catch it up and accelerate it in the real frame that it matters, the stationary (ambient air's) relative frame? “Why” can only be responded to with “because of combustion”. Combustion begins to appear as an albatross apropos our current endeavor.

The engine of a regular turbojet engine presents a significant drag factor, although it is not usually discussed in the prevalent literature since the engine is the driving agent of the aircraft. This not only makes it difficult for us to individually conceptualize the engine as causing drag, we've gone so far (in the popular understanding of jet engines) in the other direction that the engine drag has been factored out of discussion of aircraft design so fundamentally and continuously that engine drag is something almost no one envisions when their imagination entertains potential scenarios of pure flight. But, as said previously herein, it could well be an albatross in itself.

### 3) Skin Drag

Skin drag can be generalized as a drag force linearly proportional to aircraft velocity (airspeed). There is no handy path to completely ignore skin drag. An aircraft simply has to have an outer surface. Fortunately, since skin drag is linearly proportional to velocity and local air-density, the energy lost to skin drag is simply a function of the integral of distance traveled at each altitude (height above the earth) multiplied by the air density/pressure at those altitudes. By flying nearly exclusively at very high altitudes, the skin drag factor inherently plunges precipitously for a flight and the contribution of skin drag to the total parasitic energy loss during an entire flight would decline enormously. If the aircraft climbs straight upwardly with constantly increasing speed and if the acceleration to high speed and thus high altitude is brief, the skin drag component of parasitic energy loss begins to look nearly negligible, because the aircraft spends very little total time in the sky. This should be especially possible if the form drag, as described in (1) above, can be reduced to a fraction of what is currently possible in the art.

### 4) Lift-Induced Drag

The contribution of lift-induced drag is a linear function of how much lift is being produced by the aircraft, which is itself (in an ideal equation) parabolically related to airspeed; in other words, it is a function of airspeed-squared, just like the lift itself is. Most aircraft are designed to take off from a moderately long runway and even so their wings must be large enough for the aircraft to take off at approximately 80-120 mph (or over 200 mph for supersonic aircraft that usually require a corresponding runway length of over 1 mile). Once it is in the air, the aircraft is stuck with those large wings and thus the skin drag that comes with such large wings. Fortunately, lift-induced drag becomes very small (per mile traveled) at very high speeds and altitudes, because the aircraft will climb to an altitude where lift is equal to the weight of the aircraft, and at very high speeds this will be at altitudes where the air density/pressure is very, very low. If the aircraft were to be purposefully designed to take off and land vertically, the wings could be resized to provide another much smaller lift at the aircraft's optimal speed. For example, if they were designed to provide takeoff lift at 300 mph at sea level, the lift-induced drag would be inherently and considerably reduced (during cruise, etc.) even further than it already has by the above-mentioned systems. In other words, by avoiding runway takeoff and landing, the wings' profile and shape can be optimized to a much higher cruise airspeed, significantly reducing lift and lift-induced drag during cruise.

Another way to look at this is, the lift and lift-induced drag are the parasitic forces required to hold the aircraft up during a flight duration. The faster the airspeed is, the less time the wings or other lift elements spend suspending the aircraft. Even though lift and lift-induced drag are proportional to the square of the velocity, said velocity being very great, if the aircraft gets to its destination 5 or 10 times faster, the total lift-induced drag should be about ⅕ to 1/10, respectively, what it would be during the much slower flight. But again, even this lowered number will be very low because lift will stay constant and low by having the aircraft always at an altitude where lift, and thus lift-induced drag, are a constant low number (just enough to offset the weight of the aircraft). Meaning (emphasis added here) the total lift-induced drag of a flight will start to become insignificant when the flight durations get pushed down (by this invention and subsequent technology) to 6-10 minutes for moderate trips (i.e. 200-1,200 miles). For the 6-minute flight, there will only be 6 minutes of lift-induced drag, regardless of the high v² number.

To do this in a perfect scenario, a scheme for VTOL needs to be worked out for such an aircraft that does not substantially contribute to aircraft mass or volume. Lift-induced drag cannot be gotten rid of, but the amount of energy it consumes from the overall flight can be conveniently imagined as being a function of how long the aircraft hangs in the air during a flight, as described in the previous paragraph. The faster the flight, the less lift-induced drag the aircraft will experience during it. As described in the discussion of skin drag, the drastic reduction in form drag and aircraft mass allows for the aircraft to accelerate and climb very quickly. Thus, the aircraft will be in the air for a very short time indeed and therefore the amount of energy deducted from the available (battery life) energy during an entire flight by lift-induced drag, like skin drag, begins to look nearly negligible. This becomes a very attractive argument for pushing toward sub-hypersonic flight at about 70,000-100,000 feet. Not only because it would be nice to travel, say, 50-100 miles per minute (3,000-6,000 mph), but because doing so would, in the near-absence of form drag and considering the lowered form drag and skin drag due to the super-high altitude, require an energy consumption that is, counterintuitively, greatly reduced from lower-speed travel. Although hypersonic flight can be considered a futuristic possibility, the aeronautical advances required to do this are not yet available, so this application will deal with much lower (i.e. 3,000 mph) airspeeds.

### 5) Wave Drag

Wave drag is not well understood by the Applicant but from what he can gather, it is probably unavoidable at the front edges of the wings. Also, because of wave drag, for higher and higher speeds, the nose cone is traditionally made longer. This is another good reason to get rid of the nose cone. If the engine intake were to be at the front of the aircraft, such that the air coming at the aircraft was cleanly sliced into internal flow and external flow constituents, the wave drag should become less of an obstacle. Hopefully much less. Of course, this requires dealing with the internal flow which will now, in this scenario, be passing into the aircraft at extremely high velocities. This problem will be dealt with in the summary of the invention. It is proposed by the applicant that the wave drag on the wings or other parts of the aircraft is a problem that was probably solved via several means during the era of near-hypersonic cold-war-era interceptor aircraft, and that the aeronautical solutions for it are known to persons of ordinary skill in those arts or at least a few retired professors.

Replacing the nose cone with the engine intake would also replace the displacement (form) drag of the fuselage with the displacement (form) drag of the engine which otherwise would have been elsewhere on the aircraft and gratuitous, such that there would (in such a case, and in prior art solutions) be form drag for both engine(s) and fuselage. Just taken by itself, the thrust-per-drag relationship will be significantly reduced by removing the engine from another part (other parts) of the aircraft and making its intake coincidental with the front of the aircraft. It is possible that the thrust/drag ratio could be improved by more than 20-40% by putting an engine (or fan) intake in the same place where the incoming air was previously impacting the nose cone and being compressed outwardly around the aircraft and this way there would not be separate (i.e. outboard and costly) locations or ducts for the engine intake(s).

### II. Combustion (2^{nd} Primary Impediment to Supersonic Flight)

A turbofan cannot go supersonic for a long list of well-known reasons, but mainly because the fan would destroy itself and probably the aircraft it is attached to via shock waves, destructive shuddering of its vanes, flow separation problems, and/or thermal breakdown of parts of the fan vanes, not to mention the flow and pressure breakdowns within the compressors, combustors, and turbines. Therefore turbofans will not be discussed herein.

A standard turbojet can be made to go supersonic by shocking the intake air before the air reaches the engine's compressors, and usually afterburning the exhaust, in most instances advantageously using some bypass flow. All of this entails enormous complexity and fuel consumption, not to mention a consequently considerable added mass and volume of the overall aircraft in addition to almost all of the drawbacks discussed during the “ENGINE DRAG” discussion above. The afterburner and exhaust nozzle need to be long enough to accelerate the air so that when it exits the aircraft it is going faster than it was when it got taken into the aircraft.

The turbojet's principal defects, however, aren't limited to just the required afterburner/nozzle volume and the engine drag described previously. The whole reason these exist is because the engine basically catches the air (accelerates it to a velocity several hundred mph less than the aircraft's airspeed as seen in the relative frame of the ground or standing air) before exploding it and letting it accelerate again. It only positively accelerates it for thrust across a very (longitudinally) short traversal across the 1^{st} compressor or fan stage for a high-bypass flow engine, or across all of the compressor stages for a zero-bypass flow engine, which is at most still less than 18 (longitudinal) inches. Meanwhile it is reducing the exhaust gas speed via the turbines to recover energy to drive the compressors. As a consequence, in giving the exhaust the room it needs to pressurize and expand in order to accelerate it up to a useful speed, the exhaust of a turbojet requires a set of accoutrements that literally define the shape of the rear of the aircraft, not to mention the amount of volume added to the overall aircraft, both the volumes described above and volumes that can't be gone into here. This adds more mass, more skin drag, etc. And it forces us to build the rear of the aircraft around the tubular shape of the exhaust elements. So, whatever attempts might be made to taper the rear of the aircraft to a flattened wedge shape, which would make the fuselage inherently generate lift, the resulting aircraft would still be stuck with the centralized, large-diameter tubular exhaust that would ruin those attempts.

Also, even if someone were to put the most powerful afterburner imaginable, and the most efficient nozzle, behind a specialized high-bypass flow turbojet, there is simply a limit on how fast the exhaust can be ejected out the back, because we've already separated it from the outside air, the outside air is rushing past the system at over 1000 mph, and the exhaust air uses a significant amount of its (chemically and pressure induced) expansion energy just catching up to that. But say we could get a turbojet to eject its exhaust at the velocities required for pushing up to the speeds and altitudes that are desired in the present invention, the aircraft would run out of fuel on its way up to cruise or be forced to carry so much fuel that it wouldn't be able to get up to those speeds and altitudes within a reasonable time anyway. Or if it did, it would be reprehensibly wasteful. This is the case of the Pratt & Whitney J58, which almost miraculously did (and its successors surely still do) find a way to afterburn compressed bypass flow to allow airspeeds of over 2,000 mph. The more the Applicant learns about this power plant and the various aircraft it propelled, the more these systems seem to resemble very fast, high-altitude fuel conveyance devices—meaning, they do little more than push around the fuel they're going to use. If the point of them wasn't to attach a spy camera to that fuel, they wouldn't accomplish very much.

Because of this, for extremely fast travel, the high-supersonic “concept” industry often proposes ram-jets or scram-jets. These options, although promising for reducing engine drag at high-supersonic speeds, are simply lousy, and in fact unfeasible at low, moderate, and moderately high speeds, which we will need to push through to get to the very high speeds, and the strategies that could be used for getting around these and residual problems are inherently as exotic as the engines themselves are simple. The applicant cannot envision any possibility that a ram-jet or scram-jet could perform vertical takeoff or landing, or even perform a regular takeoff, and in fact the most current iteration of scram-jets requires a booster rocket to get the aircraft up to supersonic before using the scram-jet. This does not bode well for this concept in commercial and/or leisure industries. So, as can probably be perceived by the reader, this application will not deal with these types of power plants.

So, in part for the reasons put forth in the foregoing description, even the Concorde had to settle for the turbojet. For all the work done in that aircraft's development, the thing was still slow, and it guzzled fuel, basically for a lot of the reasons described in the discussion of drag, but also because it was a regular airplane using a set of non-qualitative improvements upon a regular turbojet as well as a set of non-qualitative improvements upon the aeronautics of a regular aircraft.

Another problem with turbojets is rotating all of their parts and matching them up to the intake air's velocity and pressure. A compressor-based power plant designed for high speed suffers in performance at low speed, and vice versa. Also, supersonic turbojet inlets are complex structures whose primary goal is to manage the intake air so that the compressors don't create shock waves. This is because the compressor vanes are three-dimensional structures that cannot slice directly into the intake air, because they are axial compressor components that do not throw the air, but merely compress it using pressure differentials. So, an ideal system would do away with axial compressors altogether, and turbines as well. The axial compressor is as big a part of the problem posed by combustion as the form drag is a part of the problem posed by drag. It needs to be discarded if a perfect device is to be conceived of at all. This, it is understood, requires first a massive paradigm shift. The industry is addicted to axial compressors.

To summarize the last several paragraphs, the prior art relating to gas turbine engines suffers in essence a 2-prong combustion problem. The first prong is that the air is slowed to a relative crawl and then re-accelerated, requiring an axial length of 5-12 feet or more (or much more with afterburning) and limiting the exhaust gas velocity which determines thrust. The second prong is that the axial compressor vanes can't cut into a supersonic intake stream and work on it. The applicant has considered the axial compressor as part of the combustion problem because the whole point of the compressor is to work the air to a pressure that it can be combusted while being constantly replenished. The discussion of the problems posed by the turbine vanes could follow here but would be gratuitous. Likewise a discussion of fuel-to-air ratio problems that arise at high altitudes, especially over 50,000 feet. We can skip all that, thanks to the embodiments proposed herein.

With such enormous, almost insurmountable obstacles posed by the combustion impediment, and given that putting a turbojet in line with the passengers without scoops has not been heretofore possible if we want to take the intake air through the passenger compartment (there's too much air), what is needed is to “squeeze” the intake air down by speeding it up, using a mechanism such as an impeller placed between the nose of the aircraft and the passenger cabin. This will be described later in this specification.

For reasons that will become apparent to the reader as this application develops, the idea of a fossil fuel engine needs to be completely scrapped. In a perfect aircraft, some electrical device is preferable, to obviate all the problems associated with combustion, described above. Also, if properly designed, an electrical device could theoretically be driven at an infinitely variable rate so that, no matter how fast the intake air comes into the aircraft, the intake air can be accelerated to a much higher speed than it came in, resulting in significant thrust at all airspeeds and, importantly, at all altitudes.

It is noted that fossil fuel engines must inherently suffer performance detriments at the altitudes that are unconducive to drag, because inherently the altitudes whereat drag is very low have very few molecules in any given cubic foot. This low number of molecules appertains insofar as the amount of oxygen is concerned. If at 70,000 feet there are 1/17 the number of molecules as at sea level, which is the case, then there are also 1/17 the number of oxygen molecules available for power. Not only that, but the ones that do come in are cold. It would be even nicer to travel at 85,000 feet where the density of molecules is ridiculously small. There is hardly any air here at all, but the lift being created by the aircraft will be proportional to airspeed-squared, and if airspeed is in the thousands of miles per hour, it is not inconceivable to envision a typical flight reaching such an altitude. Again, and this is extremely important and can't be overstated, we don't need the oxygen if we use an electrical system.

Super-high flight, while being required for super-fast flight with minimal energy usage, is irremediably a worst-case scenario for a fossil fuel engine. A perfected system simply cannot depend on a favorable combination of temperature, altitude, fuel-to-air ratio, and airspeed to project adequate thrust. There is no way now to avoid the fact that the perfect system will be electrical. The perfect system cannot be reliant on fuel-to-air ratios at the lean-oxygen realms it will inhabit. It must simply project as much exhaust velocity as there is energy to project it, and it must do so electrically.

It is also notable that an electrical aircraft, such as if the proposed invention were globally adopted, could replace all conventional air travel by being much faster and thus more desirable than the latter, which would in turn considerably reduce the carbon footprint of humans.

For the intents of the present application, we will call the total inefficiency component of fossil fuel engines the engine drag. There is an additional engine drag component that has not been discussed much herein, but it is not insignificant so it must be thrown into the discussion before we move on, and this is that the air and products of combustion passing through a fossil fuel engine cause more form drag and skin drag on the engine's internal components (mainly but not only vanes) than its nacelle experiences from passing air. This like everything else just contributes to making the engines work harder to maintain airspeed, increasing fuel consumption and reducing the potential top speed.

### III. Takeoff and Landing (3^{rd} Primary Impediment to Supersonic Flight)

Speaking negatively now of the takeoff and landing of conventional aircraft, the losses of time and energy of the traditional runway-based and helicopter systems, and the unfortunately and inevitably adverse gains these aircrafts incur in traditional manifestations especially as exemplified by their extra mass, cost, complexity, and geographical restrictions, not to mention their insufficient power output (thrust), the Applicant takes it for granted that any reader is in agreement that they will all be mostly obviated by a vertical-takeoff-and-landing (VTOL) system and with good riddance. The VTOL system must be described much later and not here, but it is very important. Solutions for VTOL are to be found, abundantly and at times even redundantly, later in this document.

The shape of an aircraft and the size of its wings are partially defined by their ability to take off and land at an altitude near sea level in a longitudinal, horizontal direction, and using long runways. For supersonic aircrafts, their shape is also, and almost by-definition never in a complimentary manner, majorly defined by their ability to fly at an extremely high speed. If the takeoff and landing requisites were advantageously discarded via any available or novel technology, the shape of the aircraft/wings could be wholly reconceptualized to conduce only to high-speed travel.

In other words (writing all the while in passive and empathetic criticism of the current state of the art), almost all potential advancements whose goals are toward simplified supersonic flight that also require performance decreases vis-à-vis takeoff adaptableness are handicapped in this paradigm, and as a result are fugitives residing randomly and indiscriminately outside the ken of most of the smartest engineering minds even when their thoughts might be given over to this matter, and therefore this state of utilization (meaning the eradication from design considerations of the takeoff performance) is rarely if ever gamed out in a serious way.

In yet more words, if the aircraft doesn't have to sit on a tarmac and then crawl over to the runway and then go half a mile or more on the runway just to get enough throughflow in the fans to achieve 80 mph airspeed and if we don't have these giant wings whose entire existences are due to the waiting on said runway until the aircraft achieves the throughflow of fans going at 80 mph airspeed, then we can throw out half of what the world takes for granted as modern air travel. We can, almost magically, start from scratch. And this is good news if it can be solved. It is believed by the Applicant that these considerations are dealt with and adequately solved by the present application. And to speak in the most reductive sense, for all aircraft and in a most general sense, in any and every way that aircraft design considerations are constricted by takeoff requirements (high lift at low speed), the best and most efficient/fast design considerations inherently come into play only when VTOL will have replaced runway takeoff. To put a number on all this, let us imagine a wing scheme that does not need to create lift at an airspeed less than 300 mph. Whatever that is, in an optimal embodiment we can use it as it is (when it has come to be) as being experimentally and theoretically the more perfect, without changing and limiting it for operation at lesser airspeeds.

The level of infrastructure associated with building, running, and maintaining, as well as entertaining and feeding persons awaiting a departure within, the various airports of the world, is a major economic factor adversely influencing the total (high) cost of a flight, not to mention the geographical obstacles to air travel for most persons living in the world who are not near an airport. Additionally, the fact that an aircraft both departs and approaches airports through a serpentine course represents significant deviation from a preferable/profitable straight line between the arrival and destination. The fact that an aircraft must carry fuel enough to make its way to an unplanned runway or to circle an airport for up to 30 minutes if landing conditions are not favorable upon arrival at destination obviously additionally increases energy consumption during a typical flight of a prior art aircraft. VTOL inherently cures these problems.

The detriments associated with runway takeoff and runway landing account for more waste than the preceding paragraph describes, not to mention the countless hours/expense/fuel sacrificed by flyers spending an hour or two at an airport they spent half an hour getting to.

Considering the costs and energy wastage of the takeoff and landing of a typical aircraft, due to reliance on runways, airports, speed-buildup, etc., a VTOL scheme must be part of a perfected solution. If done properly, such that the physical manifestations of the VTOL scheme do not detract from the high-speed functionality of the aircraft, the cost and energy savings could be colossal. The shape and mass of the aircraft would no longer have anything to do with how the aircraft takes off and lands. Further, the aircraft would begin its flight aimed exactly at its destination, and land at any of any number of spots at the destination or, during emergency, it could just land anywhere. This reduces the reliance on runway usage, runway length, runway direction, etc. The end result would be much less paved-over land, much-diminished airport acreage, many more and widely-dispersed airports (airfields), less time waiting, less time and expense getting to and from the airport and being stuck there, expanded rural access to air travel, etc. On an extreme level, it is not unimaginable that a certain type of person/entity could simply have such an aircraft on their roof or in their yard or, for a large estate, office park, resort, hospital, etc., in a small hangar with an openable roof. As this is a background summary, we'll summarize in saying that these are all very desirable things we don't have yet.

Another small waste associated with the prior art is the need for an aircraft to use part of its charge (fuel) to taxi to the beginning of a runway, to taxi from the end of a runway, wait for its slot on the runway, and also to accelerate the engine to its takeoff rotational rate while simultaneously working on the air coming into it during the period beginning when the acceleration is negligible—another way of saying this is that the engines are running constantly from a moment well before takeoff to a moment well after touchdown, and this consumes fuel. It would be desirable to shut the intake of the propulsion system, to create a vacuum within it, so that the runup to takeoff can be done at only the loss associated within spinning a few devices up to takeoff rotational rate at a vacuum. This can only be accomplished with an electrical impeller system. Although desirable, this shutting of the intake of an engine to run up its rotational velocity with negligible drag is absent from the relevant arts, probably because of the complexity that would correspond to implementing it in a normal, annular system. A boxy intake to the engine would allow this, but boxy intakes would be too much a deviation from anything we recognize as an airplane, if implemented the way airplanes are right now.

### IV. Heat (4^{th} Impediment to Supersonic Flight)

Composites that tolerate extreme temperatures are often used to deal with the heat issues that a high-supersonic aircraft encounters, especially along the leading edges of the impeller system intake, the nose of the aircraft, and the leading edges of the wings and empennage, while high-temperature-withstanding metal alloys can be used for the areas/parts that get too hot even for the specialized composites. So, apropos the invention to be unveiled shortly, where composites might experience thermal breakdown or excessive thermal or mechanical wear, specialized metal alloys should be used.

The heat issues that we can expect at extremely high airspeeds can hopefully be mitigated greatly by the practice of only practicing high-supersonic flight at high altitudes, where the air is sparse enough and so cool that it will not generate sufficient heat on the aircraft's surfaces to thermally over-stress its parts. However, this is probably not enough provision to keep the wings from overheating, so there will be a wing cooling scheme proposed herein as well.

Although heat is well known to be problematic for supersonic vehicles, the prior art will not be described herein because this application will not propose to solve heat problems. As easy as it is to say the technology might not yet exist to protect a passenger aircraft such as the one to be proposed herein without prohibitive monetary cost, it is just as easy for the Applicant to say that if the prototype performs as well as the Applicant believes it will, and testing and modeling predict that with such protections it will be possible to fly people at over 2,000 mph, the Applicant believes that the technology for heat-guarding the aircraft will become available, and eventually inexpensive due to the inevitable economies of scale.

### V. Accessories (5^{th} Primary Impediments to Supersonic Flight).

All things take up mass and volume. All measures must be taken herein to get rid of them, not just design them to be as small and light as possible. So, a perfect device needs to absolutely and without question eliminate a pilot, cockpit/flight deck, aisle, flight attendants, lavatory, kitchen, monuments, landing gear, etc. This creates a positive feedback loop Eliminating those things could potentially reduce the mass of the aircraft by as much as 50% (because the amount of fuel and airframe carried around to propel, encase, and support the accessories will also be slashed by 50%), resulting in 1.5 or more times the acceleration per given thrust and thus an extremely brief flight, such that those auxiliary things are unnecessary to begin with. If the engine intake is to be in front of the passengers, there would be no space for a pilot anyway. With vertical takeoff and landing and a generally straight-line flight path controlled using GPS data and specialized software coupled via fly-by-wire means with the actuators of the aircraft's functional apparatuses, there really isn't much for the pilot to do anymore. Also, the pilot's cockpit and console, needing windows and implements in prescribed areas, put design and material constraints on the front of the aircraft that should be done away with to allow for more radical aircraft configurations, which will be needed to allow the aircraft to attain its maximum potential. Also, in a 5-, 12-, or 20-minute flight, passengers should willingly forgo hospitality and ergonomic accommodations.

Another accessory is the additional fuel that passenger aircraft are required to carry (and the fuel tanks that hold it and the extra airframe mass to hold the tanks) for unforeseen events, such as the inability to land at the desired airport or the rare need to be put into a very long holding pattern at the desired airport. If vertical landing is available, this auxiliary mass can be forgone outright, bringing us closer to the goal of 50% mass reduction mentioned above.

The applicant will include in the accessories the elements associated with fossil fuel engines, such as shafts, disks, runners, bearings, stator vanes, fuel lines and injectors, lubrication and cooling arrangements, starter motors, pumps, sensors, etc. A small aircraft probably carries around no less than 1,000 pounds per engine (ballpark around 1 pound of weight for 3-4 lb of takeoff thrust) of these accessories whose job is to facilitate the spinning of the fan blades and the combustion. An electrical system, if made to be air-cooled, will have almost the entirety of its mass made up by its magnets. Although a lot of magnets will be needed for the power desired of the fans in the present application, it is hoped for that they will not weigh nearly the aforementioned 1,000 pounds per fan module.

Life Support—at very high altitudes the aircraft might as well be in space, since we can consider the barometric pressure and oxygen presence to be effectively zero. So, the fuselage will have to be constructed according to the engineering specifications being used for modern passenger space flight. This is well outside the Applicant's expertise and so it will not be discussed within this application. However, since it has been and is being done successfully by multiple entities in the world, there is no reason to believe the concepts being used are not amenable to adaptation for use in the present application and the aircraft embodiments proposed herein.

### VI. Noise and Shock Waves (6^{th} Primary Impediment to Supersonic Flight)

Noise is a problem for supersonic aircraft. Noise (sonic boom) should not be a problem if the wings are properly designed and the nose cone is obviated via a nose-replacing frontally throated impeller system intake that spans the frontal cross-section of the fuselage, such that there is no nose cone. “Experienced” noise (that which is heard by communities on the ground) can be specifically eliminated if all of the curved surfaces of the aircraft are facing vertically upward (to outer space) and all of the surfaces that face down are completely flat. Especially so if the high-speed flight takes place only at extremely high altitudes. Although the explanations for this are not self-evident, they cannot be gone into detail here. Simply said, if there are no curved surfaces that have a downward-facing convex portion, there should be no sonic wave in the downward direction. Applicant intends to provide an aircraft with no convex surfaces that face downwardly toward the earth. Any sonic boom, when it occurs, will hopefully only be directed up into space.

Like the discussions of heat problems for supersonic flight and life support for high-altitude flight above, the Applicant cannot discuss shock waves as they are not understood by him. These three issues are the domain of an array of other types of specializing engineers and the Applicant's specialization is basically limited to the technologies proposed herein. So, since the Applicant does not understand the phenomenon of shock, this application will not attempt to describe it theoretically or summarize the history of how engineers have addressed it as a problem. However, they have addressed it, so the Applicant will leave this to them, and hope that if there are shock problems with the prototype proposed in the detailed description (and of course there will be), they will solve them in due course.

In light of all of the foregoing and the preponderance of major obstacles, the Applicant believes a completely revolutionary approach is necessary to advance in any meaningful way past the plateau the industry seems to be stuck in. Although there are some major issues left unresolved in this patent application, and surely there are (as there always are for something completely new) myriad unforeseen issues, major and minor, that can be pointed out by other practitioners in the various arts, and others that will result from any attempt to construct the proposed invention, the Applicant presents the following invention as an opportunity to start from scratch, so to speak, and open up a whole new lane for research and development toward sustained supersonic passenger air travel. He cannot guarantee that it will work, and it's possible the first prototypes might not work very well, but he believes his solution has the potential to surpass the capabilities (top speeds, energy efficiency, range, costliness, etc.) of what is out there within a handful of years, if someone were to give it a real chance and try to make it, or at least model it.

### SUMMARY OF THE INVENTION

### Brief Summary of the Invention

The following is a brief summary of the invention, wherein the aircraft and its sequence of operations and states will be described as succinctly as possible. After the brief summary is an expanded summary of invention, wherein the details of the best modes, as well as the enablement and industrial applicability propositions, will be established in greater detail.

Proposed is an aircraft consisting of an elongated fuselage with bilaterally opposed cantilevered wings and a rear empennage. In a simplest embodiment the aircraft contains two longitudinal rows of seats for the passengers, who sit side-by-side in a cabin portion of the fuselage. The front of the aircraft is open to the incoming air, forming a large duct that serves as the intake for an impeller system. There is no nose cone. The impeller system comprises a 1^{st} impeller module in front of the cabin portion and a 2^{nd} impeller module behind the cabin portion. The 1^{st} impeller module comprises two parallel sets of fans, each set spinning in a rotational direction opposite to the other set. Each set of fans comprises a 1^{st} diagonal fan and a 2^{nd} diagonal fan, in series, such that the 1^{st} feeds air to the 2^{nd}. The fans are diagonal fans modeled on diagonal (otherwise known as mixed-flow) compressors that are known in the art. Each set of the 1^{st} impeller module's parallel sets of fans resides directly in front of and is coaxial with one of the rows of passengers. The exhaust streams from the two sets of fans leave their respective fan sets in opposite tangential directions (the left side is spinning in a clockwise direction and the right side is spinning in a counterclockwise direction) and these streams converge to form a single 1^{st} impeller module exhaust that now enters a duct system. Instantly upon arriving at said duct system the exhaust is bent toward the rear direction and then it passes along the center of the bottom of the aircraft, below the inboard elbows/forearms of the passengers. The use of dual series fans (2 for each set) allows the air to be accelerated to a high-enough speed that the cross-sectional area required for the flow is greatly (such as ⅛) reduced from the cross-sectional area of the impeller system intake.

The 1^{st} impeller module exhaust in the duct system represents all the air that entered the front of the aircraft. When it has arrived at a point behind the cabin it is redirected upwardly or outwardly a little and then straight downwardly to enter the 2^{nd} impeller module (or it is redirected in other ways, for example see the preferred embodiments of FIGS. 5C-5E). The 2^{nd} impeller module consists of two centrifugal fans, one stacked on top of the other, and the top one spinning in a rotational direction opposite to the bottom one. The inlets to the centrifugal fans are constructed such that an equal amount of air coming from the duct system enters each fan, half of the air having gone past the top centrifugal fan to reach the inlet of the bottom one (again, see the preferred embodiments of FIGS. 5C-5E). The centrifugal fans are not expected to be very different from a typical centrifugal fan, except their vanes are swept forward (i.e. flingers) at the outer radiuses such that the exhaust from them is extremely fast and tangential, and in the preferred embodiment they could have a less-conventional intake. At this point it is ejected out the back of the aircraft using a specialized volute system. Since each centrifugal fan spins in an opposite direction, each has its exhaust branched away from the volute system on opposite sides of the aircraft. The right-rear of the aircraft has a duct for ejecting the right-side exhaust from the top centrifugal fan, and the left-rear of the aircraft has an identical (except that one must slope down further to reach, and lie along, the bottom of the aircraft) duct for ejecting the left-side exhaust from the bottom centrifugal fan. Since the incoming air to the centrifugal fans has already been accelerated by two series diagonal fans whose speed ratios are each around (for example, this varies during a flight cycle) 4:1, the centrifugal fans must spin at super-high rotational speeds and the air will be ejected at even higher speeds than the fans' tangential velocity (centrifugal forces will constantly push the air through the flingers with some nozzle effect), which results in extremely high thrust.

The entire impeller system is electric, powered by rechargeable batteries that are preferably but not necessarily housed in removable wings that can be swapped out for fresh batteries at every stop/port and put on recharging racks. Certain machines (i.e. specialized lift-trucks or hoists) will facilitate the battery swapping.

As mentioned, the impeller system is electric. There is no combustion anywhere. All of the fans of both impeller modules are preferably unitary (monolithic) elements, self-contained with their respective motors such that each's body, with vanes internal, is affixed directly to and locked for rotation with a rotor that contains electrical coils. The rotors are annular and can be on the bottom or top of the peripheries of the centrifugal fans and radially within/inside the diagonal fans. Since the rotors are annular, they can spin freely in a no-contact manner between inner and outer annular stators that contain annular arrays of magnets. Each of the annular arrays of magnets (inner and outer) is configured in a Halbach array such that the magnetic flux of the inner stator magnets is lensed outward toward the rotors and the magnetic flux of the outer stator magnets is lensed inward toward the rotors. This means that when the rotor coils are excited, they will experience an electromotive force in a tangential direction that is twice as powerful as a regular Halbach system of this type but which regular system has only one annular array of magnets. Although this nearly doubles the amount of magnets required, and magnets are heavy, the double-Halbach configuration proposed herein, by nearly doubling the power, means that less overall mass will be used to generate a given amount of power, because less structure will be needed and this is important because we are trying to tuck and squeeze the motors into small spaces.

The fans and their rotors do not touch anything, thus allowing them to be driven at any speed without resistance, wear, etc. The centrifugal fans of the 2^{nd} impeller module are electromagnetically suspended by electromagnetic thrust bearings. The bottoms of the centrifugal fans comprise a coil array that is electrified by the same electrical source as the rotor coils, and beneath each coil array is a corresponding magnet array that is preferably configured in the Halbach manner. The rotors and coil arrays are electrified in the brushless DC manner. Typically one brushless DC interface will be used to pass the electricity into all of the coils of a single fan.

An electromagnetic thrust bearing is not possible to suspend the 1^{st} impeller module fans, although one will be used to constrain its longitudinal pull in both directions, when necessary.

To levitate the fans of the 1^{st} impeller module, either a) dedicated coils in the upper and lower sectors of the rotors can be phased to provide radial pushing and pulling instead of torquing, or preferably b) the controller will phase-shift certain of, or all of, the coils as required to keep the gap between all stators and rotors constant at all times. The latter is preferred because the aircraft will not always be horizontal.

Thus, the fans have no mechanical interface with stationary structures. There will be no bearings, shafts, lubrication, starter-motor, etc., and this reduces the wear, complexity, mass, volume consumed, and cost of manufacture. More importantly, all this means that all the fans can all be torqued at maximum power and since they experience no friction the only constraint to how fast they will spin is the work being performed by them. So, inside the 1^{st} impeller module, for each set of dual series diagonal fans, the 2^{nd} diagonal fan can spin at a range averaging, although not often instantaneously exactly, about twice the rotational rate of the 1^{st} diagonal fan. This is mandatory, because if the 2^{nd} diagonal fan spins at a similar rate to the 1^{st} diagonal fan, it will not do useful work. If it spins at a more than twice the rate of the 1^{st} diagonal fan while having the same mass of magnets as the 1^{st} diagonal fan, it violates the conservation of work equations. Once fully torqued by EMF, the fans should find an equilibrium that is optimal for most situations, but of course the controller (main CPU) could vary the relationship of power delivered to the 1^{st} and 2^{nd} diagonal fans to achieve ends unforeseen as necessary at this time.

The 2^{nd} impeller module's centrifugal fans are completely decoupled from those of the 1^{st} impeller module, such that they will always be driven at a rate required to produce an exact amount of thrust deemed advantageous at any point in a flight. Meanwhile, the 1^{st} impeller module can deal with and do work on the incoming air in a way that is not directly related to the activity of the 2^{nd} impeller module. It is inherently inevitable that during a typical sequence of changes in speed and altitude (a flight), this will conserve battery life and possibly provide leverage toward unexpected combinations that result in augmented thrust at certain altitudes. The relationship of the 1^{st} impeller module to the 2^{nd} impeller module is analogous to the relationship of a supercharger to an engine, although in this instance the 1^{st} impeller module will carry a larger proportion of the workload than a supercharger would in an automobile. Importantly, the 1^{st} impeller module primes the 2^{nd} impeller module. If the 2^{nd} impeller module just sucked in ambient air, it would spend a lot of its work creating the vacuum required to pull in the air. But with the 1^{st} impeller module constantly priming it with air that might be traveling anywhere between 800 and 2,000 mph, all of the work performed by the 2^{nd} impeller module can be used to further accelerate the air to anywhere between 2,000 and 4,000 mph (or higher, once the industry has caught onto the idea and improved it in future iterations).

The aircraft can take off and land vertically (VTOL) using a system of flaps and valves that will be discussed in great detail later in the application. This system has been thoroughly developed hereinbelow such that the Applicant is confident that all of the things that used to be needed for runway takeoff and landing can be completely omitted, including pilot, pilot cabin, hydraulics, landing gear, extra contingency fuel, etc., while a standard flight will be point-to-point (a straight line with no runway-approaches or post-takeoff redirections). This reduces mass, complexity, and volume greatly, and in turn increases the thrust-to-weight ratio, which makes doing VTOL much easier, while shortening flight time and flight distance. The VTOL system avails of the fact that there are impeller modules at both the front and rear of the aircraft. Most of the time the 1^{st} impeller module feeds air to the 2^{nd} impeller module and the latter's thrust is ejected rearwardly. But once the VTOL flaps and valves have been activated to their respective VTOL positions, the 1^{st} impeller module ejects its air downward and so does the 2^{nd} impeller module. Also described later are transition phases wherein the aircraft goes from vertical thrust to horizontal thrust and vice versa.

Preferably each of the fan-sets of the 1^{st} impeller module has a swirler in front of it to pre-swirl the intake air in the same rotational direction the fan-set is spinning. We are accelerating air here, and not trying to pressurize it, so instead of allowing each of the diagonal fans to absorb the brunt of the intake air and using them to swirl it which adds to their duties, this burden has been separated from the impeller system and implemented by a stator element that performs this work for the 1^{st} impeller module, which work will result in a major increase in the rotational rates of the diagonal fans, leading to added thrust for the aircraft, which will drive the swirler into the incoming air, in turn offsetting the work done by the swirler. The swirler serves an additional purpose at supersonic airspeeds; as it spins the air coming into the fan sets in the same rotational directions as the leading edges of the vanes of the 1^{st} impeller module are spinning, it reduces the velocity of the intake air relative to the leading edges, allowing for a smoother flow there and lower impact of air on the tips of the leading edges. The swirler is used in lieu of an intake ramp because, as mentioned, we don't want to pressurize the air, we just want to accelerate it.

The aircraft should be provided with enough total magnets of adequate power to provide a thrust-to-weight ratio of at least 1.3:1 or preferably 1.5:1. If this is dictated as a design imperative, then the aircraft if we extrapolate the effects of this mandate (either before takeoff or shortly thereafter) can thereby be tilted up to point more or less straight upward at the sky and driven constantly at near-maximum load/power. It then accomplishes an uninterrupted climb for 1-2 minutes while the nose is actively pushed steadily downward (to offset lift which will increase as airspeed increases) to keep the trajectory along the vertical. At some point the nose is pushed over/down even harder (by thrust vectoring and using a stabilator) and the flight path is bent from vertical to horizontal. During all of this, the aircraft is always accelerating because, as mentioned, the thrust-to-weight ratio is at least 3:2 (1.5-to-1). Aimed upward, gravity is pulling it downward at 9.8 m/s or 22 mph/s. So, we are giving it enough thrust to give it an acceleration of at least 33 mph/s minus gravity. This means it will accelerate at 11 mph/s while pointed straight up (33−22=11, but we will use 10 mph/s because it is easier) so that after 80 seconds it will be traveling at least 800 mph which is higher than the speed of sound. By this point the aircraft will approaching 50,000 feet in the air and the push-over-toward-horizontal period will gain the aircraft another (guesstimate) 10,000-20,000 feet and as it levels out the longitudinal acceleration constantly increases such that by 100 seconds and at 63,000 feet it is now accelerating at the full 33 mph/s (we'll use 30 mph/s in this application) such that within another minute it is approaching 3,000 mph, with 3 minutes of flight time lapsed and 3 minutes of full-power battery minutes consumed. While performing the last part just mentioned, the aircraft will naturally climb to the elevation that suits whatever airspeed is desired to travel at. Since lift and lift-induced drag are proportional to velocity squared and also to air density, what it means to travel at 3,000 mph and let the velocity-squared factor “find” a ceiling altitude is that all of the cruising that will now take place will do so in a hyper-rare environment where all of the drags (except lift-induced drag) are suppressed to near nil (especially since the aircraft does not displace air, having an open-throated nose). Lift-induced drag still exists as a significant drag but since the flight duration will be very short, it will not contribute much in total. Because of all of this, almost all of the battery power consumed (3 “full-power battery minutes”) during the first 3 minutes of a typical flight is used to increase the potential and kinetic energy of the aircraft.

The controller will now reduce power to an amount that uses, for example, ¼ full-power battery minutes per minute, because the aircraft doesn't need any more energy. It only needs to provide enough power to offset lift-induced drag and the much-suppressed other drags. When the aircraft gets to within 50-100 miles of its destination, it does everything it can to completely power down (although possibly not feasible) and glide to its destination. At some point while approaching the destination, flaperons and the stabilator will pitch in opposite directions to augment lift and help brake the aircraft. When the aircraft gets to the landing zone, thrust reversers are activated and the vertical downward thrust is again achieved by deflecting downward the 1^{st} impeller module's exhaust and separately and simultaneously deflecting downward the 2^{nd} impeller module's exhaust, in a controlled descent, until the aircraft touches down. The flaperons, stabilator, thrust reversers, etc., will be discussed in greater detail later in the application. At the end of cruise, the swirler outlet could be opened up to the environment to eject air laterally, in order to use the swirler as a brake, but the Applicant has not really figured out yet how to slow down the aircraft while it descends from the highest altitude, and only offers this as a placeholder to at least show we aren't without options here. Although it would be preferred to not actively brake the aircraft until the last few seconds of the flight, such as by using the thrust reversers (all good options seem to suck battery power), there is a problem here in that the aircraft, following the cruise portion of the flight and entering the descent portion of the flight, is going too fast and stopping the impeller system might be destructive, while keeping it going would (in addition to sucking battery power anyway) allow the aircraft to accelerate, instead of decelerate, as it trades altitude for airspeed (if a regular airplane idles the engines during descent, the aircraft slows down and drops, which is fine, but the proposed aircraft would encounter lower altitudes still going too fast, which is very dangerous).

When discussing a flight in terms of battery minutes, it is helpful and entertaining to realize that the first 3 minutes of maximum power consume 3 full-power battery minutes, while the next 12 minutes of cruise also consume 3 full-power battery minutes, and if we reserve 1 or 2 battery minutes for landing and contingencies, we only need 8 battery minutes' worth of total batteries for a whole flight. This is because during those 12 minutes of cruise the aircraft has gone (3,000 mph=50 mi/min) no less than 600 miles, and when the impeller modules shut off for the glide-down, the aircraft has enough energy to go possibly another 100 miles, during descent, without consuming any more battery. Also, it probably traverses about 30-50 geographical miles while getting to cruise at the beginning. In short, it is possible to envision a scenario where 8 battery minutes' worth of full-power battery life can accomplish over 700 geographical miles. Meanwhile 9 battery minutes' worth can accomplish 900 miles, 10 battery minutes' worth accomplishes 1,100 miles, etc. How many battery-minutes' worth of batteries can be put into the wings while maintaining the 3:2 thrust-to-weight ratio is a very important factor, and the Applicant does not have the resources to calculate this. Hopefully it is (for the prototype) at least 7 or more, but if it is only 2 or 4 this will be disappointing but it would then be hoped-for that improvements could be made by future engineers to minimize battery weight or maximize battery power, and minimize aircraft mass, such that we can have the hope of at least performing medium-range flights without severe interventions (booster batteries, launch systems, etc.). Also in the event that this 2-4 scenario is the truth, we might have to be content with transporting less people at a time. However, it might turn out that we can fit 12 or more battery minutes' worth of batteries into the wings (and also within the fuselage, if desired) without the thrust-to-weight ratio dropping below 3:2. If this is the case, the possibilities this invention opens up for the future might be quite astonishing once applied and perfected. Unfortunately it requires modeling and perhaps some early prototyping to determine this factor, and the Applicant cannot offer any evidence, either pessimistic or optimistic. However, the Applicant has become aware of practicable small electrical 2-passenger aircrafts that can VTOL and travel 240 miles on a single charge in about one hour. Taken as an optimistic boundary value (for a hypothetical battery-mass-to-aircraft-mass ratio), this should indicate that we can hope for significant flight times (12-20 minutes at 3 times the voltage of the example) and very significant flight distances of perhaps over 1,000 miles in the future.

### EXPANDED SUMMARY OF THE INVENTION

This expanded summary of invention is layered, complicated, and full of esoteric language. The Examiner or other reader is earnestly advised to look at the drawings and read the detailed description, or at least skim over it, before endeavoring to assess the expanded summary of invention that follows.

The current invention is an attempt to wholly obviate the prior-art aeronautical solutions by using a novel configuration of known and novel mechanical devices to overcome the primary impediments to supersonic flight using mechanical engineering principles instead of aeronautical engineering principles. It is foreseen by the applicant that the new device will obviously require new aeronautical engineering advancements, after the fact, to make a more perfect and improvable aircraft.

As such, the new rearrangement of the parts of an aircraft and the novel parts used to achieve the new rearrangement of parts are a mechanical solution to the entire array of impediments in one shot, and this application proffers an outline of a supersonic-capable prototype, which can in turn be tested and improved upon, to increase the top speed via subsequent iterations (and thereby its desirability and efficiency). The field of aeronautical engineering will have to “complete the equation” and solve myriad consequential problems associated with the proposed design/prototype, because what is proposed herein is so novel.

To realize the benefits of such an aircraft, the first discussion presented herein is one of markedly reducing all types of drag. Many statements that follow include a comparison with a fossil fuel engine propelling a standard passenger aircraft. A key term used herein is “flight”, and it describes the period between takeoff of the aircraft and the landing of the aircraft several minutes later.

### Form Drag

1) Form drag will be drastically reduced by making the forward-facing nose of the aircraft the actual intake of the impeller system. In short, the majority of the front of the aircraft should be an impeller intake duct. This makes the system more like a “flying tube” wherein a theoretical model of the aircraft (sans wings and empennage) represents an elongated tube/duct whose front feeds an internal impeller and whose rear ejects the impeller's exhaust. This obviates a nose cone, consequently reducing skin drag and mass of the aircraft while almost eliminating form drag since the aircraft no longer outwardly displaces air. It is believed by the Applicant that form drag is proportional to air displacement which is equivalent to the diameter of the fuselage—the incoming air gets pushed outward by the nose of a typical aircraft, and the force required to perform this adds up to work and, therefore, wasted energy, whose quantity should track with the energy lost to form drag in the standard aeronautical equations/models. Thus, if the air impinging the front of the aircraft simply passes through it, there will be, importantly, no air displacement around the fuselage. The eradication of air displacement around the fuselage renders the velocity-squared component of form drag practically negligible. These last several sentences are just various ways of mentally modeling the way the open-throated “flying tube” model should nearly eliminate most form drag.

### Engine Drag

2) Engine drag (described earlier in the background summary) is drastically reduced by the replacement of fossil fuel engines with an electrical impeller system that almost constantly accelerates the intake air inside of it without touching many of the air molecules, unlike what is the case for prior art fueled engines that shove into the intake air a huge number of small three-dimensional spinning rotor vanes and small three-dimensional non-spinning stator vanes while previously (upstream) purposefully slowing the air down to such a low relative air velocity that the air can then be combusted at a proper pressure and without being snuffed out by its own velocity, at which point the combustion products and air are allowed (as in they are free, there being no active push on them) to expand rearwardly for thrust.

If all of the incoming air, from the aircraft's reference frame, is to be handled via electrically powered impellers, then the air should and can be “worked on” throughout as much of the traversal distance it spends within the aircraft as possible. Thus it is roughly proposed in this current discussion that the air be preferably worked on through/along at least 60 inches (longitudinal inches as perceived by the air traveling through) of fan/blower/compressor elements (compared with 5-15 inches for the first stage or first and second stages of the compressor/fan of a turbojet); for example, at least 12 inches through a 1^{st} diagonal fan stage, at least 12 inches through a 2^{nd} diagonal fan stage, and at least 30 inches through a centrifugal stage. Provided a requisite mass of magnets for the fans to use for EMF, and also magnetic levitation for the fans to enable them to spin at any speed that is optimal for any certain stage of a flight, this is merely a matter of acquiring, assembling, and supporting enough magnets for the fans to use for electromotive force (via coils) and self-levitation.

Although drag has been discussed as the 1^{st} primary impediment to supersonic flight, all the solutions proposed in this portion of the disclosure to reduce drag are contingent upon the combustion (2^{nd}) impediment to supersonic flight. An impeller system is required that is an alternative to the known types of combustion engine, especially for the reasons that the proposed system as a whole requires a very specific attribute; namely, it must be able to provide accelerative thrust at all airspeeds (except top speed) and at all altitudes. We will return to this.

### Skin Drag

3) Skin drag will be drastically reduced by performing a majority of the flight, and almost all of the high-airspeed flight, at very high altitude. Vertical takeoff at low airspeed into a fully vertical climb, or even such a vertical climb after a regular runway takeoff, at moderate initial airspeed while continuously accelerating, can take the aircraft up to elevations where skin drag approaches a miniscule quantity per mile traveled, and can do so within a few initial climb minutes, where after a transitional point the aircraft can push over to the horizontal direction and after said transition point the vast majority of horizontal travel is commenced and accomplished, resulting in a severe minimization of the low-altitude travel that typically contributes to the overall skin drag losses and heat stresses of a typical flight. If the aircraft climbs straight upwardly early in the flight with constantly increasing speed and if the acceleration to high airspeed and thus high altitude is brief, the skin drag component of parasitic energy loss begins to appear nearly negligible for the subsequent, horizontal portion of the flight, and thereby for the entire flight since the aircraft revels in high-altitude flight and gets there as fast as possible.

### Lift-Induced Drag

4) Lift-induced drag is reduced (as is lift itself) to a very small cumulative factor, per flight, because the aircraft spends so little total time actually experiencing or inducing lift during a single flight. This was described in the background summary, if the reader wishes to understand the theory better, and it will not be completely rehashed here. In short, although the lift-induced drag is proportional to the square of the airspeed (an extremely high scalar quantity indeed at very high airspeeds at low altitude but not so much at very high altitude), it is nearly negated by the super-low air density/pressure the ambient air will be at as the aircraft continually “finds” the altitude whose air density/pressure provides the required lift (as an upward force basically equal to the weight of the aircraft) for a given airspeed. For instance, at 3,000 mph airspeed and at sea level, the lift would be 100 times the lift that it is at 300 mph (which has elsewhere been proposed as the sea-level airspeed this aircraft should be designed for), and so would be the lift-induced drag. So, the aircraft won't reside at such an altitude or any altitude near it and will simply find itself at an equilibrium point, where at its (tentatively proposed) instantaneous velocity of 3,000 mph its surrounding/passing air will be at a factor (such as air density or air pressure) that is 1/30 of what it would be at sea level, which equilibrium it could find at around 85,000 feet above sea level. Applicant is unsure whether he has actually estimated the proper altitude for such flight at such speed in this paragraph, however he hopes that this paragraph is instructive for establishing the theory, which is not new and is one of the basic tenets of aeronautical engineering. However, as the proposed invention and the claims proposed herein might be wont to stretch the credulity of a reader, some basis for arriving at the speeds and altitudes (and ambient conditions) proposed herein needed to be solidly founded before moving on. In other words and for reasons not explained, these numbers could all be wrong. They still provide some arbitrary basis and boundary-value scalars for us to work with while we mentally imagine the aircraft experiencing the lift and lift-induced drag.

### Wave Drag

5) Wave drag should inherently be reduced by the structural minimizations of form drag and overall volume and complexity of the proposed aircraft, and the wave-drag problems associated with the wings are assumed to have been worked-out and solved by the aeronautical industry during the 1960-'s and 1970's when various companies around the world were manufacturing interceptor aircraft, or even lately as there are various state-of-the-art attempts being made for high-altitude supersonic passenger flight. Still, the wings and fuselage contribute to wave drag. Nonetheless, it is hoped for by the Applicant at the time of filing that aeronautical engineers can design simple or not-so-simple wings that attain the requisite lift and drag capabilities of the proposed device, at the respective altitudes, while minimizing the wave drag. It is also hoped-for by the Applicant at the time of filing that the proposed invention is not overly plagued by wave drag concerns, and it seems to him that this is not an unadvised hope, since the proposed aircraft is so simple in nature and in outward morphology.

### Turbojet Unusefulness (an Aside)

The turbojet, to state it bluntly, maxes out at a relatively low speed without an afterburner, and at a relatively moderate speed with an afterburner excepting exotic examples. However, it should never be considered to use an afterburner for a small or moderately-sized passenger aircraft because the fuel consumption rate would be unconscionable. So too would be the cost of operation and the structural difficulties of implementing such type of device within or on a real vessel. The afterburner will therefore soon be no longer part of the discussion.

Although faster than turbofan engines, non-afterburner turbojet options provide insufficient thrust and too many constraints to accomplish the airspeeds necessary for operating a high-supersonic aircraft such as that proposed herein. Also, as discussed in the background summary, they are inordinately complex, problematic (shock effects), and expensive to manufacture and operate. They are not an attractive option so far. Nor are the solutions that use an afterburner, because of the latter's gluttonous consumption of fuel.

The fatal flaw for the turbojet, however, is that it cannot provide on-demand thrust in every situation, because it requires the incoming ambient oxygen to power itself. Variations in air density and throughput, dependent on altitude and airspeed, will predictably although not controllably or often favorably determine the amount of available oxygen into/through the engine. The engine ultimately has to deal with the air it finds itself operating in (having no other source of oxidant) in all situations and eject it as combustion products and bypass/afterburner flow at a velocity greater than the aircraft's airspeed. The ambient air has for all intents and purposes been nearly stopped or greatly slowed (relative to the supersonic airspeed) prior to combustion(s), and if the aircraft is going Mach 3, there is just no reasonable way for the combustion products to expand themselves (the application is including in the “combustion products” only for this paragraph the products of afterburner combustion in addition to the combustion products of the combustor) up to Mach 3.2-3.5, which would be necessitated to accelerate the aircraft from Mach 3 to a higher airspeed. This can be extrapolated up and down to other airspeeds. There is always, when dealing with the turbojet engine, the irremediable conundrum that the combustion products (combustor and afterburner) have to accelerate themselves via their own pressure. There is no way in the GTE-based arts to positively or actively accelerate the combustion products or the intake air (such as pushing them/it or flinging them/it). Also, the turbine blades are relentlessly decelerating much of the combustion product (of the combustor). Of course bypass flow from the first few compressor stages can be added to the nozzled thrust as an annularly enveloping stream and also as an offering to the afterburner, but the first few compressor stages are too short, being axial stages, to do significant work on the air, and the afterburner remains a passive actor, and this means it must inherently be extremely wasteful. The known performance data for afterburners bears this out. Applicant would not be surprised if an afterburner spent more than 30% of its chemical energy in a longitudinally rearward zone beyond the longitudinally rearward point where a fuel molecule would have given more than 70% of its energy to useful thrust. And any mechanical engineer can see that most of the heat energy is completely wasted. The afterburner is an abomination. Yet it remains tempting, in a technological world that lacks the options provided in this application, and for this reason some entities seem prepared to try to use it. They might succeed momentarily, at great cost (especially fuel cost to the consumer and cost to the environment) but if this application has any impact at all on the world, they will find themselves entirely broadsided and superseded.

Due to the deficiencies of the turbojet with afterburner, and mainly its inability to positively/actively accelerate the combustion products from low (even during high-speed flight) to very high speeds by using any known mechanical system, and the fact that there is no known energy-efficient fossil-fuel engine that serves the purposes of achieving the high speeds that are the desideratum of the present application while also providing high thrust at low airspeeds, a new impeller system has been developed and discussion of it follows.

### Battery Powered Electrical Impeller System

The proposed impeller system is an electrically powered one. It will be driven by powered rotor coils spinning between magnetic stator arrays. The rotor coils will be powered, i.e. in a brushless DC manner, by batteries.

The usual drawback to a battery-powered electrical impeller system is that its range is limited by the amount of battery life its batteries can hold. The applicant will argue, here and later, that there is no significant obstacle/drawback as concerns the power availability. Provided the novel impeller system proposed herein, the applicant asserts that the power requirements will be met by calculating the required max acceleration/thrust, and simply providing enough magnets and coils to spin the impeller systems' modules at sufficient rotational velocities to provide said required acceleration/thrust.

As for the range (battery life) drawback, the Applicant will try to show that a moderate amount of battery mass can complete a single flight of a considerable distance that would be attractive to passengers. This will be done not by installing thousands and thousands of pounds of batteries, but by reducing to an extreme minimum the accessories (non-passenger discretionary mass) and the drag impediments (hopefully all five) such that the aircraft accelerates extremely quickly (in a few minutes or less) to extremely high speed and altitude, during a fit of full-battery consumption rate, before transitioning into a cruise portion of the flight, representing approximately one-quarter full-power battery consumption per minute. Utilizing extremely high cruise speed, a mere 12-24 minutes of cruise carries the aircraft a very great distance (600-1,200 miles), using only 3-6 battery-minutes, respectively, of stored power (for cruise only we are talking here). The point of all this is to get from one city or zone to another city or zone considerably far away, on only 8-10 minutes of total battery charge. This will, of course, require super-high-voltage batteries, which will not be discussed herein, but which will have traded off longevity for voltage (by being super-high voltage, they won't last very long). Also, a modicum or more of battery life must be conserved for descent/approach and landing and another modicum for emergencies. The range drawback should be overcome once the impeller system has been expounded to the satisfaction of the practitioners of the art, and it is the mission of the rest of the application to do this. There hopefully should be little argument that this aircraft is incapable of carrying 9-10 minutes' worth of full-power battery life, and anecdotal proof supporting this hope, or at least a baseline for reaching such a proof, has been laid out elsewhere within this application.

So, in order to meet the mandates put forth in the several paragraphs (because any one achievement requires all of the others), the impeller system will now be described.

### 1^{st} Impeller Module

The proposed electrical impeller system comprises a 1^{st} impeller module and a 2^{nd} impeller module. The 1^{st} impeller module takes in ambient air as the ambient air enters an impeller system intake (the open-throated front ducting of the aircraft whose air capture feeds the 1^{st} impeller module and the 2^{nd} impeller module and everything that connects them and is associated with them) at the front of the aircraft (or at the front or leading edge of an element of an aircraft, in certain scenarios). The 1^{st} impeller module comprises at least one diagonal fan that accelerates the ambient air to a high speed which manifests itself in a mostly tangential component but also with an extant, fractional axial component. The at least one 1^{st} diagonal fan is driven by a rotor coil set that is integrated with its internal diameter. The rotor coil set is annular and faces on its inner diameter an inner annular magnetic stator array of Halbach-effect-configured rare earth magnetic cubes, and it faces on its outer diameter another, outer annular magnetic stator array of Halbach-effect-configured rare earth magnetic cubes. The Halbach effect/phenomenon and possible configurations for optimally harnessing said Halbach effect will be described subsequently in this application. The main thing about it is that the Halbach effect will focus the magnetic flux of the inner and outer annular magnetic stator arrays onto the annular rotor coils spinning in the annular slot between them, such that magnetic flux will not meaningfully leak in any non-useful vector/field away from the volumes populated by the rotor coil sets, at which latter location the magnetic flux is useful for work. This allows the use of less magnets. Using less magnets reduces the overall mass of the aircraft.

A concentric pair of air gaps is actively (preferably electromagnetically via CPU-based control schemata) maintained between the rotor coil set and the respective annular magnetic stator arrays, and the rotor coil set is integrally united, as mentioned previously, to the inner diameter of the at least one diagonal fan. This diagonal fan is modeled on what is known in the art as a diagonal compressor. The difference between a diagonal fan (very few examples exist in the prior art using this term) and a diagonal (or mixed-flow) compressor is that the air exiting the at least one diagonal fan is not slowed in the exit (exhaust volute) to pressurize it for later use/expansion as is done downstream of most prior-art diagonal compressors. Instead, the air is loosely entrained by an intermediate passage and simply passed downstream to a second diagonal fan stage or other stage/mechanism and thereby through the impeller system at parabolically higher velocities whose overall power depends upon the quantity of stages (diagonal and centrifugal, see later discussions).

In the preferred embodiment, although not necessarily, the first impeller module includes a 2^{nd} diagonal fan. The 2^{nd} diagonal fan is similar to the 1^{st} diagonal fan but its vane and housing geometries will vary somewhat from the former's because it operates at different rotational velocities and on a narrower annulus of air. The 1^{st} diagonal fan of the first impeller module ejects the air tangentially (around the perimeter) as well as axially (toward the rear). The 2^{nd} diagonal fan ejects its air almost completely tangentially. The 2^{nd} diagonal fan has a narrower cross-section than the 1^{st} diagonal fan because the air flow velocity through it will be much higher, for reasons known to practitioners in the art. It is noted, and it will be described later many times in this application, that the vanes of the 1^{st} impeller module will be swept forward at their trailing edges such that their exhaust will be more tangential than if they were straight like for instance the structure shown in FIG. 19A. A good understanding of how the 1^{st} diagonal fans will have their vane trailing edges swept forward can be gleaned from FIGS. 5B and 5E, which show a profile for a preferred centrifugal fan vane but whose profile serves relatively well for a (looking radially inwardly on a diagonal fan) diagonal fan vane of the 1^{st} impeller module. Referring to the latter FIGS. 5B and 5E), interstitial vanes could also be used for the diagonal fans of the 1st impeller module. It is likely that the trailing edges of the 2^{nd} diagonal fan will preferably be swept forward more than the trailing edges of the 1^{st} diagonal fan, but this is only speculation. There are reasons for saying this, but they are also just gut instincts, i.e. more-or-less speculation. Let's move on.

The 2^{nd} diagonal fan rotates at a 2^{nd} fan rotational velocity much higher than a 1^{st} fan rotational velocity. The leading edges of the vanes of the 2^{nd} diagonal fan cut into the incoming air, which is the swirling exhaust of the 1^{st} diagonal fan, in the same rotational direction as the swirl (tangential component) of the 1^{st} diagonal fan exhaust, which is the same direction as the rotation of the 1^{st} diagonal fan. But, it is spinning approximately 2 (or more, or less) times as fast as the 1^{st} diagonal fan (the speed ratios will actually vary widely during a typical flight cycle), such that the exit velocity of the 2^{nd} diagonal fan exhaust is approximately 2 (or somewhat more or somewhat less) times the exit velocity of the 1^{st} diagonal fan exhaust, which is itself an indirect function of the relative velocity of the ambient air coming into the impeller system intake, which is the aircraft's airspeed.

However, even though this gives us a 2^{nd} diagonal fan exhaust velocity of about 8 times the aircraft's airspeed (during moderately-low airspeed and at low altitude, i.e. 300-500 mph—again, the ratios will vary greatly), we are not going to use it to create thrust. We could, but we have other uses for it. It should be said here that obviously there is indeed the option of using the 1st impeller module and providing thrust using only the 1^{st} impeller module, and skipping the steps that are too follow. The Applicant believes that this would be shortsighted and doing so would forgo too many advantages, described below, to be considered positively. However, this alternative embodiment has now on the record as having been considered by one of ordinary skill in the art.

Using a first impeller module with a series-flow dual diagonal fan combination produces a super-high flow tangential velocity for the air it has accelerated. However, the 2^{nd} diagonal fan exhaust seems irrecoverably tangential, meaning there's no well-known way to use guide vanes or other stator structures to redirect the 2^{nd} diagonal fan exhaust back toward the rear of the aircraft in a thrust-providing, longitudinal direction.

This is where we can discuss putting the first impeller module at the fore of the aircraft, in front of the (preferably two) rows of passengers. Because the 2^{nd} diagonal fan exhaust velocity is as much as 8 times the incoming aircraft airspeed velocity, the volutes and ducts that conduct said exhaust away from the 2^{nd} diagonal fan can be about ⅛^{th} the cross sectional area of the impeller system intake cross sectional area.

If we create an annular volute (see figures) and conduct the 2^{nd} diagonal fan exhaust around in a loop and then branch it off downward such that a branch duct diverges from the annular volute, we can bend the volute's exhaust, via an elbow duct, toward the rear of the aircraft. It will be so narrow that we can sneak it past the passengers without widening or heightening the aircraft.

To compound this effect (the advantages will be observable and only obvious after several additional things will have been described), we can put two 1^{st} impeller modules next to each other, one in front of each row of passengers, and counter-rotating such that the left-front 1^{st} impeller module rotates in a counter-clockwise direction (as viewed from the front of the aircraft) and the right-front 2^{nd} impeller module rotates in a clockwise direction, their volutes can converge into a single shared elbow duct. The elbow duct bends the converged downwardly flowing 2^{nd} diagonal fan exhausts rearwardly toward the rear of the aircraft, whence it runs along and through a longitudinal duct at the bottom (or anywhere that is convenient for a certain type of aircraft) of the aircraft between the pairs of legs of the rows of passengers, and under their (inboard) elbows. This is how the air is passed from the 1^{st} impeller modules to the 2^{nd} impeller module, which is behind the passenger compartment.

It is noteworthy that already the switch to electrical power has evinced incomparable advantages, because there is almost no way to drive two successive fans or compressors like this using turbine blades, wherein the rotational velocity of one upstream fan is greatly disparate from that of a downstream other fan, with all these being infinitely and instantaneously variable. And if a way were conceived of, it would require the turbines and combustors, as well as their heat, to somehow coexist in the same part of the aircraft as, and be connected to, the driven parts. If we stopped the solution here to blow up air or put it through turbines, we would have no chance of completing our project like we are about to do. As it is, the magnets are perfect. We just put them inside of or on the outer radii of the fans. Of course, a cooling regimen for the stator coils will be summarized at some point herein. Also, if we tried to drive the fans at the front of the aircraft with turbines at the front of the aircraft, we would only reward ourselves with less flow to the rear of the aircraft, where a real fan is, and a few hundred added pounds, not to mention cooling, shafts, etc.

So, what to do with the air passing along the bottom center of the aircraft, through a duct that passes along a “hump” (like the hump of rear-wheel-drive vehicles) between the inboard calves/feet of the passengers. The 2^{nd} diagonal fan exhaust is already going very fast. It could be used for thrust. This would function, and probably somewhat well. We have conducted it to the rear of the vehicle, up to and including getting it past the rear-most passenger; we could just extend the longitudinal duct to the rear of the aircraft and let the air out there. But we will not let it escape like that, since we can actually work on it even more. And not just more; a lot more.

The 1^{st} impeller module exhaust, passing through the longitudinal duct, once it passes the lower backs of the rear-most passengers, bends upward, then arcs downward to enter another, centrifugal fan set. This fan set is the 2^{nd} impeller module (it is noted in passing that this original, first embodiment is no longer the preferred embodiment, and a second embodiment, wherein the 1^{st} impeller module exhaust is scrolled horizontally around the 2^{nd} impeller module intakes, is at the time of filing the preferred embodiment, even though it is not described in the summary of invention—it is described in full in the detailed description of the drawings). So, in this first, non-preferred embodiment, the air from the longitudinal duct arcs upwardly, then downwardly and into the 2^{nd} impeller module, to enter into the 2^{nd} impeller module from above, moving as it does so substantially downwardly.

Now that the preferred embodiment for the 1^{st} impeller module has been put forth, it must be said that a workable aircraft could be made that contained only one diagonal fan per 1^{st} impeller module. In this latter strategy, two diagonal fans would be located at the front of the aircraft, side-by-side (or in another, perhaps staggered relationship) and counter-rotating, and their exhausts would converge to be vertically downward and into the 1^{st} impeller module exhaust along the elbow bend. This is not seen as currently preferable, but “currently” means that this can change. The last paragraph does not limit the claims of the present application, but instead blows them up to a very broad swath of interpretation. When the applicant discusses a 1^{st} impeller module, he might only be talking about a single fan with a single motor driving said single fan, and/or the previously described system set side-by-side with an identical other single motor driving a single fan. Regardless, the 1^{st} impeller exhausts converge, or don't, and arc through the elbow bend to move toward the 2^{nd} impeller module, with a flap on the bottom of the elbow duct ready to pivot up so that the entire 1^{st} impeller module exhaust can eject straight downwardly when needed for VTOL.

### 2^{nd} Impeller Module

The 2^{nd} impeller module is a centrifugal fan stage. Air is injected, by the high velocity of the 1^{st} impeller system 2^{nd} fan stage exhaust, post-longitudinal-duct, into at least one centrifugal fan. The air enters at least one 1^{st} centrifugal fan, which rotates at a (yet another) high rotational rate, and it is flung outward centrifugally (like in a centrifugal compressor), such that the air is ejected from the at least one 1^{st} centrifugal fan at a velocity that is a sum of both the linear/tangential speed of the perimeter of the centrifugal fan (very high) and a velocity-add result of the centrifugal force that the gas encounters by being squeezed by centrifugal force toward the perimeter of the centrifugal fans. The work that was done by the first impeller module is not lost here. It is used to charge the 2^{nd} impeller module with a constantly sufficient stream of air, air that naturally pushes itself to the outward radial direction once it arrives at the 2^{nd} impeller module's centrifugal fan(s). Thus, other than its job of “squeezing down” the intake air to be fast/narrow enough to be ducted through the center-bottom of the aircraft and past all the passengers, the 1^{st} impeller module significantly reduces the work done by the 2^{nd} impeller system module, allowing the 2^{nd} impeller system module to rotate even faster while exerting less work.

In reality, there have to be exactly 2 (or 4 or 6, etc.) centrifugal fans of the 2^{nd} impeller module, for two reasons: 1) the Coriolis forces of each must offset that of the other or the aircraft will inevitably squirm and wrest itself out of the sky to detrimental effect; 2) the outlet of each centrifugal fan will be tangential, and the tangential exhaust of each centrifugal fan can preferentially be made to branch off and exit the aircraft from one, and in parallel the other, side of the aircraft.

Thus, the 1^{st} centrifugal fan of the 2^{nd} impeller module will be on top of a 2^{nd} centrifugal fan of the 2^{nd} impeller module. They'll both accept equal parallel flows coming from the 1^{st} impeller module, using one of the embodiments provided (discussed later in the application) for specialized centrifugal fan intake manifolds.

Like with the 1^{st} impeller module, each 2^{nd} impeller module fan is driven by having an annular rotor coil set whose inner diameter faces an inner annular magnetic stator array of Halbach-effect-configured rare earth magnetic cubes, and it faces on its outer diameter another, outer annular magnetic stator array of Halbach-effect-configured rare earth magnetic cubes. The annular rotor coil sets are preferably integrally attached to the 2^{nd} impeller module's fans, more near their outer rims than near their intakes. Again like the 1^{st} impeller module, the rotor coil sets are integral with the bodies of the fans, and they are annular. However, they protrude from them in a different way, as described more in the detailed description.

### Discussion of Diagonal and Centrifugal Fans

Diagonal and centrifugal fans, used separately or in successive combination such as has been proposed so far in this application, are not susceptible to the drag and supersonic problems associated with axial fans and axial compressors. There are no three-dimensional bodies that contact the incoming air flow at any point, assuming the fans' vanes are designed properly. Known solutions should be used, if needed, to create a laminar flow across the vanes of the fans, especially at their leading edges; these solutions could include sharpening the leading edges of the fan vanes to razor-like profiles or serrating or saw-toothing the leading edges. Properly implemented, the fans' vanes will slice into their respective incoming intake airflow, splitting it into useful adjacent portions and working on those portions with only skin drag being experienced by the air as it is accelerated—“only skin drag” meaning only a very a slight reduction in the acceleration the air is otherwise experiencing, an acceleration that will be so powerful that skin drag through the fans should be, in an ideal impeller system, for all intents and purposes negligible.

FIG. 19A—for an example of what a diagonal fan would look like, let us observe FIG. 19A which is a snapshot taken from a figure of WO 2020263614 A1 (Joly et al.) and it has been labeled “prior art” (full disclosure: it has been horizontally inverted from the original document's figure and that is why the reference numbers are illegible). The 2-dimensional plane of attack is evident (no form drag). There will be no non-laminar flow or shock waves generated when using this type of device, no matter how high the rate of rotation is made to be. It is noted that this depiction of a diagonal compressor is not exactly what will be used for the fans of the proposed invention. However, it is the only one the Applicant could find showing the knife-like leading edges of the vanes. As was recently noted, the diagonal compressor shown in FIG. 19A is not a fully-functional diagonal fan all by itself. For the intents and purposes of the present invention, and probably for most diagonal fans that this nascent technology will co-opt from the diagonal compressor art and build upon, the trailing edges of the diagonal fans of the present application will differ primarily from FIG. 19A in that the trailing edges of their vanes will be sometimes when advantageous swept forward (counterclockwise in the view shown in FIG. 19A), such that the air escaping them will use the potential energy created by the outward/radial centrifugal force (inherent in the diagonal flow) to bend the flow of air in a tangential direction, specifically in the tangential direction that is in the same rotational direction of the fans.

FIG. 19B—to envision what one cross-sectional version of the diagonal fans will look like we will start with a cross-section for an aircraft dual series diagonal compressor and use a snapshot of a figure from US 20050002781 A1 (Robert Tonks) as shown in FIG. 19B of this application. This figure is the basis for the other cross-sectional drawings of the diagonal fans in this application and is labeled “prior art”. This (the dual series diagonal compressors) is obviously being or has been explored in the industry, but apparently only for compressors at subsonic airspeed, not for fans at supersonic airspeed. We are going to lift/borrow this configuration/device and its figures but call it a pair of fans instead of a pair of compressors.

FIG. 19B, already summarized and designated as prior art, and 19C, also labeled “prior art” and including a snapshot from the figures of CN 104389800 B (Chen), show excellent examples of the types of dual-series compressors whose layout could be leveraged or co-opted for use as the fans of the presently proposed embodiments. Clearly there is some exploratory work going on in this field using the dual series diagonal compressor system. These are the types of systems that will be incorporated herein to create the series diagonal fans, although it should be obvious that once these systems are manipulated to engineer diagonal fans instead of diagonal compressors, the overall geometries and cross-sections of the fans will have been modified from what has been shown in this section and these figures.

FIG. 20 shows a snapshot of a figure from CN 209844801 U (credited to Hou—the patent is live as of 2021 in China but it has no family members outside of China) providing a dual Halbach array (8) arranged annularly about an annular rotor (9) in the inner-and-outer flux-trapping system described within this application (described later). Although Hou's system is meant to drive a shaft element (1), we are going to use it or something like it to directly drive, by fusing its electromechanical/electromagnetic architecture to elements within or on the impeller bodies themselves, a set of fans.

The specifications and drawings of CN 209844801 U, US 20050002781 A1, CN 104389800 B, and WO 2020263614 A1 (included in the IDS) are herein incorporated by reference, such that their subject matter is by invocation included both interpretively and/or explicitly as a result of this paragraph, and their subject matters provide support for the efficacy of certain components of the present application even though there are no more figures or specification segments herein devoted to these references or certain components (it should be obvious to any smart person that is trying to build this thing), this application being already too lengthy. Redundantly though it is to say it, this application directly and completely invokes CN 209844801 U, US 20050002781 A1, CN 104389800 B, and WO 2020263614 A1 by reference, such that their specifications are now a corporeal part of this application, and combinable with the other embodiments of this application when the combining is beneficial, obvious, or a vector for hypothesis or useful speculation, and also because they are a little different from what is being proposed herein. Even though they were found during a prior-art search, the fact that they are so similar to the proposed invention's comparable parts is not a coincidence. It's because they are the best way to do what they, and we, are doing, and this application is the best way to do what the Applicant is trying to do.

As mentioned earlier, the 2^{nd} impeller module consists of two fans being fed by an arc duct (this is no longer the preferred embodiment but the easiest one to understand and thus the one used to summarize the invention), such that the air passes down into the centrifugal fans. One centrifugal fan is stacked on top of the other so that half of the air from the duct gets peeled off from the main flow to enter the 2^{nd} impeller module first centrifugal fan and the rest immediately passes into the 2^{nd} impeller module second centrifugal fan. The 2^{nd} impeller module first centrifugal fan and the 2^{nd} impeller module second centrifugal fan are preferably identical, except their vanes will be mirror images of each other. They are centrifugal-type fans with vane structures designed to scoop air into them at their upper, small diameter, axial intakes. The flow then bends outward toward the radial direction toward their perimeter, where there is a radially open exhaust slit. The vanes, and thus the passages between them, are designed to accelerate the air flow toward the exhaust slit, through a relatively straight portion, and at the vanes' outer ends, they scoop (see discussion of flingers later in this application) forward toward the rotational/tangential direction. Surrounding the perimeter of each fan is a 2^{nd} impeller module volute or thrust volute, which is annular in shape and its bottom surface is in a plane with the bottom surface of its corresponding fan.

The exhaust from each 2^{nd} impeller module volute (thrust volute) is split or branched off from the annular structure and into a longitudinal, straight 2^{nd} impeller module exhaust duct, otherwise called a thrust duct. There is one thrust duct on each side of the aircraft and each thrust duct leads straight back tangentially, from the outboard portion of its corresponding thrust volute to the rear of the aircraft where it empties to the environment, with or without the use of a nozzle. Because the rear ends of the thrust ducts are so narrow in both the vertical and horizontal directions, it would be very easy to bend them up and down to gain thrust vectoring, and since it's so easy to do and is so advantageous, as is well known in the art, we'll include it in this application and discuss it further in the detailed description.

### Maglev of Impeller Modules

It is noted that the 2^{nd} impeller module fans must be supported by magnetic thrust bearings, or in other words, they must be electromagnetically levitated. In such an embodiment, each 2^{nd} impeller module fan will have under it a maglev stator, being an array of rare earth magnetic cubes that levitate the centrifugal fans via said fans each being provided with a maglev rotor in the same area and above the maglev stator, wherein the maglev rotor comprises a set of electrical windings that are powered by electricity (from the batteries via the same route the electricity has already been passed into the centrifugal fans for the main power). The synchronicity of the polarities of all of the coils can then be modulated by a distributor either mechanically or via electrical switching arrangements. An electrical DC brush, or alternative (i.e. brushless) mechanism, will deliver all of the electrical power into the centrifugal fans, making the system simpler and more failsafe than if there were two different types of electrical arrangements going on here. This is why the traditional magnetic thrust bearing arrangement has been forgone (usually for a magnetic thrust bearing, the stator is electrified and the rotor has the magnets).

Anyway, the controlled oscillations of the electrical currents in the maglev rotor components electromagnetically suspend the fans above the maglev stators as the maglev rotors' magnetic fluxes are continuously managed to make the fans float over the maglev stators, which as has been mentioned are magnets. Thus, no mechanical hinderances exist to inhibit the fans from attaining any conceivable speed, even extremely high speeds.

To piggyback on the maglev concept proposed here for the 2^{nd} impeller system, in a perfected aircraft (even though the prototype's 1^{st} impeller modules could have stand-in traditional roller/ball/thrust bearings), the magnets and coils of the 1^{st} impeller module will also have an electrical control system that electromagnetically suspends the 1^{st} impeller module fans, like the maglev scheme of the 2^{nd} impeller system but obviously different from it. This will be more complicated (as concerns the controlling of electricity in the various coils) than electromagnetically levitating the 2^{nd} impeller module fans via their traditional (but reversed) magnetic thrust bearings, but this will require less parts and consequently less mass (no roller bearings means literally no roller bearings as well as the lubrication, drag, and wear problems that come with them). The technology exists in several arts (i.e. the power-storage flywheel arts, to mention one) to electromagnetically levitate a rotating system with a horizontal rotational axis using coil-plus-magnetic arrangements similar to those described herein. It is highly improbable that this technology is not available or adaptable to the current endeavor. Of course, the prior-art systems for doing this must be modified somewhat to conform to the current invention.

There is also to consider the starting and climbing orientations of the aircraft, especially when it is upright with the nose straight up. In this case, the rotors will be being pulled downwardly by gravity in a way that the maglev system, proposed in the last few paragraphs and elsewhere within this application, offers insufficient support. So, multiple complementary means must be made available for at all times keeping the rotors from grinding into the stators. For the 2^{nd} impeller module, the solution could be to have the timing of the regular rotor coils offset from the normal sync to create some electromagnetic levitation, or maglev, such as has been incompletely proposed in the last paragraph for the 1^{st} impeller module during normal travel. For the 1^{st} impeller module fans, it is proposed that an annular magnetic thrust bearing support them from the bottom (when the aircraft is pointed up) that serves as a reverse thrust bearing during horizontal flight. In other words, an annular maglev stator is placed behind each of the 1^{st} impeller module fans' rotors, and their (right-hand-side in FIG. 2A) back surfaces are provided with maglev rotor coils. During nose-up takeoff and vertical climb, this bearing would repel the diagonal fans upward toward the front of the aircraft, and during horizontal flight this bearing would attract the diagonal fans rearward toward the rear of the aircraft, keeping them from sucking forward into the impeller system intake in which event they would otherwise need to be constrained. The possible means for immobilizing the rotors/fans of the impeller modules so that they do not move or oscillate and/or slide off of their maglev bearings are many and depend on the type of impeller system used and the available hardware surrounding it. It is noted that magnetic thrust bearings and the other maglev means provided herein, even though they will need to be energized, and sometimes with considerable current, perform no work and therefore should consume very little battery power.

### Impeller/Fan Speed Ratios

Within the 1st impeller module and also within the impeller system as a whole, it is helpful at this point in the application to establish velocity ratios of the individual fans or modules. To begin with the 1st impeller module would be most effective by having an overall velocity ratio of about 8:1 (air velocity exiting the 1^{st} impeller module and into a longitudinal duct, divided by intake velocity). So, we will give both diagonal fans a velocity ratio of 4:1, since this is possible during most portions of a normal flight while using diagonal fans in the way we are using them (the overall velocity gain will typically be a function of the sum total of magnet mass that is driving the sum total of the fans), all also further being merely a linear function of the amount of voltage applied to each fan.

To obtain this simplified model while still staying within the world of words on a page, we have to omit the swirler and its effects because its effects will require serious computer modeling to understand, especially as they appertain to the velocity ratios of the fans and the respective speeds of the fans. Swirler effects will be left out of the discussion other than to say that of course they change the intake velocity vectors in 3D-space and by doing so and giving the air an abundant tangential velocity they do affect in too many ways to elucidate herein the speed ratios of the fans relative to each other. The swirler must be overlooked in this simple summary so that we can move forward with a meaningful discussion.

The velocity ratios (over the impeller system intake velocity) of the successive fan stages rise as multiplicands of the respective stage number, the latter being an integer, with each 1^{st} impeller module diagonal fan (on each side) contributing an increment, and the 2nd impeller module by itself contributing two increments (since it provides as much acceleration to the air as all of the diagonal fans of the 1st impeller module it is thereby a double-stage). Such that for example if the 1^{st} impeller module's 1^{st} diagonal fans are exhausting air at 500 mph tangential, its 2nd diagonal fans are exhausting air at 1,000 mph tangential and the 2nd impeller module's centrifugal fans are exhausting air at 2,000 mph tangential. If both impeller modules have substantially the same mass of magnets, conservation of work basically mandates the foregoing, unless it is decided for reasons unforeseen at the time of filing but which might arise that certain fan stages should have more magnet mass driving them than others, in which scenario the ratios would of course be tweaked, if this is deemed beneficial in the future.

We must now refer to FIG. 18A several times in the succeeding passages, even though this is not the detailed description. But before we refer to FIG. 18A and exploring a simple thought-experiment, let us consider the point where the aircraft is still near sea level but is traveling upward at 200 mph. Again, we are operating under the presumption that each fan stage, properly equipped and described elsewhere herein, can effectuate a speed ratio of 4:1.

In a 1^{st} example wherein the aircraft has an airspeed of 200 mph—still near sea level but ingesting a decent amount of intake air. Due to the speed ratio, air leaves the 1st diagonal fans at 800 mph and the 2nd diagonal fans at 1600 mph, and ultimately the 2nd impeller module's centrifugal fans at 3,200 mph, which might be too fast (see succeeding paragraphs).

So let's propose a 2nd example wherein airspeed at 300 mph, after which (due to elevation, see FIG. 18A) the air density falls off relatively quickly and at a rate that probably works out pretty well for us, but if not perhaps the aircraft will have to reduce acceleration for several seconds before and after this point. The airspeed range near 300 mph is the most troublesome; it turns out to be a boundary value problem, for it is approximately this airspeed and altitude combination that requires the most work from the 1st impeller module. At most other airspeed/altitude combinations below and above this range the 1st impeller module will run at higher rotational rates because the incoming air mass (throughput) will be less.

So let us now move to a 2nd example for 300 mph airspeed has the impeller system exhaust leaving at about 4,000 mph. At such high throughput, this is excessive, so perhaps the initial acceleration should be subdued to less than 1.5 g even though this adds a dozen or two seconds to our takeoff routine (FIG. 18A), in order to allow the aircraft to get to rarer air densities before traveling too fast to process the incoming air. Also, the 1st impeller module in such an instance could stay at full power while the 2nd impeller module slows down. This would lower the initial takeoff power (battery consumption) which is not a problem. We don't want to choke the impeller system.

However, since the aircraft is still subsonic at these troublesome airspeeds/altitudes, the impeller system intake could be selectively modifiable, such as by angling flaps inward near its front, to bypass a considerable fraction of the incoming air around the aircraft to reduce the throughput, allowing the impeller modules to spin at the optimum rates while producing the appropriate thrust without choking the impeller system. The 2nd impeller module exhaust would still be 4,000 mph at 300 mph airspeed but the throughput would be decreased to a workable quantity, while form drag would be increased a little, but at these airspeeds we needn't worry much about this because it will last less than a minute and not at high-drag airspeeds. The angling flaps discussed herein are not shown in the drawings, but a suggestion toward them is illustrated in FIG. 8E of this application.

### Airframe

The airframe comprises, in the embodiment preferred at the time of filing, an elongated hollow payload area with multiple rows of seats for human payload (passengers), or alternatively multiple rows of support means or fastening means for a non-human payload. In front of the payload area resides said dual counterrotating 1^{st} impeller modules, and behind the payload area resides the 2^{nd} impeller module. In front of the 1^{st} impeller modules is the impeller system intake, also hollow and open to the environment. For all payloads, the payload area part of the airframe can taper, being taller or wider in the front, and shorter or thinner in the rear. For non-human payload, this requires organizing the payload to be accommodated by the taper. For human payloads, this requires putting the taller people up front and the shorter people in the rear; preferably the passengers will sort themselves or be given recommendations to do so such that there is a continuum of heights, from tallest to shortest, along the longitudinal length of the payload area.

With the tapered payload area of the airframe, the height of the rearmost passenger, seated, will be approximately 10-14″ less than the height of the frontmost passenger. Since the 1^{st} impeller module fans should have diameters of approximately 36 inches, the front-most passengers' shoulder-heights can be a bit higher than 42 inches. But if the dimensions described in these paragraphs are prescribed (corresponding to the figures of this application showing the seats), the shoulder height of the rear-most passengers could be as low as 30 inches (i.e. children under 11 years of age). For supersonic airspeeds, the airframe must taper down to 0 inches “tall” at its rear terminus. Preliminary tapering of the payload area of the airframe allows us to begin tapering the aircraft from 42 inches (tall) to 0 inches before the payload area ends (in the rearward direction), and if a properly designed transition of taper angle occurs around the longitudinal point where the head of the rearmost passengers is, the taper down to 0 inches rear terminus can be much shorter in longitudinal length. It may seem to the passengers a bit authoritarian that they be requested to conform to such instructions, but this feature reduces the overall length of the airframe by several feet, and the overall length of the aircraft will be a problem if it is not constrained at every opportunity during design and that begins here, at inception. A super-long aircraft will be unwieldy to move around in an airfield/airport, and it will also have more mass and complexity, as well as more skin drag. So, although not required to implement the current invention, the tallest-to-shortest self-seating requirement has multiple advantages.

While discussing the “height” of the airframe, we used the heights of the shoulders of the front-most and rearmost passengers. Their heads certainly exist and the airframe must accommodate them. Since the heads of the passengers are aligned behind the apices of the parallel 1^{st} impeller modules, a special outcrop of the upper surface of the aircraft is provided for encompassing each row of heads. This arrangement displaces minimal amounts of air outwardly, thus causing near-negligible amounts of form drag. The outcrop for the heads should have sharply tapered fore and rear terminal zones to preclude other types of drag and shock. But, in all, the (preferably) two rows of outcrop ledges (two upstanding rows of head-humps sticking up from both sides of the airframe) should not cause significant drag. Furthermore, they entrain the air going over the aircraft to within the middle area and don't let it slip down over the sides of the aircraft, and they block air from the side of the aircraft from slipping up over the top of the aircraft. This increases the inherent lift of the aircraft because this entrained air will end up being shifted vertically downwardly by a foot or more as it traverses the length of the aircraft, and since this work is being passively performed on the entrained air by the aircraft, an equal and opposite work must be performed on the aircraft by the air (basically, in simpler words, because the air above the roof of the aircraft between the head-humps will be at a lower pressure than the air below the aircraft's floor), and this thus decreases the amount of lift required by the wings, which can now be made smaller.

The front of the airframe is made up of an impeller system intake, and specifically the 1^{st} impeller modules' parallel intakes. The impeller system intake is wider than tall and its lower and upper walls are substantially horizontal while its side walls are distended to conform to the rounded intake of the 1^{st} impeller modules' fans, left and right.

The impeller system intake could include intake ramps (although this is no longer a preferred embodiment—see the multiple discussions herein of the “swirler” feature that probably supersedes the intake ramps), at least one set of intake ramps on the top wall inner surface of the impeller system intake. These intake ramps can have their angles varied to proportionally control the intake velocity and intake pressure of the air encountering the 1^{st} impeller. Importantly, they should be able to angle themselves (or at least one main ramp should), to abut an opposed ramp or (more likely) the bottom wall of the impeller system intake, in order to close (hermetically seal) the impeller system intake so that the 1^{st} impeller module and 2^{nd} impeller module can accelerate to takeoff rates while internally experiencing a vacuum, before at some point suddenly opening to commence a flight.

The airframe also supports the wings and an empennage, discussed further hereinbelow.

### Wings

The lateral sides of the airframe each comprise releasable fastening means to secure removable wings. The fastening means per se can be borrowed from any known type of fastening means for attaching an elongated planar structure to a cylindrical surface longitudinally such that they abut and are coextensive and non-separable or selectively separable, and any other mode of fastening/latching should not be considered to require more than ordinary skill in the art to choose and implement. The wings will be, ideally, selected from the various types of wings known to be conducive to high supersonic airspeeds. Any of known delta or non-delta high-supersonic wing shapes could be used to complete or complement this disclosure. The cross-section of supersonic wings is not an airfoil. This must be stressed. To travel supersonic, wings cannot have the airfoil shape. The cross-sectional geometries of all high-supersonic wings are generally long, flattened, and sharp at the front and the back edges. The wings can be fastened to the sides of the aircraft using a sliding longitudinal dovetail joint, or multiple cradle-like vertically-receiving dovetail joints. In all likelihood, the preferred method will have them removable from the front or top, such that the aircraft, having the female joint half (halves), and the wings, having the male joint half (halves), are joined by sliding the wings longitudinally from the front of the aircraft to the rear or vertically from the top of the aircraft and down into the cradles.

The wings contain at least a majority of the batteries of the aircraft (as envisioned so far, there is not much space within the airframe to advantageously fit batteries). The batteries are of course rechargeable and for that reason the wings are removable. The aircraft is only serving the public and/or generating revenue when it is flying, so every time the aircraft lands, the depleted-battery wings will be switched out for wings that have fresh batteries, such that the aircraft can quickly/immediately turn around and serve the public and/or generate revenue again. The wings that must be produced in total, being an expense but only a minor expense of the entire fleet and infrastructure package, will probably outnumber the quantity of aircraft in a fleet by several-fold. It is foreseen that the wings used by a single flight duration could take 2-5 times the amount of that time duration to recharge. So, it is likely that a well equipped airfield/airport could contain 4-10 or more wings per aircraft that land at it during an average flight period, and large charging “racks” at each airfield/network with multiple conveying mechanisms on hand can constantly resupply fresh-battery wings to the aircraft that are accommodated and serviced by said airfield/airport. Also envisioned are lift-trucks or gantry-like hoist systems for transferring the wings/batteries between the aircrafts and the charging racks without incurring danger to workers.

The forward majority portion of each wing is fixed, immobile. A rear minority portion of each wing is a flap, capable of flexing downward, pushing its trailing edge downward toward the earth, to effectuate increased lift and thus also lift-induced drag. Two scenarios are envisioned and only one of them is shown in the embodiment delineated in the drawings of this application. The first scenario, that shown, is that the flaps can be pivoted upwardly and downwardly (but almost exclusively downwardly) to magnify the lift of the wings when needed, and there is also an aileron on the back edge of each wing's flap, to control the roll of the aircraft during cruise for purposes of turning and maintaining trajectory. The [change if we keep those other views of the wings] second scenario (not shown) is that the flaps can be used without the ailerons on the back edges and by themselves serve the function of ailerons.

This latter type of system is called a “flaperon” and is equally useful for the purposes purported herein. The flaperon concept is known in the art and commonly used in supersonic military aircraft. The flaperon+aileron scenario is only preferred in the current invention because the ailerons at the back edge of each flaperon can combine to scoop the incoming air nearly completely downwardly, due to the compounding bends, to slow the aircraft at very low speeds while still generating a fair amount of lift at said very low speeds. The flaperon is nonetheless useful by itself as slight pivots up or down of opposed flaperons in opposite unison will be satisfactory for meaningful flight control to be effectuated while strenuous manipulations of each flaperon in a downward direction can be accomplished to do just as much as the flap+aileron scenario, albeit at lower aeronautical efficiency (which might be okay, since we'll spend a miniscule time/duration of each flight with the flaperons or flaperons+ailerons in such a position). In the event that just the flaperons are preferred, the angular difference between each flaperon, even when both are deployed downwardly to increase lift/drag, can be adjusted to modulate the roll of the aircraft. In the event that the ailerons are included on the trailing edges of the flaperons, they will be used for fine roll stabilization and turning, and the flaperons will be immobile when not serving as brakes and/or flaps. It is possible that the flaperons alone can be utilized for flight stabilization and turning, even if there are ailerons on the back of them, during extreme conditions or for any other unforeseen eventuality. In this case, we could use the flaperons as flaperons and the ailerons as flaperon-exaggerators.

### Wing Cooling

The wings for supersonic aircraft are notorious for experiencing intense thermal stresses—intense because the heat absorption is high, due to the ultra-high speed of the passing air around them and its consequent friction with the wings' skins, and because the heat exposure is prolonged, such that it is cumulative—each second in the air means the temperature goes up a little more, with no reprieve. Passive means are preferred in the present invention—those that reduce the thermal stresses, such as material selection for the skins themselves and perhaps insulating the parts of the wings that experience the heat absorption with a spray-on ceramic coating or some such. But it is possible that the wings, even with the passive means aforementioned, or others, will require to be actively cooled.

Active cooling of the wings, when it is required, can take many forms. The preferred embodiment is air cooling. Air cooling is simple and doesn't require liquid coolants with their extraneous complexities, ancillaries, and mass. The currently preferred and best mode form of air cooling proposed herein is based upon the cooling schemes currently in use in the turbine blade cooling strategies known in the GTE arts. In the GTE (gas turbine engine) arts, the turbine blades (rotor and stator) and their platforms are often cooled with internal bores/holes that lead pressurized cooling air through hollow portions of the respective members (blades/platforms) and using the hollow portions as a source of pressurized air, lead the air along small bore-holes or channels closer to the blades' exterior surfaces, to pass along/through an array of parallel micro-tunnels near the surfaces of the members, and the bore-holes are usually concentrated at the places where the heat adsorption is happening the most. We won't describe herein that actual practice. It was just a metaphor for what we will do next.

The wings can be designed to accept pressurized air from the aircraft. A fraction of the flow from the annular volutes (so, the 1^{st} impeller module's exhaust) or the longitudinal duct can be diverted to at least one compartment where the air automatically stagnates and the high velocity flow transforms itself into high pressure flow. This flow fraction can be passed to the roots of the wings, whence (via ducts or slits) the flow fraction, charged air, enters the internal chamber of each wing. The wings will have spars and stringers with batteries stuffed all over the place, but the spars and stringers will not be completely solid structures (to save mass they will have holes in them), and the batteries will not be completely jammed together, hopefully, such that the batteries themselves can also benefit from this cooling flow. The interior of the wings (a chamber in itself), spars-stringers-batteries-and-all, will serve as a pressurized cooling air source for the skin-cooling scheme.

The skin-cooling scheme uses thousands of small-diameter, or micro-diameter bores or channels that run near the surfaces of the skin that are in contact with the belligerent zones of air flow, especially the zones of the wings that are near the front and bear the brunt of thermic stress. Each of the bores will have as its intake an inlet that faces the interior chamber, to force the higher-pressure air from the interior chamber into the bores, and each will have as its working passage a long tunnel (relative to diameter) that passes, parallel to the other working passages of other bores, under or through the skin. The outlets of the bores could be anywhere, but most of them would probably be best located near the transition region or rear edge of the wing, where a venturi force would provide a suction force to assist in the migration of air through the working passages (bores). In this way, the skins of the wings should remain perpetually unstressed by the heat absorption, as the heat from the skins will be drawn by convection into the air passing through the bores and thence conveyed out of the wings via the bores' outlets.

Assuming the skin of each wing will be a thin plate or group of plates attached by affixing (welding, etc.) its/their inner surface(s) to the spars and stringers of the wing, the skin-cooling scheme could be effected by a two-ply skin, a 1^{st} (under) skin to create the outer shape of the wing and which is not subject to thermal stress, and a 2^{nd} (outer) skin to contact the air and which is. The 2^{nd} (outer) skin could be provided with channels on its internal surface such that when it is welded or otherwise attached to the 1^{st} (under) skin, the bores are inherently created by the adhering of the 1^{st} skin to the 2^{nd} skin. The 1^{st} (under) skin would in this scenario have the holes/orifices that form the inlets to the bores, leading the charged air from the interior chamber to the beginnings of the tunnels/bores. These channels in the internal surface of the 2^{nd} (outer) skin could be made by milling, etching, scoring, laser-milling, or any other method for creating small grooves in metal (or other hard) surfaces.

The wing-cooling and skin-cooling strategies proposed at this point are not shown in the drawings or discussed in the detailed description. However, some things can be said about them. Firstly, and this is offered as an example and should not be seen as limiting, the 1^{st} (under) skin could be a light-weight non-metal while the 2^{nd} (outer) skin could be a thinly cast and/or rolled sheet of steel alloy or aluminum alloy. Once the 2^{nd} skin is formed and cooled, one (eventually the inner) face of it would be etched with such a preponderance of channels that it is really a super-thin sheet with thousands of ribs that touch the 1^{st} (under) skin. The 1^{st} skin would be rigidly attached to the spars and stringers of the wing but the 2^{nd} skin could be placed, in tension, around the 1^{st} skin without considerable attempt to conjoin them (welding metal to ceramic, resin, or polymer is costly and difficult). This would mean that the thousands of ribs do not have a direct thermal conduction path to the 1^{st} (under) skin, and no measures need to be undertaken to protect the 1^{st} skin from the heat of the 2^{nd} skin. The bores/channels will have air passing through them, under the 2^{nd} skin, forming a heat exchanger to remove a significant portion of heat from the wings and particularly from the 2^{nd} skin. It is also quite possible that the 1^{st} (under) skin could be made from the same material as the 2^{nd} (outer) skin, for example a metal alloy. It is only incumbent that the 1^{st} (under) skin could be made from any material that is appropriate for its use, while the 2^{nd} (outer) skin could also be made from any material that is appropriate for its use. It would also be possible to utilize a single skin, not laminated or in plies as has been described thus far. For the cooling, the skin could contain small integral cooling ducts/bores within its actual material self. These ducts/bores could be incorporated into said skin during manufacture thereof, or with some other method.

Although the wings' batteries are rechargeable, they will of course not undergo recharging during a flight. This hopefully means that the batteries will not put off a lot of heat during a flight while they are discharging. If they do, we are still covered, because they can be cooled by the wing cooling scheme put forth above, and this could be augmented by placing baffles at strategic locations within the interior of the wing to encourage a flow path of cooling air that passes around all of the batteries on its way to the bores. However, when the batteries are on a recharging rack, or other such recharging implement, they could become hot, so the recharging rack might comprise a pressurized means for injecting the battery chambers with cool air to cool off the batteries during recharging, using the scheme proposed above (through the roots and out the bores).

To summarize the proposed embodiment for wing cooling—the wings take in a small bit of pressurized cooling air from the 1^{st} impeller module exhaust (via their root) in such a way that a small fraction of the 1^{st} impeller module exhaust moves laterally outward through the interiors of the wings and is stoppered by the wings having no direct air outlet. The air is forced by pressure through bores striating the wings skins' interior surfaces or through the skins themselves, bores that have been etched or milled into the underside of the skins of the wings and constrained by an interior surface. The heat from the incoming air's impingement upon the wings will hopefully by this strategy be efficiently converted and ejected as the raised enthalpy of heated cooling air—thus any other thermal concerns about the wings' temperature have been provisionally answered, such that we may move forward in this discussion, after mentioning the fact that the aircraft should only go supersonic at very high altitudes where the air is very sparse and cold and hopefully we inherently won't need to cool the wings at all.

### Swirler

As mentioned in the brief summary of the invention, each of the 1^{st} impeller sub-modules has a swirler in front of it to pre-swirl the intake air in the same rotational direction as the respective (downstream) diagonal fans are spinning. We are accelerating air and not pressurizing it, so the diagonal fans receive the air after it has been pre-swirled by the swirler and they just compound its swirl all the more, and always, continually, in the same rotational direction. It has been mentioned but must be mentioned again here that the trailing edges of the vanes of the diagonal fans are swept forward to fling/hurl the air in an advanced, tangential direction in the same was as has been done with the 2nd impeller system's centrifugal fans, particularly as will be shown in FIGS. 5B and 5E.

The swirler should be designed to accept air longitudinally and then, preferably by using vanes, make the air twist gradually at first but with increasing circumferential pitch such that when it exits the swirler the air velocity has acquired a considerable tangential component. Although the Applicant cannot predict at this time what proportion the tangential component will be, it can probably be safely estimated to be more than ⅓ and less than ⅔. Twisting the air to more than ⅔ tangential would probably suffer from diminishing returns. It would probably also cause too much drag on the intake air.

Continuing with our reluctance to pressurize the intake air and our overarching desire to simply accelerate the intake air, the 2^{nd} diagonal fan will likely, at low altitudes as well as during other times of a flight, rotate with a rotational rate of approximately 2 times the rotational rate (and in the same direction) of the 1^{st} diagonal fan, or also at times at higher and lower ratios. This ratio of rotational rates is here 2:1, but it is possible that during the total cycle of a typical flight the ratio will dip well below 2:1 as well as rise up to 3:1, depending upon the airspeed and elevation (air density) conditions the aircraft finds itself operating in.

### Adjunct Discussion of Braking

About brakes, the flaps/flaperons can bend downwardly toward the earth during the slowing of the aircraft in the “approach” and “land” stages, to passively decelerate the aircraft by converting forward kinetic energy to downward thrust (lift). The bending will probably be continuous such that the aircraft during approach, when longitudinal airspeed is no longer needed to be maintained, will initially pitch the flaps/flaperons downward a little (and the horizontal stabilizers simultaneously upward) and then a little more, and then more, and so on, such that each mph (quantity of airspeed) possessed by the aircraft at the beginning of approach is sacrificed to flight longevity and for deceleration before the aircraft begins to drop. This is the point that the VTOL system kicks in, discussed later and above.

The benefits of using wings that are full of batteries, or more adeptly put, using battery packs that are in the shape of wings, are myriad, and a few of them are as follows:

1) Foremost among the advantages is that all the batteries of the aircraft can be switched out for a fresh battery set by replacing the wings. It is likely that the batteries will need much more time to recharge than they need to discharge. An airfield/airport facility that is designed to receive and dispatch such an aircraft as is described herein will thus require a battery/wing change-out station that has racks of battery-wing chargers, wherein a lift truck or such device (or a large conveyor or robotic shuttle) removes the wings from an aircraft, places the wings on recharging racks, takes charged wings from other racks or other places on the same racks, and brings them over to the aircraft and pushes and/or slides them into place. It is possible that an airfield/airport facility will comprise many more wings and rack-spaces than the number of aircraft it is designed to serve in any given hour. This allows the facility to take its time in recharging the wings, while the only drawback is that there will be many more wings in the field than aircraft. The cost of the wings will be much lower than the cost of the aircraft, so this expenditure is although not negligible still miniscule compared with the advantages of constantly refreshing aircrafts with batteries and not needing a super-fast charger that, more importantly, requires super-fast-charging batteries. Of course, at present it is preferred that the batteries will be whatever is contemporaneously the best for such a system. The inventor suggests lithium-ion batteries because they are well-known and widely available. However, other batteries could be used, either because they are more powerful or less expensive, or because they are more expensive but considerably less massive, or for any reason that seems optimal or lucrative to the industries utilizing them at any given time in the future.

2) Secondly among the advantages is that the wing-shaped cross section of such battery packs (wings) will make them lift themselves during flight. Since the batteries are a substantial mass contribution to the aircraft, they inherently must be lifted. It makes no sense to use wings to lift an aircraft that has this substantial battery mass component inside it, when we can simply by having the batteries in the wings use the wings to lift their heavy selves. This reduces the torque upon the joints that unite the wings to the aircraft throughout the majority of a flight (the wings will only “hang” during the last minute of the flight, where there is less lift).

3) Thirdly, by putting this substantial battery mass component of the aircraft laterally out on cantilevered wing elements, the moments of inertia (MOIs) of the aircraft around its roll and yaw axes are substantially improved, such that sudden undesired movements of the aircraft around the roll axis (and the yaw axis, when this is important) will be negligible or easily dealt with. It is noted at this point that having many of the impeller systems' components, with all those magnets, at the front and also at the rear of the aircraft, increases the MOIs of the overall aircraft about the pitch axis and the yaw axis, such that the aircraft, by having considerable MOI about all axes, should never experience uncontrollable and/or unpredictable shifts or shoves about the 3 axes due to wind, turbulence, or other agencies not discussed herein. It is further noted in passing that the heavy battery-laden wings will also stabilize or otherwise reduce unwanted accelerations about the yaw axis almost as much as having the impeller modules' magnets at the respective front and rear ends does.

### Empennage

The empennage in a preferred embodiment consists of two vertical stabilizers extending upwardly from each lateral side of the rear of the aircraft, with a stabilator (all-moving horizontal stabilizer that serves as an elevator) residing between their tops and attached to said tops with means to pivot it (the stabilator) being provided in or on the vertical stabilizers or provided in or on the stabilator. Each lateral side of the aircraft has a vertical stabilizer sticking up from it. The stabilator can include portions that stick laterally outward beyond the vertical stabilizers, but in a simplest embodiment the stabilator is one big panel between the vertical stabilizers. In either the simplest embodiment or the wing-cross-section embodiment, the two vertical stabilizers stick up from the airframe's rear and eliminate undesirable yaw inherently, while they with movement/bending create desirable yaw for maneuvering the aircraft; in other words serving as rudders for the aircraft. The stabilator can pivot around a horizontal axis or have a flap that does so, in order to serve as an elevator.

The flaps/flaperons of the wings can be pivoted in conjunction with the pivotable stabilator (elevator) to brake the aircraft during approach and landing. In the proposed embodiment, which is basically the same way regular airplanes slow down during descent but judiciously modified (and before the runway but still during touchdown) the stabilator pitches down (the trailing edge of it pivots up), pushing the rear of the aircraft downward and creating lift induced drag (by diverting air upwardly), slowing the aircraft. The flaps/flaperons then pitch up (their trailing edges pivot down), which creates lift and lift-induced drag, slowing the aircraft. As the aircraft's airspeed slows, the stabilator's trailing edge pivots higher and higher and the flaps'/flaperons' trailing edges pivot lower and lower. Their angles will be continuously controlled to complement each other in maintaining the appropriate aircraft pitch. The stabilator and flaps/flaperons should be able to pivot to extreme, nearly vertical angles (up and down, respectively), such that at the end of the flight, they destroy the airstream around the aircraft, and quickly slow it to a near-halt.

The empennage's vertical and horizontal stabilizers should probably not have any significant width/thickness whatsoever. If they are flat sheets, they only contribute skin drag and not any other form drag; a little heat, but hopefully not enough heat to require cooling. It is also possible to envision a system wherein the vertical stabilizers and the stabilators can retract into themselves or each other or fold upon each other or anything really that could make them smaller and remove a good portion of them from the passing airstream.

### VTOL System

The VTOL (vertical takeoff-and-landing) system of the present invention comprises two downward exhaust modules (downwardly directed thrust from the front end and the back end of the aircraft) including; 1) a front downward exhaust module, and 2) a pair of rear downward exhaust modules, or more precisely for the latter, one rear left downward exhaust module and one rear right downward exhaust, downward exhausts existing on both sides of the rear of the aircraft.

For the front downward exhaust module, it was mentioned earlier that the 1^{st} impeller module's exhaust comes out of the volute in a downward direction, where it is bent to pass in the rear direction by an elbow duct. Although many options are available, the simplest embodiment at this time for VTOL would be to put a flap (we'll call this the 1^{st} flap since there will be more) in the bottom of the elbow duct that pivots up to allow the 1^{st} impeller module's exhaust to simply escape downwardly at speed, creating a downward thrust. This 1^{st} flap will be the front downward exhaust module. It is possible that the 1^{st} flap will be sufficient, once explained in the detailed description, to do what we want, but it is possible that a more sophisticated apparatus will be needed. This might consist of multiple flaps, guide vanes, or nozzle features, to gather the thrust and aim it in the right direction with the right force. It also requires a control scheme, which will not be discussed at this time but is inherently a part of this discussion however it is omitted here because its conditions will be obvious to one of ordinary skill in those arts.

Concerning the rear downward exhaust module(s), at least one and preferably two rear downward exhaust modules should be placed downstream of the 2^{nd} impeller module, where the flow is straight and narrow, and thus easy to get at and manipulate. Although many mechanisms could be used here to downwardly deflect the rearwardly flowing 2^{nd} impeller modules' exhausts, the simplest that comes to mind for the embodiment to be proposed here is a reciprocating valve block. The valve block is interposed amidst each 2^{nd} impeller module exhaust duct (i.e. the ducts have a gap/hiatus for putting the valve box between a front extent and a rear extent). Each valve block has two passages; firstly an open ended longitudinal straight bottom passage that aligns at both its front and rear with the 2^{nd} impeller module exhaust duct; and secondly an open ended curved upper passage that when the valve box is shifted downwardly it aligns at its front with the 2^{nd} impeller module exhaust duct's front extent, and at its back it does not align with any duct, but is curved around and aimed straight down toward the earth as a VTOL vertical exhaust. The valve block is preferably a rectangular prism in shape, and slides in a rectangular chamber that is open at its bottom. The bottom wall of the straight bottom passage will be, in the valve block's home (upward) position, flush with the bottom surface of the aircraft. Simple means will of course be provided for shifting the valve box down and out of the chamber (such that much of it extends out of the aircraft) and retracting it back in again. When it is up, the straight bottom passage aligns with the front extent and rear extent of the 2^{nd} impeller module exhaust duct, merely serving as an extension of it to bridge the said gap/hiatus.

When the valve block is pushed totally down, the straight bottom passage is not in use, and the curved upper passage accepts the air from the 2^{nd} impeller module exhaust thrust duct, bends it from a horizontal flow direction to a vertically downward flow direction, and ejects it down toward the earth. If this latter position of the valve block is used in coordination with the opening of the flap of the front downward exhaust, downward thrust will be provided from one centralized front portion of the aircraft, and from each side of the rear of the aircraft. This is the sufficient criterion for a primary VTOL necessitation, and we can't go too far into this already lengthy disclosure. Various other features and methods of control can be designed and used by anyone desiring to utilize this invention, and some will be discussed in the detailed description. They will be obvious to practitioners in the art and discussing them now will detract from the more important features of the present invention. The applicant simply had to propose at least one VTOL mechanism to comply with 35 U.S.C. 112, 1^{st} and 2^{nd} paragraphs. Simply stated, there are fans at the front and rear of the aircraft, each with a high-velocity exhaust. Routing the exhausts downwardly is therefore a simple endeavor, provided now as we are with the schemes described herein and in the detailed description.

It is noted that VTOL will take place only at very low airspeeds, so it does not matter that the valve block protrudes into the airspace around the aircraft. Also, another (2^{nd}) flap could be located on top of the arc duct above the 2^{nd} impeller module's fans, on the roof of the arc duct, such that when the 2^{nd} flap is open, the 2^{nd} impeller module can draw in its own intake air (it won't be receiving 1^{st} impeller module exhaust anymore). Another (3^{rd}) flap could be placed on a rear wall of the arc duct, which when open leads to a rear extension of the arc duct that bypasses the 2^{nd} impeller module and leads the 1^{st} impeller module exhaust straight back out the rear of the aircraft.

There are two primary modes proposed in the present application for performing the takeoff of the aircraft. They consist of:
1) Mode 1—Takeoff using a launch tower wherein the launch tower comprises rails, guides, magnets, pneumatics, bearings, etc. for constraining the aircraft's lateral accelerations to include/allow only linearly forward (upward) acceleration;
2) Mode 2—Takeoff from a field or launch pad, wherein the aircraft lifts off from the ground with a horizontal/flat initial orientation and then, either immediately or several seconds after the liftoff, it pivots its nose upward and then begins to accelerate linearly forwardly (upward).
3) Mode 3—The aircraft could pivot up while on the ground such that the 1st impeller module's forward downward exhaust briefly overwhelms the 2^{nd} impeller module's rearward downward exhaust at the beginning, while the tail remains on the ground for a second before the transition to full rearward exhaust takes place. Meanwhile, the stabilization system (relief valves up, down, and sideways coming out of or bleeding off of the 1^{st} volute of the 1^{st} impeller module) would modulate its motion and make sure the pivot is controlled, at the same time offsetting unwanted accelerations. This scheme would work well for Modes 1 and 2 as well, although it would be performed while the aircraft is already airborne.

There is more to this and it will be discussed elsewhere in this application, but for now, practically, it helps us greatly in designing and testing the prototype(s), because the prototype can be tested in/for its two most important performance modes simultaneously: via Mode 1 for all of the flight portions and their resulting problems that happen after the aircraft is aimed upwardly with all thrust exhaust being ejected linearly rearwardly; and via Mode 2 for the vertical takeoff protocols that will be required to lift off from a horizontal surface while the aircraft is itself horizontal, and then it assumes quickly or eventually the vertically oriented and vertically accelerated configuration.

Not only that, but Mode 1 (launch tower vertical takeoff with rails etc.) will certainly be FAA (or any country's aviation regulation body) certified for safety and reliability while Mode 2 is still being tested because Mode 2 has more uncertainties inherently involved with it and because the system has to accomplish Mode 2 to get to Mode 1 for non-launch-tower scenarios, but these latter scenarios are secondary because the launch-tower is so helpful as foreseen at the time of filing. This importantly allows the places that have the capacity and demand for the launch tower embodiment (with a landing field and requisite accoutrements and also the higher profit margins) to use more of this aircraft right away while Mode 2 is still being perfected.

Mode 2 takeoff (without the launch tower) from a field or tarmac can have at least two modes, firstly (Mode 3) one wherein the aircraft almost immediately after popping up off the ground (liftoff) tilts its fore up to achieve an overall vertical orientation for the aircraft and secondly (Mode 4) one wherein it does so after climbing a few hundred feet in altitude.

The currently preferred mode for (not-initially-preferred) field takeoff is that of (Mode 3); the aircraft begins to tilt its nose upward relative to the rear of the aircraft only a few seconds after liftoff, when the aircraft is ascending at approximately 20 mph. Faster than approximately 20 (+−10) mph and the drag of the aircraft, which is moving in its least efficient orientation, drains heavily on power output of the impeller system once the aircraft travels upward soon thereafter at somewhat higher speeds (30-40 mph). For these reasons we need to point the front of the aircraft upward as soon as possible following the 20 mph condition. On the same note, considering this is the least efficient stage of the flight, by several orders of magnitude, it needs to be gotten out of as quickly as possible.

The intakes of the impeller system will be closed during run-up to liftoff until the max-speed takeoff rotational rates of the fans have been achieved, such that they accelerate in a near-vacuum and the run-up consumes negligible battery power. When the intakes open, they are intentionally initially pointed upward such that their suction effect is upward and not forward, which latter case would pull the aircraft forward and into stuff.

The aircraft should steadily accelerate at approximately 10 mph/s (wide margin of error here) such that at 2 seconds in it could be going approximately 20 mph straight upward and still be very low to the ground. This is great because it's “safe” here to do the transition to horizontal thrust. The higher we go before doing the transition, the more safety concerns must be considered.

At this point the VTOL valves and the elbow duct's flap begin to move toward their 2^{nd} positions. More specifically, the 1^{st} of a VTOL valve's valve pair (there are two valves side by side, a first VTOL valve and a second VTOL valve) switches to the upward position allowing its portion of fan exhaust to exit straight out the back of the aircraft, for rearward thrust. The 1st impeller module's exhaust is still being ejected straight downwardly, so this lifts the nose of the aircraft quickly because the rear of the aircraft will begin to drop relative to it. The stabilizer nozzles will smooth this operation and also offset windage and errors or delays when the other flaps and valves don't immediately effectuate their aims, all in a manner (observed via a inertial measurement unit [IMU] or 6 DOF accelerometer/gyrometer) that corrects the orientation and trajectory of the aircraft in opposition to unwanted accelerations.

During the last paragraph, the flap system valving the impeller system intake went from completely closed at the front and top, to being completely closed at the front only while being open at the top, to a final stage where it is open at the front and closed at the top. This latter configuration creates a very large suction effect toward the front of the aircraft, meaning that the lowered pressure of the air contacting the nose of the aircraft (a fan intake) is low enough compared to the pressure of the air contacting the rear of the aircraft (basically everything behind the fan intake) that the aircraft will passively propel itself forward with a significant acceleration that can be compared to thrust, and in effect will be additive to the actual thrust. At this point the closures of the flaps and the actions of the stabilizer vents/outputs will aim the aircraft straight upward and stabilize it in that position, wherein the flaps now feed the 1^{st} impeller module exhaust to the 2^{nd} impeller module and all of the 2^{nd} impeller module exhaust is ejected through the thrust ducts to provide an acceleration that is at least approximately 0.5 g (1.5 g minus the 1.0 g deceleration from gravity the aircraft is naturally experiencing).

Immediately after liftoff and/or during transition and/or climb the stabilizer jets/ducts can pitch, roll, and yaw the aircraft such that it is a) always advantageously facing against, with, or across the prevailing wind gusts, and b) when the time comes to begin to head towards its destination, the aircraft twists to be lined up (oriented) such that when it pitches over (goes from vertical to horizontal) it is already aimed directly at that destination.

### Descent and Braking

Braking has already been discussed herein during the discussions of the stabilator (horizontal stabilizer combined with elevator) and the flaperons. The flaperons, at the back of the wings and near the rear of the aircraft, begin to pivot down (pitch up) and provide lift and lift-induced drag, pitching the aircraft down. To keep the nose from pointing too much toward the earth, the stabilator reciprocally pivots up (pitches down) to provide negative lift (offsetting the pitching caused by the flaperons) and to create lift-induced drag. These combined and complementary actions increase the drag and lift of the aircraft such that it loses altitude at a controlled rate and reaches a lower altitude at a low airspeed. Then, when the airspeed has slowed to a threshold value, the flaperons and stabilators pivot to extreme angles, disrupting the airstream around the aircraft and attempting to brake the aircraft to a halt.

The aircraft will need a thrust reverser. There are several thrust reverser embodiments that cannot be discussed herein because the instant application has already gotten too lengthy. However, the simplest embodiments of thrust reversers are that each 2^{nd} impeller module centrifugal fan will have a bleed valve on the side of it opposite to the side of its volute branch, and the bleed valve will be comprised of a flap that is usually flush with the side wall of the aircraft, but which when opened creates a longitudinally forward-directing pathway to eject air from the 2^{nd} impeller modules toward the front of the aircraft.

In a preferred embodiment, as mentioned, the thrust reverser comprises escape valves on the outer diameters of the thrust volutes of the 2^{nd} impeller module. In the form of flaps or panels, they can be pivoted outwardly (hinged at their rear ends to the volutes) such that an opening is created in the outer wall of the thrust volutes and a portion of the air within the thrust volutes is allowed to leave the volute in the area of the thrust reverser (at lateral opposite side of each volute) where the air is traveling longitudinally forwardly (in the aircraft travel direction). Thus, no deflectors are required. The air will prefer a linear, tangential vector and with no curved wall in the way of it to guide it around and keep it spinning in the volute, it naturally exits while still going in the forward direction. This creates a de facto thrust reverser, at negligible manufacturing cost. This system will be used leading up to and during a vertical landing, so the rear valve boxes will still require significant airflow to maintain downward thrust in the rear of aircraft. To avoid a torque imbalance where the rear of the aircraft dips down, the 2^{nd} impeller module's rotational velocity will likely be increased to make up the deficit in that thrust, the increase being equal to the thrust that is being borrowed from the valve boxes by the thrust reverser valves.

The overall descent/approach and braking scheme is summarized as follows:

Step 1) following cruise, the aircraft stops providing rearward thrust and starts losing airspeed and altitude. The incoming air to the intake duct is, in a handy but unpreferred embodiment, cleared out by the inhalation of the 1^{st} impeller module and expelled along the 2^{nd} impeller system bypass duct described elsewhere within the application. Alternatively, the impeller system's intake duct's top and bottom walls can pivot toward each other to provide a tapered nose, thereby bypassing the entire impeller system by routing the incoming airstream around the aircraft (this would create constant shock waves and should probably be avoided). This tapered nose will be briefly revisited elsewhere within the application, so it is not without its benefits.

There are several reasons we might want to divert air out of or around the impeller system intake. However, in the current scenario the aircraft is going extremely fast so the structure required to have a taper-capable nose probably will not work because of the shock waves. A 3^{rd}, simplest alternative would be to simply let the incoming airstream stagnate in the impeller system intake by stopping the 1^{st} impeller module. This might create a static air buffer/bubble of air (with an accompanying stand-off bow-shock) in front of the intake that could (or not) conform to the airflow and create a virtual nose, or the air in front of the intake might of its own volition turn into twin mirror-image eddies that form the virtual nose. The bow-shock would cause significant drag and could be figured into the strategies for slowing the aircraft down more quickly.

A 4^{th} alternative for slowing and descending the aircraft near the end of its flight is probably preferred, and is as follows. It involves the swirler (the previous alternatives of the last paragraph were envisioned before it was determined that the swirler was to be part of the preferred embodiment). As described previously, at high airspeeds the swirler pre-swirls the intake air such that its longitudinal velocity (in the relative frame of the aircraft) is converted into tangential velocity, and the swirler does perform considerable work to do this. During normal flight including cruise, this work is regained automatically since a non-negligible portion of the total air ejection velocity that makes up the thrust is a residual of this initial acceleration. However, if we stall the impeller system and open up (via flaps, louvers, panels, etc.) the outer walls of the 1^{st} impeller module intake, the spinning (pre-swirled) air would of its own volition (via centrifugal force) leave the intake and completely exit the aircraft, such that the swirler will have “wasted” the work it performed. Meaning, in the relative frame of the earth or ambient air, the aircraft would be constantly entraining a tubular swath of still air, accelerating it to a velocity near the aircraft's airspeed, and then simply letting go of it. The work that is “wasted” by swirling it while not utilizing the swirl for thrust can de facto be used as a brake without any further mechanisms or steps.

It is believed by the Applicant that using the swirler to drag on the air in this manner would provide enough deceleration at high airspeeds and altitudes so that the aircraft could slow itself for/during initial descent while its airspeed-to-air-density ratio should be maintained at a reasonable number such that the aircraft will not experience mechanical or thermal damage during the descent. The walls of the 1^{st} impeller module intake would close eventually and proportionally once the aircraft has slowed enough to do so, and the 1^{st} impeller module can be re-activated to complement this transition either well before or just before the vertical landing protocol is initiated. Thus has the Applicant conceived of a functional, controlled descent and deceleration strategy that minimizes the amount of battery power that is wasted by active braking. Although the Applicant cannot solve for a non-active braking strategy at this time, of course it would be best to descend and decelerate the aircraft during its descent and approach in a way that does not waste energy—meaning letting it glide all the way such that the lift that is performed by the aircraft during this period is the only loss and this loss is taken from stored/potential energy (altitude). However, as described elsewhere herein, the aircraft at the end of cruise is too high up and going too fast to be allowed to glide, so the active braking alternatives provided in this and the last two paragraphs have been put forth as a best mode and will have to do at the time of filing.

Step 2) once the aircraft has been actively braked to a reasonable airspeed, it will then be allowed to glide eventually to a low altitude while trading off altitude for airspeed, thus completing the last leg of the flight using negligible power, as is standard procedure in the aircraft industry. The stabilator's angle should in this instance be modulated to keep the nose of the aircraft pitched at the most desirable angle for the descent. Importantly, the stabilator can pitch significantly downward to “skiff” up the aircraft as it experiences the initial and main portions of its descent; as the aircraft is pulled downwardly by gravity, this drop in altitude could be converted into a sustained forward “skiffing”, braking, and landing routine. The flaperons could be pitched up in a modulated or strategic way to increase lift, as well as lift-induced drag, if and when this becomes necessary or useful.

Step 3) the aircraft further pitches the flaps/flaperons upward and the stabilator downward to create drag and lift while keeping the medial plane of the aircraft appropriately near the horizontal plane.

Step 4) the aircraft, after being slowed considerably and now requiring exaggerated lift, has the flaps/flaperons pitched upward at a drastic angle to create extreme lift for a very slow airspeed. The stabilator is also pitched downward at a great angle to supplement drag and to keep the aircraft's pitch up. The braking force is great at the beginning of step 4 but as the airspeed drops under 50 mph it will become insufficient to adequately decelerate the aircraft at this critical juncture. Also, at some point during step 4 the lift created by the aircraft will no longer keep the aircraft from succumbing to gravity. This is when the VTOL system will be brought online to perform a vertical landing.

Step 5) the thrust reverser is activated to effect more rapid deceleration of the airspeed until the airspeed is 0. Then the thrust reverser is deactivated (its flaps close) and the 1^{st} impeller module and the 2^{nd} impeller module are slowed down through a landing protocol designed to smoothly and safely drop the aircraft vertically to the ground. During the drop, the flaperons will be raised so that they do not touch the ground.

### Takeoff

It is preferred that a takeoff usually not be performed from standstill on a field or lot. Although the Applicant has devised a system for doing so, and this system is detailed later in the application, the provision of a launch assist structure would have compounding advantages, so one is proposed in this application. The launch assist structure could guide the aircraft in/on a near-vertical track or support to allow it to take off directly upwardly by its own thrust or by a catapult or by a combination of thrust and catapult. With the launch assist structure, the aircraft would be supported against the whimsicalness of the wind and would not exit the launch assist structure's track/constraints until its airspeed was over a hundred or more miles per hour. Thus, takeoff can be performed regardless of weather conditions.

Launch System—Airport or Airfield with Fork Truck, Staging, and Vertical Pivot

The launch assist structure or launch system (as it will now be called), in the simplest embodiment foreseen here, begins with a set of forklift or equivalent trucks that rove around an airfield and move in on each aircraft as it approaches to pick it up quickly after the aircraft lands by sliding forked/parallel beams under the aircraft's lateral sides. Aircrafts land in succession on a field of grass or turf or any other known useful and appealing surface. The forklifts deliver the aircrafts one after the other to an airport, this latter being located on the same grounds and having a hollow aircraft inlet where the forklifts set the aircrafts down onto a conveyor that carries the aircrafts through a sequence that contains, in the following succession:
1) A debarkation room where the overhead hatch rises and the passengers exit the aircrafts onto pedestrian platforms.
2) A wing replacement room wherein hoists or lift trucks remove the spent-battery wings from the previous flight and replenish the aircrafts with fresh-battery wings for the upcoming flight.
3) An embarkation room where new passengers seat themselves in the aircrafts and the hatch descends to seal them in.
4) A launch zone (not a room since it's open to the environment but it can still be called a room) that pivots up the fronts of the aircrafts to put them on and/or align them with a takeoff/launch ramp or near-vertical rail system that is the support/constraint that allows them to accelerate themselves (with or without a catapult launch-assist system that could be part of the ramp/rail system) to achieve a threshold velocity (i.e. at least 100 mph or more) so that when they leave it, any prevailing winds or even high wind gusts cannot shove them laterally, change their posture, or in any other way deter a successful launch.

The airport is a housed and climate-controlled elongated structure and it also comprises at least one track, guide, or conveyor for carrying aircrafts from the forklift truck to the launch zone, and through each room in a preferably linear, series way. The airport could have two or more conveyors, identical or not and probably parallel to each other, in order that it could process more aircrafts per unit time.

As an aside, although not usually preferable, takeoff from standstill is possible and a method for achieving this is put forth in the detailed description. However, that description relies so heavily on the figures it is associated with that a summary of it will be forgone here, and the reader is directed to the portion of the detailed description that deals with that if s/he is interested. The following paragraphs return to the latest subheading for a launch system at an airport or airfield with a fork truck, a staging system, and a vertical pivot.

If the aircraft's vertical takeoff is from a standstill while using a launch system (vertical track or other launch pad) as described above, the thrust must first and foremost overcome the (negative) acceleration of gravity. The acceleration of gravity, traditionally known as 9.8 m/s², has been converted now, for convenience, into 22 mph/s. Thus the thrust required to levitate the aircraft but not accelerate it upwardly is 22 mph/s times the mass of the aircraft. This will be the standard unit (SU=22 mph/s) we will use for some subsequent calculations. Say we provide enough stator magnets and rotor coils (and battery voltage) to levitate the aircraft, we now have 1 SU as the total acceleration as a function of stator magnet mass and rotor coil mass. This requires a considerable mass of magnets+coils, but it should be easily feasible, since we can keep adding them up to simply produce the number of banks of magnets and coils required, and it should be still a small-to-moderate fraction (i.e. ⅕ or ⅓) of the total mass of a laden (fully populated) aircraft.

Proposing further that we provide 1.5 or 2.0 times this mass of magnets+coils, and we will theoretically provide 1.5 SU or 2.0 SU of thrust. Staying conservative at 1.5 SU now, this will mean that we can not only levitate the aircraft, but achieve 0.5 SU (11 mph/sec) of additional acceleration; 0.5×22 mph/s=11 mph/s. This calculation results in the aircraft having available to it an acceleration of 11 mph/s on top of the levitational requirements during a vertical climb. Once the aircraft path bends over toward the horizontal, the acceleration will be raised by an additional 1.0 SU (gravity no longer a factor), giving us an acceleration of 33 mph/s. This is an ideal acceleration, ignoring drag. The transition period between vertical climb and horizontal acceleration will be an acceleration curve/continuum from between 11 mph/s to 33 mph/s. So even at the beginning of the vertical climb, the 11 mph/s means that after 10 seconds the aircraft is traveling straight upwardly at 110 mph. Although this seems astonishing, it is pretty much the same upward velocity that a quad-copter (or 5- or 6-fan) VTOL craft, now well known in the art, would have after a similar number of seconds if it could take off at full power while experiencing zero drag. However, unlike that other type of VTOL craft, this one is not going to stop accelerating.

We will now round down the acceleration numbers (and standard units or SUs) to multiples of ten to simplify the discussion and the calculations that follow. Instead of 11 mph/s and 33 mph/s we will use 10 mph/s and 30 mph/s. Now we will plot out some significant attributes and chronologies of the takeoff herein being described.

After 20 seconds the aircraft is traveling straight upwardly at 200 mph. After 40 seconds, 400 mph. After 60 seconds the aircraft is traveling upwardly at 600 mph and could possibly begin the protocol for transitioning from vertical to horizontal flight. At 60 flight time seconds it is going 10 miles per minute and is only at about 25,000 feet (having gone 5 miles which is easy to calculate from the preceding numbers because we are holding acceleration constant—see FIG. 18A). By integrating the velocity function to a distance function (or using the simplified calculation put forth in the previous parentheses), it looks like we have only gone about 5 miles up. So, to fulfill the conditions proposed several paragraphs above, about only performing horizontal (travel) flight at high altitudes, we should go up a little more before bending the flight path toward the horizontal. After the 60 second mark where the aircraft is going 600 miles per hour, using the integration of the velocity function to a distance function the next 20 seconds completely do the trick. Between 60 seconds and 80 seconds the aircraft climbs another 4 miles (to 9 total), and the airspeed is 800 mph. The air density here is ⅙ of what it is at sea level, and this allows us to finally start pushing over to horizontal flight. This whole protocol seems wasteful and unnecessary at first glance, and because it is counterintuitive, the inventor believes that is why the straight-up approach has never been taken before. A significant portion (approximately ¼) of the battery life is used to get us nowhere closer to our goal. Our endeavor appears unappealing and inutile, but check this.

At 11 miles up (or around 60,000 feet altitude), the air exerts about 1/10^{th} the effect (its static pressure and its density are about 1/10^{th} of what they were) that it did on the aircraft at 0 miles up. This means that an aircraft designed (wing size, etc.) to maintain adequate lift at 300 mph at sea level can comfortably cruise at more than 2,000 mph at 11 miles altitude, and at 1/10^{th} the drag factor of what the air would do to it down there if it tried to go that fast. The fans will be spinning much faster than they did at lower speeds and altitudes, in order to create the required constant thrust, with so much less incoming intake air to work on. Still, the drag conditions are all steadily nearing optimal and it's time to go into the protocol for bending the aircraft's travel path from vertical to horizontal, at around 80 flight time seconds. To summarize, in the ideal acceleration scenario we are going 800 mph after 80 flight time seconds. But we're still going straight up and have used nearly a quarter of our battery without traversing ten feet toward our destination.

In the transition protocol, the aircraft's stabilator pitches up (pitching the aircraft nose down) while a thrust-vectoring arrangement on the thrust ducts (2^{nd} impeller module exhausts) angles the thrust proportionally downward at an acute angle relative to the aircraft's medial plane. The aircraft goes from 90 degrees straight up, during said transition protocol, to 80 degrees, 70, 60, etc., until after about 20 seconds (100 flight time seconds), the aircraft is at an approximate altitude of 12 miles (63,000 feet) and moving substantially horizontally (but with lift continuous) at about 1,200 mph.

At every second of the bend-over protocol, the longitudinal acceleration follows a near-parabolic increase in acceleration from (i.e.) 80 flight time seconds to (i.e.) 100 flight time seconds, as the acceleration progresses non-linearly from 10 mph/s to 30 mph/s. As for the latter value, let us just presuppose that for every ten seconds of such acceleration, the aircraft gains 300 mph. Again all of the numbers provided in the foregoing are ideal numbers, not accounting for drag. Regardless of the boasts, about drag, of the previous segments of this application, there will be enough drag and other problems that the ideal numbers will have proved too ideal, and that the realistic accelerations will begin to slow once the airspeed increases to high amounts. We can either offset this by more magnets and more coils, or simply by adding a few seconds to our takeoff routine.

The actual data that are proposed by the Applicant for a typical flight chronology are provided in the detailed description and will not be gone into in-depth here. The summary of invention had to show why we're going through all this trouble, and that's what we're getting to now.

At 30 mph/s acceleration, after it has pushed over to horizontal flight, the aircraft will reach 3,000 mph and 85,000 feet within 3 or so minutes after takeoff. From this moment, it is traversing 50 miles per minute in geographical distance. To put this into perspective, that is DC to Boston or San Francisco to LA in 8 minutes, or New York to Miami in 22 minutes. Importantly, reaching 3,000 mph drained the batteries of 3 full-power battery minutes and it will only have a few full-power battery minutes left. Once the max speed has been reached, the impeller system slows down to provide cruise thrust, and the Applicant estimates that this will require less than 25% battery power, per minute, than takeoff did. Here begin the fruits of the deal we made. Provided we make such an aircraft and give it 3 minutes of max-battery power just to reach its cruise speed and altitude, it can possibly travel 200 miles per additional battery max-power minute that we fly past that point (keeping in mind that its power losses are very low because it is practically coasting through space). So, if we designate an aircraft for shuttling between DC and Boston, the wings used will have enough, and only enough, batteries to provide about 5 minutes (3 minutes plus 0.25×8 minutes plus a little reserve) of max-battery power. The total trip, with takeoff and cruise, has consumed 11 minutes of human time (very different from max-battery minutes). The aircraft receives new wings and people and at 20 minutes from the first takeoff, it's headed back to DC. So if it does the trip 3 times per hour, it has flown (if there are 16 seats) 48 people this distance per hour, so 96 in two hours. In other words, it is lucrative. For comparison, a Boeing 737 takes more than 2 hours to deliver 200 people along the same route and then be prepped for the return flight. Meaning, this aircraft can service half as many passengers as a B-737. It can probably also be manufactured for less than 1/10^{th} the price and its energy consumption in dollars is probably around 1/100.

This previously described, exemplary 11-minute airplane ride from DC to Boston has not arrived at Boston, it has arrived at a point about 12 miles above Boston. So, the descent and landing protocol described many paragraphs previous must be used and the result will be that even less battery power is needed (there will be a minute or two of coasting) than described in the last paragraph, and a minute or two will be added to the human experience. So, here is the result of the proposed prototype—a 13 minute, 400-mile flight; something that is currently considered wildly futuristic. Still, this is just the prototype, and the Applicant presumes that the next few decades will be used to get the aircraft up to 6,000 mph at even higher altitudes, with external booster-battery systems that can keep the aircraft's batteries fully charged until after takeoff and a minute or two of cruise, are completed and then separate from the aircraft and fly back to the launch area. Such a system's flight range could even be intercontinental and/or transcontinental while taking up less than an hour of our lives (100 miles per minute means we could go from LA to London in 55 minutes). This all seems like fantasy. It will instead be a simple extrapolation of the numbers and concepts put forth in the present application, coupled with an active industry and a lot of talented engineers to carry it forward.

### Approach Chronology and Landing Chronology

The approach and landing chronologies were already summarized above in the braking discussion, and they will be discussed thoroughly in the detailed description, so this segment will be forgone.

### Mass Considerations and Total Mass of Aircraft

The total mass of the aircraft is dependent upon the number of passengers. The average weight of a passenger is less than 200 pounds, let's say 180 pounds. Sixteen passengers has been chosen as a nice starting point for a first prototype, with the passengers in two rows of eight to a row. Of course the aircraft could have more or less passengers, or even more rows, without departing from the scope of the present application.

Thus, the basis weight of the aircraft is the weight of the passengers, or 16×180 lb=2,880 lb, or approximately 3,000 pounds. The amount of weight (sum total) of the fans is approximately 500 lb if they are to be made from aluminum alloy (because of thermal stressors) or 200 lb if they can be made from a fiber composite (preferred, if there are insignificant thermal stressors). The motors and batteries will probably combine for 2,000-3,000 lb, and the fuselage designed to carry all these things will probably weigh 6,000-8,000 pounds. Thus, the total weight (laden) of the aircraft can be estimated optimistically to be about 13,000 pounds. Which means that the impeller system needs to be provided with enough coils, magnets, and batteries to achieve a thrust of approximately 20,000 pounds. And if this requires more than 3,000 pounds of coils, magnets, and batteries, then as their weight is increased to provide more thrust and distance, the weight of this addition must be re-accounted for and the thrust raised a little more in a feedback equation that will balance out using modeling or a differential equation.

### Magnets, Coils, and Batteries

The motors that spin the fans, as described above, are comprised of annular rotors, with electrical coils in the annular rotors, and said rotors spinning within annular rows of magnets. The magnets are preferably rare-earth magnets, such as Neodymium or equivalent specimens, in the form of cubes. The cubes are arrayed side-by-side or end-to-end (cubes' ends are sides, technically, for want of a better term), and are preferably configured in what is called a Halbach array.

As summarized in Wikipedia, a Halbach array is a special arrangement of permanent magnets that augments the magnetic field on one side of the array while cancelling the field to near zero on the other side. This is achieved by having a spatially rotating pattern of magnetization and it also provides more field on the first side than if the magnets' poles were all aligned. The rotating pattern of permanent magnets (on the front face; left, up, right, down) can be continued indefinitely and have the same effect.

For a further understanding of a Halbach array, the reader is advised to go to the Wikipedia entry for it. It is not necessary to describe more here because Halbach arrays are very widely known to be used to lens annular rotor coil fluxes onto annular stator coils, or vice versa. What is new here is that the rotor rides between two concentric, oppositely-fluxed (lensed in opposite radial directions) Halbach arrays. However, this is not completely new because it has been disclosed exactly as proposed herein by Chinese patent CN 104389800 B. Although the Applicant did independently originate the improvement, there is no credit taken for it because CN 104389800 B patent is so similar and was antecedent. However, the current invention fuses the rotor directly to the backside (or the inner diameter) of the thing to be rotated, wherein CN 104389800 B is evidently turning a shaft. This is important because going shaftless inordinately simplifies the system and reduces the space it takes up.

The power of the impeller modules can be approximated by the sum of the mass of all of the magnets. For each mass unit of magnets that exist, a corresponding mass of coils will exist, but the coils are copper, a very light substance, and their insulations are also lightweight. Such that the overwhelming mass concern is the magnets themselves, because Neodymium, and most conceivable rare-earth magnets, are iron-based and thus unavoidably heavy. Of course, novel alternatives that do not require the heavy magnets but still provide the high torque, would be preferred, but the Applicant is unaware of any.

The first impulse in the design of such an aircraft is to minimize their (the magnets') number or size or both. After all, we have spent a lot of our strategy in elimination of mass. The lightest aircraft possible seems to be the means to our ends. But this is where the proposed invention is counterintuitive. The Halbach Array allows us to get a lot of flux out of relatively small masses of the iron-based cubes, but there is a certain amount required for liftoff and it must be met. Instead of sticking to the margins of what is needed, the applicant proposes significantly increasing the amount of magnetic mass, even if the mass of the magnets starts to become a significant mass portion of the aircraft; although hopefully not as massive as the payload (16 people), it might need to be to achieve the 1.5 g acceleration at full payload.

The counter-intuitive aspect of such thinking is that, although the magnets are heavy, there would normally be a certain minimum amount/weight of them (i.e. 1,000 pounds) available in order to levitate or fly the aircraft. This represents perhaps 10% of the overall aircraft, if the laden aircraft, with almost 3,000 lb in passengers, totals 10,000 lb. Doubling (i.e. 2,000 pounds) the amount of magnets increases the total weight of the aircraft to 11,000 lb, and increases the proportion of magnet weight to total weight to 18% (magnet weight divided by total weight), but it DOUBLES the acceleration. Of course, doubling the amount of magnets requires doubling the amount of coils and consequently doubling the voltage of the battery system. But the doubling of acceleration reduces the flight time by a factor of approximately 2. It also doubles (minus the inertia factor contributed by the 10% increase in mass) the velocity at each stage of the journey during acceleration (after it reaches max velocity, which will also be increased by the doubling of the batteries, coils, etc., the acceleration advantage does not factor in). Because the aircraft spends half as much time accelerating to high speed, and travels at a much higher top airspeed, it spends much less time in the air, and thus the battery usage to maintain the aircraft aloft (via lift-induced drag) is tremendously reduced, resulting in the use of much less battery weight. As a boundary-value problem, for additional point of view, imagine an aircraft (helicopter) moving from one city to another at 100 mph. Where does most of its fuel reserve/power go to? Suspending the aircraft. So, we have written off much of the losses associated with levitating the aircraft by simply doing so for half as long (estimated), by using 2,000 lb of magnets instead of 1,000 lb. This was all an example and if in reality it takes up to 4,000 lb of magnets to do what is proposed herein, it would still result in only a 14,000-pound aircraft, an increase of only 1.4 times the originally proposed weight.

The most obvious battery source (at the time of filing) that could be used is clusters or stacks of Lithium-Ion Batteries. These could be manufactured to be of various convenient shapes so that they can be stuffed into all the dead-space areas of the aircraft and/or wings. However, many other battery types are available and the Applicant does not rule any rechargeable battery out of consideration. There are many battery types available from the various industries that are using them, and whichever of them is most readily available or for any reason preferable should be considered for use with this invention.

It could also be possible, but unlikely, to use a fuel cell as the source of electrical energy as an alternative, or in combination with, the batteries. There are many types of fuel cells and the preferred one is not the subject of this application. For example, a high-voltage fuel cell running on stored hydrogen fuel would suffice. This approach would utilize onboard stores of hydrogen. It could also utilize onboard stores of oxygen, or even better, there must be technology available for extracting oxygen from the ambient air or flow-through air, such that the aircraft would not need its own oxygen supply; even better would be a fuel cell that simply uses the ambient air for its oxygen content. More likely is that there is technology known in the arts for oxidizing the hydrogen fuel in a fuel cell without separating the oxygen from the air. If the fuel cell option is preferred, the wings could either still be swapped out between trips for wings with a fresh hydrogen supply or the wings could be permanently fixed to the aircraft and the airport facility would have a refueling system for resupplying the wings with a complete charge of fresh hydrogen in the short time that the airport is docked and/or moving through the airport facility.

While on the topic of alternative power sources, nothing should be ruled out; everything is on the table while for the prototype all that is needed really is a compact high-voltage source of electricity. But still while on this topic, an inquiry should be made into what nuclear energy can offer the present discussion. A nuclear reactor is too large and more germanely too heavy to be considered an essential part of this overall discussion. However, high-tech (fission) micro-reactors are approximately the size of an American tractor-trailer (smaller in volume than the fuselage of a Boeing 787). Of course they are inordinately heavy. But their electrical output is enormous, continuous, and for current concerns it is virtually endless. It has been purported in various news reports and in the prior art that a nuclear-powered aircraft could stay in the sky for over a year while operating at moderate power. Although this is useless for immediate VTOL objectives, it could help our bespoke and long-term VTOL objectives. One of the limitations or possible complaints of this application could well be that the battery lives of the aircraft types proffered herein are short, meaning global reach could require multiple stops at multiple airports.

To mentally arrive to the next stage of this discussion, the reader is asked to kindly imagine first an air-force in-air refueling aircraft. Then imagine it wherein its fuselage houses a high-tech fission micro-reactor (and it is pilotless and the charging cables, see below, trail far behind the aircraft). Then imagine it with enormously proportioned supersonic wings (jumbo versions of those shown in FIG. 1D) and many (i.e. conjoined or separated) power nacelles or in-wing drives as per FIG. 5F, or even better yet, less but larger versions of those. If we call it a mega-plane, and presume it is obvious that its wings will be huge and it will travel at around (or over) 3,000 mph while permanently residing at an altitude of 85,000 (or more) feet, with or without the uncanny name it could advantageously trail many (a dozen or more) spaced electrical cables behind it. When one of the aircrafts described in this application caught up to the mega-plane it could functionally connect to one of the electrical cables such that it would cease using its own battery power to drive its fans and would instead use the electrical power from its respective electrical cable (from the fission reactor) to drive itself. The electrical cable connection would probably be tension-based, such that the mega-plane would slightly pull the aircrafts, but the aircrafts' impeller systems would themselves be driven at a high rate in order to keep their impeller systems from dragging or choking. It is further possible that the electrical cable connection would have the hardware and software required to simultaneously recharge the batteries of the aircrafts in addition to driving their impeller systems, while the hardware would also include a mechanical assembly designed to guide the cables' conductive ends to the aircrafts in the right place and keep them there (fins and magnets, probably). In some scenarios the mega-planes would circumscribe the globe every several hours, and in other scenarios (such as going up and down the east or west coasts of the US or traveling between Madrid and St. Petersburg or between London and Istanbul) they could do a big wide 180 at the end of these shorter routes and just oscillate about two loci while the relevant routes would be serviced by aircrafts coming up to the mega-plane, hitching onto it to borrow its electricity, and then unhitching off of it to pursue a course not in line with that of the mega-plane, wherein upon unhitching each aircraft has more and not less battery power than it had upon hitching, and much less distance to traverse than if it had performed the trip unaided. Belt-like routes could also be effective, such as: England to North America to the Caribbean to North Africa to Turkey to Poland to Sweden to England; and simultaneously another one in the reverse direction. Or another belt, such as: Los Angeles to Seattle to Korea to Australia to Los Angeles. Everyone within 2,000 miles of the belts can avail of the belts. But we have gotten off-topic. Let's get down to the absolute basics of this thing.

### Impeller System Intake

The impeller system intake is at the nose/front of the aircraft and encompasses nearly the entire cross-section/profile of the front of the aircraft. It juts out, cantilever fashion, from the front of the 1^{st} impeller modules, creating an impeller system intake duct that separates the 1^{st} impeller module's intake air from the air that passes around the nose of the aircraft and, unimpededly, around the aircraft itself. As mentioned above, there is no nose cone and the aircraft, as it leaps across the stratosphere after having bounded straight up through the troposphere directly, experiences very low drag that would deter the aircraft's acceleration. All the while the incoming air at the nose is impinging on the front of the aircraft, and thereby being sucked into the impeller system.

The incoming air during a major part of the vertical traversal of the troposphere will have relatively small relative velocity, such that the impeller system intake should be an open-throated duct. The fans' speeds should be modulated to provide maximum thrust at this point while not breaking any aerospace no-no's.

However, once the aircraft begins exiting the troposphere (after 10 miles up), the aircraft trajectory bends over, that is it begins to become continuously more horizontal and less vertical, slowly and via an intelligent arcing protocol, such that the aircraft's airspeed will become vastly larger and larger while the air density atrophies to smaller and smaller values.

At some point (around 300-400 mph plus or minus an additional 100 mph) the 1^{st} impeller module's fans possibly will not be able to spin fast enough to deal with the high-velocity intake air. The outlook for the 2^{nd} impeller module's fans, spinning much faster than the 1^{st} impeller module, is just as dire if no mediation is enacted. At this (or another near) point, the impeller system intake probably will (or must) be throttled in a way that constricts the volumetric air flow through the impeller system.

The throttling and/or shocking of the impeller system intake air could be accomplished with at least one variable intake ramp. Wikipedia has a substantial entry dealing with intake ramps and all of it should be considered relevant herein. However, as we are trying to get a working prototype up and going right now, with experimentation and new modeling being used later to further perfect the aircraft, we had to propose something in addition to the swirler, because it is possible the swirler will not be capable of working properly. It is also possible that a best embodiment for the impeller system intake could involve multiple intake ramps and also spill doors.

What is proposed in a non-preferred embodiment is an impeller system intake with at least one top wall and at least one bottom wall, wherein the at least one top wall has an intake ramp and the at least one bottom wall has an intake ramp. The ramps can be angled toward each other to control the relative velocity and pressure of the intake air being delivered to the 1^{st} impeller module's 1^{st} diagonal fans. They can also be angled further toward each other such that their trailing edges meet, which closes off the impeller system intake and produces a vacuum, since the fans will evacuate themselves, such that the fans can all (including the 2^{nd} impeller module's centrifugal fans) accelerate to takeoff rates without air resistance.

Because the nose of the aircraft is rounded on its ends, a top ramp and a bottom ramp might not be sufficient. Supplemental ramps can be distributed where advantageous to implement the proposed strategy, and this will require further research, testing, and design, but it should not be considered beyond normal skill in the art. Herein the term “ramps” describes not only intake ramps (for supersonic flight), but also other angular plates that could be complimentarily repositionable to create an effective inner intake geometry for the impeller system intake.

The applicant is not sure how long the impeller system intake duct should be. Logically, the air being shocked/slowed/pressurized by the intake ramps (or swirler) needs a sufficient longitudinal extent to attain a homogeneous pressure distribution or quasi-equilibrium before it is sucked into the 1^{st} impeller system. Hopefully it is only 3-5 feet, but it might have to be longer. This is another reason why the swirler embodiments might be preferred.

In a non-preferred embodiment with intake ramps (but this also describes in essence an embodiment, provided herein and later, that does the same thing using another way to seal the intake) having for instance a top intake ramp and a bottom intake ramp, some of the intake ramps can come together to hermetically seal the impeller system intake completely, at which point during the takeoff runup the impeller system will evacuate itself (all air, literally) out the rear of the aircraft. Once this has been accomplished, and even while it is being accomplished, the impeller system's fans are all rotationally accelerating to their takeoff rates such that when takeoff is initiated, the fans are already rotating at the appropriate takeoff rates, without having encountered air resistance or wasted thrust in accelerating to those rates. This reduces the drain on the battery that would normally be incurred during a normal runup of an electrical or fossil fuel impeller system that had no such measures. In a preferred embodiment without intake ramps, another panel or pivoting wall portion could be used to close the impeller intake. This will be described in greater detail in the detailed description.

### About the Intake Ramps

Firstly the Applicant notes that the preferred embodiment for the present invention is to use a swirler in the intake and not intake ramps. So, the subsequent discussion of them can be skipped with relative zest. However, it has been left in the invention summary in case the swirler turns out to be unfeasible.

Intake ramps (unlike the swirler) are well known in the supersonic flight arts. They are usually used to shock the intake flow down to a velocity, relative to the engine, that allows the engine to work on the air while not creating shock waves that hinder or prohibit the proper functioning of the engine(s). Shocking the air down to a lower velocity increases its pressure. This is done in order that the compressor elements of a typical turbojet engine do not create of shock waves that cause constant flow problems as well as structural damage to the aircraft and loud noises. The intake ramps squeeze the cross-sectional area of the intake to be less than it is, and then they let the flow expand. The air stream within the intake is decelerated and its pressure is increased. As concerns the present application, however, there is not so much of a need to slow down the air stream coming in, because the vanes of the 1^{st} and 2^{nd} impeller system do not present 3-dimensional impact surfaces that the incoming air will collide with and create the flow/sonic problems. The fan vanes of the entire impeller system are two-dimensional plates (however twisted they may be they are not three-dimensional bodies) with razor-fine leading edges and this results in their ability to cut into incoming air at very high velocity hopefully without causing flow problems or sonic problems.

So, why have we included intake ramps in the present disclosure? We might have to include them because the air density will change as a function of altitude and the airspeed of the aircraft is going to be very high and because the upper ranges of airspeed are so disparate from the lower ranges of speed and because the air density varies so greatly along a continuum between sea level and the preferred flight level, which will be more than 70,000 feet. So, at these high altitudes and high speeds, we could use the intake ramps to compress the air, which is coming in at a very low air density at high altitudes, for a sufficient pressure to exist just before the intake of the 1^{st} impeller module, while not reducing the flow capacity. And we can secondly use the intake ramps to slow the air down, so that the 1^{st} impeller module and the 2^{nd} impeller module can be driven at lower speeds, such that their material requirements, as well as their rate of failure, can be minimized.

The intake ramps begin the flight and end it with the intake ramps laid down flat against the wall(s) of the impeller system intake. They will likely begin to move away from the wall(s) once the aircraft has attained adequate airspeed to require the modification of impeller system intake pressure and impeller system intake velocity. Their angles, relative to the horizontal, will be controlled, respectively, by a CPU. Their deflection angles at any given time will be the result of a computer program that has as its inputs airspeed, altitude, 1^{st} impeller module rate of rotation, and 2^{nd} impeller module rate of rotation.

### Vertical Takeoff and Landing (VTOL)

Although the shape of the aircraft and the placement of the impeller modules therein, and the impeller modules themselves, comprise the bulk of the present discussion, it must be admitted by the Applicant that the system itself is the result of the applicant's persistent inquiry concerning the idea that an elongated multi-passenger aircraft would be best lifted off the ground and landed softly thereon via an aircraft that had a 1^{st} impeller module at its front and a 2^{nd} impeller module at its rear, wherein both impeller modules could deflect the thrust downwardly during a takeoff protocol and/or a landing protocol.

Only after the applicant invented the 1^{st} impeller module during the development of another invention, a patent application for which will be filed soon and whose overall impeller system will further and fully expound on the 1^{st} impeller module of the present application, did the idea arise of using the disclosed 1^{st} impeller module at the front of the aircraft while superseding the nose cone. The idea of having an impeller module at the front, which can aim thrust down, and an impeller module at the rear, which can also aim thrust down, might be pretty common among the minds trying to imagine a multi-passenger (i.e. more than 4 passengers) long aircraft. The applicant has always had this in his mind, but the present invention, once the 1^{st} impeller module was invented during the pursual of the other invention, erupted from the applicant's mind only after the idea of accelerating the 1^{st} impeller intake air to a very high and low-cross-sectional-area exhaust had come to him. The deliverance of the 1^{st} impeller module exhaust to the 2^{nd} impeller module's intake followed, somehow. The memory is fuzzy. But using the large-diameter, extremely-high-rotational-rate centrifugal fans to further accelerate it was also quickly settled upon and the problems associated with that part solved. The applicant is unsure of when and how it all happened. However, a lot of the rest has been serendipity, particularly the fact that the 1^{st} impeller module ejects its exhaust, if properly configured, straight downwardly. The narrowness of the 2^{nd} impeller module exhausts (thrust ducts) was also serendipity, for it allows us to valve the air there straight downwardly using very small, yet effective, valve blocks or thrust vectoring exhaust ducts.

The fact is that the VTOL nature of the present invention is a de facto prerequisite for the functionality of the proposed aircraft, so it should not be overlooked. It is not only necessary for constructing a perfected aircraft, but it was the impetus for the overall enquiry, by the applicant, that led to the supersonic aspects as well as the mass-reduction aspects, and that resulted in the instant application. However, once the VTOL aspects were solved and their means manifested in the present invention, the VTOL aspects had to be somewhat minimized in this discussion. This has been inadvertent and a (in hind-sight) result of the more exciting and profound improvements deserving of more abundant disclosure. It is noted that the VTOL nature/aspects of the present application are necessary conditions for the preferred embodiment of the proposed invention, if it is to operate simply and efficiently. A party may pull off a practicable edition/variant of the present application without VTOL, and particularly, without the VTOL embodiments proposed herein, but the party will probably be achieving an inferior variant to the present invention. Following the detailed description of the preferred embodiments, below, the solution is clear, it is important, it is simple, and it is entirely feasible and possibly, once run up to scale, very inexpensive.

It is noted that the 1^{st} impeller module is extremely important to the present application, but has been and will be cursorily discussed. This is because the 1^{st} impeller module has been borrowed from a patent application that will be filed by the Applicant subsequently to the filing of the current application. For this reason, to comply with the requirements of 35 USC 102, 1^{st} paragraph, enough of the 1^{st} impeller module has been described herein to fulfill the patentability requirements, but for a complete understanding, the other patent application will offer a fuller account of it.

### Safety Considerations and Modes of Failure

Considering that almost everything in the current application is completely new, the prototype, and even more so the saleable product that comes from it, are subject to a critical appreciation of the costs of a catastrophic failure, even if the chances of this are extremely low. Given the proposed airspeeds, the vertical takeoff, approach methodology, and the various vertical landing aspects, it would seem there is no room for failure of even a single moving part of the aircraft. This is not completely true. The conditions for prior art long-haul flight for a regular aircraft hinge on whether the regular aircraft has two or more engines, and how often (per number of flight hours) the engine model needs to be shut down during a flight. If it has only two engines of a model that has not been in service long enough to prove that it almost never needs to be shut down, its flight path is subject to stringent restraints. The flight path restrictions are greatly reduced over time due to re-engineering, and the restraints are dependent on the actuarial calculations that basically factor in the likelihood that the second engine will fail after the first engine fails. So, so-named ETOPS (extended twin ops) regulations allow the flight path of a multi-engine aircraft to be more straight and less serpentine or zig-zag than that of a single-engine aircraft tracing a path that keeps the aircraft close to airports all the time. The actuary science behind this is convoluted but rooted in a safety threshold that by design statistically never allows an aircraft to be unable to be too far away from an airfield to land safely because of the sequential shutdown of both engines. The ETOPS rating is a result of manufacturer testing, FAA testing, and also proven success rate (usage hours between failures of an entire fleet of the particular engine model).

Importantly, the proposed invention has so many impellers in it that the ETOPS factors are scrambled and not as important and probably will be much more lenient. The proposed aircraft has two impeller modules each comprising at least two fans. All are completely stand-alone and self-driven. The complete failure of a fan of the 1^{st} impeller module would slow the aircraft, but it would not be catastrophic, as the controller could adjust to the stopped fan and continue to provide a very large thrust via the still-active fans, while also still facilitating vertical landing when an airfield is reached. The chances that another impeller would fail while accomplishing this is very low. Still, to offset this, we must remember that the proposed aircraft has very few moving parts and will be therefore less susceptible to the 2^{nd} failure (as it will have been for the 1^{st} failure).

However, this is not the case for the 2^{nd} impeller module. Because of two reasons, a complete failure of one of the centrifugal fans would hamper landing. It will not hamper flight because in the event that one of the centrifugal fans of the 2^{nd} impeller module failed, the bypass(es) above the 2^{nd} impeller module would open, letting the exhaust from the 1^{st} impeller module drive the aircraft by itself (the other, working centrifugal fan would be forcibly arrested, elsewise its Coriolis force would make continued flight very difficult or even impossible).

As mentioned, the failure of one of the 2^{nd} impeller module fans would prohibit the normal landing operation in two ways. The first way is that the remaining fan cannot spin fast enough to provide downward thrust from its respective side (left or right) without creating an uncontrollable level of Coriolis force that would twist one side of the aircraft downwardly. The second way is that it would only be providing downward thrust from one side of the aircraft, also twisting one side of the aircraft downwardly (the VTOL valve boxes would have only one side providing downward thrust). Therefore, an emergency landing protocol must be available if we are to protect the prototype, and further down the road the people in the aircraft, from a crash caused by failure of one of the 2^{nd} impeller module fans.

Of course there is the obvious and desirable possibility, and this might be required for many years until the actuarial data allow us to forgo considerations of such a failure, of putting a parachute in the top of the aircraft, a little aftward of the center of mass. It is presumed at the time of filing that the prototype will require 1) a large parachute, 2) a pyrotechnic deployment system for the parachute, and 3) a control system for discharging the parachute upwardly and rearwardly while also perhaps discharging some smaller parachutes that are located elsewhere along the top of the aircraft. The parachute could have pyrotechnic or other means for expanding it immediately once it is freed from its launch bore.

Still it is foreseen that there are other elements whose total failure or immobility due to jamming would be extremely dangerous. Such as, for example, the flaps/flaperons, the stabilator, and the flaps. As there is no way to write this off as an overconcern, it must be dealt with by the entities that attempt to manufacture the proposed aircraft or one like it. Every major moving aeronautical implement on the proposed aircraft, especially the prototype and early versions of the aircraft, will have a redundant actuator. Even if this means two equivalent parallel actuators (pistons, servomotors, worm-gear motors, whatever) are in place for every manipulable part with a first actuator being neutralized or decoupled in the event of a 1^{st} failure and the second actuator taking over for the 1^{st}, no useful safety feature can be off limits. However, strategic systems that are redundant or super-reliable in themselves are more welcome, and the engineers of the world can figure them out and implement them. This isn't the first time the engineering world has been called upon to produce a fail-safe system for an important and nascent industry, and this time it's as important as ever. In the case of a double parallel redundancy, the controller for the aircraft must be provided with intelligent algorithms for such a handoff of duty among a single actuator pair, as well as a handoff from a primary controller to a backup controller in the event of failure of the primary controller. This all won't be easy, but most of it will be required at first. Nonetheless, it is not prohibitive. If the problem of the possible failure of a 2^{nd} impeller module fan can be solved, there can be little nay-saying of the proposed invention. But even if it can't, we have the parachute.

Still, the possibility exists of a large-scale electrical outage or surge, and so the parachute with automatic (caused by the outage or surge itself or accelerometer readings, etc.) as well as manual (from air-traffic-control or another remote monitoring station) will still be necessary at first and, for the foreseeable future, ubiquitous in the industry. The wings, fuselage, fan vanes, empennage, etc. must be deliberately over-engineered to preclude the breakage of a non-moving part (or of a moving part). The latter phenomenon is unacceptable and probably fatal and therefore when something must be made thicker or of a stronger alloy, it will be. A steep regimen of incremental re-designs and testing of them can tell us, later, what the perfected aircraft will actually entail, structurally. Perhaps many years will be needed to show us how light and fast the aircraft can be made. For now, it will be a bit heavier than the perfected aircraft. A major bevvy of investments or especially an immense angel investment dedicated to the development of the proposed aircraft in all its potential forms could facilitate all the testing needed to make the perfected aircraft within just a few years, and a consequent fleet of available perfected aircrafts would result and be a priceless boon to society and the planet.

### Heating and Cooling

The proposed invention has two heat problems (other than external heat on the skin of the aircraft). The first is the temperature inside the cabin and the second is the temperature of the rotor coils.

1) The temperature inside the cabin will begin, following takeoff, at the same temperature as it was when the hatch closed.

The body heat of the passengers will start to slowly raise the cabin temperature but the aircraft will take off before this becomes uncomfortable. Within 2 minutes the aircraft will be traveling through sub-zero temperatures, due to the high altitude that is quickly acquired by the takeoff chronologies described herein. It is foreseen that insulation of the cabin would be a complicated affair that is not worth pursuing since the proposed flight times are brief, but insulation is always an obvious supplementary solution. Also, due to the large pressure difference between the passenger compartment and the ambient air, the passenger compartment will likely have a multi-layer high-strength, high-rigidity shell. This will probably offer a moderate thermal barrier to keep heat in the compartment.

However, the aircraft will fly extremely fast through very cold temperatures for the majority of its flight. The convection across the outer skin of the aircraft at such speeds is very high, and with the extremely low temperatures the aircraft will reside in during the middle portion of the trip/flight, there must be either insulation with a small amount of cabin heating, or a substantial effort toward cabin heating. The good thing is that we probably won't ever have to cool the cabin . . . air conditioners are heavy and complicated. As for the heating of the cabin, we already have an enormous source of electrical energy on board (the batteries), and the simplest solution is to place around the interior of the cabin a plurality of space heaters, probably with most of them located under some of the seats, but other places are possible. In a simplest embodiment each space heater comprises a fan and a resistor-based electrical heat exchanger, with the former upstream of the latter or vice versa. The space heaters can be positioned and shaped to conform to the ergonomics of the cabin.

It is further envisioned that at least one of the space heaters could incorporate a small oxygen supply system since the cabin, being insulated from the environment, will be continually deprived of oxygen by the respiration of the occupants. Putting the oxygen supply system as a part of at least one of the space heaters allows each oxygen supply systems to avail itself of the fan of the space heater, such that an additional set of fans for the oxygen supply systems is unneeded. Also included with the oxygen supply system must be an anti-viral, anti-bacterial filter system. In other words, at least one space heater would have upstream or downstream of its fan an outlet from a compressed source of oxygen and a germ filter, the compressed source of oxygen being perhaps an important life-support system for this aircraft that flies so high. However, it is possible that each flight will be so brief that the oxygen is not needed. On the other hand, the people are packed pretty tightly in the aircraft, so several oxygen supply systems might be preferred.

2) The rotor coils will need to be cooled. Each 1^{st} impeller module can be provided with (see figures) a small axial or diagonal fan near its axis and integrally formed with each 1^{st} impeller module, that blows a small amount of ambient air into an annular space that is coincident with the rotor coils, at which point the ambient air, being slightly accelerated and/or pressurized, flows along the coils, or between them or between their poles or both. This embodiment needs further development, but the description provided herein, in conjunction with the drawings provided in this application, offers a best-mode example that at least satisfies the 35 U.S.C. 112, 1^{st} paragraph requirements.

Each 2^{nd} impeller module can be provided with (not shown in the figures, as it would be very small) a rotor coil cooling ducting system wherein a very small portion of the air in the 2^{nd} impeller module fans (one tiny scoop from each entrainment duct/passage of each 2^{nd} impeller module fan) is scooped or ducted away from the outwardly flowing main flow to pass between the rotor coils, or between their poles, or both between/among the coils and the coils' poles.

### Booster Module

Because the aircraft only carries a certain maximum mass of batteries, it is obvious that a booster module, if used for the majority of power expenditures during takeoff and/or initial acceleration, can boost the range of the aircraft by hundreds of miles. Options for this are unlimited. The minimalist sense of this would be a streamlined battery pack or set of battery packs that are attached to the aircraft such that after the aircraft nears a threshold altitude or threshold speed, they fall off and fall back down to the landing field via parachutes (with or without some additional thrust device to make sure they land in the right place). The maximalist sense of this would be having a booster that is another version of the aircraft itself, without passengers/payload and with batteries in their place. It might be scaled down from the aircraft's size, or just shorter, or have smaller sized 1^{st} and 2^{nd} impeller modules and its wings could still be the battery chamber or one of multiple battery chambers. Everything about it could be smaller than the aircraft itself or it could be a repurposed aircraft. The latter alternative, wherein the booster module is another aircraft just like the main aircraft but with batteries instead of people/cargo, is advantageous because it would not require new machines or technologies, and there would be commonality of parts. Regardless, a maximalist approach would have the booster comprising its own impeller modules with their own magnets and accoutrements, as well as its battery-wings, and a similar empennage and a stand-alone VTOL system so it could brake and land on its own. Of course, the booster will be removably fastened to the aircraft, either nestled against it or held spatially distant by struts or beams or the like.

So, following the string of the last paragraph, the options for the booster module encompass on one end everything from a few added batteries, advantageously shaped for suppressed drag at low speeds and with a parachute, to on the other end a fully functional booster aircraft that is attached to the main aircraft via some sort of brace or adapter, such that they can travel together during acceleration to a high speed, wherein a portion of the thrust (but 100% of the electrical power) is contributed by the booster aircraft, and the booster aircraft can also break away from the main aircraft, turn around, go home (or somewhere else), and land in an airfield. There are dozens of other types of booster modules that would be obvious to one of ordinary skill in the art. For moderate flights they might only consist of extra batteries, with the batteries in an airframe that is shaped to glide back to the launch field and land softly. For long flights they might consist of a separable supersonic VTOL aircraft whose entire volume, power, and mass are devoted to the cargo of batteries, but are still equipped to return to the landing field and land there for reuse. These booster aircraft could closely resemble the main aircraft but might omit the long passenger cabin and life-support and ergonomic elements. They could also be shorter in every dimension from the main aircraft and they, as well as the alternative, more simple booster modules, could attach to the main aircraft via braces, claws, loops, straps or other flexible tension members, tow bars, direct joints, adapters, skiffs, struts, magnets, electromagnets, latches, clamps, cables, etc. In this scenario, the aircrafts will of course separate once the batteries of the booster aircraft are almost depleted. The booster aircraft would then glide home and use the rest of its battery power to land.

Another booster system could be incorporated into the airport/airfield launch system mentioned previously. If the takeoff were performed using a vertical track, the track could have a catapult system built in and the track could extend over 1,000 feet above the surface of the earth. The aircraft's impellers could be active during this vertical launch scheme or (best mode) not. Anyway, the vertical track with a catapult system could accelerate the aircraft or aircraft-plus-booster combination to 300-500 mph regardless of how massive the booster module is, such that the acceleration scheme during the vertical-only portion of the takeoff will be different from the preferred embodiments presented in this application.

It is presumed that a perfected aircraft, with a tall launch track and with the maximized booster module attached at takeoff, could leave the aircraft in the advantageous position of being able to travel 600-2,000 miles more, on a single charge, than it would be without the booster embodiments described hereinabove. 600 miles is of course actually a conservative estimate. It is also foreseen that it might be simpler or cheaper to hop the aircraft around in 500-mile or 1,000-mile increments, with repeated battery changes, to get around the world, than to incorporate the boosters discussed herein. This will be left to the incipient industries to decide, or accommodate, following some testing, modeling, and market analysis.

Instead of an external booster system, the range of the aircraft could be extended by replacing some of the seats with internal replaceable batteries. For the same size/model airframe, the more seats that are swapped out for booster batteries, the farther the aircraft can go.

### Alternative Types of Motors and Electrical Systems

It is inevitable, if the presently proposed invention were to become globally successful and prevalent, that there will be at least two problems: 1) a run on rare-earth elements, for their use as an ingredient in the magnets of this invention, such that their supply will increase steadily but their demand will rise hyperbolically and, from a historical point of view, instantaneously or at least disruptively—this will lead to neodymium and the other elements/compounds useful for powerful permanent magnets becoming very expensive, offsetting the benefits to the common person; and 2) magnets are heavy. The Applicant proposes, and in fact prefers as a most advantageous embodiment, that the motors that drive the fans are not based on permanent magnets. It would be much better to use motors that do not have magnets, such as for example synchronous or asynchronous motors. The Halbach-array permanent (rare-earth) magnet configuration proposed herein is very powerful and it has proved useful in this discussion, and with no political or humanitarian objection to the pillaging of the earth and displacement of the people on it, the rare-earth option could become the standard means for propelling people around the world. But if a review of the scientific research literature cannot put forth a competitor for this embodiment that does not strip the very mountains, valleys, and streams of the world, there must be a huge effort (or a simple one—this is a new field and it seems that lots of ideas work in lots of ways) to find a lightweight alternative to the proposed permanent-magnet embodiments proposed in this application. The theme of this endeavor should be five words: copper is cheap and light. Nonetheless, the prototype should be made of Halbach-array permanent rare-earth magnets, and this embodiment could be used until someone invents a better motor, preferably one that does not entail the baggage of permanent magnets and particularly rare-earth magnets. Their name says it all—they are rare, and if the whole world were to suddenly want to use them in order to fly about, a lot of the earth would need to be dug up.

Pursuant to the previous paragraph, the Applicant concedes that he cannot describe a fully-functional non-permanent-magnet alternative to the Halbach array system proposed herein, but he does propose that an electrical engineer of higher-than-ordinary skill in her/his art could read this document and possibly just solve every problem for us, including the pre-eminent problem of how to use electrified conductor coils for both rotors and stators, and how much/many of each to use Eliminating the magnets has a compounded efficiency effect via the overall reduction in the mass of the aircraft, and thereby the reduced battery power needed to accelerate the now-reduced mass of the aircraft. So this option must be seriously pursued.

### Miscellany

It is of course always preferred and will be obvious to ones of ordinary skill in the art that each component of the proposed aircraft be made of the most advantageous material available while constraining the costs of manufacture. In many places and parts of the proposed invention metals will be necessary, and those metals should be the lightest and strongest metals that are appropriate for fulfilling each component's task. Although many come to mind, the materials most suitable for high-strength applications should probably be made of an aluminum alloy, and most preferably Al—Ti alloy. However, other aluminum alloys and martensitic steels or other ferritic alloys (etc. ad nauseum) could be useful for small or thin parts or also for pieces subject to extreme thermal stress. The ASME can be used in conjunction with testing and modelling to prescribe all the materials optimal for metal parts as well as for non-metal parts. The components that can be made from a non-metal should preferably be reinforced composites, such as fiber-reinforced plastic, fiber-reinforced resin composite, particulate-reinforced plastic or resin, other reinforced thermosets and thermoplastics of all types, etc. The list for potential materials for each part is the ASME tables themselves (i.e. what strength is needed, and at what temperature and weight/volume? Select from the relevant material-selection tables in the available ASME tables and worldwide literature), as well as any patent or NPL source available online. Also, for some components that must be lightweight but also might experience thermal stress, the Applicant foresees using low-thermal-resistance materials coated (i.e. via spray coating) with a ceramic or another convenient applique, when this is possible, and when not possible, a metallic remedy will be used. Material selection should not be grounds for patentability in a follow-on advancement that is predicated on the present application, due to the wealth of professional knowledge in the world that can dedicate and prescribe any industrial use with its adequate material. Metallurgy and polymer science are exhaustively developed now and their respective resources should be seen as grazing ground for any industry that steps up to manifest the proposed invention in our daily and commercial lives.

Also, it is quite possible that the neodymium Halbach array magnets are not the best arrangement for driving the rotor coils. The Applicant is not fully in tune with the world of electric motors, and it is possible that many types of stator magnets and or arrays of stator magnets might be more powerful, per unit mass, than what is proposed herein. In this case, the more powerful-per-unit-mass magnet or magnetic array should always be promulgated, if its price is not excessively exorbitant, for use within the current invention, but if it exists in the prior art it should be considered obvious, as any engineer who comes into the understanding of the contents of the present application, with previous knowledge of another motorized system that is better, can combine the non-neodymium-Halbach, superior magnet or magnetic array with the other components taught herein. Likewise, anyone that comes to understand the present application can go off looking for a more amenable or more powerful magnet or magnetic array and, having found it, import it into the current invention. These activities are available to anyone of ordinary skill in the art, and should not constitute qualitative, patentable improvements on what is proposed herein.

It is also possible that an asynchronous motor could be used, to eliminate the mass of the magnets proposed herein. It is additionally possible to use a rare-earth magnet that is not neodymium, or even, someone could use a magnet that is not rare-earth. The preferred embodiments proposed herein are simply a first offering for the industry, the offering that is coming off the Applicant's head as he types. Relying on a single type of magnet, if this invention is shown to be enormously successful, will lead to shortages, price-gouging, and strategic export-bans, especially by the country and/or companies that currently mine(s) most of the neodymium in the world. So, it is hoped that there are readily available sources of powerful permanent magnets available that do not rely on elemental neodymium, and it hoped for in parallel that elemental neodymium can be mined at scale in many places where it is currently not.

There can be no confident divination herein of how the prototype will be completed. So too there can be even less settled alignment herein of how the perfected aircraft will deviate from this application, and said perfected aircraft eventually must assuredly come to exist, via vast and diverse disciplines of future endeavors, those endeavors which will accomplish what has been proposed in a more basic sense by this application.

In terms of the scope of coverage of the instant application; although a prodigious amount of text has been consigned to the public record herein, no lone sentence, paragraph, figure, title, abstract, or various combinations of the foregoing segments should be seen as limiting the coverage of the present application other than what is delineated by the claims as tendered hereinbelow, at the terminus of this application. The claims stand alone, by their support via this discussion but exclusively nonobservant of this discussion's syntax or vocabulary, in what they directly claim, one word at a time.

### Methods of Manufacturing the Rotors

The rotors (impeller/fan+electrical rotor coil housing combinations) can be constructed via a “lost wax” or analogous method and all the analogous methods are well-known in the art. Conceivably in this case a copy model of the eventual (end-product) rotor is built up via a 3D printing or SLS or equivalent equipment that is rotationally based (the build-up is rotated on a mandrel while it is worked on), such that the rotors' copy models are built up of a sinter-based metallic (or newer-tech) substance that can be melted away later. Once the copy model has been built up it can be machined to perfection and then it is encased in a liquid-based, hardening plaster mold, inside and out (meaning the mold material will fill completely all hollow spaces in the copy model). At this point the filled mold (the plaster part, or if not plaster a like substance, whatever is being used today instead of plaster) is subjected to a temperature that melts away the sinter/substance of the copy model but does not affect the plaster (or analogous material). The mold is now empty and can be used as a die into which the real metal (probably a high-performance, high-heat-resistant aluminum alloy) can be poured into it in a very-high-temperature, molten state and left to solidify via cooling. During this stage, any heat cycle or curing, tempering or heat-stressing, etc. metallurgical work can be performed on the mold/die and metal together or on the metal alone after the mold/die has been cleared away. The mold/die will be obliterated either chemically or mechanically as soon as it is no longer needed. The rotor that results from this process will then be machined to comply with all tolerances and mechanical specifications, and then again polished, and finally modified at its geometrical extremes if needed such as by metallurgically adding titanium powder to be cured into some leading edges or whatever, and then certain parts of the rotor will be machined and polished again, and then it is pretty much done, unless a final heat treatment is needed. In reference to the creation of the mold/die, it would probably be advantageous to intermittently pause the 3d print or SLS process at certain stages, several times, to do the machining at the opportune instances that the subject material can be fully accessible for machining, especially before a transition (i.e. radial surface transitioning to axial surface or vice versa) layer is begun, and at any advantageous inter-stages during that process.

The process defined in the last paragraph can be called a destructive process, in that the model and mold/die are unavoidably destroyed during each use and must subsequently be refabricated (which is fine for a prototype). Of course a more preferred process for wholescale manufacture of the various components would utilize a reusable non-disposable mold/die that is incorporated with/among machinery that filled it with a molten metal supply, controlled the heat transfer to and from the metal (or other substance better than metal), and separated or parted moving elements of the mold/die such that the completed rotor could be ejected or lifted off/away, etc.

### Theoretical Limits vs Practical Limits

What is being described herein is a prototype and perhaps the beginnings of the first and second generations of production models that will evolve from the prototype. But many theoretical aspects described herein (below) are practical limits, practical solutions, conducive to instantly achievable things, and there are beyond the practical limits the theoretical limits and they are licentious, a gushing power romp so to speak, if the practical considerations are pushed past, and we then simply rely on the powerfulness of the impeller modules and the elimination of drag, with follow-up engineering coming along to make the future modifications needed because this thing surely has flaws and the Applicant surely has some blind spots.

To begin with, although the practically proffered current values for cruise altitude and max airspeed were not overly exotic (85,000 ft and 3,000 mph, respectively), the theoretical limit on the altitude is not beholden to the prototype, meaning the theoretical limit on max altitude, although it must exist, is very ill-defined and probably extremely high, and becomes such that the aircraft can increasingly penetrate altitudes where speed equals height equals freedom-from-energy-drain equals more speed and then repeat that equation. Also, the practical limit on the top speed is now, but will not always be, beholden to the prototype. It is basically a believable amount. 3,000 mph is believable. The perfected aircraft will go faster and higher. But the prototype has to be a real thing that we can make soon and beyond it we must initially relinquish our claims to knowledge or even estimation. By recording data during lower and slower flights, it should quickly come to light that a version of this thing, without major modification or with it, will eventually be made that travels 6,000 mph, meaning 100 miles per minute, and it will probably do this at an altitude between 100,000 and 140,000 feet.

Theoretically still, let us say that we are 5 minutes into a long flight, the maximized-version type booster has just detached itself to return to the airport, and we are going 6,000 mph (airspeed). We have a full battery and we're going 100 miles per minute, while we're about 110,000 feet up. There is almost no drag to speak of here in these rare altitudes. The 2^{nd} impeller module's fans run a bit higher than the airspeed, and are spinning at a rate that their outer-perimeter linear velocity is at about, for instance, 7,000 mph. It would be easy and convenient to spin the 2^{nd} impeller module's fans up to 8,000-12,000 mph (tangential/linear outlet velocity) as needed, and this ease should stand as a compliment to the current discussion. The rotational rates of the 2^{nd} impeller module can be extremely high, when that is needed, as in “on demand”. Even to historically preposterous levels. Let's just say it again—the aircraft is experiencing nearly zero drag and it has at its disposal a 2^{nd} impeller module fan system that can provide any thrust velocity no matter the intake conditions to the impeller system.

There seem to be zero theoretical limits on the maximum airspeed that are inherent in the present application. The impeller system intake, the intake ramps, the 1^{st} impeller module, the 2^{nd} impeller module, and the thrust ducts/nozzles can all be refined or redesigned such that the velocity and altitude can be forever increased. It is not unforeseen by the Applicant that an aircraft like the one disclosed herein might one day be able to travel 9,000 mph (150 miles per minute) or more at elevations considerably higher than 100,000 feet. The higher it goes and the faster, the less energy it consumes per mile. However, there are practical mechanical restraints, and this century's converts to this new art form will hopefully rise to the challenge over and over again and make them go away.

### The Profit-Vs-Expenditure of the Invention

(Going back down to the practicable, preferred prototype-derivative airspeed of 3,000 mph)

Whereas the average cost of a 1-way ticket is $100 (for 250-600 miles);

Whereas the average number of passengers per trip is 15 ($1,500 per trip);

Whereas the aircraft can fly from origin to destination in 7-20 minutes;

Such that the aircraft performs at least 2 flights per hour ($3,000/hr);

Wherein the aircraft is fully active 16 total flight hours per day (20 hours by the clock);

The aircraft can earn at least $48,000 per day. The last figure results in over $17M (USD) per year. That figure is for when the ticket cost is $100. In the first few years or decade, the tickets will be worth many hundreds of dollars, such that the profit per day of the aircraft will be much higher, but this higher cost and its revenue will be reinvested for further development of the concept, such that the aircraft will become cheaper and safer continuously until it is perfected.

As to what the manufacturing and delivery cost (it will deliver itself from the factory to its first airfield), the Applicant cannot predict what they might be. Surely (and this “surely” is literal) it will be much less than its first year's gross income. That's absurdly lucrative by itself so we needn't say any more.

### What the Invention can Realistically be Used in

The proposed impeller system can be used within the fuselage of a small aircraft (front or back or front-to-back), or the fuselage of a large aircraft (also front to back or front to wings or wings to back), or the wings of a large or military aircraft, or within a nacelle somewhere on the body or wings of an aircraft, or within multiple such nacelles. It is easy to imagine how the different parts of the simple structure of FIG. 1A can just be stuffed into any parts of any aircraft, although it is believed at the time of filing that the disclosed embodiments are superior for various reasons. Of course, if it's not within the fuselage (front fans and rear fans), the longitudinal duct doesn't have to be long or straight; in fact, it can be omitted or minimized because the elbow duct can just feed the arc duct in certain situations, or the system of FIG. 4 (the annular volute system) could be flipped upside down so that the elbow duct goes up and then back to feed another duct that just goes down into the 2^{nd} impeller module. But this would probably ruin, in any but the most innovative systems, the VTOL capability. But there are brilliant engineers out there, so it can probably be done and at a reduction of complexity, length, and cost. Also, there are systems that could be driven by the proposed invention that do not require VTOL, such as one or more of these impeller systems being retrofitted into the wings or nacelles of a large commercial or cargo aircraft. In this case, the benefits of the invention could be availed of without the VTOL portions.

Competitive Analysis—this Aircraft Vs. the B-737 in a Typical Route, New York to Pittsburgh
I. For a shuttle between New York and Pittsburgh or San Francisco and Los Angeles:
A. 340 miles
B. 2 hours turnaround time for the B-737 (conservative estimate)
C. 20 minutes turnaround time for the proposed aircraft (liberal estimate)
D. 180 passengers per trip for the B-737
E. 16 passengers per trip for the proposed aircraft
F. 0.167 turnaround ratio advantage×11.25 passenger disadvantage=1.9
G. This means the prototype carries about half as many people per day as a B-737 on the same route.

II. For the same route(s)
A. The investment/startup cost analysis can be easily guesstimated (by looking at the figures of this application and imagining its number of parts and their cost) at less than 10% per aircraft for the proposed aircraft than a B-737 (i.e. $10M vs $100M).
B. The energy cost of the proposed aircraft will be much less than 10% per day of the B-737's
   1. B-737: 1000 gallons per trip @ $2/gal and 8 trips/day=$16K/day=$5M/yr
   2. Proposed aircraft (grid power)=$1K/day=$350K/yr
C. The labor cost of the proposed aircraft will be around 10% per day of the B-737's.
   1. B-737: 8 people (including pilots, crew, ground support)) at $50/hr (avg) for 16 hours=$6K/day=$2M/yr
   2. Proposed aircraft (ground support only)=$600/day=$2,00K/yr
D. The yearly costs of the B-737 vs. the proposed invention:
   1. B-737: $5M/yr (fuel)+$2M/yr (labor)=$7M/yr operational cost
   2. Proposed aircraft: $350K/yr+$200K/yr=$550K/yr operational cost

III. For the same route(s), the total ledger for the B-737 and the proposed invention over 10 years is:
A. B-737: $100M (material investment)+$70M ($7M*10)=$170M
B. Proposed aircraft: $10M (material investment)+$5.5M ($550K*10)=$15.5M
C. And the proposed aircraft/invention (the prototype, not to mention the later generation aircraft that will follow) carries about half as many passengers per year as the B-737 in the same route (which means that for the benefits listed above, you have to divide them by 2)
D. So the proposed aircraft is around (10/2) 5 times more profitable than a B-737
E. The carbon footprint is orders of magnitude better
F. People will probably like the idea of getting there in 10-12 minutes or so, which is less than how long they usually spend sitting in the aircraft before it backs away from the gate
   Alternative Versions Including Large Aircraft, Fossil-Fuel-Propelled Aircraft, and/or Long-Range Aircraft

I. Rationale and excuses for not being conducive to battery-powered flight:
A. Long distance flight might require fossil fuels no matter how perfected the battery version will be designed and effectuated. It is proposed that the long-distance fossil-fuel-propelled flight herein proposed will consume less fuel than any prior-art aircraft would during an equivalent flight, so it should be duly considered at this time, and various alternatives are proposed hereinbelow that give a perspective of how this might take place.
B. It is tangentially proposed by the Applicant to, in addition to battery power or as a distinct alternative to battery power, utilize compressed hydrogen gas or a fossil fuel (methane, etc.) to drive a turbine or set of turbines in order to provide via generators the electrical power being consumed by the impeller modules, using ambient oxygen as an oxidant.

II. 1^{st} impeller modules/front of aircraft
A. Two large or 4-6 small 1^{st} impeller sub-modules could be horizontally arrayed along the front of the aircraft. They could either all feed to a common duct or could have separate or various ducting schemes to get the air from the front of the aircraft to its rear. It is noted that the basic principles of the foregoing summary of invention and the detailed description of the invention, to follow, are still being used, although the components and ideas established therein are being modified and/or multiplied here and their uses might be coopted or shunted, as required by this add-on embodiment.
B. Alternatives:
   1. All of the 1^{st} impeller sub-modules can feed/flow into a single duct and then be split up toward the rear of the aircraft for different uses; or
   2. Some of the 1^{st} impeller sub-modules can feed/flow into at least one 1^{st} duct or one 1^{st} set of distinct ducts for at least one 1^{st} use and some of said 1^{st} impeller sub-modules can feed/flow into at least one 2^{nd} duct or 2^{nd} set of ducts for at least one 2^{nd} use or 2^{nd} set of distinct uses.
C. Wherein the multiple 1^{st} impeller modules collectively and/or individually accelerate and/or pressurize air to deliver the air as thrust or combustion ingredients to the rear of the aircraft, at which rear point it is utilized for thrust, as well as (in a possible embodiment) combustion.

III. Body of aircraft:
A. The seating array should in this embodiment be 4-6 seats wide by 15-30 seats long, which would carry 60-180 passengers. Of course, ever-larger embodiments are obvious. The more we increase the seats, the more we need to increase the power of the impeller system. That's all. So, it is possible that this concept could be applied to a 300-seater. Not likely, but not unforeseen by the Applicant at this time.
B. This arrangement creates a flattened (wide and long but not tall) structure that would inherently, effectually, be a flying wing. For reasons perhaps obvious, the structure should have longitudinal limiting panels/humps along its top and/or bottom to constrain the ambient airflow to augment inherent lift of the fuselage. Thus, wings might in this scenario be obsolete and intellectual effort should be invested to try to eliminate the wings, even if this causes engineers to have to re-apportion or even re-invent certain segments of the aircraft. Where to put the batteries/fuel in this case is not yet established, but the Applicant proposes as a possibility that the batteries/fuel could be housed in the rear tapered tail of the aircraft, among the fans and turbines and also (preferred) in the rearward tail portion that is hollow anyways and has no function other than managing the convergence of the upper and lower ambient/passing airstreams. The extra batteries/fuel could be housed anywhere, even in many small places amongst the utilitarian elements. This consideration of where to store energy is not the purview of the present application but it should showcase some of the many ways that the invention could be practiced in the alternative embodiments detailed herein without diverging from the scope of the present application.

IV. Turbines, fuel, and combustion (in the following, turbines would drive a generator):
A. One or more components of the exhaust of the 1^{st} impeller sub-modules can be directly ejected out of the rear of the aircraft as thrust by two large-diameter (10-14 foot) 2^{nd} impeller module centrifugal fans.
B. One or more components of the exhaust of the 1^{st} impeller sub-modules can be introduced to at least one duct where the air self-pressurizes (speed turns into pressure if stagnated) and then it is fed to a combustion system that ingests the pressurized air, combusts it using methane (or hydrogen gas from a compressed-hydrogen tank), and delivers resulting exhaust to a turbine system that extracts as much power from it as possible.
C. One simple combustion cannister with an elongated tube that feeds a series of mixed-flow/diagonal turbines that would look like the 1^{st} impeller module but wherein the 2^{nd} stage would be larger than the 1^{st} stage, and wherein there might also be a 3^{rd} turbine stage. This scenario could include a sequential pair or trio of increasingly-sized Francis turbines.
D. One simple combustion cannister with an elongated tube outlet that feeds a pair or series of Francis turbines, each of whose intakes consumes the exhaust from an exit volute from the previous turbine (or the cannister). The exhaust of this system would have very low velocity. This could change the rear profile of the aircraft, but it is noted that we are not trying to get thrust out of the combustor/turbine system. It has already been slowed down (in the relative frame of the aircraft) and this is a small loss. But we shouldn't try to get the loss back. We should just let the exhaust drift rearwardly in a way that can be controlled such that it does not contribute to any other losses.
E. A quasi-axial system wherein the combustor is annular and it feeds an annular array, or multiple annular arrays, of axial turbines. After a certain quantity of axial turbine stages (2-5 stages) the exhaust could be thence be delivered to a Francis turbine or two, or a mixed-flow turbine or two, or to a centrifugal turbine or sequential set of centrifugal turbines.
F. The turbines each have an electrical generator (such as those shown for the 1st impeller module or the 2nd impeller module in the detailed description of the drawings) that either shaftlessly, or with a shaft or other implement, converts the mechanical energy of each turbine into electrical energy that is fed in a DC or AC manner to the fans of the 1st impeller module and the 2nd impeller module.

### Marine Applications of the Invention

Although the fluid being worked on so far herein is air, it could and should become tempting to one of ordinary skill in the marine (shipping/boat) arts to utilize some of the elements and relationships proposed herein for marine applications, particularly the intermittent-continuous system of accelerating a single fluid stream (or multiple fluid streams) to a very high exhaust velocity using successive fluid acceleration stages that rely much on obtusely-angled vane intakes, centrifugal force applied to the fluid, and tangential exit flows, with all three of these being stacked up densely on each other in certain successions, while not mentioning the unforgotten others inherent in such a discussion (the rest of this application and future advancements by other engineers). The traditional screw propeller is prone to various inefficiencies but the greatest of these is cavitation whose contribution to fast marine travel is basically a boundary condition nearly equivalent to the speed of light in physics. Screw propellers are efficient at low speeds, but it is perhaps whimsically (or not) proffered at this point by the Applicant that using the scheme provided herein, or an analogous scheme, we could eradicate the cavitation-problems of marine propellers (and other problems as well) and come up with a very fast boat or submarine.

This application makes no claim on reducing the skin drag around the hull of a marine vessel (due to the high Reynolds numbers associated with hulls in water), but perhaps the hull's fore portion could partly consist of a water intake, and once the water has entered this intake, whose cross-sectional area would be somewhat large and an integral, forward open-throated part of the front of the hull, it is constantly accelerated by diagonal or centrifugal propellers in a similar way to the ways proposed herein for air. The drive/rotational force in such a case would likely be provided in a manner more traditional to the marine arts, such as by shafts, gears, differentials, etc. (from a prime mover) or it could conform to the intentions of the present (aerial) application and be electric. Obvious candidates for such use are speedboats, ferries, submarines, and hydrofoils, but no use should be ignored. Although the working fluid would be different (water instead of air), the Applicant sees few impediments to attempting this. Of possible impediments, some could be very serious, but the Applicant lays down this challenge to those who are in the hydrodynamic (marine propulsion) arts. As a primordial consideration, it is proposed now that the fluid-acceleration elements of the present application could be used to accelerate water at high outlet speed without causing cavitation, even while the thrust could be made to be very large i.e. to such an extent that cavitation would necessarily preclude such large thrust in a prior art system. This is not the purview of the present application so we need to move past it.

### Another Way of Discussing the Invention

So, what is proposed herein before and after this section can be seen in many different ways including ways that use the following terminology and descriptions of elements and the relationships between/among elements.

The application in general teaches an aircraft comprising an impeller system, said aircraft further comprising a longitudinal forward flight direction (the forward flight direction, from right-to-left in FIG. 1A) and a longitudinal rearward direction (reverse direction, from left-to-right in FIG. 1A) parallel to said longitudinal forward flight direction and opposite to said longitudinal forward flight direction, said aircraft further comprising a downward direction (vertically downward in FIG. 1A) that is orthogonal to said longitudinal forward flight direction and toward the earth; said aircraft being propelled by at least one longitudinal thrust (left-to-right in FIG. 1A); wherein said aircraft comprises at least one of a fuselage, a wing, and a nacelle; wherein said impeller system comprises at least one electrically powered first impeller module situated in a forward zone within said at least one of said fuselage, wing, and nacelle; wherein said impeller system further comprises at least one electrically powered second impeller module situated in an aftward zone within said at least one of said fuselage, wing, and nacelle; and wherein said aftward zone is rearward, in said longitudinal rearward direction, of said forward zone (and as seen in FIG. 1A).

The application further teaches the aforementioned aircraft wherein said aircraft comprises at least two replaceable cantilevered wings, wherein said at least two replaceable wings each comprise internal batteries, and wherein said at least two replaceable wings both comprise means for rapid attachment to said fuselage, the means preferred at the time of filing being vertically-sliding and seating dovetail joints, but which means could also comprise anything else that has been described or not in this application to accomplish the means' end, such as for example including latches, hooks, slots, clamps, Legos, rails, cam-locks, cables, rods, etc.

The application further teaches said at least one first impeller module feeding air through at least one hollow duct to said at least one second impeller module and said at least one longitudinal thrust is generated by air being ejected directly from the aircraft by said at least one second impeller and not by said first impeller module (as the first impeller module is usually feeding its exhaust air to the second impeller module); wherein said at least one hollow duct extends more than two feet in said longitudinal rearward direction (to get it more towards the rear of the aircraft and/or past any obstacles such as cargo) away from the at least one first impeller module; wherein said at least one first impeller module comprises at least one electrically powered diagonal fan having an axis of rotation and at least one inlet diameter defined by a diameter of a fan inlet area outer annular surface, and at least one outlet diameter defined by a diameter of a fan outlet area outer annular surface; wherein said at least one outlet diameter is more than 15% greater than said at least one inlet diameter. What this means is that the inlet as viewed from in front of the diagonal fan is significantly smaller than the outlet is as viewed from behind the diagonal fan. Although the transition from smaller inlet to larger outlet is not step-wise or linear, it is somewhere between these two, the important thing being that the air inside will experience centrifugal force which will accelerate it or at least pump it through the fan while the vanes of the fan impart their own acceleration to it.

The application further teaches an aircraft wherein said at least one of said first impeller module and said second impeller module comprises a spinning fan body that is directly fused in a shaftless manner (preferably with the end of an annular rotor being permanently or removably connected to an inner diameter of the fan) with an electrical-coil-containing rotor that is driven via electromotive force; wherein said at least one first impeller module also ejects air for VTOL purposes selectively and sequentially a) downwardly in said downward direction and then b) rearwardly in said longitudinal rearward or, oppositely a) rearwardly in said longitudinal rearward direction and then b) downwardly in said downward direction, wherein said selectively and sequentially are effectuated via a movable duct, a pivotable wall or flap, a valve, or a nozzle (or any other conceivable means that ordinary practitioners in the art would easily come up with); wherein said aircraft comprises forward-blasting thrust reverser means for actively braking said aircraft and said at least one second impeller module comprises a volute with an outer wall, said thrust reverser means for actively braking said aircraft further comprising at least one thrust reverser closure (flap, panel, pivoting wall, sliding door, scoop, etc.) that moves to partially open said outer wall of said volute. So, when the outer wall (one moving element on each side of a pair of volutes) opens, the air escapes the volutes and shoots forward at an acute angle to the longitudinal forward direction.

The application further teaches an aircraft wherein said at least one second impeller module comprises at least two centrifugal fans, wherein said at least two centrifugal fans exhaust outlet air in said longitudinal rearward direction to create at least two parts of said at least one longitudinal thrust (they preferably comprise all of the longitudinal thrust); wherein the second impeller module comprises two second impeller module sub-units, including a 1^{st} second impeller sub-unit spinning in a first rotational direction and a 2^{nd} second impeller sub-unit spinning in a second rotational direction opposite to said first rotational direction; wherein said 2^{nd} second impeller sub-unit is situated on top of said 1^{st} second impeller sub-unit; wherein the first impeller module comprises dual first impeller module sub-units including a 1^{st} first impeller sub-module spinning in a first rotational direction and a 2^{nd} first impeller sub-module spinning in a second rotational direction opposite said first rotational direction, such that an exhaust from said 1^{st} first impeller sub-module and an exhaust from said 2^{nd} impeller sub-module merge in a confluence duct.

The application further teaches an aircraft wherein at least one fan of said at least one of said at least one first impeller module and said at least one second impeller module is driven by magnets annularly arrayed via at least one matched pair of concentric annular oppositely-flux-focused Halbach arrays (such as for example via the system shown in prior-art-labeled FIG. 20); wherein said first impeller module includes at least one first diagonal fan and at least one second diagonal fan, said at least one first diagonal fan and said at least one second diagonal fan being arranged in series such that the at least one first diagonal fan feeds air to said at least one second diagonal fan, wherein said at least one first diagonal fan rotates at a first fan rotational velocity A and said at least one second diagonal fan rotates at a second fan rotational velocity B, and wherein B/A>1.4. It is likely that during some operational ranges B/A=2 or 2.5 or 3, and it is also likely that during some operation ranges B/A=1.0 or 1.2, which although outside of the first-mentioned range, these modes of operation would be anomalous or transient and thus are not discussed in the present application. The gist of all this is that the 2^{nd} diagonal fan stage of the first impeller module will usually be spinning much faster than the 1^{st} diagonal fan stage of the first impeller module, such that its vane leading edges can slice into the already fast-moving air and fling it forward (tangentially) even faster. Since the fans are electrically driven and ride on electromagnet bearings, many fans could be stacked up with each succeeding one spinning much faster than the fan before it.

The application further teaches an aircraft wherein said impeller system is a vertical-takeoff-and-landing impeller system, and wherein said impeller system expels a VTOL thrust downwardly along said downward direction simultaneously from at least two distinct areas via a 1^{st} VTOL airflow flowing downwardly away from said 1st impeller module and a 2^{nd} VTOL airflow flowing downwardly away from said 2^{nd} impeller module; wherein the 1^{st} impeller module also can feed air to the 2^{nd} impeller module; wherein said aircraft comprises a nose and said at least one first impeller module takes in air from said nose of the aircraft through an impeller system intake that is concentric with said nose of said aircraft or three-dimensionally subsumes (takes up) a majority of the interior of said nose of said aircraft. What this means is that although we speak of a “nose”, we're only talking about the front of the aircraft as it is shown in these embodiments. A nose cone is omitted herein because it would block the impeller system intake and foil our plot.

The application further teaches an aircraft further comprising at least one pre-swirler upstream of said 1^{st} impeller module, wherein said at least one pre-swirler converts a primarily axial intake air flow into a flow that is between 30% and 80% tangential. The pre-swirler lets the 1^{st} fan stage of the first impeller module slice into already-spinning air, allowing the 1^{st} fan stage to spin faster, which in turn allows the 2^{nd} fan stage to spin even faster than it would be able to without the pre-swirler.

The application further teaches an aircraft wherein said second impeller module comprises at least one electrically powered centrifugal impeller module; wherein said centrifugal impeller module comprises at least two centrifugal impeller module sub-units, wherein said at least two centrifugal impeller module sub-units share the same axis, wherein said at least two centrifugal impeller module sub-units comprise a 1^{st} centrifugal impeller sub-unit spinning in a first rotational direction about said axis and a 2^{nd} centrifugal impeller sub-unit spinning in a second rotational direction opposite to said first rotational direction around said axis.

The application further teaches an electrically powered diagonal impeller module situated in a forward zone within said at least one of said fuselage, wing, and nacelle; wherein said impeller system further comprises at least one electrically powered centrifugal impeller module situated in an aftward zone within said at least one of said fuselage, wing, and nacelle; and wherein said aftward zone is rearward, in said longitudinal rearward direction, of said forward zone; and wherein the impeller system comprises an impeller system intake wherein said impeller system intake comprises at least one pre-swirler in said impeller system intake, forward in said longitudinal forward direction of said at least one first diagonal fan, that tangentially swirls intake air before said intake air arrives at said at least one first diagonal fan.

The application further teaches an aircraft further comprising at least two centrifugal impeller module sub-units, wherein said centrifugal impeller module sub-units share the same axis, wherein said at least two centrifugal impeller module sub-units comprise a 1^{st} centrifugal impeller sub-unit spinning in a first rotational direction about said axis and a 2^{nd} centrifugal impeller sub-unit spinning in a second rotational direction opposite to said first rotational direction around said axis; wherein said impeller system comprises at least one electrically powered diagonal impeller module situated in a forward zone within said at least one of said fuselage, wing, and nacelle; wherein said centrifugal impeller module is situated in an aftward zone within said at least one of said fuselage, wing, and nacelle; and wherein said aftward zone is rearward, in said longitudinal rearward direction, of said forward zone.

### BRIEF DESCRIPTION OF THE DRAWINGS

FIGS. 1A and 1B jointly illustrate the outlay of the most important components of the proposed aircraft. The two schematics are shown side-by-side or one-atop-the-other as further described fully in this application, and are incorporated together here in a single two-part figure. Specifically, FIG. 1A shows a side-cross-sectional view of the aircraft, said side section view being transparent for non-essential elements so that the outlines of essential elements can be depicted and summarized herein, while FIG. 1B shows a plan view of the aircraft, seen from above, said plan view also being transparent for non-essential elements so that the outlines of essential elements can be depicted and summarized herein. FIGS. 1C and 1D jointly illustrate another wing shape, possibly a preferred wing shape (more in line with what is being most commonly used for supersonic flight at the time of filing) but with new configurations for the flaperons 23 and with each figure facing opposite directions for convenience of portrayal only. FIG. 1E illustrates a plan view of the parallel 1^{st} impeller counter-rotating sub-modules wherein the outer profiles of their vanes are shown and wherein their intermediate passages are shortened to provide an example of a radial-inflow embodiment.

FIG. 2A illustrates a first side-cross-sectional view of the 1^{st} impeller module 100 from FIGS. 1A-1B. FIGS. 2B-2C illustrate embodiments of the 1^{st} impeller module with a preferred radial-inflow intermediate passage, while FIGS. 2D-2E provide side-cross-sectional views of various other embodiments of the 1^{st} impeller module wherein there is no intermediate passage or wherein the latter where it occurs is small or less important.

FIG. 3 illustrates a second, more exploded side-cross-sectional view of the 1^{st} impeller module 100, blown up further to show smaller details within the 1^{st} impeller module 100.

FIG. 4A illustrates the annular volutes 150 from behind, along the cross section labeled 4A in FIG. 4B, while FIG. 4B shows a general side-view of the aircraft that establishes basis for the cross-section FIG. 4A.

FIG. 5A illustrates a side-cross-sectional view of the 2^{nd} impeller module 200 from FIGS. 1A and 1B, while FIG. 5B shows a plan view of the 2^{nd} impeller module 200 from FIGS. 1A, 1B, and 5A. FIG. 5C depicts a side-view of an alternative embodiment for the 2^{nd} impeller module intakes (arc ducts), while FIG. 5D shows a side-view of another, preferred alternative embodiment for the 2^{nd} impeller module intakes (arc ducts). FIG. 5E provides a plan view of the preferred embodiment of FIG. 5D, having all things invisible except the parts that will be discussed in the detailed description apropos these drawings. And FIG. 5F is a simple unlabeled side-cross-sectional view of the invention as it would likely but not definitively be if it were to be implemented in a wing or nacelle, or other existing component, of a traditional aircraft or equivalent thereof.

FIG. 6A illustrates a side-cross-section of the rear half of the 2^{nd} impeller module, while FIG. 6B is a close-up of FIG. 6A that allows one to see clearly the rotors and stators of the 2^{nd} impeller module.

FIGS. 7A-7B are views similar to FIGS. 1A and 1B, of the side and top of the aircraft, transparent for non-essential elements such that the outlines of the VTOL flaps, valves, etc. can be highlighted. FIGS. 7C-7E are blown-up views of the VTOL valves to show their at least three different possible stages of operation.

FIGS. 8A-8E are close-up views of the front of the aircraft, specifically the impeller system intake, which depict the different configurations for (non-preferred) intake ramps, while 8F is a close-up view of the rear of the aircraft during a proposed (1^{ST} impeller module exhaust bypasses 2^{nd} impeller module) low-power descent operation described in conjunction with FIG. 8E, and FIGS. 8G-8J illustrate a preferred embodiment for the front of the aircraft, specifically one that forgoes intake ramps and uses a pre-swirling mechanism to change the direction of the intake air instead of shocking it. FIG. 8J depicts a system for bypassing some of the intake air around the impeller system, or most or all of it if the system of FIG. 8J were to be used for braking.

FIGS. 9A-9J illustrate the succession of VTOL elements' positionings during a single flight from take-off from a field or platform/pad, while FIGS. 9K-9T correspond to the respective FIGS. 9A-9J directly to their left, and show what angle relative to the horizontal the aircraft will be at during each of the respective stages in FIGS. 9A-9J.

FIGS. 10A-10H illustrate a series of side views of the aircraft with everything invisible except the profile of the aircraft, a wing, a flaperon, and the stabilator, wherein the stabilator and flaperons are depicted in the various positions they will move to during a typical flight.

FIG. 11A illustrates a side view of the aircraft to establish a reference for the forward-facing cross-sectional views 11B and 11C-11H, while 11B shows the annular volute from the rear allowing an understanding of the front stabilizer valves and ducts, and FIGS. 11C-11H show the thrust ducts (and the floor of the aircraft between them which is not labeled) along their longitude allowing an understanding of the rear stabilizer valves.

FIGS. 12A-12F illustrate a series of side views of the aircraft with everything missing or invisible except the profile of the aircraft, the impeller modules, the longitudinal duct, the near-side thrust vector nozzle, and the stabilator, wherein the near-side thrust vectoring nozzle and the stabilator are depicted in the various positions they will move to during a typical flight.

FIGS. 13A-13D illustrate a series of side views of the aircraft with everything missing or invisible except the profile of the aircraft, the impeller modules, the longitudinal duct, the seats, and supplemental batteries, wherein FIG. 13A shows two sets of supplemental batteries, FIG. 13B shows three supplemental batteries, FIG. 13C shows four supplemental batteries, and FIG. 13D shows five supplemental batteries.

FIGS. 14A-14C illustrate the aircraft with an external battery booster module attached and also the external batter booster module detaching.

FIG. 15A illustrates a side view of the aircraft to establish a reference for the forward-facing cross-sectional views of FIGS. 15B-15D, while FIGS. 15B-15D illustrate front (looking rearward) views of the aircraft at various longitudinal cross-sections along FIG. 15A. FIGS. 15D and 15E are variant embodiments but could be used together.

FIGS. 16A-B illustrate alternative versions of wings and one preferred embodiment for attaching them to the fuselage, while FIGS. 16C-16E illustrate other alternative versions of wings that could used as part of the present invention. All of these views include an attempt to locate the center of lift of the wings at or near the longitudinal position of the center of mass of the aircraft, except FIG. 16E which by being quasi-delta in nature will achieve lift by putting the center of lift longitudinally way behind the center of mass while constantly having the aircraft pitched up a little bit. Any practitioner of ordinary skill in the art will understand what the wing-forms of FIGS. 16C-16E are, and what their advantages and disadvantages are, and whether or not they might be useful for one or another of the embodiments proposed herein.

FIG. 17A illustrates an airfield/airport of the present invention, with the infeed of aircrafts via a carrying vehicle coming center-ward from the right-hand side, wherein the aircrafts move from right-to-left in this view, with the sequential operative stages of the airport in the center region and a launch tower on the left-hand-side. But all this could be flipped in the other direction (North to South, East to West, North to East, etc). FIGS. 17B-17C are unlabeled blown-up segments of FIG. 17A that depict some of the specifics of the airfield/airport of FIG. 17A.

FIG. 18A provides a chronological table detailing the characteristics, pose, and trajectory of the aircraft and its environment at various stages of a typical flight (wherein acceleration is maintained constant at 10 mph/s), while FIG. 18B provides the basis for the altitude-specific air density scalars that are used in FIG. 18A. FIG. 18A has been based upon a constant-acceleration flight method that does not precisely track with reality, but it does the best job of explaining the pertinent data about each segment of a typical, idealized flight.

FIG. 19A is an isometric view of a prior art diagonal compressor taken from WO 2020263614 A1, while FIG. 19B is a side-cross-sectional view of a prior art dual series diagonal compressor taken from US 20050002781 A, and FIG. 19C is a side cross-sectional view of a prior art dual series diagonal compressor taken from CN 104389800 B.

FIG. 20 is a side cross-sectional view of a prior art dual concentric Halbach-array motor taken from CN 209844801 U, which is a shaft-driving motor and is not associated with a compressor or fan.

### DETAILED DESCRIPTION OF THE PREFERRED EMBODIMENTS

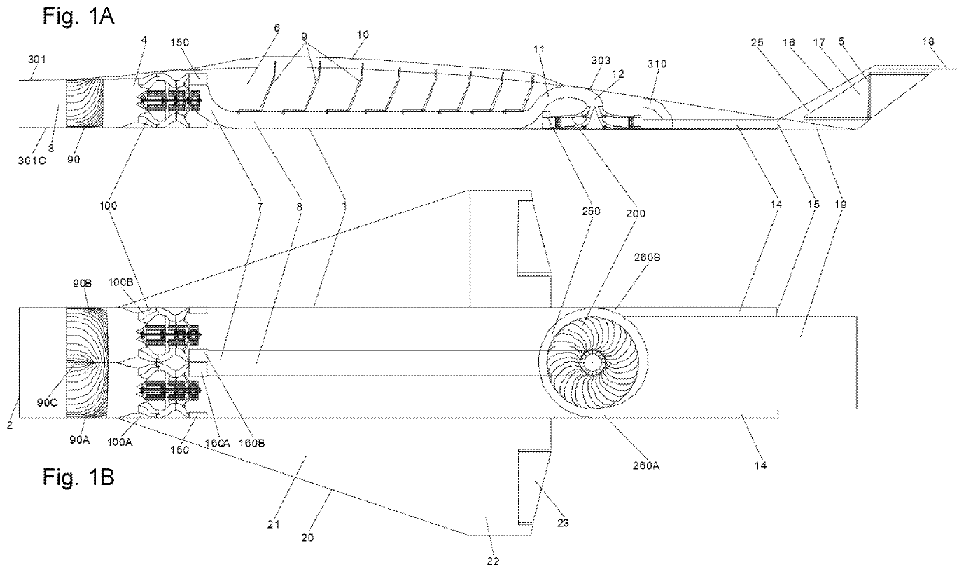

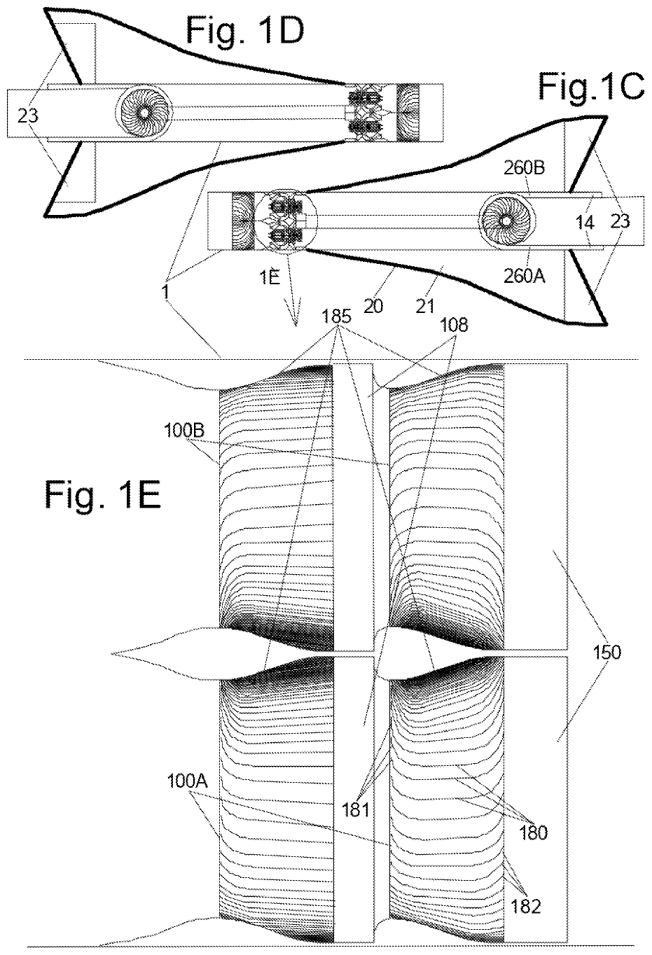

FIGS. 1A and 1B are displayed on the same page so that their corresponding elements can be labeled or described in tandem and/or in a unitary description. FIG. 1A represents a side-facing cross-sectional view of the aircraft as it would be observed as if it were transparent, from the side, with only essential elements being outlined. FIG. 1B represents another view of the same aircraft in the same way but viewed from the top. Where a single component of the aircraft is shown in both FIGS. 1A and 1B, a single reference number has been used with two arrows, one arrow being directed to FIG. 1A and the other directed to FIG. 1B.

Referring to FIGS. 1A and 1B, said aircraft consists of an aircraft body or airframe 1. The airframe has an aircraft front 2 that surrounds an impeller system intake 3. The aircraft front is hollow and open-throated such that all incoming ambient air (coming in from the left-hand side of the figures) that impinges the aircraft is entrained by the aircraft front 2 and impeller system intake 3 such that the incoming ambient air travels through the aircraft. The impeller system intake 3 comprises a swirler 90, which imparts rotation to the airflow around a longitudinal axis, and which will be described later. The 1^{st} impeller module 100 ingests ambient air along a 1^{st} impeller module intake 4 downstream of said swirler 90.

As can be seen from FIG. 1B, the 1^{st} impeller module consists of two 1^{st} impeller sub-modules including a left front impeller sub-module 100A and right front impeller sub-module 100B. The 1^{st} impeller module was described in the summary of invention and its operability will be described in further detail later in the application, so there will be little detail provided at this point. Importantly, however, it must be noted here that both 1^{st} impeller sub-modules 100A and 100B contain a plurality of diagonal fans that spin in opposing directions. For every fan in left front impeller sub-module 100A that spins clockwise (as seen from behind the sub-modules facing forward), its corresponding fan in the right front impeller sub-module 100B spins counterclockwise. This serves to cancel out Coriolis forces, the Coriolis of each fan being negated by its counter-rotating twin on the other side. In a similar fashion but by stator means, the left front swirler 90A rotates air in a clockwise direction (as seen from behind the sub-modules facing forward) and its corresponding right front swirler 90B rotates air in a counter-clockwise direction. Somewhat like inlet guide vanes, the swirlers feed the air at a pitch angle, relative to the angle of the leading edges of the vanes of the diagonal fans, that maximizes the power of the fans while minimizing turbulence and separation around the flow surfaces of the fans. 90C is a virtual swirler septum that divides the opposing swirlers 90A and 90C from each other although it does not really exist.

The 1^{st} impeller sub-modules 100A and 100B each accelerate the air in parallel streams using the diagonal fans and they each emit high-velocity tangential exhaust streams along and within a pair of annular volutes 150, described later. The segments of the annular volutes 150 where they are closest to each other is where the annular volutes comprise volute branches 160A and 160B (FIG. 1B) to split off the tangential exhaust streams from the annular volutes 150, such that the exhaust streams no longer curve to flow annularly, but they instead are ejected straight downwardly. The branches 160A and 160B can be laterally separated by an inch or two, or more likely they abut back-to-back and simply share a wall or partition. If they are separated they should quickly converge to form a confluence. If they abut, the wall/partition between them should abruptly end, effecting the confluence.

The branches 160A and 160B each convey half of the 1^{st} impeller module exhaust. Once they reach the confluence point (see previous paragraph) in the branches 160A and 160B, respectively, the two halves of the exhaust have merged to become a unitary 1^{st} impeller module exhaust and this enters the elbow joint 7. The elbow joint redirects the 1^{st} impeller module exhaust from vertical to horizontal by bending it using a curved bottom wall that, when the air encounters this wall, the wall guides the 1^{st} impeller module exhaust around an arc such that it exits the elbow joint 7 in a rearward horizontal direction and the exhaust enters a longitudinal duct 8. The longitudinal duct is in a preferred embodiment at the center of the bottom of the aircraft, but the elbow duct and longitudinal ducts could be modified to pass air along some other longitudinal swath, or swaths, of the aircraft, and the branches 160A/160B could be modified to facilitate this. If there are two rows of passengers in the cabin 6, then the longitudinal duct is thus between the rows' occupants' lower legs. However, other scenarios for the longitudinal duct are possible, including its being somewhere else or splitting into multiple parallel flows, depending on the cargo.

The cargo in the embodiment we are dealing with now is human occupants. However, if the cargo were not human occupants, it is possible that the longitudinal duct could take some other form, and further, various alternative forms that allow the length and/or profile of the aircraft to be reduced. Also, in the event that the structure 1 is a nacelle (the airframe 1 being for instance a nacelle attached to a wing or fuselage of the actual payload-carrying aircraft, meaning the invention described herein would replace the engine of an aircraft), many alternatives could be imagined by one of ordinary skill in the art to conform the overall assemblage of moving parts, stator elements, and ducts, to any intended use, including uses that are not VTOL. For instance, a shortened occupant-less wingless variation of FIGS. 1A-1B could be attached (retrofitted or during manufacture) to the wings of a commercial aircraft, being driven by wing-borne batteries or by a fossil-fuel or fuel-cell-fueled generator located near the rear of the aircraft.

Getting back to the primary embodiment with human occupants seated in two parallel rows, in seats 9, at any given longitudinal extent of the aircraft cabin 6, a passenger and the passenger directly next to her/him would find an open space between them at their torso level, but the open space would not extend down past the plane of their parallel seat pans. That is the space taken up, all the way along the length of the passenger compartment's bottom center (it is similar to the “hump” of a rear-wheel drive automobile that accommodates the drive shaft of the automobile), by the longitudinal duct 8. This, or some other passenger-body bypass arrangement for the 1^{st} impeller module exhaust, is necessary to deliver the 1^{st} impeller module exhaust to the 2^{nd} impeller module 200 without fancy ducting schemes. It will be obvious to one of ordinary skill in the art that other more or less complex ducting schemes, known in the relevant arts, could be handily used without departing from the scope of the present application.

On a side note, the longitudinal duct 8 can be constructed such that it is very strong and stiff (its hollowness provides an enormous advantage here), and in such case it could serve as the primary frame member of the aircraft—it would not only be a duct, it would simultaneously be a box beam. It would have at its front end a support extension set/struts to hold the 1^{st} impeller module and at its rear end another support extension set/struts to hold the 2^{nd} impeller module. As the aircraft requires seats 9 for the passengers, these could extend outwardly from the longitudinal duct 8 in cantilever fashion. In this way, the airframe 1 (outer shell) could be constructed from lightweight composites in monocoque fashion and simply fasten to: a) struts that extend outwardly at various points from the longitudinal duct 8; as well as to b) the outboard edges of the seats 9 and the outboard regions of the 1^{st} and 2^{nd} impeller modules 100 and 200. This is an extremely lightweight embodiment and is naturally preferred. It could be said that it would not be very safe in an accident, but in truth this is a prototype being described herein, and we need to simplify it as much as possible. Also, the aircraft is going to have a parachute and many means for braking and landing vertically, so collisions are probably precluded intrinsically.

The rear end of the longitudinal duct 8 leads to an arc duct 11. The arc duct accepts the 1^{st} impeller module exhaust from the longitudinal duct 8, deflects it upwardly somewhat and then leads it along an arc-shaped path to deliver it downwardly into the 2^{nd} impeller module 200 using a 2^{nd} impeller module intake 12.

As mentioned above, the 2^{nd} impeller module intake 12 is where the arc duct 11 communicates with the 2^{nd} impeller module 200 and delivers the 1^{st} impeller module exhaust to the 2^{nd} impeller module 200. The 2^{nd} impeller module 200 in a preferred embodiment comprises a stacked pair of centrifugal fans, described in more detail later in the application. The 1^{st} impeller module exhaust entering via 11 and 12 is split into two parallel and equal fractions by a splitting system, at least two versions of which are described later. Each of the two equally-volumetric and parallel fractions enters a different one of the two centrifugal fans. The 2^{nd} impeller module 200, in a way similar to the 1^{st} impeller sub-modules 100A and 100B, has the two centrifugal fans spinning in opposite rotational directions such that, if they are nearly identically shaped and they spin at the same rotational velocity, Coriolis forces are canceled out.

As will be described later in a detailed discussion of the 2^{nd} impeller module 200, of the counter-rotating centrifugal fans of the 2^{nd} impeller module 200 each has as its exhaust outlet a perimetric slit that matches up with an inlet slit on the inner diameter of a thrust volute 250 (this is also how the 1^{st} impeller module 100 outlets to annular volute 150). The volutes will be described in further detail during the discussions of their respective impeller modules. The air coming through the slit is traveling at extremely high tangential velocity and constantly increases air mass in the thrust volute 250 as the air mass travels along the thrust volute via tapered, constantly increasing/widening volute cross-sectional areas. The 2^{nd} impeller module exhaust thus passes tangentially (relative to the fan) along the annular volute, and around the fan. Every inch it travels it is supplemented by more exhaust such that when it has gone all the way around the volute it reaches, like the 1^{st} impeller module's annular volute 150, a branch 260A (or 260B for the other thrust volute) whereat it splits off to be ducted in a straight line toward the rear of the aircraft by a 2^{nd} impeller module exhaust duct 14 at full velocity to provide one-half of the rearward thrust of the aircraft. The other fan does the same thing but in an opposite rotational direction and on the opposite side of the aircraft to provide the other half of the rearward thrust at another 2^{nd} impeller module exhaust duct (also labeled 14). Both of the 2^{nd} impeller module exhaust ducts 14 have at their termini outlets 15 which are part of thrust vectoring nozzles 30, described later.

The aircraft further comprises an empennage 25 (see FIG. 1A) and two cantilevered wings 20, one wing on each lateral side of the airframe 1 (see FIG. 1b).

The aircraft further comprises a passenger cabin 6 which is a life-support chamber, meaning it likely requires a mechanized oxygen supply as well as air filters and a passenger heating system, not to mention walls capable of being internally pressurized to at least 7 psi via their mechanical attributes and also internally via some type of controlled pressurization system, all surrounded by a hermetically sealed and thermally insulated outer shell, said passenger compartment further comprising a plurality of seats 9 while consuming a majority volume of the airframe 1, and a head hump 10 above each row of passengers that extends upwardly from the airframe 1 to encompass and protect the heads of the passengers in a pair of rows, while allowing the upper longitudinal airframe swath between the head humps to taper down, in order to channel the passing air between the head humps and disallow it from sliding down and around the sides of the aircraft, or equivalently in different ways of looking at this, to keep outboard air from slipping inwardly.

The passenger cabin 6 has as its top surface a hatch (not shown) that lifts up, pivotable from the rear or from the front or from the side of the cabin, to allow the passengers to step down into and climb up out of the aircraft. The hatch actively forms a seal with the airframe 1 before flight commences with a redundant latch by pivoting down to the airframe 1 and performing at least 2 latching functions to unite the hatch with the airframe 1 along a gasket between them. This is common knowledge in the art and will not be described further.

In a preferred but non-limiting embodiment, the seats 9 are tallest near the front of the passenger compartment and shortest near the rear of the passenger compartment, with the intervening seats shrinking sequentially from tallest to shortest as one passes from the front to the rear. This allows us to more aggressively taper the portion of the aircraft behind the front seats so that when we get to the last passenger, the taper has shrunk the vertical height of the aircraft to be less than the height at the first passenger's shoulder. This tapering reduces the overall length (and consequently the aircraft mass and total skin drag) of the aircraft by allowing us to more aggressively taper its rear. The airframe 1 wraps around the rear passengers, and concludes the rear of the aircraft in an optimal way, meaning: short but still having the best geometry, the best geometry being in other words the most acute convergence angle and sleekest profile. Of course, there are many possible alternatives to the shape of the airframe 1 that do not require the tapering of the seats' height, and these should be considered obvious to one of ordinary skill in the art. The Applicant had to choose a best mode, and the one that solved the most problems via a single cross-sectional diagram was chosen for this patent application and should be considered exemplary only, and, as mentioned, non-limiting.

Having the seats 9 slightly converge from larger to smaller (as shown in FIG. 1A) as one passes from front to rear of the aircraft is accomplished simply by having the passengers sort themselves prior to boarding. Tall adults will be in the front seats, and children will be in the back seats. The seats between them will be populated by a height-graduated assortment of persons who will recognize their places, with guidance, and seat themselves accordingly. This seems like a hassle, but it reduces the dimensions and costliness of the aircraft and its operation by a non-negligible fraction, such that it should usually be seen as the preferred way. Nonetheless, having uniform seat sizes from front to back is of course a default way, even if it increases the length and mass of the aircraft by a significant amount, which it probably will, if the preferred embodiment (shrinking) is for some reason not favorable to the job at hand or because people just loathe being told what to do.

The head hump, mentioned a few paragraphs previously, is a small continuous longitudinal hump that exists over each row of passengers. In the preferred embodiment, there will be two parallel head humps at the top of the airframe 1. One is on the left side, above the left row of passengers and encompassing and protecting their heads, and the other is on the right side over the other passenger row for the same reasons. But, an additional reason, apropos serendipity, is that the airframe between the two head humps is concave (laterally). This geometry entrains the air going over the top of the aircraft so that it cannot escape laterally outwardly, or to the sides. Thus, the air entrained between them is isolated from passing air; it is kept between the head humps as it passes from the front of the aircraft to the rear, and thus the acceleration of said air, according to Bernoulli's equation, because of its longer travel distance relative to the distance of all of the other passing airs, will have a lowered pressure, such that the pressure above the aircraft, in the area between the head humps, increases lift as a function of a) the coefficient created by this paragraph, and b) the airspeed. The futuristic perfected aircraft, after several years of modification, will probably end up being capable of flying without wings. But for now, we'll keep the wings. They have the batteries and the flaperons.

The airframe comprises a tail 19 for smoothly completing the rear end of the aircraft as is well known in the industry, and the tail also supports the empennage 25, also known in the industry.

Thus, the tail 19 will not be described in detail. However, it is mentioned in passing that the tail, on its lateral sides, does not extend all the way back to the rear tip shown in FIG. 1A, because the outlets 15 have their termini there and thus serve to truncate the tail's sides where they let out, and only where they let out. The airframe areas above the 2^{nd} impeller module exhaust ducts are tapered like the tail and conform to the geometry shown in FIG. 1A. In FIG. 1B the 2^{nd} impeller module exhaust ducts 14 are shown to extend to the outlets 15, but this is only to depict them in the same drawing as everything else. In other words, the airframe portions above 2^{nd} impeller module exhaust ducts 14 are not horizontally flat on the sides. They taper with the tail until the they end at 15, where their terminal edges lie along a vertical plane.

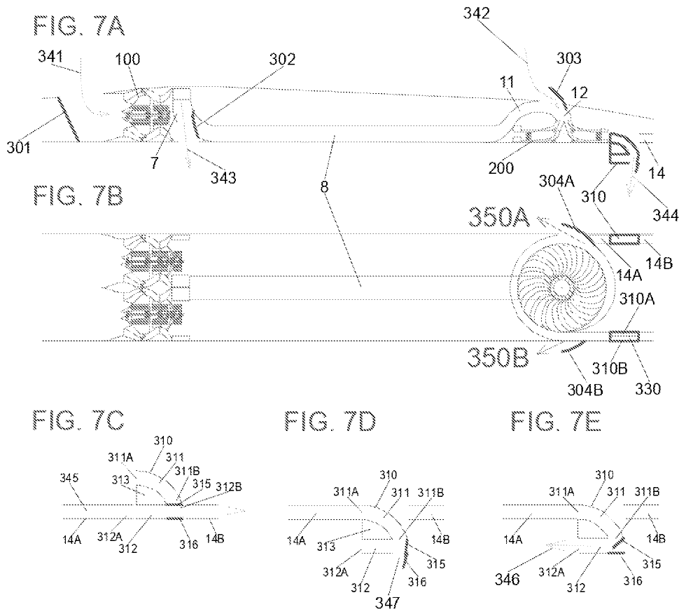

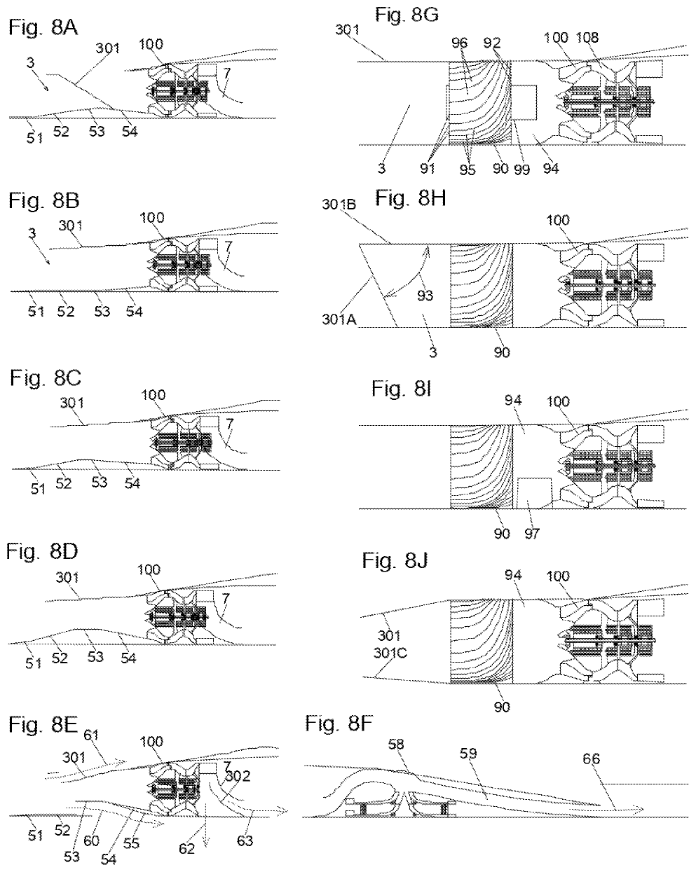

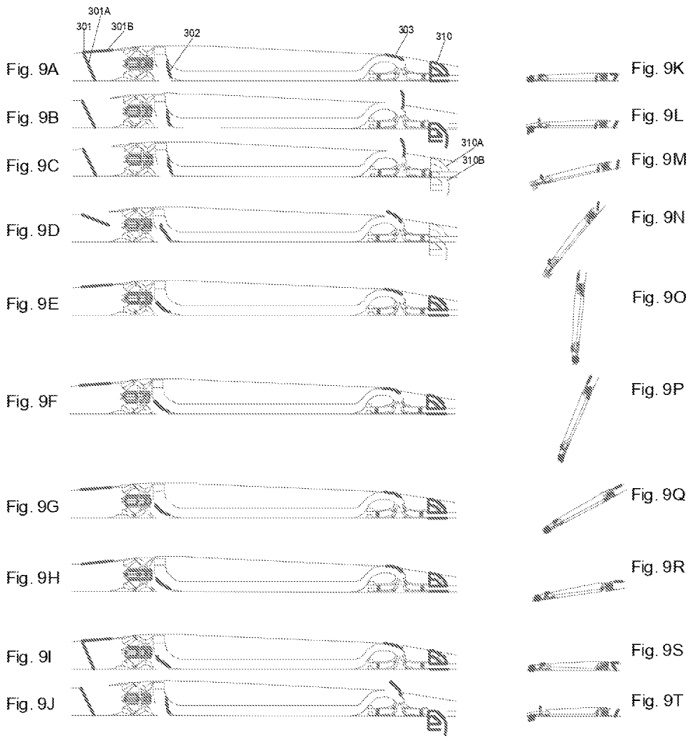

The front of the aircraft comprises two flaps, a roof 301 (or 301A and a floor panel 301C, and both are repositionable and/or pivotable about at least one lateral axis. Importantly they are hinged at their rear extents to the airframe 1 and the sides of the front 2 are still there such that airflow entrained over and under the roof 301 and floor panel 301C must be directed upwardly and downwardly, respectively. When roof 301 and floor panel 301C move moderately toward each other as shown in FIG. 8J, a significant amount of ambient airflow can bypass the impeller system, while when not moved toward each other they allow all the air in. If they (301, 301C) are pivoted toward each other such that their leading edges meet then they block the inflow of air to the impeller system intake and this can be used for both a) braking the aircraft and b) closing the impeller system intake. Both of these aspects are items of particular concern (problems to solve) in other parts of this application and FIG. 8J goes farther towards solving them, so for now this discussion will be left off since it is best left for the description of FIG. 8J. Rear flap 303 will be described with reference to FIG. 7A and discussion of it will therefore be postponed.

### Wings

Wings 20 are shown in FIG. 1B. The Applicant is not sure what types of wings will be used in a finalized embodiment. However, for now the potential prototype is shown in FIG. 1B to be the type of wings used on modern supersonic fighter jets. It is not believed that these types of wings will be useful at airspeeds higher than M2, but for now we need a substrate on which to lay out our imaginary scheme. These wings 20 cantilever out from each side of the airframe 1. Each wing is identical so only one will be described in detail most of the time, as follows.

Each wing 20 has a stationary wing front portion 21 that contains the batteries (not shown) which are the source of the electricity that is consumed by the impeller system. Each wing also has a pivotable rear portion 22 that will be called a flaperon. Although flaperons are not the only way to accomplish the present invention's aims, they are preferred at this time because they serve several purposes simultaneously. Flaperons are known so the theory will not be gone into here. Each flaperon 22 can pivot upward and downward from its hinge point (the solid line between 21 and 22 in FIG. 1B). When the flaperon on the left side pivots up and the flaperon on the right side pivots down, or vice versa, the flaperons serve as ailerons. When both flaperons pivot down they serve as flaps, to augment the natural lift of the wings. Additional sub-ailerons 23 have been included for fine roll adjustments at supersonic flight. The sub-ailerons 23 are simply ailerons and are well known in the art. So, returning to the flaperons 22, they serve as ailerons and flaps, alternatively, or, importantly, simultaneously; this last statement meaning the flaperons are able to counter-pivot to perform the function of ailerons, while they are being already in a flap-like pivoted (non-horizontal) position. The flaps also serve as brakes, which activity is discussed elsewhere in this specification. The flaperons can also contain batteries, if the space within wings 20 is not sufficient to house enough batteries to complete a flight, however this is not preferred as it would weigh down the flaperons and require extra structure to keep them in position.

The wings have a cross-sectional geometry that conforms to the requirements of supersonic flight. They will not be airfoils of the subsonic type. Regular subsonic flight will preferably not be performed during a typical flight of this aircraft, as it has been precluded by the preferred strategies that have been proposed to avoid drag and heat, described elsewhere in this specification. The hinges for the flaperons and the means for pivoting the flaperons are mechanical features well known in the art, and thus they will not be described herein.

The wings are removably attached to the airframe such that a rapid battery-swap can be performed between each flight. One embodiment could entail the airframe comprising female dovetail slots, while the inner edges of the wings would have male dovetail slots. This is described elsewhere within the specification. The flaperons 23 are not part of the dovetail connection, but instead cantilever from the rear edge of the stationary front portion 21.

A VTOL valve 310 is shown in FIG. 1A, but this is part of the VTOL system and will be discussed while referencing another drawing. In FIG. 1A it is in its upward, inactive position, wherein it bridges a gap in the 2^{nd} impeller module exhaust duct 14, and passively conducts air along the latter.

As shown in FIGS. 1C and 1D, the shape of the wings 20 can be completely different from the shape shown in FIG. 1B and probably will be. The wing profiles shown in FIGS. 1C and 1D (the two sub-figures are mirror images of each other in overall profile) are more in line with the variants that are currently being most commonly used by the supersonic passenger aircraft entities/endeavors at the time of filing this application, and the seemingly most advantageous profile as shown in FIGS. 1C-1D is more or less an amalgam of what the Applicant has garnered from various prior art references as the best mode based upon the available online literature. Of course, whatever wing geometry will work best for the speeds that the aircraft is going to travel at shall be considered ipso facto the best mode of the present application, but no single one should be seen as limiting or being limited from. Still in the same vein, a particularly useful profile as shown in FIGS. 1C and 1D is a well-established (in the industry) and advantageous variation of the standard delta wing configuration, and it is possible but not necessary that this will eventually become even more preferred as the best embodiment, and that is why it has been added to the discussion here and included in the first figure group (FIGS. 1A-1E). Although the center of lift of the wings shown in FIGS. 1C-1D is behind the regular center of mass, in these embodiments the center of mass of the batteries will move the center-of-mass of the overall aircraft rearwardly, such that the heavy wings by their own alteration in form and placement have moved the center of mass of the overall aircraft rearwardly (since they are so heavy, with all the batteries inside them), and so the center of lift is still somewhat near, but a little behind perhaps, the center of mass of the fuselage per se.

In addition to showing in FIGS. 1C-1D the other possible (of many possible) wing forms, FIGS. 1C and 1D differ in that they depict alternative versions of the flaperons 23, which will be obvious in nature to persons skilled in the art so no further discussion is provided herein. As all of the functioning elements have been already described above, further description of these figures will be omitted hereafter, while relevant reference numbers are retained from other figures when appropriate. As concerns FIG. 1C, reference numerals 14, 21, 260a, and 260B were disclosed earlier and as their existences and functions have been delineated, discussion of them here would be repetitive and is forgone.

### Fan Vanes

FIG. 1E illustrates the 1^{st} impeller module from a vantage above it (as in FIG. 1C) and looking downward at all of the 1^{st} impeller module fans (FIG. 1E is a blow-up of the 1^{st} impeller module from FIG. 1C) in one cohesive bunch, collectively presenting the left-front 1^{st} impeller sub-module 100A and the right-front 1^{st} impeller sub-module 100B, and importantly it depicts the essential 1^{st} impeller module air-accelerating spinning components in a way that allows us to understand them better. To articulate more, FIG. 1E shows the virtual outer edges of the diagonal fan vanes 180 as if the diagonal fans' housings 185 were invisible or removed, or it could equivalently be seen to virtually show the junction line/curve at every place where the vanes 180 connect to said (outer) diagonal fan housings 185. At this point, the outer housing of the fans is not shown except at the outer edges 185, where it defines the outward shapes of the fans in FIG. 1E, and the rest must be imagined by the reader.

So as we familiarize ourselves with FIG. 1E, which is very important to the present discussion, we must establish that we are not viewing the innards or surrounds of the fans, but simply their vanes' curvatures at said vanes' outermost extents. Since the vanes are similar in function even though the front sets of vanes are slightly different from the rear sets of vanes, for brevity's sake we need to discuss a single vane set, to build an understanding of all the vanes.

The fans of left-front 1^{st} impeller sub-module 100A are spinning clockwise (as seen from behind) and therefore all of their outboard vanes 180 (bottom-most in FIG. 1E) are moving upward on the page in FIG. 1E. The fan vanes of the right-front 1^{st} impeller sub-module 100B are spinning counterclockwise and therefore all of their outboard vanes 180 (upper-most in FIG. 1E) are moving upward on the page in FIG. 1E.

As such, the leading edges 181 of all of the fans are cutting into their respective intake airflows at an acute angle of a prescribed (or variable if desirable) pitch. The Applicant guesstimates that this angle should probably be between 15 and 35 degrees relative to the tangential. As shown in FIG. 1E it is around 20 degrees (their curved intake complicates things so perhaps the actual angle could be less). This, or another more acute or obtuse angle, allows the vane leading edges 181 to travel much faster in the spin/swirl direction than the air coming into the fans is traveling/swirling (in the same rotational direction), and by doing so the vanes capture the incoming air in such a way that said air must follow along the forward (in rotation direction) surfaces of the vanes 180. By being thus entrained, where the vane leading edges 181 have curved around to transition to the straightened portion of vanes 180 (obvious from FIG. 1E), the air is now being subjected to centrifugal (see reference numeral 185) force such that when the air reaches the trailing edges 182, which can be swept forward in the spin direction (for some fans), the centrifugally-derived kinetic and potential energy accumulated by being centrifugally forced radially outward along 180 results in the air following the forward surfaces of the vanes 180 and trailing edges 182 in a way that positively accelerates the air in the tangential direction, such that diagonal fan exhausts that enter the intermediate passages 108 and the annular volutes 150 have more tangential velocity than axial velocity.

Most importantly, if the diagonal fans were all to spin at the same rotational rates/velocities, the 2^{nd} diagonal fans would not perform useful work. So, the 2^{nd} diagonal fans (right-hand side of FIG. 1E) spin at about twice the rotational rate of the 1^{st} diagonal fans (left-hand side of FIG. 1E). The air coming in from the left-hand side of FIG. 1E has been pre-swirled by the swirler 90, to an amount that is heavily dependent upon the airspeed. Low airspeeds mean minimal pre-swirling and usually at high air densities, and high airspeeds mean maximal pre-swirling but usually at low air densities. So, the ratio of the 1^{st} diagonal fans' rotational rate to the 2^{nd} diagonal fans' rotational rate will probably be as low as 1.5:1 at times and at other times as high as 3:1. But for now let us imagine that we are in a convenient state wherein the ratio is 2:1, meaning the 2^{nd} diagonal fans spin at a rotational rate twice the rotational rate of the 1^{st} diagonal fans.

Tentatively provided that the swirler is beneficial but will variably affect the ratio of rotational rates between the 1^{st} diagonal fan stages 101/102 and the 2^{nd} diagonal fan stage 103 and their overall rotational rates, let us forget about it and simply envision the air coming into the lower half of FIG. 1E. This air will be swept up by the leading edges 181 of the 1^{st} diagonal fan (left-hand side) which are spinning (upward for the bottom edge of FIG. 1E) at hundreds of mph higher than its swirl velocity, and then curved around to travel more axially along vanes 180, and therefore will thereby have acquired the tangential velocity of the outer extent of the 1^{st} diagonal fan as well as a residual axial velocity. Because of the compound taper of the annular flow passage within the fans, the air will accumulate additional kinetic energy (due to centrifugal force) while also accelerating to the tangential velocity of the outer extent of the 1^{st} diagonal fan as the air moves along the vanes 180. As the vanes sweep forward (when possible) to their angled trailing edges 182, the centrifugally harnessed energy from the tapered fan profile/housing is harnessed to accelerate the air in an accentuated tangential direction.

The 2^{nd} diagonal fan stage (right-hand side of FIG. 1E) picks up this super-swirled air and its leading edges are spinning at a rate several hundreds of mph (tangential) higher relative to the air's outlet swirl speed from the 1^{st} diagonal fan stage (left-hand side of FIG. 1E). The air has first been trapped for radially inward movement by the intermediate passage 108, as shown in FIG. 1E, and thence it is ducted radially inwardly and axially rearwardly to enter the 2^{nd} diagonal fan stage. If necessary, canted arc vanes can be provided within the intermediate passage to migrate the air inwardly. Otherwise, the pressure buildup within the intermediate passage can be used to passively allow the air to migrate inwardly. As air is fed into the passage 108 from the 1^{st} diagonal fan stage, it will swirl and conservation of matter requires that a static pressure will manifest itself such that all of the air entering the intermediate passage 108 must eventually enter the 2^{nd} diagonal fan stage. Either of the preceding is possibly the best mode. Each variation has its tradeoffs.

The 2^{nd} diagonal fan stage (right-hand side of FIG. 1E) scoops up with its leading edges the flow from the intermediate passage 108 which air is already swirling at a high tangential velocity and the 2^{nd} diagonal fan stage's leading edges 181 cut into the flow and cause it to bend once more such that the air will assume the tangential velocity of the inner (concave) extent of the vanes 180 of the 2^{nd} diagonal fan stage, which is approximately twice the tangential velocity of the vanes 180 of the 1^{st} diagonal fan. The 2^{nd} diagonal fan stage's vanes 180 now contain the air and as the air moves axially from the 2^{nd} diagonal fan vanes stage's leading edges 181 to the vanes themselves 180, the air's vector is now highly tangential, and has a velocity roughly equivalent to the rotational velocity of the 2^{nd} diagonal fan stage. As the air moves from the leading edges 181 to the trailing edges 182 of the 2^{nd} diagonal fan stage, it accumulates kinetic and potential energy via centrifugal force and blunt force. Then it hits the trailing edges 182 which are swept forward and the air enters the annular volute 150 with tremendous tangential velocity and whatever axial velocity it had is simply absorbed by the annular volute 150 and it has been functionally and completely transduced into tangential energy by hitting the back wall of 150. The intermediate passage 108 and the annular volute 150 will be discussed in further detail hereinbelow, so if the reader is confused, it would behoove him/her to review further details of the invention before trying to fully understand FIG. 1E.

### Empennage

The empennage includes a pair of vertical stabilizers 16, only the left-hand side of which is shown in FIG. 1A with the right-hand side one being hidden behind the left-hand side one in the view. The entire empennage has been omitted from FIG. 1B to keep that figure simple. Each vertical stabilizer further comprises a rudder 17 which is pivotable about rudder pivot shaft 5 and said rudder being well known in the art is not described further herein except for the way it pivots about the rudder pivot shaft 5 which is not in the front or rear of the rudder 17, but in a location that allows the rudders 17 to pivot/flare laterally to form a braking-wall, in which event the rudder pair are oppositely torqued and kept in a position that only creates drag (their leading edges mutually approach each other while their trailing ends mutually diverge from each other) while not creating appreciable torque about the center-of-mass of the aircraft. The positioning of the rudder pivot shafts 5 near the centers of the rudders 17 (instead of along a side/edge) reduces to nil the force needed to pivot them to any needed position.

Atop the vertical stabilizers 16 and suspended between them is a combined horizontal stabilizer and elevator (stabilator) 18, which is also well known in the art and will not be described much herein. However, the stabilator 18 of the proposed invention can advantageously be pitched downward to an extreme position to contribute, along with extremely pitched-up flaperons and flared rudders 17 (mentioned above), to a braking strategy discussed elsewhere within this application. The empennage is shifted longitudinally back a bit by using slanted/oblique vertical stabilizers 16 in order to increase the torque effects about the center of mass of the aircraft as well as about the center of lift of the wings. However preferred this might be, all of the above are simply best modes, having been chosen at the time of filing by the Applicant because they most simply solve the largest number of problems with the smallest number of parts. None of the aspects of the embodiment of this paragraph are necessary, and many other solutions (i.e. a single vertical stabilizer 16 with a single rudder and a dually cantilevered stabilator pair 18 on top, or even somewhere else such as on the vertical stabilizer or even somewhere else such as on the outboard sides of the tail 19) would be obvious to one of ordinary skill in the art, and probably, at least with some variation from the foregoing, will possibly indeed become the best modes after computer modeling, testing, and prototyping have been attempted.

The most important thing about the best mode described herein is that it is robust and seems to be infallibly effective no matter how many scenarios the Applicant imagines it accomplishing or being put through. The rudders 17 are probably not very efficient as shown and also they are larger than they will probably need to be, but rudders are very unimportant in the present invention and its methods and so although they should be minimized (smaller than shown in FIG. 1A), in the event that smaller versions are insufficient, they will simply be re-enlarged to a moderate size without consuming additional space or mass. The shape of them is also completely open to redesign without diverging from the scope of invention, as their geometry is simply at this time chosen to conform to the shape/extent of the vertical stabilizers 16, while reducing shock at supersonic flight. For instance, the leading edge of the rudders would usually be very close to the leading edge of the vertical stabilizers (to reduce shock upon actuation at supersonic airspeeds), but it is possible that the embodiment shown does not require this since once they are pivoted/flared, they no longer make a single flow structure with the vertical stabilizers 16 because of the way the Applicant has made them pivot around a central pivot shaft 5. It was not mentioned earlier but come to think of it, this was another reason the pivot shaft 5 has been placed where it is. If the rudder pivot were instead a hinge between the front edge of the rudder 17 and a cut-out or edge of the vertical stabilizer 16, the rudder leading edge would probably have to be coincidental with the vertical stabilizer leading edge, and this would leave us with nowhere to put the frame of the vertical stabilizer. So for all of these reasons the best mode shown in FIG. 1A allows the front edge of the vertical stabilizer and the pivot shaft 15 to contribute to a polygonal interior framework, not shown, for the vertical stabilizers 16. Although it should be obvious, the right-hand-side and left-hand-side rudders should operate substantially in unison at any speeds. However, in the best mode shown in FIG. 1A, it is further obvious that if the stabilator is pitched up, at least one of the rudders will not be free to pivot. Since this will probably never happen during transitional or supersonic flight scenarios, the Applicant will propose that when this is the case, over-pivoting only one rudder to compensate for the requisite yaw force will be performed, and even if this is inefficient, it will be so rare that consideration of doing this is probably not necessary and should simply be a minor (non-feedback) correction module of the flight control algorithm.

### Swirler

As previously described in the summary of invention, the 1st impeller module receives its intake air from the environment through an impeller system intake 3 that captures/entrains all incoming ambient air, and then each 1st impeller module 100A, 100B (see FIG. 1B) ingests its respective half of the intake air from 3 through its own 1st impeller module intake 4. Between the impeller system intake 3 and each 1st impeller module intake 4 exists a swirler 90, such that two twinned swirlers are side-by-side in a lateral sense, such that the left-front impeller sub-module 100A has in front of it a left front swirler 90A and the right-front impeller sub-module 100B has in front of it a right front swirler 90B. The left front swirler 90A imparts a clockwise (as seen from behind and looking forward along a longitudinal axis) rotation to the incoming air that is then captured and further accelerated in the clockwise direction by the left-front impeller sub-module 100A, while the swirler 90B imparts a counter-clockwise rotation to the incoming air that is then captured and further accelerated in the counter-clockwise direction by the right-front impeller sub-module 100B.

Now that we have tentatively posited the pairs of swirlers 90A and 90B and their relation to the pairs of 1^{st} impeller sub-modules 100A and 100B with reference to FIG. 1B, we will return to discussing one swirler 90 and one 1st impeller module 100 using FIGS. 1A and 8G. As we will be soon discussing the details of the 1st impeller module 100, we will first describe the swirler 90 as part of the 1st impeller module intake 4 for the 1st impeller module 100.

The swirler 90 is substantially coaxial with the 1st impeller module, “substantially” because in futuristic designs the impeller system intake could flourish into many distinctive and equally effective varieties compared to the current (at the time of filing) best mode which is the one shown in this application, wherein due to these changes the swirler's axis might be laterally or vertically shifted while still being parallel to the 1st impeller module's axis, or the axes might not even be completely parallel to each other. All the same, as shown in or inferred by the figures, we can simply say that the swirler 90 is located in front of the 1st impeller module 100 such that air entering the impeller system intake 3 arrives to the swirler 90, which has radial swirl vanes 95, and wherein (as shown in FIG. 8G) the swirler vane leading edges 91 divide the incoming intake air into (between i.e. twelve and forty) distinct sector-shaped passages 96. These leading edges 91 should be forged, cast, filed down, etc. to be razor sharp and have an extremely acute taper angle in the wake of the leading edge's forward tip, insomuch as material science allows, and/or they could be saw-toothed or scalloped or any other modification could be given to them, to make them have zero encroachment (shock/drag/heat) on the passing airstreams—in other words, the leading edges 91 should and will slice into the incoming airstream and almost every molecule of air should find itself within a sector-shaped passage without having impinged on a physical surface.

Also, although shown to be continuous, if needed for flow separation mitigation reasons at high-supersonic airspeeds, axial gaps could be placed in each vane 95 such that some air would slip from one sector-shaped passage 96 into the succeeding passage, for reasons that cannot be gone into here. The rear vane-half annulus in such a case could be shifted forward to overlap the forward one (the leading edges of the rear vane-half would, or perhaps not, overlap the trailing edges of the fore vane-half). This might not be necessary and since the reasons for it that could be included herein rely on historical research done by the Applicant, and since the prior art on this matter only offers hypotheses as to why it might be effective but does apparently show that this scheme has proven to work in similar endeavors, so the present application mentions this as an alternative geometry but does not need another peripheral discussion so we will move on.

As can be seen in FIG. 8G, the swirler vanes 95 arc about an annular/cylindrical swath in such a way that the intake air from impeller system 3 is not at first diverted but enters the swirler 90 completely axially. However, as soon as the air enters the vanes 95 it begins to curve, thus imparting a rotation or swirl to the air within passages 96. The vanes 95 and thereby the passages 96, and thus the air sub-streams themselves, curve in a manner such that the air sub-streams' vectors (averaged for all air molecules in a sub-stream) are continuously curved from an axial direction (straight backward toward the rear of the aircraft) to 20-35% tangential at a longitudinal midpoint of the swirler 90, and to 50-80% at the trailing edges 92 of the swirler vanes, whereat the swirler vanes 95 end and the air enters a vortex chamber 94, where the sub-streams merge together, and their molecules' vectors interact with each other to come to equilibrium and spin together in the vortex chamber 94 in such a way that they are fed in a homogeneous manner to the 1^{st} impeller sub-modules such that when each 1st diagonal fan 101 of the 1st impeller module 100 sweeps out the rear end (right-hand-side in FIG. 8G) of the vortex chamber 94, all of the air molecules will have assumed nearly identical velocity vectors relative to the leading edges of the vanes of the 1st diagonal fan 100.

Due to the swirler 90 and the vortex chamber 94, the velocity of the air is, for example, 65% tangential (approximately 60 degrees) and 35% axial (approximately 30 degrees). During non-transient, normal operations, the 1st diagonal fan 101 can thus be run at a much higher rotational rate than it would without a swirler, for instance at a tangential speed of i.e. 600 mph higher than the tangential speed of the air in the vortex chamber 94. The result of this is that the outlet velocity of the air exhausted from the 1st diagonal fan is pretty high, and since the 2nd diagonal fan 102 will be made to sweep into the 1st diagonal fan's exhaust at a relative speed of i.e. 600 mph (tangential) faster than the tangential speed of the 1st diagonal fan exhaust, the 2nd diagonal fan exhaust will have a tangential velocity of thousands of miles per hour (in most situations) higher than the tangential speed of the air swirling in the vortex chamber 94, which due to the swirler 90 can range from a few hundred miles per hour (at 0 mph airspeed via suction) to 2000 mph (at 3000 mph airspeed at very high altitude).

At takeoff (0 mph airspeed), the swirler causes some resistance to the air coming into the 1st impeller module intake 4. However, since the vortex chamber 94 is being evacuated by the 1st impeller module, the swirler will be naturally pressurized by a 14 psi pressure head (ambient) from the front or top, such that the air will impel itself through the swirler 90 and the air will have the aforementioned tangential velocity (i.e. 100-300 mph) in the vortex chamber. Some extra work will be done by the impeller system (all the fans) to make this happen, but this extra work will subside as the aircraft achieves a forward airspeed of over (i.e.) 100-200 mph. Once the higher airspeeds begin to allow the swirler to swirl the air without using suction, by its being positively charged with incoming air, the swirler begins to perform work on the incoming air (because it has almost no backpressure).

To understand this, we must view the air in the aircraft and the air passing the aircraft from the relative frame of the aircraft itself, wherein the swirler, vortex chamber, 1st impeller module, etc. have a 0 mph forward velocity and the incoming airstream has a negative forward velocity. In this relative frame, the swirler, by trading axial air velocity for tangential air velocity, has accelerated the incoming air mass by an amount approximately 65% (give or take 10%, depending on the design) of the airspeed. Since this air is now swirling with a high tangential velocity to feed the 1st impeller module at a high tangential velocity, giving the 1st impeller module a higher rotational rate and a higher exhaust velocity (mostly tangential, even more than the vortex chamber), a large amount of work has been done (especially at high airspeeds) by the swirler. This work is not free, for although it is performed by a stator element, it, like lift-induced drag, is work being accomplished by a virtual drag inside the swirler, which must be powered by the aircraft thrust. So, to arbitrarily pick simple numbers, if the swirler imparts a tangential swirl velocity of 500 mph to the incoming air (at approximately 800 mph aircraft airspeed), the incoming air mas has been accelerated by 500 mph (longitudinally) in the relative frame of the aircraft, and therefore the effective thrust of the 2nd impeller module exhaust (thrust) at the outlets 15 will be reduced by a thrust amount that is: T_{effective}=T−f(500 mph) in the thrust equation. In other words, the impeller system will have a much increased exhaust velocity at the thrust ducts 14 due to the existence of the swirler 90, but the extra thrust that comes from this will be moderately if not mostly offset by the virtual drag caused by the swirlers 90A and 90B.

The last few sentences beg the question, if the work performed by the swirler is moderately offset at middling airspeeds and mostly offset at high airspeeds, while causing flow resistance at very low airspeeds, why use it at all? The answer is, we need a way to deal with the air intake at supersonic airspeeds and more importantly, at high-supersonic airspeeds. In the prior art, intake ramps have been used to slow down the air and shock it, creating a raised-pressure air chamber afore the impeller system. This allows the impeller system to work on the air without flow and shock problems, as is well known in the art. However, if intake ramps were to be used in the present invention, we would be accelerating the intake air (in the relative frame of the aircraft, as discussed in the last paragraph) which is work that must be done on the air by the thrust.

But the result of this work would be stagnated air that must inherently be re-accelerated by the impeller system. All of the work of the 1^{st} diagonal fan would probably be used just to get the air back up to the speed (tangential) that it was already coming in before the intake ramps.

Although it would be at higher pressure and this pressure could be useful later (for expansion in a duct), this is what we have been trying to avoid by using the multi-series-fan system all along (see expanded summary of the invention). We only want to accelerate the air, not pressurize it. Although de facto pressurization will take place in the 1st impeller module, which pressurization will be recouped in the longitudinal duct 8 as the air therein accelerates itself (not discussed herein, but inherent in the proposed design), the more we pressurize the air, the more opportunity for accelerating it forwardly (carrying it forward, at a loss) we have wasted. Utilizing pressurized air for thrust is passive and full of losses and thus we wish to avoid it.

But aside from the fact that by pre-swirling the air we accelerate it forwardly (in the relative frame of the earth or ambient air), by pre-swirling it in a tangential direction and velocity more closely matched to the intake rotational velocity of the 1st impeller module (specifically the 1st diagonal fan or the aircraft itself), by swirling it we remove a major problem, that of matching the rotational rate of the 1st diagonal fan, whose vane leading edges are spinning tangentially, to the velocity vector of the incoming air, which before the swirler or after an intake ramp is entirely axial. It is presumed without any evidence or modeling provided herein that at high and very high airspeeds, even though the vanes of the 1st and 2nd diagonal fans are two-dimensional elements (i.e. thin contoured sheets/plates with sharp leading edges) it is going to be exceedingly difficult to match up the 1st diagonal fan vane's leading edge velocity vectors with the intake air molecules' velocity vectors at many operating airspeed ranges, even provided the swirler.

With the swirler, assuming we can work through the flow-separation issues that might arise at very high airspeeds as the air tries to cavitate by being bent too sharply diverted (we could always just lengthen the swirler in the longitudinal direction as a primary means of mitigating these issues), it seems prima facie that the air should, by being pre-swirled, lay itself out at an optimal (average) vector for being picked up by the 1st diagonal fan throughout a very wide range of 1st diagonal fan leading edge tangential speeds. Although throughout this application the Applicant will put a theoretical limit on the difference between the swirling chamber tangential speed and the 1st diagonal fan leading edge tangential speed (higher than 600 mph over the aircraft's airspeed), because at startup and at supersonic airspeeds the pressure of the air entering the swirler is so low, the 1st diagonal fan's rotational rate is probably not limited by such an arbitrary limit.

Nonetheless, an alternative to the swirler has been provided in the present application, namely a set of intake ramps which are the prior art solution that has been obviated by the swirler, and they are shown in FIGS. 8A-8E and described later with reference thereto, such that if the swirler cannot be made to work properly in the practical world, a backup solution is at hand and has been disclosed herein.

It must be stressed once more that at very low and very high airspeeds, the pressure of the air exiting the swirler 90 into the vortex chamber 94 is very low, such that the 1st diagonal fan should be able to operate at whatever rotational rate is optimal for the creation of the required thrust for any situation. This low pressure (due to high altitude in the case of supersonic airspeeds) is relevant insofar as the swirler is concerned, for if we shut off or slow down the 1st impeller module, while allowing the air within the vortex chamber to bleed downwardly or outwardly at several angles or at all angles, the swirler can be used to slow down the aircraft by creating the swirler drag described a few paragraphs ago, while not offsetting it with positive thrust from the impeller system. This will be discussed with reference to FIGS. 8G-8I much later in the application.

### The 1^{st} Impeller Module

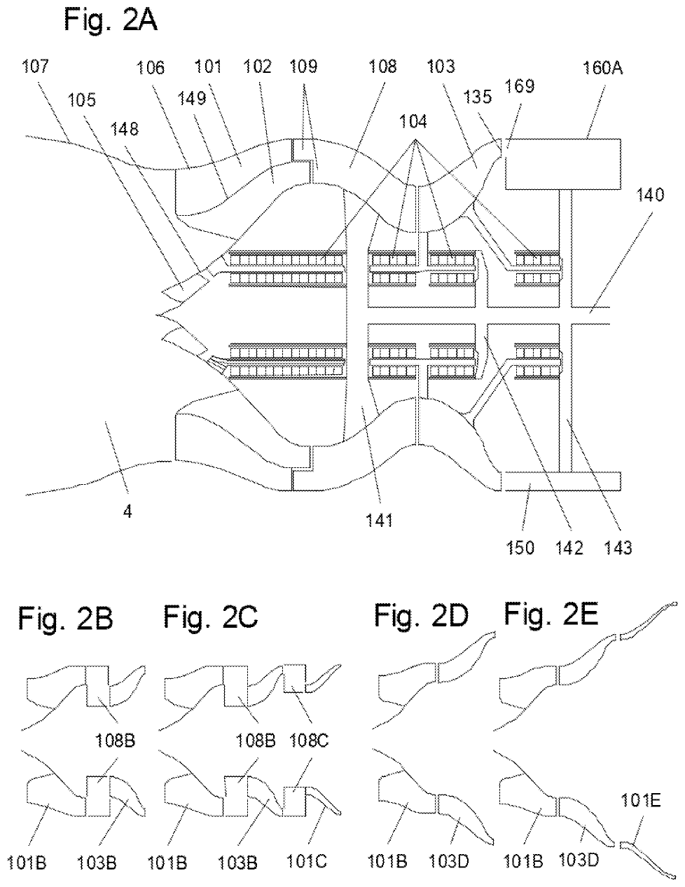

FIG. 2A is a lateral cross-sectional view of the 1^{st} impeller module, specifically the front left 1st impeller sub-module 100A from FIG. 1B. As the 1^{st} impeller sub-modules 100A and 100B are identical, only 100A will be described herein.

The lateral cross-sectional view (such as that shown in FIG. 2A and in other figures) is commonly used in the GTE arts. All the parts in a gas turbine engine are annular, so they can be diagrammed for engineering and lay understanding purposes using this view. The same goes for the motor arts, the blower arts, etc. In fact, the only cut-away that is sufficient to envision the engine/motor is the top half of the lateral cross-sectional view. The top half can be used by an engineer to imagine the entire revolving sweep or swath of the annular system because everything in the annular system is concentric, repetitious, and has equal purpose. What one sees in the top half of the lateral cross-sectional view represents what is drawn but fleshed out in 3D intellectually using the axis and rotating what one sees in the mind around about the axis, once designated, in and out of the page.

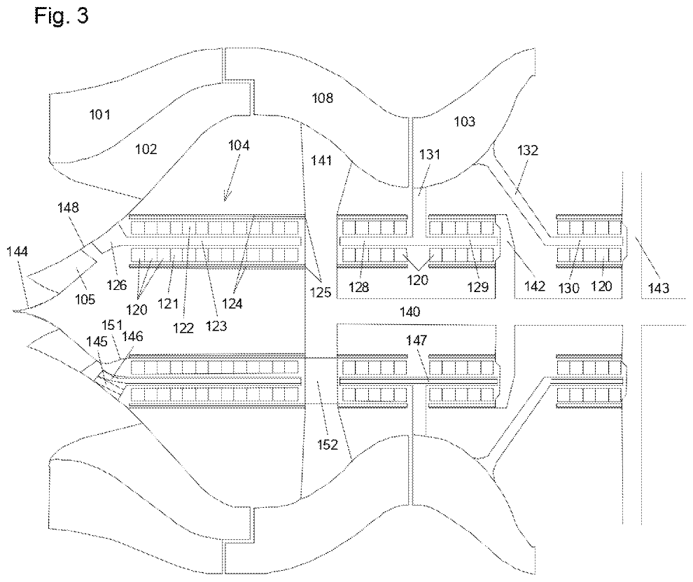

For this reason, the figures (especially FIGS. 2A and 3) that describe the 1^{st} impeller module have mostly been labeled on their top halves. The bottom half of each cross-section is a mirror image of the top half, because the parts that appear there are in fact the same parts. So, for everything that is shown in the top half of each of the drawings for the 1^{st} impeller module, the mirror image objects displayed below them will not always be labeled, because it is presumed that the Examiner and/or the person reading this document is familiar with this practice. Even if not, a casual reader should recognize, by the obvious use by the applicant of the mirror image, what is going on. It's not really that hard. However, if the Examiner wishes to object to the drawings about this for some reason, the Applicant will submit supplemental drawings comprising labels for the bottom half of the cross-sectional drawings and, although this shouldn't be necessary for obvious reasons and if done it will not be an addition of new matter to the application.

Referring to FIG. 2A, the first fan stage 106 comprises two concentric diagonal fans united or locked for rotation together, a 1^{st} diagonal fan 101 and a 2^{nd} diagonal fan 102 nested concentrically within the 1^{st} diagonal fan 101. They draw ambient air from the 1^{st} impeller module intake 4, which is surrounded by a cowl 107 that is only partly shown in the area where it extends forward from the 1^{st} impeller module, the rest of it being more or less the front part of the airframe 1 (not shown in FIG. 2A). The 1^{st} impeller diagonal fans 101 and 102 sequentially ingest and work on the incoming air.

This concentric parallel-flow dual diagonal fan intake (101 and 102) is probably more optimal than a single, larger diagonal fan, but it might not be. A single diagonal fan would be simpler, but the Applicant arrived at the concentric series-flow dual diagonal fan embodiment while pursuing another invention (patent application to follow soon) and it is probably the preferred system, as it seems intuitively capable of capturing more air at a higher average intake velocity and accomplishing a greater rate of air acceleration (work) than a single diagonal fan with an intake cone would. Nonetheless, a single diagonal fan 101 (without 102 but incorporating the space of 102) would perform just fine. The reason “intuitively” was mentioned two sentences ago is because the work the fan(s) do/does near the center/axis of rotation of the fan(s) is negligible. The spinning parts near the axis of rotation are spinning too slowly, relative to the spin speed of the outer parts, to really add to the work being done by the latter. So, a larger 1^{st} diagonal fan would reach deeper (the vanes) toward the center/axis but would not accomplish very much. Better it would be in this case to simply use just the 1^{st} diagonal fan that has been shown with a center nose/cone to entrain (taper) incoming air outwardly to it. But this increases the pressure of the air arriving to the 1^{st} diagonal fan, which is helpful for most commercial aircraft fans, but not for us, so the Applicant prefers to allow the central airstream to encounter a set-back nose/cone 148 that displaces air radially outwardly, in order to deliver it to a separate 2^{nd} diagonal fan for a mechanical interface that only begins at a radius (from center/axis) where the 2^{nd} fan vanes begin, which is outwardly displaced from the center/axis of rotation and where the speed of the vanes is high enough to start doing useful work on the air.

In other words, or another way to look at it, were the 2^{nd} diagonal fan 102 to extend like it does forward to the front of the 1^{st} impeller system but also inward to the axis, it would be encountering high-velocity air with no means to deal with it or to work on it. It is possible that no shape could ever be invented for this part to deal with this problem, and even if it could, the endeavor would be problematic and it wouldn't accomplish anything that the specific embodiment shown in FIG. 2A has not already accomplished. In yet more words, the 2^{nd} diagonal fan 102 allows the impeller system access to an intrinsic mechanism to work on the central airstream that would normally not be available for meaningful work in a system that is not trying to pressurize the air. There is, obviously, a dividing wall 149 between the 1^{st} diagonal fan 101 and the 2^{nd} diagonal fan 102. It is possible also to utilize a shape similar to that shown in FIG. 2A but omitting the diagonal wall 149.

Moving on and still referring to FIG. 2, the 1^{st} diagonal fan 101 and the 2^{nd} diagonal fan 102 deliver their airstreams at an elevated air velocity which is mostly tangential (swirling) to an intermediate passage 108 which conducts them to the 3^{rd} diagonal fan 103. In an aside, in a non-preferred embodiment, at 109 where the airstreams enter the intermediate passage, they could encounter guide vanes that guide the airstreams around an arcuate (anti-swirling) path to decrease the swirling motion and accelerate the airstreams longitudinally (straight back, more or less, toward the 3^{rd} diagonal fan). The prior art provides several extant solutions for guide vanes downstream of diagonal compressors, and the most common solution appears to be placing two rings of stator vanes after the diagonal compressor. The prior art solutions further teach that it is not enough to simply have two rings of stator vanes (the air is going too fast and apparently this causes problems). For some reason, the two rings' vanes must be interdigitated and designed such that the trailing edges of upstream stator vanes overlap with the leading edges of downstream stator vanes, with a small gap between the overlapping edges (this design might be later borrowed for the swirler, and was briefly described above). The Applicant must assume that this works, since so many patents have solved the same problem the same way. It is noted that the use of guide vanes at 109 has been superseded by the current, preferred embodiment in which they are omitted, which preferred embodiment allowing the air coming out of the 1^{st} and 2^{nd} diagonal fans to continue its natural swirling motion while traversing the intermediate passage, albeit more slowly, in a longitudinal sense. It is noted that the guide vanes, if used, do not have to completely un-swirl the airstreams. However, it is further noted that, as we are attempting to constantly impart higher and higher tangential velocities to the air as it travels from front to back of the aircraft, especially since the addition of the swirler was settled upon as the best mode, the Applicant has determined that any guide vanes that un-swirl the air do more damage than good, reducing the tangential velocity of the air and thus inherently requiring some one or more of the fans to re-accelerate the air. So, it is emphasized that the space designated 109 should probably not include straightener guide vanes, but that it could if it is determined that they are beneficial or necessitated.

After entering the intermediate passage 108, the airstreams being propelled rearward by the diagonal fans 101 and 102 join in confluence when the cylindrical dividing wall between the airstreams ends, and the combined airstream passes through the annular intermediate passage 108, which routes the air back inward, radially, toward the center, forming a waist portion (not labeled but obvious) of the overall module's shape, to a point where the intermediate passage 108 is aligned with and meets the 3^{rd} diagonal fan 103. It is noted that other than seals between relatively spinning parts (and actually there might not even need to be seals, since the air inside the impeller modules is at a lower pressure than the air outside it, so the worse they could do is suck in a little air by accident), there is no outer structure around the 1^{st} impeller module (elements 101, 108, 103, etc.). This reduces the mass of the system.

The 1^{st}, 2^{nd}, and 3^{rd} diagonal fans are driven by motors 104, in a manner to be described later with reference to FIG. 3.

Importantly, the third diagonal fan 103 spins at a rate of 1.4 to 3 times the rotational velocity of the 1^{st} and 2^{nd} diagonal fans 101 and 102, the ratio between them (1.4-3) being dependent upon the aircraft's airspeed (but having an average or sweet-spot of 2:1), such that at low airspeeds such as 300 mph the 3^{rd} diagonal fan might spin at 3 times the rate as the 1^{st} and 2^{nd} diagonal fans, while at maximum airspeed the 3^{rd} diagonal fan might spin at only 1.4 times the rate of the 1^{st} and 2^{nd} diagonal fans. As mentioned above, the air gets left to spin in a vortex along the intermediate passage 108 after it exits the 1^{st} and 2^{nd} diagonal fans 101 and 102. The speed of this air will be mostly tangential and a given air molecule might even complete a rotation or two around the intermediate passage before being swept up by the 3^{rd} diagonal fan 103. The third diagonal fan 103 spins at an extremely high rate and all measures must be taken to mitigate the flow problems at its inlet. Many traditional mechanical measures can be used simultaneously, such as a) sharpening the leading edge of the vanes of the 3^{rd} diagonal fan, b) profiling the leading edge with a serrated or saw-tooth pattern, c) making the leading edges part of a variable geometry vane system with the ability to adjust the angle of attack of the vanes' leading edges, d) etc. The foregoing list is not exhaustive. However, even though the vanes of the 3^{rd} diagonal fan are going to, hopefully, slice directly into the combined airstream passing through the intermediate passage by modulating the 3^{rd} fan rotational velocity according to its instantaneous air intake velocity (roughly proportional to the linear velocity of the outer perimeter of the 2^{nd} diagonal fan 102), it will help greatly if the air is already swirling at very high velocity in the same direction as the vanes' leading edges' rotation. No matter how much the combined airstream is still swirling, the extremely high rotational rate of the 3^{rd} diagonal fan means that the 3^{rd} diagonal fan's vanes are going to elegantly slice into the air properly anyway. Again, the 3^{rd} diagonal fan 103 spins at an extremely high rotational velocity more than 1.4 and as much as 3 (or more) times the rotational velocity of the 1^{st} and 2^{nd} diagonal fans.

If the velocity of the air exiting the 1^{st} and 2^{nd} diagonal fans and swirling in the intermediate passage 108 has a very high tangential velocity, such as between a minimum (at airspeed 200 mph) 1000 mph and a maximum (at airspeed 3000 mph, keeping in mind the swirler) 2700 mph, the 3^{rd} diagonal fan simply can't be going slower or the same speed as that. This is where the rotational velocity of the 3^{rd} diagonal fan 103 becomes crucial. If it spins at the same rotational velocity as the 1^{st} and 2^{nd} diagonal fans, the outlet velocity will be the same as the inlet velocity, such that the 3^{rd} diagonal fan will have performed no useful work, and is a waste of space and magnets (mass and expense). What we must do, to get maximum work out of the 3^{rd} diagonal fan, is to spin it at a rotational rate such that the tangential velocity of its vanes' leading edges is approximately 600 mph (or more) higher than the tangential velocity of the air swirling in the intermediate passage 103, which will be at or higher than the tangential velocity of the trailing edges of the vanes of the 1^{st} and 2^{nd} diagonal fans, due to the nature and performance of the diagonal fans.

The applicant has wondered for some time why no one has tried to use dual series diagonal fans and so few have tried to use dual series diagonal compressors in the aircraft industry. It is possible that no one ever thought to spin the last fan stage at an extremely high and extremely variable velocity relative to the preceding fan stage(s). It is however more likely that this extremely high later-stage's rotational velocity, relative to the first fan stage's rotational velocity, cannot be accomplished by a gas turbine engine (an overdrive system could be interposed between the shaft and the last fan stage or the first turbine and the last fan stage shaft, or something like that, but at huge expense and even huger fail-rates). Also, un-swirling the air coming out of the last fan stage is very difficult if the designer intends to (for pressure-reasons) keep pushing it longitudinally toward the back of the aircraft for thrust. The system required to simultaneously (or successively) de-swirl the air from the last fan stage (or any or all of the fan stages) and envelope it while also entraining it into a thrust nozzle (in the traditional manner) would be nearly impossible to realize once the speed of the last fan stage's outer diameter's linear velocity rose to the velocities needed to harness all the power available to the system (between 2000 and 6000 mph), depending on the diameters and quantity of fan stages.

It is well known in the mechanical and aerospace engineering arts that as the velocity of an airstream through a duct increases, the cross-sectional area of the duct can and must be reduced proportionally/linearly. So, any time we are accelerating the air, we must be simultaneously reducing the duct width or cross-sectional flow area. Thus, FIGS. 2 and 3 show that all of the fans become thinner (their cross-sectional flow area) as the air moves further or deeper through them, and each fan begins with a narrower cross-sectional flow area than the fan upstream of it. By doing this, it is possible and advantageous to have the outlet of the 3^{rd} diagonal fan, and thus the volute that it feeds as well, have as its cross-sectional flow area a relatively small fraction of the cross-sectional flow area of the combined intake of the 1^{st} and 2^{nd} diagonal fans.

If the velocity ratio for the 1^{st} fan stage (1^{st} diagonal fan 101 and parallel 2^{nd} diagonal fan 102) is 3:1 or 4:1 (during most flight segments) and the velocity ratio for the 2nd fan stage (3^{rd} diagonal fan 103) is also 3:1 or 4:1, the total velocity ratio for the entire 1^{st} impeller system is 6:1 or 8:1, respectively. Consequently, the cross-sectional flow area of the ducting leading away from the outlet of the 3^{rd} diagonal fan 103 could conceivably be as little as ⅛^{th} of the cross-sectional flow area of the impeller system intake 3. What we find as a proposed consequence of this is that the exit ducting (elbow duct 7 and longitudinal duct 8) carrying the air away from the 1^{st} impeller module 100 should be ⅛^{th} (give or take 30%, as the prototype might be quite crude) the cross-sectional area of the aircraft intake's cross-sectional area. Which means this exhaust will fit in the space shown in FIGS. 1A and 1B, down between the legs of parallel rows of passengers seated abreast. So, this we have done, as was described in conjunction with FIGS. 1A and 1B.

Still referring to FIG. 2, the 3^{rd} diagonal fan 103 ejects its exhaust air into an annular volute 150 first through an annular fan slit 135 that represents the downstream end/outlet of the 3^{rd} diagonal fan 103 and then into an annular volute slit 169 on the upstream side of the annular volute body 160A, such that the volute slit 169 directly faces the fan slit 135 to make a single longitudinal passage through them from the third fan 103 into the annular volute body 160A. As mentioned above, the 3^{rd} fan's exhaust air will be spinning almost completely tangential to the 3^{rd} fan (swirling), and only somewhat moving from front to back. So, the annular volute is, as its name would suggest, an annular ring, which could also be referred to as a polygonal-cross-sectioned torus. Now that it has done this, the air that was swirling and unusable by any longitudinal machinery has now been captured in a tangential duct which can be curved or bent to conduct the air anywhere we want it to go. However, there are some things that won't make implicit sense and must be described further. Firstly, the volute slit 169 feeds air to a ring-shaped duct (volute body 160A) that has air going around in it. We know how the air goes in, through the slits 135 and 169. The slits 135 and 169 are about the same diameter and width, they face each other with negligible space between them for air to leak out, and this width is minute compared to the diameter of the 3^{rd} diagonal fan 103. The diameter of the 3^{rd} diagonal fan 103, at its rear end, is roughly identical to the diameter of the annular volute 150. The flow area through the slits is small and the annular volute body 160A is large.

A regular prior-art volute in this case would be an annular volute that had a circular inner diameter and an outer diameter that tapered progressively outward, radially, from the circular inner diameter. The problem with this is that such an outward taper would cause most of the annular volute to have a larger diameter than the third diagonal fan 103, and thus it would have parts that stick out laterally from behind the 1^{st} impeller module, increasing the width and height of the front of the aircraft. So, to preclude this, the Applicant has created an annular volute with a circular outer diameter and an inner diameter that tapers progressively inward away from the circular outer diameter.

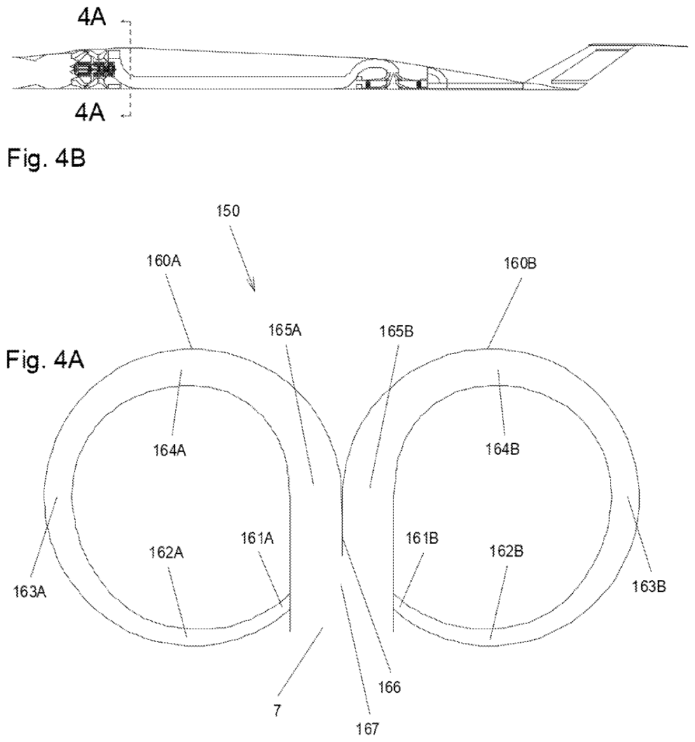

The novel volute is shown in FIG. 4A and is still generically labeled 150 to correspond to FIG. 2. FIG. 4A is a view of the annular volute 150 from behind it, meaning the viewer is longitudinally rearward of the volute, on the opposite side of it from the 1^{st} impeller module 100, and looking in the longitudinal forward flight direction of the aircraft (toward the impeller system intake 3). Thus, the fans are obscured and the Applicant has chosen not to depict the innards of the 1^{st} impeller module in this figure, even though the center of the annular volute 160A is empty, in order to render a clearer depiction of the annular volute 150 by itself. The volute slit 169 is also not visible because it is on the other side of the volute.

FIG. 4B is provided for the insight of the reader, such as: FIG. 4A is a cross-section taken from FIG. 4B, which is a copy of FIG. 1A meant to reveal to the reader the shape of the aircraft, and what section is being discussed and from what angle. FIG. 4B has a bracketed arrow pair labeled 4A to identify the direction and location of the cross-section that FIG. 4A is taken from.

The first thing that will be noticed about the annular volute in observing FIG. 4A is that it incorporates both annular volute bodies, a 1^{st} volute body 160A that is behind the left front impeller sub-module 100A (see FIG. 2), and a 2^{nd} volute body 160B that is behind the right front impeller sub-module 100B. So, from the forward-facing vantage provided in FIG. 4A, the reader must imagine the left front impeller sub-module 100A rotating in a clockwise direction and the right front impeller sub-module 100B rotating in a counterclockwise direction. It will become obvious upon such imagining that the air being exhausted by the left front impeller sub-module 100A enters the annular volute body 160A via its volute slit 169 and travels clockwise in 1^{st} volute body 160A, from a first (thin) 1^{st} volute initial body section 161A, to a (widened) bottom 1^{st} volute body section 162A, and then to an (wider still) outer 1^{st} volute body section 163A, and then to an upper (wide) 1^{st} volute body section 164A, and finally to the 1^{st} volute branch 165A. The air being exhausted by the right front impeller sub-module 100B simultaneously enters the second volute body 160B via its volute slit 169 and travels counterclockwise in 2^{nd} volute body 160B, from the first 2^{nd} volute initial body section 161B, to a bottom 2^{nd} volute body section 162B, and then to an outer 2nd volute body section 163B, and then to an upper 2^{nd} volute body section 164B, and finally to the 2^{nd} volute branch 165B. The branches, entailing a left-side branch 165A and a right-side branch 165B, are wider than the upper volute body sections 164A, 164B, which are themselves wider than the outer volute body sections 163A, 164B, which are themselves wider than the bottom volute body sections 162A, 162B, which are themselves about the same width or slightly wider than the first volute initial body sections 161A, 161B.

As the air comes out of the 3^{rd} diagonal fan 103 (2^{nd} diagonal fan stage) and through the slits 135 and 169, it is simultaneously entering all of the volute initial body sections 161A through 165B equally. It is entering them, further, with a majority of its velocity vector along the volutes, tangentially. At the 1^{st} volute initial body sections 161A and 161B the air at that section enters each 1^{st} volute body section travels around from the 1^{st} volute body sections. The rear side of the volute bodies (160A, 160B), not shown, blocks the air from traveling rearwardly any further, and the airstreams through the volutes will conform to the overall ducting and all of the air is now spinning around in a circular path leading from the 1^{st} volute initial body sections 161A, 161B to the volute branches 165A, 165B.

While the airstreams in the volute bodies 160A, 160B travel around their opposite circular paths, they are being constantly supplemented with more air from the 1^{st} impeller sub-modules. This is why the inner diameter tapers progressively away from the outer diameter; the volumetric flow of the airstreams is increasing and it needs more cross-sectional area to accommodate its increase. Importantly, at the volute branches 165A, 165B, the counter-rotating airstreams stop increasing in width and become parallel to each other, such that they are both traveling directly downwardly toward the earth in straight lines. A dividing wall 166 separates them for a bit. Keeping them separate via the dividing wall 166 is necessary for some small extent, to stabilize the flows so that they do not slam into each other. However, as soon as it is possible, which juncture point is not known at the time of filing, the dividing wall 166 should end so that it no longer causes drag on the airstream, which is now described in the singular, because there is now a single unified flow or airstream 167 from both volute bodies 160A, 160B as the unified airstream 167 enters the elbow duct 7, as shown in FIGS. 1B and 4.

In the manner described in the last few paragraphs, two separate airstreams pass through two parallel 1^{st} impeller sub-modules in a longitudinal direction while both being simultaneously and equally accelerated by two stages of diagonal fans (the 1^{st} stage is diagonal fans 101 and 102, the 3^{rd} stage is diagonal fan 103). The airstreams' directions get deflected, de facto, to be mostly tangential by the actions of the 2^{nd} fan stage (3^{rd} diagonal fan 103). A pair of volutes which are mirror images of each other gather the air from the rear end of the 2^{nd} fan stage via an inlet slit 135, 169 and the two airstreams are no longer parallel, they are arcing out away from each other, then up, then back toward each other, and then down in a vertical direction, where they conjoin to create a single airstream, and then the single airstream is bent by an elbow duct 7 to be completely rearwardly directed to a location where it can be simply ducted along the center of the bottom of the aircraft along longitudinal duct 8.

Referring one more time to FIG. 2A, the structural support for the first impeller system 100 is shown as a longitudinal beam or girder 140, which may or may not be made of metal or thermoset or reinforced thermoplastic or fiber reinforced composite, and which also may or may not be hollow and could even possibly be a thermoset-filled or foam-filled or honeycomb filled or lattice-filled stronger, harder outer shell. This beam 140 could be attached as a continuation of the longitudinal duct 8 via various intervening braces and struts. It might be remembered from an earlier discussion herein that the longitudinal duct 8 was offered as a potential candidate for being the primary structural framework member of the aircraft. Anyway, regardless of whether the beam 140 is connected to longitudinal duct 8, the beam 140 serves as the hub for disk-like or spoke-like support means 141, 142, and 143 that connect all of the non-moving stator elements (i.e. 104, 108, 150) of the 1^{st} impeller module and the main frame together such that they are rigidly bound and unable to move, shift, or vibrate relative to each other. This configuration also cantilevers (see FIG. 2A) the 1^{st} impeller module out (left-ward) toward the front of the main frame such that there is no additional framing or nacelle associated with supporting the 1^{st} impeller module 100. This results in hefty savings in mass and expenditures. Specifically, the support means 141, 142, and 143 support the magnets 120 (described later) of motors 104, which electromagnetically suspend the rotors and thereby the fans. The support means further attach to the intermediate passage 108 and the annular volute 150. If the annular volute 150 and intermediate passage 108 are further rigidly connected to the monocoque airframe (described earlier), then the system has rigid attachment points to the elements 8 and 140 on the inside and the airframe 1 on the outside, with the magnet carriers suspended between this inside and outside, such that the magnet carriers and how they connect to the support means are providing additional anti-shearing and anti-vibration reinforcement for the airframe.

FIG. 2B illustrates a primary alternative embodiment for the fan combination of the 1^{st} impeller module wherein the 1^{st} diagonal fan stage is represented by a single 1^{st} diagonal fan stage, namely a front diagonal fan 101B. The front diagonal fan is followed by a downstream rear diagonal fan 103B and between the front diagonal fan 101B and the rear diagonal fan 103B is, similarly to the embodiment shown in FIGS. 1A and 2A, an intermediate passage 108B. However, in this alternative embodiment the intermediate passage 108B is longitudinally shortened from the original embodiment 108 from FIGS. 1A-2A. This embodiment will be shorter in longitudinal length than the embodiment shown in FIGS. 1A and 2A, which shortness could be advantageous for multiple reasons, not to be delineated herein, but probably beneficial in the end, since the originally proposed intermediate passage 108 does not have a real advantage over it that the Applicant can see at the time of filing, other than the fact that as shown in FIGS. 1A, 1B, and 2A the fans, all of them, conform to the design that allows them to be driven in a single rotation direction by the rotors and stators shown in the application, which are not at all preferred or thought to have been fleshed out in any robust sense at the time of filing of the present application. In other words, the Applicant drew FIGS. 1A and 2A before conceiving of the later idea of FIGS. 2B-2E, but the electronics and magnets of all of this application can be shifted and shuffled around to conform to any conceivable assemblage without diverting from the taught scope of this application.

Although the magnets, rotors, and coils of FIGS. 2B-2E are not shown, it should be obvious to anyone of ordinary skill in the art, in light of the other embodiments illustrated and described in painful detail within this disclosure, where and how they would be implemented and how the myriad electromagnet configurations to drive the fans should be concocted. We must forego now the possible embodiments of how these fans are to be driven, or how they or the intermediate passage will be supported or the inlets and outlets of the combined assembly should be formed to deal with the air entering and exiting the assembly. We must presume that the industry will, in the event that the embodiments of FIGS. 2B-2E have any merit at all, figure out how to make the stuff and how to fit the stuff into the machines it will fly. For this discussion, such that we can return to the general gist of the invention at large, we will move through this detailed description quickly, succinctly, and with an imagination full of how these various alternative embodiments could be employed in various fields all-be-they (the fields) as yet undefined or untenanted.

Returning to FIG. 2B, as mentioned a single front diagonal fan 101B feeds air into an intermediate passage 108B. The air from front diagonal fan 101B will spin within the intermediate passage 108B and since it has nowhere else to go, it will have a radially inward velocity contingent that will scroll it to the inlet of rear diagonal fan 103B whence the leading edges of the vanes of the rear diagonal fan 103B will take it up and work on it in the same way as in the previously described embodiments of third diagonal fan 103 from FIG. 2A, by spinning at or near twice the rotational rate of diagonal fan 101B.

FIG. 2C shows the same thing but there is a second intermediate passage 108C to gather and harness the output from the rear diagonal fan 103B and feed it to a rear-most diagonal fan 101C. This embodiment has an insanely high output air velocity and even if it were coupled with an annular volute as shown in FIG. 4A, the Applicant does not know yet how it could be used. The third diagonal fan 101C will be spinning at about (plus or minus one standard deviation or sometimes thrice it) three times the rotational rate of the first diagonal fan 101B (as described previously, although it is tempting to spin the secondary fans at even higher speed ratios compared to the fans upstream of them, this would result in the air coming out of them having too much energy, and since this energy gain would require that that fan stage perform more work than another fan stage, in an embodiment where all of the fan stages have the same sized motors we are restricted to having linear air velocity gains for each stage, not compounding ones, and that is why the third fan stage “only” spins at three times the rotational rate of the first fan stage.

FIG. 2D shows an interesting embodiment, one in which there is no inherent requirement that the rear diagonal fan 103D share the same diameter as the front diagonal fan 101B. We can dispose of the formality of the intermediate passages 108, 108B and simply spin the rear diagonal fan 103D at two or more times (it can have a larger drive motor) the rate of the front diagonal fan 101B. It is quite possible that there need be zero buffer between the fan stages, and thus simply running the rear diagonal fan 103D at a higher rate of rotation than the front diagonal fan 101B will simply compound the speed of the air without any penalty. This seems to be serendipitous and overly optimistic but the Applicant cannot foresee any prohibitive obstacles to the idea that this might be really easy to pull off. The fans 101B and 103D spin in the same direction but at different rates, and all of the energy spent by the front diagonal fan 101B is simply forwarded to the air within the rear diagonal fan 103D in which space it is accelerated to a high tangential velocity, whence it can be consumed and ejected as thrust, or priming flow for a subsequent fan or compressor.

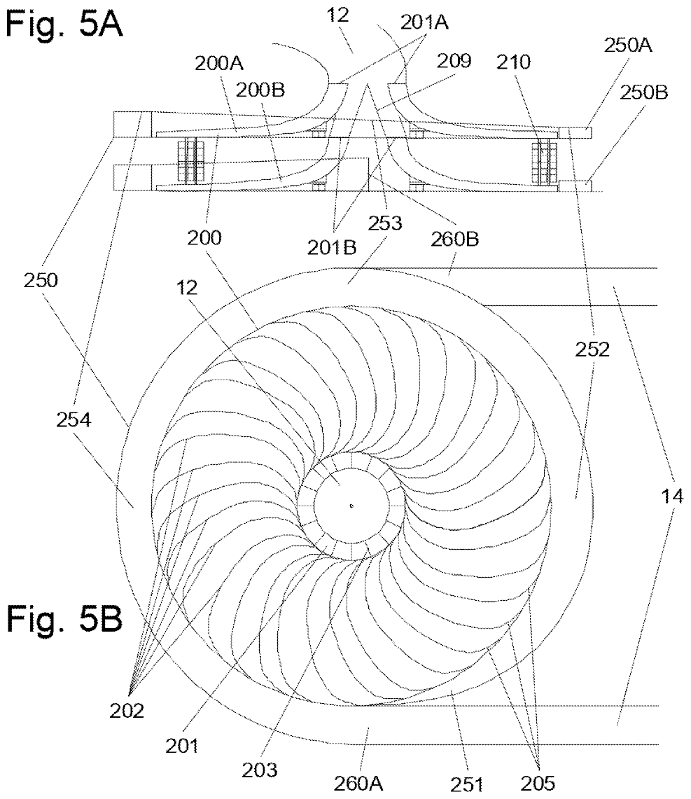

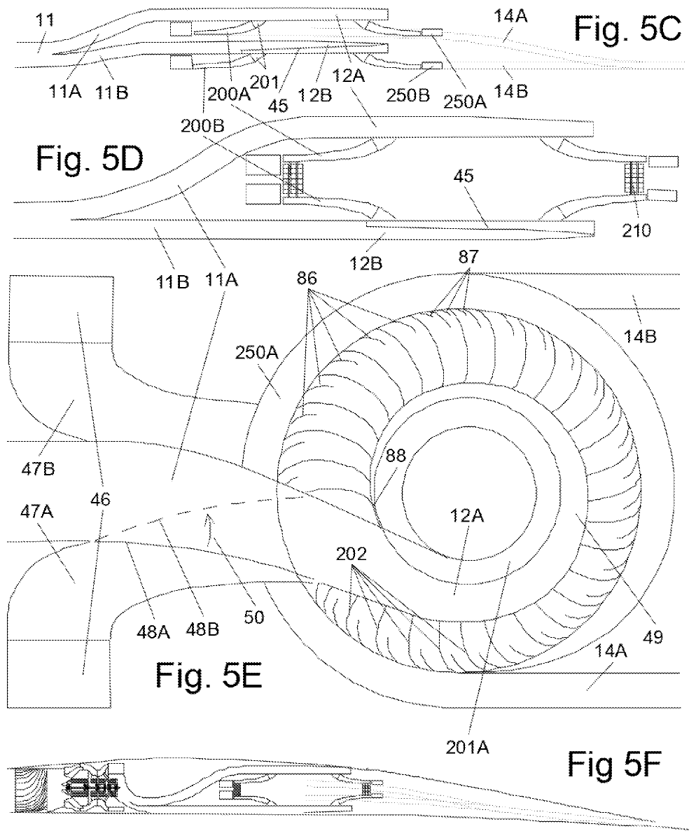

FIG. 2E is the same thing as FIG. 2D but with a 3^{rd} diagonal stage 101E juxtaposed onto the output of the rear diagonal fan 103D. The Applicant cannot here go into detail about all these peripheral (no pun intended) embodiments and why they might be advantageous, but the idea can be expressed in terms of the fact that more stages equals more power, but that the power of more than two stages in the preferred embodiment might be too much since we are using the centrifugal fan stages (2^{nd} impeller module 200) of FIGS. 5A-5E for final thrust, but whether the centrifugal fans are used for final thrust or whether the 1^{st} impeller module is the sole mode of thrust, there exist so many obvious combinations of elements within the present application and also multiplications or subtractions therefrom (it is possible that the invention of this application can work with only a single 1^{st} diagonal fan, etc.) that the embodiments of FIGS. 2A-2C are simply proffered out of hand as the raw stock from which various derivative machines can be built. FIG. 2E is a natural extrapolation of FIGS. 2A, 2C, and 2D that we have to just summarize and say that many combinations of spinning elements can be stacked up end-to-end. But FIG. 2E, if rigged up with its requisite Halbach array stator+rotor arrangement elsewhere laid out in this application, could be an extremely powerful thrust sub-machine for an (i.e. commercial jumbo-jet) aircraft that is not employing the overall scheme of the present application. Used somehow as a high compressor stage, it would naturally provide a 15:1 or higher pressure ratio (all elements spinning the same direction but each one 2-3 times faster than its predecessor) or the same (15:1) velocity ratio with very little overall size being appropriated by it. But still, this side-discussion is for now just a widget and who knows what will come of it if anyone happens to notice it.

Referring now to FIG. 3, which is a close-up view of the contents of FIG. 2A but enlarged so that we can see the inner workings of the 1^{st} impeller module 100. Again the 1^{st} impeller module 100 comprises the 1^{st} diagonal fan 101 and 2^{nd} diagonal fan 102 making up a 1^{st} fan stage, then we have the intermediate passage 108 that delivers air from the 1^{st} fan stage to the 3^{rd} diagonal fan 103 that makes up a 2^{nd} fan stage. Only one of the motors 104 is labeled, but it is obvious from FIG. 2A that there are four of them. The first motor 104, on the left-hand side of FIG. 3, will be described in detail and then the other three motors 104 will be cursorily described especially where they are different from the first motor.

The 1^{st} and 2^{nd} diagonal fans 101 and 102 are integral with each other or united for rotation together, and an extension of the inner diameter wall of the 2^{nd} diagonal fan 102 extends inwardly to form a cone 148. The cone 148 takes a middling portion of the incoming air that is traveling toward the motors 104 and deflects it radially outwardly and into the 2^{nd} diagonal fan 102, increasing the intake flow capacity of the 2^{nd} diagonal fan 102 and protecting the motors and other rotating elements from contamination, foreign objects and debris, etc. It was discussed earlier that a single diagonal fan could be used for the 1^{st} fan stage. Another option discussed in that paragraph was the idea of having the vanes of the 2^{nd} diagonal fan 102 extend forwardly as far as the vanes of the 1^{st} diagonal fan 101. However, as the Applicant believes that this would create flow problems at the leading edges of the 2^{nd} diagonal fan while performing negligible work, the vanes have been undercut to reveal the bare cone 148.

The cone 148 represents a junction point for fixing the 2^{nd} diagonal fan 102 (and thereby the 1st diagonal fan 101) to a rotor 123. The junction is accomplished via an annular pedestal 126 that resolves shear stresses and increases the bonding area between the rotor 123 and the cone 148. It must be kept in mind that all the elements are annular and/or cylindrical, such that the rotor is not actually flimsily cantilevered like it seems in the figures. The rotor 123 comprises electrical coils (wiring in insulation wrapped around on itself many times) which are not shown in the figures but are well known in the electric motor arts. It is not considered necessary here to explain commonly known features of electric motors, however the type of electric motor being used here must be summarily dealt with at some other points in this application. The most appropriate rotor for the job at hand will probably be a cylinder with slots in it, with adjacent slot pairs containing the two poles of a single winding. However, there are other means known in the art for seating the poles at an appropriate distance from each other on a cylindrical rotor. Regardless of which of these is used, the motors proposed herein are in a simplest embodiment brushed DC electrical motors. Since the batteries' voltage is DC, this allows us to synchronize the polarities of the coils using the rotational phase of the rotor itself, simplifying the system and reducing the amount of required electrical equipment. As this technology is old and well-known, the Applicant will forgo a discussion of brushed DC motors herein. As will be hinted at or disclosed at other moments in this application, the motors could be synchronous or asynchronous motors, or whatever type of motor is best suited to accomplish the aims of the proposed invention. This means that all the discussion provided herein about the (Halbach etc.) preferred embodiments for the electric motors could be wrong, and a simpler (lighter/less-costly) manner could of course be eventually a preferred embodiment.

So, in short, the motors 140, and specifically the first motor labeled 140 on the left-hand side of FIG. 3, each comprise a rotor with electrical coils (also known as windings) arranged in pole pairs, the pole pairs being arranged in slots or other channels or grooves or conduits on or within the rotor, which is a cylindrical monolith. The rotor monolith is preferably cast from aluminum alloy with the slots already formed in it by the mold, but any suitable material and/or manufacturing method could be used without departing from the scope of this application. The rotor is integrally cast with the annular pedestal 126. Once the rotor is cast, polished, and rigged out with all its electrical equipment including the brushes, which could be anywhere on it that passes near a stator element but probably at its rear perimeter edge, it is bonded to the inner surface of the cone 148. In this way, if the rotor 123 is driven using electromotive force in a rotational direction, the fans 101 and 102 will rotate with it.

The motor 104 comprises magnet stators 121 and 122 each containing magnets 120. A lengthier discussion of the magnets 120 was provided in the summary of invention, and not all of it will be reprised here. While not limiting the scope of the overall invention, the best mode for the magnets 120 that the Applicant can think of at this time is as follows.

The magnets 120 will likely be small (such as 1-inch) cubes of rare earth magnetic material, such as for example neodymium types. As shown in FIG. 3, the neodymium cubes are arranged end-to-end (or side-by-side) in a linear array of approximately 4n+1 cubes, such as 5, 9, 13, 17, etc., for reasons that have to do with the type of magnetic effect being utilized, described earlier and later in this specification. Multiple linear arrays are arranged in parallel around the inside or outside surface of a respective combined housing plus magnetic shields 124.

Referring still to FIG. 3, an inner annular magnetic stator array 121, being for example thirteen cubes in length (how many linear arrays will fill out the annular sweep of the three-dimensional rotor as it will depend on the diameter of the rotor), resides between its housing 124 and the rotor 123. An outer annular magnetic stator array 122 is likewise placed outside of the rotor 123 and inside of its own housing/shield 124. As was hinted at, the housings 124 comprise a magnetic shield and that is why there are three lines shown for them instead of two. How to secure the magnets to the housing is up to the manufacturer, but an easy method would seem to be to heat the shielding material to a transitional, soft state, embed the magnets in it, and then let it cool, permanently embedding all the magnets in the shield at the same time.

The inner annular magnetic stator array 121 and the outer annular magnetic stator array 122 are coaxial and concentric, and arranged such that there is just enough room between them to annularly receive the rotor 123. The stator system, of course being constructed to disallow relative motion (except rotationally), allows the rotor to be suspended between the magnets without touching them, and the space between the rotors and the magnets is known as an air gap, visible in the figures but not labeled. This practice is also well-known in the arts and need not be delineated herein. However, it is noted that the air gaps should be constructed to be as narrow as possible, which is also well-known in the arts.

The annular magnetic stator arrays 122 and 121 create respective magnetic fluxes radially inwardly (thinking of the system as annular and not two-dimensional) and outwardly. The coils within the rotor 123 will exist in the area of the multiple fluxes from the two magnetic stator arrays and when an electrical current is made to run through all the coils at the same time (via applied voltage from a bank of batteries), electromotive force will apply rotational torque to the rotor, as is well known, with a force linearly proportional to the applied voltage.

As shown, the inner annular magnetic stator array 121 could waste half its magnetic flux in the radial inward direction and the outer annular magnetic stator array 122 could waste half its magnet flux in the radial outward direction. So, as is known and somewhat frequently used in the neodymium cube magnet applications, the magnetic cubes are arranged in what is called a Halbach array. Any encyclopedia (or Wikipedia) provides a good explanation of Halbach arrays, so the application will not spend much time dealing with this phenomenon. The phenomenon can be described quickly as: if the magnets are arranged such that their N-S polarity is rotated, such that each successive magnet is shifted 90 degrees (down-left-up-right-down . . . ) relative to the magnet before it, the flux of the Halbach array is focused to one side of the array and almost no flux exists on the other 3 sides. If the Halbach array is practiced in the present invention, nearly all of the magnetic fluxes of the inner annular magnetic stator array 121 and the outer magnetic stator array 122 can be focused across the air gaps and onto the rotor 123.

Although the Halbach array is used in several technologies, the use of it to drive the rotor 123 (and by the rotor the fans) doubles the power of each magnet, as felt by the rotor when a certain voltage is applied. The result of this can be seen in two different ways, which are two ends of the same stick. The first interpretation would be that the magnets shown are twice as powerful as they would be without the Halbach array, and thus the aircraft is twice as powerful as it looks (of course, the number of coils still determines the power but this can be scaled up or down at will without difficulty). The second interpretation is that we can reduce the number of magnets to be half (or a little more) as many as are shown herein. The effect is that we now have a wider avenue of alternatives for accomplishing the prototype, perhaps choosing to make a first-run prototype lightweight with less magnets, and then using the data from testing it to model several possibilities, comprising a continuum from on one end high-acceleration magnet-laden aircraft and on the other end lower-acceleration lighter-weight aircraft. However, as has been discussed and will be discussed during a discussion of modalities/methodologies later, the Applicant prefers to use a large quantity of magnets, regardless of the resulting massiveness of the aircraft, because a super-rapid acceleration of the aircraft leads to myriad follow-on advantages and results.

To summarize the magnets 120 as part of the motors 104, the rotor 123 is enveloped between an inner annular magnetic stator array 121 and an outer annular magnetic stator array 122, such that it rotates between them while they stay still and are rigidly fixed to a frame element 141 at the juncture point 125 where their housings 124 (that have magnetic shielding) meet the frame element 141. The diagonal fans 101 and 102 are attached to the rotor 123 using an annular pedestal 126 that increases the robustness of the juncture. The magnets are configured in Halbach arrays, and many such parallel Halbach arrays add up to an annular magnet array as shown at 121 and 122 if these are viewed as they should be, as if FIG. 3 were rotated into and out of the page to make the three dimensional structure it really is, FIG. 3 being simply a cross-sectional cutaway of the three dimensional module.

The main frame element 140 was described earlier. It is a hub for the disks or spokes 141, 142, and 143, which serve to connect the main frame element 140 to the stator elements (121, 122, 108, etc.). The housings 124 are attached to the disk/spokes 141, 142, 143 at juncture points 125. The other motors behind the 1^{st} motor 104, all of which drive the 3^{rd} fan 103 in this particular embodiment, are substantially identical to the first motor 104, but have various dissimilar pedestals arrangements 131 and 132 supporting various dissimilar rotor arrangements 128, 129, and 130. The 4n+1 rule has been kept for the magnets (many have 5 cubes in a row). However, it is possible that the 4n+1 rule is not needed for a Halbach array or it is wrong by an integer or more from what has been typed herein, or that in other words the formula is not correct (maybe it should be 4n or 6n i.e. 6n+1 or whatever). These details are not important here, as anyone that deals with these devices will easily know the answer, and the 1^{st} impeller system can always when needed be modified to be slightly or even severely different than it is as shown in FIGS. 2 and 3.

Attached to the cone 148, which is an inner forward conical extension of the 2^{nd} diagonal fan 102 is another diagonal fan and it is a cooling diagonal fan 105. The cooling diagonal fan 105 intakes incoming air from the 1^{st} impeller module intake 4 (the small amount of air that makes it through the aperture in the front of the nose). It flings this air outwardly and rearwardly to cool the motors 104. The air exiting the cooling diagonal fan 105 impinges on the annular pedestal 126. For discussing the motor cooling scheme, the reader is directed to the lower (reflected or mirror-image) elements instead of the upper elements. The pedestal 126 is shown there with internal conduits 145 and 146 which are cooling passages. Some of the air coming from 105 passes through outer conduit 145 to arrive at the magnets to flow through them (the linear arrays will have triangular-cross-sectioned spaces between them) and along the outer air gap. Some of the air coming from 105 passes into rotor-cooling conduit 146, which passes between the coils of the rotor and/or between the coils' pole-pairs. Another portion of the air coming from 105 will not impinge on the pedestal 126 and it will flow between the inner magnetic stator array's magnets 121 and their air gaps. Annular guide walls 151 and 152 can be provided to keep the cooling flow entrained among the stators and rotors, such that a cooling flow is available for the later rotors 128 and 129. The cooling diagonal fan has before it a small, sharp cone tip 144 to help form its inlet to improve efficiency and aerodynamic effects.

The Applicant has designed the 1^{st} and 2^{nd} impeller modules so that they do not require lubrication (this claim is effectuated by magnetic levitation or magnetic bearings) and they require minimal cooling. It is believed that the only parts of the aircraft that will experience internal heat issues will be the motor parts (104, 120, 121, 122, 123, and 124), and of this the only part of the aircraft that will experience extreme thermal loading will be the rotors 123, 128, 129, and 130. The Applicant is determined that all cooling must be air cooling, for reasons having to do with complexity and mass. Using the ambient air coming into the 1^{st} impeller module is the best way (the air is usually cold) and simplest (holes and gaps instead of liquids, plates, tubes, pumps) foreseen by the applicant. The coolant is on hand and available everywhere within the 1^{st} impeller module, once the cooling diagonal fan 105 has pumped it in there. As the coup de grace, the front of the rotor-cooling conduit 146 is inflected inwardly after inletting, such that air that gets entrained into it will, de facto, be centrifugally pumped through the rotor coils.

The Applicant has not replicated the features in the drawings or the description in the specification to extrapolate the parts and functionalities of the 1^{st} motor 104 to apply them to the other motors 104 behind the 1^{st} motor 104 and which all cooperate to drive the 3^{rd} diagonal fan 103 via rotors 128 and 129, using pedestal 131, and rotor 130, using pedestal 132. The 1^{st} impeller module has actually been borrowed from another patent application that the Applicant is still typing, and the complete description of all of the parts of the 1^{st} impeller module 100 will be included therein.

However, since the other motors will also need cooling of their rotor coils, and possibly their magnets too, the Applicant submits that since the motors' rotors all line up in an annular sequence, separated by structural elements (disks or spokes 141, 142, etc.) between them, the cooling air passing through the various passages of the 1^{st} motor 104 could be guided through the structural elements (disks/spokes) 141, 142 by passages that lead the cooling air from one motor to the next and so on, until it is allowed to escape to the environment or to the 1^{st} impeller module exhaust. Applicant has labeled another motor's possible cooling passage/conduit 147 to show how this would manifest itself in an exemplary embodiment. This passage/conduit could have canted leading vane edges to suck in the cooling air without external assistance. Anyway, we digress from the overall discussion.

The important feature pointed out here, which has been amply substantiated by the foregoing and succeeding paragraphs, is that the rotor coils should have means for cooling, and the preferred embodiment is that they are internally cooled using the ambient air coming into the impeller system along cooling passages or conduits between the magnets, inside the rotors, between pole pairs, etc. Other cooling schemes could be proposed, and one which comes to mind is that the fans could have bleed-off passages that lead through the pedestals and thence along and through the rotors. This would be difficult because the bleed-off flow would be working against the centrifugal force pushing it back out. Anyway, the application must not get bogged down at this point in minutia, and the best mode requirement has been met. The rotors are now capable of being cooled via the embodiment thus far proposed, and a significant hurdle has been overcome. The fact that they are cooled by modifications of elements that are already part of the impeller module's structure, requiring no extraneous devices, is something that should not be underestimated. Cooling of a fan motor that is pushing an aircraft at thousands of miles per hour could have become quite a burden. Thankfully, the impeller system as it was designed so far offered itself up for these simple modifications. Closing the discussion of FIG. 3, the inner wall of cooling diagonal fan 105 is extended forwardly to converge in a tapered cone that forms a cone 148, which has a sharp leading edge and keeps foreign objects and unwanted air from entering the core of the 1^{st} impeller module 100.

It is envisioned that the 1^{st} impeller module's intake could include stator inlet guide vanes to align or pre-swirl the intake air into a vortical airstream, and the IGV's would of course be angled and scaled to compliment the intake requirements of the 1^{st} impeller module's fans. It is also foreseen that IGV's for the 1^{st} diagonal fan could be different from those for the 2^{nd} diagonal fan. The potential IGV's have only been partially shown in the drawings because they and their usage are well known in the arts and they might not be needed. It is further foreseen that the IGV's for the 1^{st} impeller module could be angularly, adjustably vectored, or variably pitched relative to the tangential direction, in a continuous and infinite sense or step-wise via a stepper motor. A solenoid with an effector ring or cascade ring might be . . . no, let's not jumble up the specification with that type of minutia. Let's get back to business.

### 2^{nd} Impeller Module

Referring now to FIGS. 5A and 5B where again there are some reference numbers with leader-lines leading to both drawings when the elements being labeled and discussed are present in both figures. These figures depict the 2^{nd} impeller module 200 and correspond in many ways to overlapping or simultaneously occurring elements labeled in FIGS. 1A and 1B. FIG. 5A is a side view of the 2^{nd} impeller module 200 and FIG. 5B is a top view of the 2^{nd} impeller module 200. The 2^{nd} impeller module 200 comprises an upper 1^{st} centrifugal fan 200A and a lower 2^{nd} centrifugal fan 200B. The 1^{st} and 2^{nd} centrifugal fans are mirror images of each other. In FIG. 5B only the 1^{st} centrifugal fan 200A is shown, obscuring the 2^{nd} centrifugal fan 200B which is under it. Fan vanes 202 are shown for 1^{st} centrifugal fan 200A and they arc from the fan intake 201 at a clockwise entry portion, through a straightened middle portion, to a counter-clockwise exit portion (near 205). The fan vanes of the 2^{nd} centrifugal fan 200B will do the same in an exact opposite rotational direction (or mirror image geometry). Centrifugal fans are very well known in many arts, so they will not be described in excessive detail herein. The reason that the 1^{st} and 2^{nd} fans are mirror images (at least the fan vanes 202) is because they spin in opposite directions at exactly the same speed at all times. This way, neither of the fans can create Coriolis forces that aren't offset by those of the other fan.

So, in FIG. 5B, looking down at the fans, the 1^{st} centrifugal fan 200A spins counter-clockwise and the 2^{nd} centrifugal fan 200B (not shown) spins clockwise. The leading edges 203 of the fan vanes 202 curve forward to match their angle to the vector that is the velocity difference between the fan and the incoming air, in other words to scoop the air and entrain it within between adjacent fan vanes 202. Then they straighten out and head directly toward the perimeter of the fan(s). It is noted that instead of extending straight out to the edge of the fans, like normal centrifugal compressor vanes would, these fan vanes 202 curve back again toward the direction of rotation (counter-clockwise for 200A in FIG. 5B) to form flingers 205 that accelerate the air toward a tangential direction, such that the air exits the fans excessively tangentially at a velocity higher than the linear velocity of the fans' perimeters. Like any regular centrifugal compressor or fan might regularly be configured to do, the air exits the centrifugal fans 200A and 220B and enters volutes, herein called thrust volutes 250A and 250B. They are called thrust volutes because all the air that enters them ends up passing into the 2^{nd} impeller module exhaust ducts 14 and becomes the thrust of the aircraft. So the 2^{nd} impeller system's exhausts 14 are also called the thrust ducts herein.

The centrifugal fans are both driven by a shared motor 210, which will be described in greater detail later in this discussion.

Now that we have discussed the 2^{nd} impeller module using the top view 5B, which allowed us to envision the fan vanes and what they do to the air, we'll switch over to FIG. 5A for a step-by-step description of how the air is worked on. The air arrives from the 1^{st} impeller module via the (from FIG. 1A) longitudinal duct 8, the arc duct 11, and the 2^{nd} impeller module intake duct 12. When it arrives at the end of the intake duct 12, the air on the outer perimeter of the intake duct 12 encounters the 1^{st} fan intake 201A of the 1^{st} centrifugal fan 200A, whence it is ingested by the fan vanes' leading edges (203), accelerated outwardly by the fan vanes 202, and then redirected to flow in a tangentially forward direction (relative to the rotational direction) by the flingers 205. The air in the inner area of the intake duct 12 passes through an aperture in the 1^{st} centrifugal fan intake 201 and encounters a duct cone 209 that spreads the air outwardly such that it is led to the fan intake of the 2^{nd} centrifugal fan 200B. Again, the 2^{nd} centrifugal fan 200B is not described in detail because it is exactly the same as the 1^{st} centrifugal fan (with mirror-image vanes), but it obviously from the drawings ingests air via its intake 201B, shown in FIG. 5A. Just like the fact that the fans must spin at exactly the same rate, the system must be proportioned such that the same amount of air flows into each centrifugal fan (this will be totally the same in quantity, but mechanically distinct in the preferred embodiment). The same amount of air that is ingested by the 1^{st} centrifugal fan intake 201A for the 1^{st} centrifugal fan 200A will be ingested by the 2^{nd} centrifugal fan intake 201B for the 2^{nd} centrifugal fan 200B.

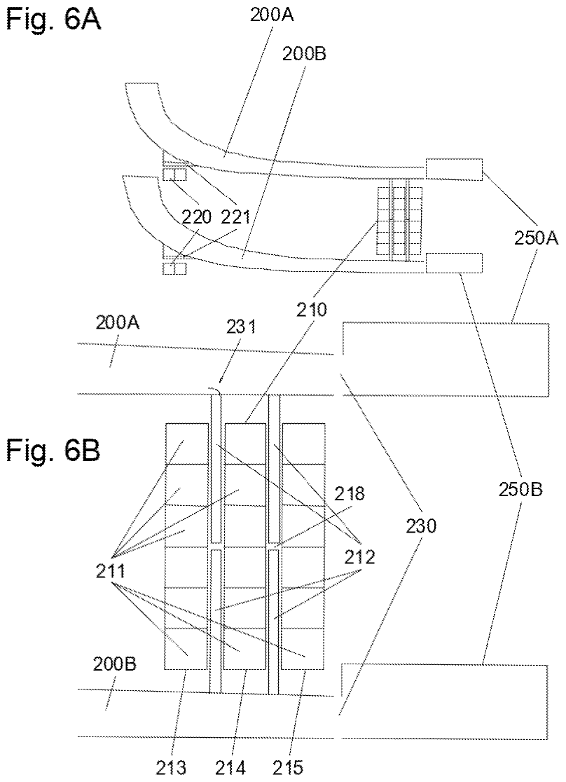

The 2^{nd} impeller module comprises thrust volutes 250A for the 1^{st} centrifugal fan and 250B for the 2^{nd} centrifugal fan and the concept we are going to use for the thrust volutes 250A and 250B is nearly identical to the one we used for the annular volutes 150 that accepted the air from the 1^{st} impeller sub-modules. The exit from each centrifugal fan will be a perimeter slit, so the inner diameter of the thrust volutes 250 have a corresponding slit, described later with reference to FIGS. 6A and 6B. As shown in FIG. 5B, although the air is exiting equally from the entire perimeter via flingers 205, we will pick a “start” point and call it a 1^{st} volute section 251. The height of the thrust volute at the 1^{st} volute section 251 is equal to the height of the perimeter of the fan, but begins to get taller as one moves counter-clockwise toward a 2^{nd} volute section 252.

As shown in FIG. 5A, the 2^{nd} volute section 252 is a little taller than the fan edge, because it has already accumulated enough air to require more cross-sectional area for the increased air flow. Likewise, as one moves further in a counter-clockwise direction, a 3^{rd} volute section 253 is even taller (evident in FIG. 5A, which is tracking the thrust volutes 250 in parallel with FIG. 5B). Likewise again, at the 4^{th} volute section 254 the thrust volute 250 is much taller than the fan edge, and this continues (the taper) until at the thrust volute branch 260A the thrust volute is as tall as the 2^{nd} impeller module exhaust duct 14 as the thrust volute 250 branches off at the thrust volute branch 260A. To depict this in FIG. 5A, the Applicant has shown the last segment of the thrust volute leading up to the branch by using the 2^{nd} thrust volute 250B (of the 2^{nd} centrifugal fan) and how it continues to taper right up to the 2^{nd} thrust volute's branch 260B. The thrust volute branches 260A and 260B represent the outlets of the 2^{nd} impeller module, and there is one on each side, such that the counter-rotating 1^{st} and 2^{nd} centrifugal fans eject equal portions of air at extremely high velocity (keeping in mind that the air entered the 2^{nd} impeller module at an already high velocity due to the 1^{st} impeller module) from both sides of the aircraft. From the branches 260A and 260B the air traverses the 2^{nd} impeller module exhaust (thrust) ducts 14 to the outlets 15 (referring to FIGS. 1A and 1B).

It is envisioned in a presently unfavored embodiment that the 2^{nd} impeller module's intake 12 could include stator inlet guide vanes (IGVs) to align or pre-swirl the intake air into a vortical air stream, and the IGVs would of course be angled and scaled to compliment the respective intake requirements of the centrifugal fans 200A and 200B. It is also foreseen that the IGV's for the 1^{st} centrifugal fan 200A will be oppositely vectored from those from the 2^{nd} centrifugal fan 200B, meaning they will twist the air in opposite directions by being axial mirror reflections of each other in their cross-sectional geometries. Meaning, whatever direction the IGV's of the 1^{st} centrifugal fan vortex the air in, the IGV's of the 2^{nd} centrifugal fan vortexes it in the opposite direction. Because the fans are spinning in opposite directions anyway. The IGV's have not been shown in the drawings because they and their usage are well know in the arts.

The last paragraph, the insinuation of IGVs to pre-swirl the air coming into the 2^{nd} impeller module through the 2^{nd} impeller module intake 12, is an admission that there is a problem with the arc duct 11 and intake 12 as shown in FIGS. 1A and 5A. We did use the swirler 90 to pre-swirl the air in the impeller system intake 3 before it arrives at the 1^{st} impeller module 100, and we had reasons for doing this. Firstly, it alleviates the load that needs to be borne by the thrust bearings. Secondly, it converts longitudinal flow to tangential flow, thereby allowing the fans to spin at higher velocities and thus produce a higher net thrust for the aircraft. But most importantly, it creates a buffer for the collision between fan vane leading edges and the air itself. Looking at FIGS. 1A and 5A, there is no reason to believe that the high inlet velocity of the air coming axially into the centrifugal fans 200A, 200B is in any commendable way helping the centrifugal fans work on the air, other than by priming the latter with a constant source of high-speed flow. From the point of view of the fan vanes 202 and the work they must do to convert the axial (vertically downward) flow into tangential velocity/flow, they are starting with a zero tangential velocity (or more with IGVs). This is actually an important detriment to performance and it must be addressed before moving forward.

As mentioned above, to solve the problem of the last paragraph, IGVs or some type of swirler would perform reasonably well, but not only does this cause the air to go through many changes of direction as it exits the longitudinal duct and finds its way to the leading edges of the centrifugal fan vanes 202, but this system would be slightly difficult to implement because the air would have to be swirled in dual opposite rotational directions without interfering with the intake flow (and hardware), since the centrifugal fans are spinning in opposite rotational directions. Further, just looking at it, reference numbers 11 and 12 obviously stick out into the surrounding volume and thus place restrictions on how the aircraft's overall form can be designed. Meaning, in some instances but not all the aircraft would have to stick out or bulge or in some other way accommodate 11 and 12 and we certainly would like to remove this restriction/accommodation if possible.

It has become increasing clear during the latter-most discussions of FIGS. 1A and 5A that there should be some attempt made to obviate all these problems if doing so can be performed with a single variant. The Applicant has decided to modify the 2^{nd} impeller module intake 12 and parts of the 2^{nd} impeller module itself, to short circuit the problems entirely and not even have to think about them anymore. To accomplish the short circuit, Applicant has re-drawn FIG. 5A as 5C, and then once more as 5D, these two (5C and 5D) being alternative embodiments of each other and of FIG. 5A. Additionally, FIG. 5B has been re-drawn as FIG. 5E which is an alternative embodiment of FIG. 5B that can be used in conjunction with the different views above it (FIGS. 5C and 5D) but cannot be used in conjunction with FIG. 5A. So, without further ado, let us proceed to the discussion of the first embodiment of the new 2^{nd} impeller module inlet and reception system (11A, 11B, 12A, and 12B) that, as advertised, suffers none of the detriments described above.

Turning to FIG. 5C, the air, as in FIGS. 1A and 5A, is moving from left to right. It has already traversed the longitudinal duct 8 and entered the arc duct 11. As shown in FIG. 5C, as the duct arcs up it is simultaneously split into two equal portions 11A and 11B and these portions as parallel flows travel obliquely upward and then flatten out as the passages transition to parallel but oppositely configured 2^{nd} impeller module intakes 12A and 12B. As seen in the viewing direction (into the page) of FIG. 5C, the upper 2nd impeller module intake 12A, which is associated with 1^{st} centrifugal fan 200A, has its back to us as the passage conducts the air through an intake scroll 49 (see FIG. 5E) which squeezes it inward and whence it begins to spiral down into the 1^{st} fan intake 201A. Now referring to lower 2^{nd} impeller module intake 12B (back up to FIG. 5C), which is a mirror image of upper 2^{nd} impeller module intake 12A but is associated with 2^{nd} centrifugal fan 200B. To nudge the air downwardly, as well as to make sure the air already inside the 1^{st} fan intake 201 does not interfere with fresh air entering from the 2^{nd} impeller module intake 12A, while the air is being squeezed inward by the intake scroll 49 it is also acted upon by the roofs of the 2^{nd} impeller module intakes 12A and 12B by a sloped annular inlet volute 45.

In other words, as the 2^{nd} impeller module intakes 12A and 12B wrap around the annular areas above the 1^{st} and 2^{nd} fan intakes 201A and (not visible) 201B, the outer wall and the upper wall of each one gradually push the air inward and downward. By the time the inlet scroll 49 and sloped annular inlet volute 45 get back around to the inlet where the air is entering, they have converged with the main walls of the system, thereby ceasing to continue further, and the air has been sent into a downward spiral/swirl to enter the fan intakes 201 with the same swirl direction as the respective centrifugal fan's spin direction. It should be obvious, but we will once more mention that the 1^{st} centrifugal fan intake 201A is visible in FIG. 5E but 2^{nd} centrifugal fan intake 201B is not because we are looking at it from above, and the sloped annular inlet volute 45 is visible only for the lower 2^{nd} impeller module intake in FIG. 5C because we are looking at it from the left-hand side. Everything on the top (A) side of the 2^{nd} impeller module is an exact mirror image of everything on the bottom (B) side. The reader is encouraged to look back and forth between FIGS. 5C and 5E to get a complete idea of all that is going on in these embodiments.

The problems associated with the original embodiment of the 2^{nd} impeller module intake, specifically the embodiment that feeds the 1^{st} impeller module exhaust downward into the intakes 201 from above in such a way that it has a vapid extant useful velocity, meaning a tangential velocity that once the air has moved outward from the intakes a bit the only reason the air has reached a moderate tangential velocity is because it has been propelled by inward-reaching leading edges of the fans 202. In other words, even though the 1^{st} impeller module exhaust came in with a high speed, it still needed to be twisted by the leading edges of the 2^{nd} impeller module's vanes to get it up to an intermediate tangential velocity, and thus work was being wasted, because in the new embodiment, that of FIGS. 5C-5E, we deliver the air to an intermediate radial swath of the centrifugal fans 200A, 200B such that the extant velocity of the air derived from its being accelerated to high velocity by the 1^{st} impeller module is not wasted. The air in the is spinning in the intakes 201 de facto, simply by the existence of the prescribed intakes in combination with their interface/abutment with the top of the centrifugal fans 200A, 200B. So, when the air in the intakes 201 has migrated outward by centrifugal force (caused by its own swirling and not by the vanes because it hasn't reached them yet) it is scooped up by the leading edges 88 of the vanes 202 (referring to FIG. 5E). Only one leading edge 88 has been labeled in FIG. 5E because the others are obscured by the intake scroll 49 because the latter is on top of the former.

As described in the previous paragraph, and still dealing with the A-side (all elements associated with the 1^{st} centrifugal fan 200A) and leaving undescribed the elements of the B-side (all elements associated with the 2^{nd} centrifugal fan 200B) because they are mirror images of and counter-rotating to each other, the air enters the the 1^{st} centrifugal fan 200A by moving downward from the upper 2^{nd} impeller module intake 12A and into the 1^{st} fan intake 201A. While it does this, it is spinning in a counterclockwise manner with a velocity that should several hundred mph higher than the 1^{st} impeller module exhaust velocity, which has already been described as very high for the reasons put forth during the discussion of the 1^{st} impeller module. Once it has moved down to the level of the 1^{st} centrifugal fan 200A it will of its own accord and inertia eject itself radially outwardly into the spaces between the fan vanes 202, at which point the fan leading edges 88 slice into it and this allows it to get swept up at an even higher velocity by the vanes 202, which bend the air's trajectory (in the relative frame of the fan and not the aircraft) in an arcuate path such that it straightens out into a radial path and then is guided gradually into a more tangential trajectory such that it enters the thrust duct 250A. Much of this has already been described with reference to FIG. 5A, so the discussion has not been fully fleshed out. If there is confusion, Applicant advises the reader to first figure out FIGS. 5A-5B and then come back to this second embodiment.

The thrust duct 250A corrals all the air from the 1^{st} centrifugal fan 200A and a branch is provided on the left-hand side of the aircraft to allow it to enter the thrust duct 14A which is open at its opposite end to indicate that this is where the air is allowed to escape at extremely high velocity to the atmosphere to provide the thrust for the aircraft. Going back to the fan vanes 202, the Applicant has added features that will be called interstitial vanes of an interstitial vane set 86. The leading edges of each interstitial vane is a little closer to the vane behind it than to that before it, but the trailing (outer) edge is equidistant between the trailing edges of its adjacent vanes, and this has the effect of spreading out or leavening the air leaving the fan 200A, such that the air's distribution within the thrust volute 250A is more even and this should preclude or eliminate any pulsations, waves, or unwanted fluctuations in the flow of the air. If the interstitial vane set 86 is not sufficient to assure an even flow profile for the air, a secondary interstitial vane set 87 can be further added. Applicant has not shown the interstitial vane set 87 as being implemented for the entire perimeter of the fan in FIG. 5E because he didn't want to clutter up the drawing and anyone of ordinary skill in the art can visualize what it would look like if he had drawn it that other way.

The Applicant will not much discuss the interstitial vane sets because they are common in many types of fans and compressors and known to those of advanced skill in those arts As the main vanes of any outwardly expanding compressor or fan get further from their center, the more space is available between adjacent vanes for the air to obey its own inertia or the pressure gradients it is experiencing and it stops conforming to the shape of the passage that is trying to manipulate it. So, by simply adding interstitial vanes (86, 87) in certain places, we can get tighter hold of the air and better manipulate it where it is, instead of waiting for it to exit the fan with an unequal mass distribution. Of course it will in any situation find equilibrium within the thrust volute 250A, but at the velocity we're dealing with here (thousands of mph), it probably won't do so quickly enough and this would probably lead to a pulsed output from the thrust duct 14A to the environment, which is unwanted. We must mention, however it might be obvious to someone of advanced skill in the art, that the diagonal fans 101 and 102 of the 1^{st} impeller module could, and maybe should, be provided with interstitial vanes as has been done in FIG. 5E. Both thrust ducts 14A and 14B have been shown in FIG. 5C and it is clear how they both move as quickly as possible to get down by the floor of the aircraft so they can be ejected from the same level, preferably, as mentioned, near the floor or bottom surface of that part of the aircraft. In FIG. 5C the thrust duct 14A doesn't have to actually bend much more than the thrust duct 14B, but in FIG. 5D it will more, although this is not shown.

The Applicant's latest and more perfected modification of the 2^{nd} impeller module intake(s) 12 has created a new problem. It was very convenient in the 1^{st} embodiment of FIG. 5A to open a flap above the 2^{nd} impeller module (shown in other drawings for VTOL reasons) such that it would suck in air from above the 2^{nd} impeller module, instead of getting air from the arc duct 11. Although this previously described embodiment or latterly described (below) embodiment may not be the best approach in the end, it is the best one the Applicant can patch together at the time of filing so, quickly, in this provisional embodiment each arc duct 11 is provided with a side intake duct 47A or 47B. The upper arc duct 11A is provided (back to FIG. 5E and none of this is shown in FIGS. 5C-5D although it could be) with a left-hand side intake duct 47A and the lower arc duct 11B is provided with a right-hand side intake duct 47B.

An arc duct sidewall 48A defines the inboard side wall of the arc duct 11A but can be pivoted inward in the direction of arrow 50 to close off the arc duct 11A such that the intake air for the 1^{st} centrifugal fan 200A is drawn instead through the left-hand side intake duct 47A, which is angled away from the longitudinal axis of the arc duct 11A and toward the left-hand side of the aircraft (and a little downward since the arc duct 11A is slanted upward at the point where they meet). The left-hand side intake duct 47A then curves outward, twists upward and meets the top wall of the aircraft 1 at side intake duct top inlet 46, where it creates, when a respective closure has been pivoted/slid out of the way, an upward-facing 2^{nd} impeller module intake 46 that draws air vertically downward into the system. The relationship of the right-hand side intake duct 47B and its accoutrements and its combination with the lower 2^{nd} impeller module intake 12B and the 2^{nd} centrifugal fan 200B can be, like everything else with FIGS. 5A-5E, envisioned by just creating a not-shown mirror image of everything described in this paragraph. In this way each centrifugal fan can draw air from the respective side of the aircraft that corresponds to the direction the aircraft needs its intake air to be coming in from. Of course the sides could be reversed such that the left-hand side intake duct 47A feeds the 2^{nd} centrifugal fan 200B, and in the event that this is more advantageous it should be employed that way. The Applicant chose the current configuration because doing so seemed to make the arc pivoting sidewalls 48 work out better without deforming the arc ducts too much.

Speaking a little further about the problems that are created by switching from a vertical linear 2^{nd} impeller module intake system 12 (FIGS. 5A-5B) to a tangential/volute-based 2^{nd} impeller module intake system (FIGS. 5C, 5D, and 5E), as will be discussed during the discussion of the 2^{nd} impeller module using FIGS. 6A and 6B, we wish to use a “shared motor” 210 such that the rotor coils 212 of the centrifugal fans 200A, 200B “share” individual and modular stacks 213, 214, 215 of magnets to improve the Halbach effects (the more magnets that are stacked serially in a Halbach array, the more effective the array is). Well, the embodiment shown in FIG. 5C precludes this possibly to its disadvantage. The arc duct 11B cuts straight through a place where the rotors 212 need to be spinning. Even if we create a gap in the magnet stacks to allow it through, there does not come to the Applicant's mind any way out of this problem, except to just invent one more embodiment and the one that seems to work best has been drawn and labeled as FIG. 5D. Everything from 5C has been kept in FIG. 5D except the 2^{nd} centrifugal fan has been flipped upside-down such that its lower 2^{nd} impeller module intake 12B is now under it (and flipped over as well). The Applicant has explicitly added the shared motors 210 here to show how they fit nicely now without any obstacle. Of course this changes the thrust bearings for the 2^{nd} centrifugal fan 200B but we can't go into that here. The Applicant has moved the thrust volutes closer together so this changes where the slit 230 will be on them but that is unimportant.

FIG. 5D, although the preferred embodiment, has not been marked up very much with labels. The Applicant would like that it be kept with the current clean appearance and any understanding of it that does not come intuitively to the reader will have to be arrived at by first learning how fig. C works. The sloped annular intake volute 45 has been labeled just because it needs to be noted in passing that it is now the bottom wall of the 2^{nd} intake 12B. However, most everything in FIG. 5D is left unchanged from FIG. 5C with the exception that now the arc duct 11B no longer interferes or shares space with the shared motor 210. It should also be mentioned that nothing has changed, relative to FIG. 5C, to how FIG. 5D corresponds to FIG. 5E. In fact, by not including the thrust ducts 14A and 14B in FIG. 5D or 5E we can blow them up to a reasonable size such that the proportions (radii, lengths) match up with each others', and each item is directly below or above itself as a reader glances back and forth (up and down) between the two complementary figures.

Although it has not been considered so far in this application, that it was going to be difficult to install the thrust bearings in a sturdy manner using the embodiment of FIG. 5A, the embodiment of FIG. 5D has an enormous advantage over that of FIG. 5A because now the shared motors 210 and thrust bearings 220, 221 can be affixed to the frame or other stationary (non-rotating) elements by rigidly attaching them to a mounting bracket extending between the 2^{nd} impeller module intakes 12A and 12B, said bracket further having the advantage of uniting in a mechanically sound way the intakes 12A and 12B themselves. At least one of the latter will be affixed to the aircraft's frame by whatever means is most appropriate.

FIG. 5F illustrates a nice compact example of how the embodiment of FIG. 5D would be used in a wing or other wide or elongated aircraft component (nacelle, etc.) wherein the passengers are not a consideration and we can place the 2^{nd} impeller module directly behind the 1^{st} impeller module, but in a manner where the overall path of the air is never kinked or overly bent from when it enters the aircraft/wing/nacelle to the moment where it exits. The details of FIG. 5F will be omitted (not labeled) because everything needed to understand this figure/embodiment has already been described with respect to FIGS. 1A-1B, 5A-5B, 5C, 5D, and 5E.

FIG. 6A is a partial cross-sectional view of the 2^{nd} impeller module 200 showing only the rear halves of the centrifugal fans 200A, 200B, and thrust volutes 250A (upper) and 250B (lower). FIG. 6A is a transition to FIG. 6B, which is a close-up of the shared motor 210 and the area where the centrifugal fans 200A, 200B meet the thrust volutes 250.

Shown in FIG. 6A is, among other items, a means for frictionlessly supporting the fans vertically. Specifically, this means comprises a magnetic thrust bearing comprising electrical coils 221 and magnets 220. The coils 221 are rigidly attached to the undersides of the centrifugal fans, and the magnets 220 are rigidly attached to a support element that is part of or rigidly supported by the airframe. So, the coils 221 spin with the centrifugal fans 200A and 200B, the magnets 220 are stationary, and the coils 221, along with the centrifugal fans 200A, 200B, revolve about a vertical axis above the respective magnets 220. Usually in thrust bearings of this type the magnets are in the fan/compressor and the coils are stationary and attached to the static parts of the machine, but in the present invention the fans are already electrified, because like the 1^{st} impeller module, for the 2^{nd} impeller module we are driving the fans with electrified coils that spin between rows/banks of magnets. So, the electricity used for the coils of the rotors (212, discussed later) is also used for the thrust bearing (220, 221), and the electricity is conducted amongst the various elements of the centrifugal fans for use all over the place therewithin where it is needed, while all magnets are parts of stationary/fixed elements. As the fans spin, the coils 221 are alternately cycled with electrical current (i.e. via a brush and a commutator or in a brushless manner) and this levitates them via the flux from the magnets 220 below them. This practice is well known among electrical and mechanical engineers and will not be discussed further herein, the only change over the prior art is that for this and for the shared (drive) motors 210 we keep all of the magnets on the stator elements. Putting magnets on any part of any of the fans would greatly increase the radially-outwardly-disposed mass of the fans and the Coriolis forces would be difficult to control, even though the fans are spinning in opposite directions in some embodiments. So, we have now levitated the centrifugal fans 200A, 200B such that they do not touch anything. At the speeds we wish to spin the fans, this is necessary. Mechanical (i.e. roller) bearings just won't serve. Also, using electromagnetic thrust bearings allows us to abide by our goal of not using lubrication or cooling anywhere in the overall system. The coils 221 of the electromagnetic thrust bearings can be cooled in a similar way we are going to cool the coils of the 1^{st} impeller module 100 and (see discussion of ref. #231 in FIG. 6B) the coils of the stators 212 in the 2^{nd} impeller module, so we won't discuss that here.

To fully discuss the shared motors 210, we have enlarged the relevant area in FIG. 6B. Each shared motor 210 comprises rotors 212 rigidly affixed to the centrifugal fans 200A, 200B. Two concentric annular rotors 212 are rigidly fixed to the bottom surface of the upper 1^{st} centrifugal fan 200A and protrude downwardly, while two identical concentric annular rotors 212 are rigidly fixed to the upper surface of the lower 2^{nd} centrifugal fan 200B. The upper rotors extend toward the lower rotors leaving a small gap 218 which is needed so that a support structure (not shown) can reach inward, between the rotors from outside the 2^{nd} impeller module, to support all of the magnets 211 and 220 and not just those on the outside. Because of the extreme motive force metrics required of the system the Applicant has undertaken to make the system as powerful as possible while being light-weight and compact, and this is the only way he has figured out to support all these magnets without interfering with the fans in the current embodiment. But it will work. The better we want the system to perform, the smaller the gap 218 should be. The rotors 212 have coils in them (not shown) that are electrified in the same way as those of the 1st impeller module (a brushed system with a commutator, a brushless DC or AC system, a synchronous motor system, etc.). The coil pairs in this case would extend vertically up-to-down in FIG. 6B.

The applicant has labeled the motors 210 “shared motors” because the rotors of the respective centrifugal fans share the same magnets 211. Three rows of magnets 211 are provided. A first row 213 is a Halbach array that is focused radially outward (Halbach flux focusing was discussed earlier in the specification so it will not be discussed again) on the two rotors 212 that immediately surround it (meaning toward the right in FIG. 6B), while a third row 215 of magnets is also a Halbach array that is focused radially inward on the two rotors 212 that it immediately surrounds (meaning toward the left in FIG. 6B). The magnetic flux shields and support structures have not been shown in order to expedite the explanation, since flux shields and their support structures have already been described with reference to the 1^{st} impeller module 100. A second row 214 of magnets is not a Halbach array. Each magnet in the second row 214 has its poles radially aligned (to the left and right in FIG. 6B), such that magnetic flux from the magnets' north sides/ends (all of the magnets in a linear or axial or axial array will have the same polarity, either north-out or south-out, while all of the magnets in the next linear array will be the opposite polarity) will flood the rotor on its north side with north flux while the magnetic flux on the magnets' south sides/ends will flood the rotor on its south (other) side with south flux, and vice versa for every successive linear axial array. The use of three rows of magnets, with the outer and inner being Halbach, while the middle magnet row 214 fluxes freely into all the rotors where they come into close proximity to it, creates two annular lanes for the rotors to ride in, and the magnets' location and orientation will be designed such that every electron that moves up or down due to applied oscillating voltage will be resisted by as much magnetic flux as possible in the smallest gap possible. The application cannot stop now to describe all the reasons this configuration was chosen, but it is the most powerful embodiment, per amount of required mass, that the applicant could think of by the time of filing, and so it has been offered up as the best mode. Neodymium magnets are very heavy, so we need to get every bit of flux out of them that we can, and leverage it on the coils using the smallest space we can.

Because the specification spent significant time talking about cooling the coils of the 1^{st} impeller module 100, it is easy to just say now that cooling of the 2^{nd} impeller module 200 is similar. But since it works out that it's even easier to cool the coils in the rotors 212, and since it is probably extremely important to cool these coils 212, a quick discussion will be put forth. Looking closely at FIG. 6B, one can see a small cooling air scoop 231. For each winding pair of the rotors 212, there will be a cooling channel between the winding pair that is fed by a scoop 231, and the cooling channel will be made to extend all the way up or down to the level where the rotors are fused with the fans. Each cooling channel traverses its respective outer wall of the fan and be exposed to the flow within the fan. The cooling air scoops 231 will scoop the air traveling outwardly and cram it into those cooling channels, where the cooling air will slow down and be pressurized to a high pressure. This pressure can be used to force the air through the channels and into any other orifices or channels that might be required to cool other parts of the coils or the air gaps. The cooling air can exit at the other end of the rotor or wherever or however doing so seems appropriate to the manufacturer. Although only one cooling air scoop is shown in FIG. 6B for simplicity, it should be obvious that there are many of them, one for each winding pair in every rotor 212.

It was described that the perimeter of each fan is an outlet slit where the air escapes radially at high speed and into the thrust volute. In FIG. 6B, the slits 230 in the inner diameters of the thrust volutes are shown. The slits are always the same width, basically corresponding to the height of the fan outlet, as shown in FIG. 6B. The slits do not grow as the thrust volutes taper to become taller. The purpose of the slits is to let air get into the thrust volutes while disallowing that the air escape, because at every point along the slits, more air is being stuffed into the thrust volutes through the slits.

### Implementation of the Invention in the Wing or Underutilized Fuselage Space

FIG. 5F, by depicting some preferred embodiments collated into at least one preferred combination within a wing, the base of a wing, or within various wing-unassociated aircraft structures (particularly underutilized fuselage space), provides a jumping-off point for us to imagine myriad other-use implementations of the inventive gist of the application as they could be applied or retrofitted to conventional aircraft or different types of supersonic aircraft that have not yet been thus far listed or alluded to herein.

Also, FIG. 5 is a nice and aesthetically pleasing combination, but it is only one example of many potential combinations. The primary embodiment of this application, requiring VTOL capability, the extirpation of the nose cone, counter-rotating rotors, and a crucial and admittedly biased bent toward high-supersonic flight, need not be the only way to use the various mechanisms and features offered up in this patent application. The mechanisms and features can in most conceived-of situations be used a la carte, and with adequate discretion can also be manifested in ways not discussed within this application possibly to even more concomitant advantage than has been described herein. Nonetheless, the Applicant feels obligated to try to describe or at least hint at several of them, even though this application runs prolix and all of them cannot be listed, and even though the Applicant has scant assiduousness left in him to draw them and describe them, so they must be inferred from this text alone.

To begin this tangent, in the scenario wherein the rotors need not be paired in any stringent sense because the Coriolis forces of the rotors intrinsically cancel each other out (such as when two identical impeller systems are on opposite lateral sides of the aircraft, the best example being in opposite wings or attached to opposite sides of the fuselage), there cease to exist many of the limitations that have been taken for granted as by necessity imposed upon the rest of this application. We can use any module or sub-module or even every fan ad hoc as if it/they were naturally insertable to add a certain acceleration of air wherever it might be needed, and not cede much in the way of matching everything up rotationally.

For instance, in such a case the 1^{st} impeller modules need not be paired as counter-rotating sub-modules. There could simply be a single sub-module, or even a single diagonal fan, at each utilizable point. Further, each 1^{st} impeller module could have only one diagonal fan, or two (as prescribed in this application), or three or more. There could conceivably be only a single 2^{nd} impeller module centrifugal fan, and it could be larger or smaller than the 2^{nd} impeller module centrifugal fans shown herein. There could also be a succession of 2^{nd} impeller module fans feeding each other down the line, with or without the 1^{st} impeller module of however many stages of diagonal fans that would be useful for priming them. The only important thing is that the outer tangential velocity of any downstream fan stage must be considerably higher than the outer tangential velocity of any upstream stage, and this maxim holds for all possible extrapolatory derivations that can be conceived of according to the teachings provided herein, and it probably holds for those that have not yet been discussed or discovered.

So, to address the aforementioned breakdowns piecemeal, we will build up the impeller system, liberated from the Coriolis and VTOL constraints, even though each breakdown could be modified in some way to comply with VTOL restraints with a bit of inventive effort, in a progression that will start with the simplest conceptualizable embodiment.

The impeller system could comprise a single diagonal fan that feeds a single centrifugal fan. The ducting for this and all of the following conceptions/embodiments can be interpolated and/or extrapolated from, or a mixture of both interpolation and extrapolation (and an open mind) from, the figures and discussions provided herein. The impeller system could alternatively comprise a series pair of diagonal fans that feeds a single centrifugal fan. The impeller system could alternatively comprise a single diagonal fan that feeds a parallel pair of centrifugal fans. The impeller system, as in the preferred embodiment, could comprise at least one series pair of diagonal fans that feeds a parallel pair of centrifugal fans. The impeller system could comprise a pair of sub-modules, each with a single diagonal fan, that feeds a parallel pair of centrifugal fans. The impeller system could alternatively comprise more than two sub-modules, each with one diagonal fan or two diagonal fans or three diagonal fans or four diagonal fans, either in series or parallel in various ways, to feed two centrifugal fans or three centrifugal fans or four centrifugal fans, these latter centrifugal fans being arrayed in series or in parallel or both (ducted in a strategic pairing-parallel arrangement). This expanding “a-la-cart” arrangement is hyperbolic in the quantity of arrangements that can be logically deduced, now that this assertion has been put forward for consideration. Apt minds, assuming they can read this and understand this, should be able to concoct a plethora of new devices using the panoply of combinations that are possible now that the present invention has been laid forth herein. All of the 1^{st} impeller module fans and 2^{nd} impeller module fans have been used together to achieve a singular effect, but they can be broken up and recombined in different combinations for use in many ways that the Applicant is simply, at the time of filing, unwilling to brainstorm, because this application must be filed soon and there are so many ways that the Applicant can see the elements being combined to advantage for the industry, the ones he conceives of might be the least useful, and the ones that the industry invents to maximize these elements could easily be the ones he would overlook.

It is also conceivable that the 1^{st} impeller module 100 could be a centrifugal fan or fan pair, such as by using something similar to the fan(s) shown in FIG. 5E, wherein such a centrifugal 1^{st} impeller module would feed a 2^{nd} impeller module functionally similar to the 1^{st} impeller module but wherein the intakes and heights of the 1^{st} impeller module's centrifugal fans were much larger than as shown, the important aspect being that the 2^{nd} impeller module would spin at a rotational rate much higher than the rotational rate of the 1^{st} impeller module.

The results of the many combinations listed in the last two paragraphs, bereft of the harsh demands imposed by VTOL, nose-obviating, and high-supersonic requirements, are very appealing for using the various pieces of the invention to accomplish multitudinous effects/achievements. By looking at FIG. 5F, we can also see that we are not limited by geometry itself. For instance, regardless of how many stages are desirable for the 1^{st} and 2^{nd} impeller modules, we can probably get rid of the arc duct(s) 11, 11A, 11B, by branching off the annular volute (exhaust) flows from the 1^{st} impeller module(s) in a laterally outward or inward (sideways) direction and just looping them around to the 2^{nd} impeller module intakes 12A, 12B (and scroll 49) in a single swoop. This allows us to move the 2^{nd} impeller module forward, closer to the 1^{st} impeller module, if we so wish. And we will probably so wish in the future, for various reasons not described herein.

### Problems of Flow Separation on the Back Sides of Convex Surfaces

The application has at this point described several physical mechanisms that bend air that is traveling at supersonic velocities (supersonic at one point or another) from one trajectory to another within a short distance, including the swirler vanes 95, the elbow duct 7, the 1^{st} and 2^{nd} diagonal fans' vanes, the centrifugal fan vanes 202, etc. Considering the extreme magnitudes of the air flow velocities within these elements, there are bound to be flow-separation problems on the back (convex) sides of some or at least one of these elements. These could prove in the long run to be detrimental, and some measures must be proposed at this point in the application to mitigate them. It is therefore proposed herein, however challenging it might seem to the most astute and experienced engineers that might be chuckling at Applicant's seeming blind spots on this matter, that there are in fact dozens of options extant in the patent prior-art. Centrifugal compressors, diagonal compressors, and other systems have indeed been proven to work within industrial pursuits wherein their outlet/tangential air velocities are supersonic, so this is no stretch of the imagination. Prior-art mitigations to such eventual problems are probably abundant in the patent literature (any respectable patent searcher should be able to find them, if commissioned to do so). But without the Applicant having the time or resources to research them, rate them, and apply them to the present invention in an advantageous way, he must simply imagine a few and call them the best mode, in order to expedite the prosecution, because this application is already lengthy and this application needs to be filed soon.

Firstly, ridges or ramps could be provided on the back (convex) sides of the elements where the air is being bent. Extra interstitial vanes, of whatever shape is necessary, could be added to blend the axial or radial flow of the air, to maintain the overall flow profile in a state where the flow separation is forcibly precluded. The swirler or 1^{st} impeller module vanes or 2^{nd} impeller module vanes could be broken down into cascading modules, tangentially and sequentially shifted such that some portion of air in an intermediate stage of the module is allowed to leak or bleed from a preceding passage into a successive passage. Elongated slits could be etched into the vanes. The list goes on. What the task ultimately requires is that the flow separation problems occasioned by the convex surfaces and high air velocities, even though it might be daunting from the point of view of an expert in these arts as s/he reviews the present application, must be perceived as a problem that will eventually be solved. The prototype might have to be built to travel with airspeeds and impeller module rotational rates that are handicapped (low enough) to preclude flow separation, particularly on the back sides of the swirler and impeller vanes. But if these problems are severe enough to temporarily impede the instant endeavor, the payoff to solving them is enormous.

### Using the Proposed Impeller System in Prior-Art Aircraft

As for retrofitting the inventive concept(s) into a prior-art aircraft or into a quasi-prior-art compromise between the main embodiments proposed herein and existing modes of air travel, it will be observed that there are at least five locations for doing so (in-wings, above-cabin, below-cabin, externally, and behind-cabin), and the locations can be used together or selectively. The primary candidate location (although this should not be seen as limiting) is within the wings, and FIG. 5F shows the preferred embodiment that could be used within such a wing. In this case, the intake air could intake from an intake space in front of the wing, or alternatively from a duct leading by whatever means from the nose of the aircraft, in which case the drag of the aircraft would be reduced for having a smaller effective displacement since the nose would comprise an air ingestion area and not be entirely consumed by its nose cone. Such a duct could be passed under and/or on the outboard sides of the cockpit. It could also come from another part of the wing or from under the wing or from above it. The system shown in FIG. 5F is such a work of art that it is impossible to find aerial scenarios that it would not be useful for, but this last statement is imbued with consequent and illimitable variations that are unforeseen by the Applicant at the time of filing but which should be pursued to the ends of the earth, because FIG. 5F conveys at first sight the promise of being the kernel of some wildly fecund proto-endeavor, if the reader, like the Applicant, understands all the things that have been proposed herein so far.

The typical jumbo-jet fuselage has a cylindrical shape, but when we walk through it as passengers the floor and ceiling we see and feel are mostly horizontal. This is only because a sizable portion of the fuselage has been—it would be nice to say reapportioned, but is really better described as—sacrificed, to the engineering dogmas that keep fuselages tubular, in course obeying many of the tenets of engineering and in large aircraft designs these tenets cannot be avoided within the prevailing paradigm. To the passenger on an airplane, the space above and below oneself can be written off as unimportant, but it is really quite voluminous and ripe for insertion thereinto of some of the stuff we've been working on.

So, in reference to FIG. 5F. the Applicant proposes stuffing the inventive impeller system, or any version of it, into any or all beneficial locations of a large aircraft, in any way that creates the power needed to achieve the designs of this application or any analogous system.

As concerns a wide-bodied aircraft (jumbo jet), the impeller system could be in the upper longitudinal hollow volume that exists above the cabin, or it could be in the lower longitudinal hollow volume that exists below the cabin, or it could be in both. It could be of the type described in this application, or it could be a permutation of that or another type, such as it could incorporate two or more series centrifugal fans for each 2^{nd} impeller module in its rear, where there is vast underutilized volume, such that the thrust velocity of the ejected air would be enormous.

To make the system more amenable to being placed in tight spots, the annular volutes 150 could have their off-branches (or if there is only one sub-stage, its off-branch) stick out to the side, bow around along a lateral (horizontally constant) arc, and come straight back in to enter the 2^{nd} impeller module intake 12.

### Vertical Takeoff and Landing

Respecting FIGS. 7A and 7B, the discussion will now deal with vertical takeoff and landing (VTOL). We begin with the 1^{st} impeller module 100 at the front of the aircraft and the 2^{nd} impeller module 200 at the rear of the aircraft, each accelerating an entrained airstream to high velocities while continuously reducing the cross-sectional area of the airstreams' entrainment passage (fans/ducts). We will no longer simply take in air from the front of the aircraft and eject it from the rear of the aircraft. We will now borrow the same system that does so and use it to selectively and on-demand intake air from the top of the aircraft while ejecting it downwardly, to achieve vertical thrust for vertical landing especially, but also to achieve vertical takeoff. And we will do it without materially increasing the mass and complexity of the aircraft.

Turning to FIG. 7A, when it is decided to implement vertical takeoff or landing, the roof 301 of the impeller system intake 3 (FIGS. 7A-7E should be read in conjunction with FIGS. 1A-1B) pivots down to close off the horizontal front intake 3 and as a result the 1^{st} impeller module 100 intakes air from above the front of the aircraft, shown by first arrow 341. Simultaneously a rear flap 303 of the intake duct 12 flares (pivots) up through the roof of the airframe 1 (the airframe being modified to accommodate this) to create an intake above the 2^{nd} impeller module 200, such that the 2^{nd} impeller module 200 intakes air from above the rear of the aircraft, shown by second arrow 342. Simultaneously still, the floor 302 of the elbow duct pivots clockwise around a lower hinge (not shown) to resemble the curved line 302 shown in FIG. 7A. This allows the exhaust from the 1^{st} impeller module to be ejected straight downwardly (vertically toward the earth), as shown by third arrow 343, which will also be called the fore downward exhaust (fore vector) 343.

At the same time as all the preceding actions of the last paragraph, two bilaterally opposed VTOL valves 310 are pushed down by actuators (not shown) into the position shown in FIGS. 7A and 7D. The VTOL valves 310 deflect the 2^{nd} impeller module exhaust in each of the thrust ducts 14, such that the upper passage 311 conducts horizontally passing air coming from an upstream thrust duct portion 14A and curves it to aim it at the earth, as shown by fourth arrow rear vector 344, which will also be called the rear downward exhaust 344. In the un-actuated position for the VTOL valves 310, shown in FIG. 7C, the lower passage 312 normally conducts the air coming from the upstream thrust duct portion 14A and passes it directly to the downstream thrust duct portion 14B, as shown by a fifth arrow 345, whence it passes rearwardly out the downstream thrust duct portion 14B and out of the aircraft, to normally create the thrust of the aircraft. Shown at 7D is a 7^{th} stage representing full-down flow form the VTOL valves when the upper passage outlet flap 315 and the lower passage outlet flap 316 are completely open. In this case, all air entering the VTOL valves is being ejected directly downward. As shown at 347, a completely open ending to the curved upper passage results in a full down-flow of all of the outlet of the 2^{nd} impeller module exhaust.

As should be self-evident from the drawings, the flipped-down roof 301 of FIG. 7A closes off the forward intake 3 and creates an upper ingress window/intake for drawing air 341 into the 1^{st} impeller module 100, and by doing so it creates a reduced-pressure window (via the suction of the 1^{st} impeller module) that will pull the front of the aircraft upward. Likewise for the air (second arrow) 342, when the rear flap 303 is pushed all the way up and back, a reduced-pressure window will be effected (via the suction of the 2^{nd} impeller module) that will pull the rear of the aircraft upward (the explanation for this has not be gone into here—of course there is no “pulling” but this is a good way to visualize these features). However, it does require some understanding of the 1^{st} impeller module 100 and its workings (especially FIGS. 2, 3, and 4B) to understand why the pivoted-up floor 302 of the elbow duct 7, shown in FIG. 7A, is so important. If the Examiner/reader becomes confused during the subsequent disclosure, s/he is directed back to previous discussions of the 1^{st} impeller module and the annular volutes.

Put as succinctly as possible, the exhausts from the right front impeller sub-module 100B and the left front impeller sub-module 100A merge at the longitudinal center-line of the aircraft and, before or after the floor 302 has been pivoted upward, normally get guided by the elbow duct 7 into the longitudinal duct 8. However, when the floor 302 is pivoted upward, it no longer bends the air rearwardly toward the longitudinal duct 8, but instead allows it to pass straight downwardly (vertically toward the earth) and also relieves it from curving rearwardly, such that the front downward exhaust 343 passes out a closeable hole (not shown) in the middle of the front of the aircraft, and this is how the front downward exhaust 343 is made. The rear downward exhausts 344 are best explained by FIG. 7D. In 7D the VTOL valves 310 are in the actuated (downward) position, where the upper passage 311 is accepting air from the upstream thrust duct portion 14A and aiming it downwardly toward the earth via valve outlet 344. As shown in FIGS. 7C-7E, the upper passage 311 has an upper passage inlet 311A and an upper passage outlet 311B. Similarly, the lower passage 312 has a lower passage inlet 312A. A dead space 313 exists between the upper passage and the lower passage and it should be obvious that these elements reside within and ride up and down within a box-shape housing that keeps all of them in their respective places and cooperates with the actuator (not shown).

Also shown in FIGS. 7C, 7D, and 7E are passage outlet flaps including an upper passage outlet flap 315 and a lower passage outlet flap 316. In the actuated position of FIG. 7D both the upper passage outlet flap 315 and the lower passage outlet flap 316 are pivoted downwardly such that the upper passage outlet flap 315 closes the lower passage outlet 312B, while the lower passage outlet flap 316 opens the valve outlet 344, 347. The cooperation of the outlet flaps 315, 316, as is clear from FIG. 7D, continues the upper passage 311 past the upper passage outlet 311B and past the lower passage outlet 312B, such that the exhaust from the 2^{nd} impeller module has nowhere to go but directly downward, to create the rear downward exhaust 344 (FIG. 7A). As is evident from FIG. 7D, the lower passage inlet 312A is open to the incoming air and although this serves no purpose, it also does not meaningfully decrease the performance because the aircraft will not be going fast when VTOL valve 310 is in the actuated position of FIG. 7D and FIG. 7A. This air will be coming from the upstream thrust duct portion 14A and enters the upper passage 311 via the upper passage inlet 311A.

However, in the unactuated position of the VTOL valve 310 shown in FIG. 7C, the upper passage inlet 311A is facing nothing (or a wall) and the lower passage inlet 312A is aligned with the upstream thrust duct portion 14A, such that the air being ejected from the 2^{nd} impeller module 200 continues unmolested along the lower passage 312 and along the lower passage outlet 312B, while the upper passage outlet flap 315 and the lower passage outlet flap close off the upper passage outlet 311B and the valve outlet 345, such that the air glides straight back to continue flowing through the downstream thrust duct portion 14B.

Turning now to FIG. 7B, the 2^{nd} impeller module area has associated with it a first thrust reverser system comprising a left-side thrust reverser flap 304B and a right-side thrust reverser flap 304A on the thrust volutes 250 (referring to FIGS. 5A and 5B). Each 2^{nd} impeller module's fan corresponds to one of the thrust reverser flaps, such that when the thrust reverser flaps 304A and 304B open, a portion of each fan's exhaust in the thrust volutes 250 will exit the aircraft while being guided in a forward direction by the thrust reverser flaps, which normally close off the thrust volute while being flush with the sidewalls of the aircraft, and this creates first thrust reversing flows 350A an 350B. When the first thrust reverser is activated and the thrust reverser flaps 304A and 304B begin to move outward, a proportionally larger and larger amount of air is flung off of the centrifugal fans in a mostly forward direction, creating a forward thrust that acts to decelerate the aircraft, and also to stabilize the aircraft during vertical travel when there is wind. When the thrust reverser flaps 304A and 304B pivot back to their closed position, the thrust reversing flows 350A and 350B are closed off and the air inside the 2^{nd} impeller module all gets ejected via the thrust ducts 14.

A second thrust reverser system (used either alternatively or supplementally to thrust-reverser flaps 304A and 304B) is shown in FIG. 7E and this one utilizes the lower passage outlet flap 316 and the upper passage outlet flap 315. The lower passage outlet flap is in its normal position (horizontal) to maintain the shape and length of the lower passage 312, while the upper passage outlet flap 315 is pivoted to an intermediate position such that the air arriving from the upper passage 311 is deflected in a forward direction relative to the airspeed (traveling oppositely to the intake), and it escapes the lower passage inlet 312A in a forward direction as shown by sixth arrow 346 that represents the second thrust reversing flow 346. It is noted that for all of the discussion in the last several paragraphs, for every element described in singular, for one side of the rear of the aircraft of for one centrifugal fan, there is often another identical or mirror-image element on the other side of the rear of the aircraft doing the same thing or achieving the same function or, in some instances, a counter-acting function.

One last thing before moving past FIGS. 7A-7E; as shown in FIG. 7B, the VTOL valves shown at 310 both can comprise dual, parallel sub-valves 310A (1^{st} sub-valve) and 310B (2^{nd} sub-valve; bottom-right of FIG. 7B) that are identical (or mirror image) to each other and which can be independently actuated, but which could be of unequal cross-sectional areas. The reason for this is that there will be a step during vertical takeoff where half of each thrust duct's constituent air will be ejected rearwardly for partial thrust while another half of its air will be ejected downwardly for rear downward partial thrusts on both sides of the aircraft. The split or division between the sub-valves 310A and 310B is shown by wall 330, but the split will not be a wall. It was just easier to draw it this way than to draw both sub-valves with a gap or bearing between them.

So, a summary of FIGS. 7A-7D follows. Roof 301 and floor 302, when actuated, cause air to be taken from the top of the front of the aircraft and ejected for thrust at the bottom of the front of the aircraft using the 1^{st} impeller module as the prime mover, and this elevates the front of the aircraft when these two elements are actuated. When they are not actuated, the 1^{st} impeller module ingests air from the front of the aircraft and ejects it to the longitudinal duct 8 for rearward thrust. Simultaneously, rear flap 303 and VTOL valves 310, when actuated, cause air to be taken from the top of the rear of the aircraft and ejected for thrust at the bottom of the rear of the aircraft using the 2^{nd} impeller module as the prime mover, and this elevates the rear of the aircraft when these two elements are actuated. When they are not actuated, the 2^{nd} impeller module ingests air from the longitudinal duct 8 and ejects it via the thrust ducts 14 to create longitudinal thrust to propel the aircraft forward. Thrust reverser ducts 304A and 304B and thrust reverser flaps, namely outlet flaps 315 and 316 of the VTOL valve 310, serve to controllably brake the aircraft or move it rearwardly. Each VTOL valve can comprise multiple tracks or sub-valves so that the controller can split the thrust duct stream in a quantized way when the takeoff method requires a rear downward thrust to be lower than the front downward thrust. The floor 302 of the elbow duct 7 can be modulated to various pivot angles between its unactuated and actuated positions to perform various operations between vertical flight and horizontal flight, and this will be described later.

FIGS. 8G-8J illustrate a preferred embodiment for the impeller system intake 3 and all its components in front of the 1^{st} impeller module 100. Much of FIG. 8G was discussed earlier in conjunction with FIG. 1A during a preliminary discussion of the swirler 90 as it relates directly to the discussion of the 1^{st} impeller module 100. Although much of the methodology and theory of that previous discussion will not be rehashed, the structure itself will be fully described in the subsequent passages.

Turning to FIG. 8G, as has been described elsewhere herein, the incoming air, as the aircraft moves from right to left in the figure, enters the impeller system intake 3. The air immediately enters the swirler 90. Again it needs to be repeated that there are two swirlers 90A and 90B, as shown in FIG. 1B, one in front of the corresponding left-front impeller sub-module 100A and the other to the right of it in front of the right-front impeller sub-module 100B, respectively, such that whatever is described in FIG. 8G for the left front swirler 90A and left-front impeller sub-module 100A inherently describes the other (right-hand or B) side elements with corresponding designations, except that all rotations of mechanical elements and air (swirl) are in opposite rotational directions from what is described for the A side. Obviously, this means that for the vortex chamber 94 shown in FIGS. 8G-8J, we are only describing the left-hand-side vortex (A) chamber that would be between the left-front swirler 90A and the left-front 1^{st} impeller sub-module 100A, and although we are not describing the right-hand-side vortex (B) chamber that in FIG. 8G is hidden behind the left-hand-side vortex (A) chamber, the reader should easily understand that it is identical (a mirror image, as shown in FIG. 1A, although not labeled) to the left-hand-side vortex chamber 94 discussed herein.

Still referring to FIG. 8G, the incoming air that has been captured by the impeller system intake 3 passes into the swirler 90 by first being split into sector-shaped passages 96 by swirler vane leading edges 91, and the sector-shaped passages 96, defined by pairs of adjacent swirl vanes 95, curve the air from having an axial velocity (in the relative frame of the swirler which is moving forward at the airspeed) at the swirler vane leading edges 91 so that when it reaches the swirler vane trailing edges 92, it has a mostly tangential velocity, meaning when it enters the vortex chamber 94, and while it is in the vortex chamber 94, it is swirling in a way that the average molecule therein has more tangential velocity than longitudinal velocity.

The intake air having passed the leading edges of the swirler trailing edges 92, as described before, is swirling at high velocity such that it can be picked/swept up by the 1^{st} and 2^{nd} diagonal fans of 1^{st} impeller module 100 and fed to intermediate passage 108 for delivery to the 3^{rd} diagonal fan 103 and thence into the annular volute 150.

Each swirler 90 can contain a hollow tube 99 extending longitudinally through its center. The swirler vanes 95 would perform no beneficial function on the air within the central portion of the swirler, and the vanes 95 if they extended inward to within the radius of the tube would have to be geometrically complex and they would also generate too much drag on the air, which would just make the air migrate to the outer radial zones. If we want to do this (migrate the air outwardly), we can put a conical cap (not shown) on the front of the hollow tube 99. While this would work just fine to make sure all of the incoming air is pre-swirled at supersonic airspeeds, it would constrict and add resistance to the intake air during transient operations and it would reduce the amount of air available for cooling the internal elements of the fans. So, as shown in FIG. 8G, the tube 99 has an extension that passes rearwardly to be near the intakes of the 1^{st} and 2^{nd} diagonal fans. The air exiting it is not pre-swirled and thus will not be subject to outward centrifugal forces, allowing the air from within the tube 99 to enter the 2^{nd} diagonal fan 102 and the cooling diagonal fan 105 (referring to FIG. 2A), which the swirler would otherwise prohibit. As the Applicant has tentatively here settled on a 1^{st} diagonal fan stage that comprises a 1^{st} fan 101, an inner 2^{nd} diagonal fan 102, and a cooling fan 105, the hollow tube actually starts to appear to be required. However, it is possible in alternative embodiments to use different 1^{st} diagonal fan stage strategies that are not affected by the swirler, in which case we could simply put the conical cap on the front of the swirler tube 99, and all of the air being ingested by the 1^{st} fan stage would be picked up where it is, along the outer radial annulus of the intake 4. Also, if the tube 99 is left without a cap (such that it is open-ended at its front and rear), during start-up, when the air is not needed to be pre-swirled but the air being sucked into the 1^{st} impeller module is facing detrimental resistance from the swirler vanes 95, the hollow tube 99 provides a short-circuit or bypass flow to allow unimpeded ingestion of the air into the impeller system.

Referring back to the discussion of fig. of FIG. 7A and forward to the discussion of FIGS. 9A-9D and 9I-9J, the impeller system intake 3 has, as part of the airframe 1, a pivotable roof 301 that can be comprised of two independently pivotable panels including an upper roof panel 301A and a lower roof panel 301B. FIG. 8G is a depiction of the aircraft front during normal non-VTOL operations, wherein the roof 301 is horizontal and flush with the top surface of the impeller system intake 3, such that it simply completes the shape of the intake 3. This position is a non-actuated position of the roof 301, and both upper roof panel 301A and lower roof panel 301B are stacked tightly together and do not obtrude outward into the passing air nor do they protrude inward into the intake air.

However, during VTOL, when necessary (the discussions of FIGS. 7A, 9A-9D, and 9I-9J will not be reiterated here), as shown in FIG. 8H, the upper roof panel 301A and the lower roof panel 301B can pivot along arrow 93 such that they can: A) close off completely the impeller system as per FIGS. 9A and 9I, as well as B) close off the front 2 of the aircraft while opening up the roof space to suck in air from above the aircraft 1 as per FIGS. 9B-9C, 9J, and 7A, and also C) close off the roof space and open the front 2 of the aircraft to suck in air from the front as per FIGS. 9E-9H, 8G, 8I, and 1A. It is noted in passing that FIGS. 7A-7B omit the swirler for simplification, but also to disclose the most obvious alternative embodiment of the aircraft, wherein there is no swirler 90 and there are also no intake ramps 51-54, because it is quite possible that the present invention could be made to work, with or without mechanical modifications, without swirler and without intake ramps, by simply modulating the speeds of the various fans, such that the 1^{st} and 2^{nd} diagonal fans perform the task of handling the supersonic intake while the 3^{rd} diagonal fan and the centrifugal fans transition the air from the 1^{st} and 2^{nd} diagonal fans and then accelerate it for thrust without requiring extra stuff and still not breaking any “supersonic rules”. It is also possible that in this case or the primary embodiment or in other cases that there could be variable inlet guide vanes (IGV's directly in front of the 1^{st} and 2^{nd} diagonal fans. It is also possible that these variable IGV's could be used with a swirler, particularly a swirler whose cant is less severe than those shown—for example, its output could be only half swirled (50% tangential or 45 degrees), and the IGV's could do the rest of the adjustment.

FIG. 8I deals with the possibility, not explored completely within the present application, of using the swirler 90 and vortex chamber 94 to perform a braking function. As discussed previously and will be discussed later in the present application, after the cruise portion of a typical flight, the aircraft will find itself in the unenviable scenario of having a surfeit of energy, its potential energy being maxed out by the aircraft cruising at a maximum elevation, and its kinetic energy being maxed out by traveling at maximum airspeed. The flaperons and stabilator probably cannot be used for braking yet due to shock concerns, and the impeller system intake 3 suffers myriad potential problems, such as; if we shut down the impeller system, a standing bow wave will manifest itself in front of the aircraft and this could cause intense shuddering, sonic waves, and also more drag than we want at this time (beginning descent after cruise). There is the option of running the impeller system at an idle to clear out the impeller system intake 3, but this uses energy and although it is definitely an option to be kept on hand, in case all other options fail, it won't really slow down the aircraft very much because the impeller system will be walking a fine line between trying to drag the aircraft without creating a standing bow wave and using too much energy to clear out the impeller intake system 3. Or, perhaps some of the foregoing is just fine and a standing bow wave is the optimal manner for slowing down the aircraft from this scenario. However, hoping for this to be true is not a sufficient plan because of the relatively low probability that that is feasible, we are left with few solutions at the time of filing.

The real problem is a relic of our original attempt to create the perfect aircraft, which left the aircraft with so little drag that any passive means, such as coasting the aircraft to shed velocity, will be ineffectual. For instance, in the event that seizing the 1^{st} impeller module 100 to stop up the impeller system intake 3 is damaging to the aircraft or uncomfortable for the passengers or simply insufficient (because if the air volume in front of the intake 3 creates a standing bow wave in a non-destructive way, the bow wave might conform to the incoming air by morphing itself into its own aerodynamically optimized geometry, as nature has a way of doing, in a manner that drag is drastically reduced), the aircraft will, as it loses velocity, also lose elevation, which as is known to everyone of any skill in the art will replenish its velocity. This means that as the aircraft tries to slow down, by not being powered anymore by the impeller system, it will drop and just keep reaccelerating to max speed. This is outright dangerous. The aircraft simply cannot and should never be allowed to re-enter the middle troposphere (i.e. 40,000 ft) at such speeds, so the Applicant feels it necessary to proffer at least some best mode at the time of filing, and he does not feel that simply shutting down the impeller system or idling it (as described with reference to FIGS. 8E and 8F later) accomplish said best mode. Nor does he believe (without resources to model this) that there is a realistic chance of using the flaperons or stabilator to create lift induced drag because pitching the flaperons the required amount at supersonic speeds will create enormous shock waves. So, clutching at straws though it seems, the Applicant proposes using the swirler 90 and vortex chamber 94 to brake the aircraft at high (post-cruise) speed and high elevation to cause and maintain the descent and deceleration in a manner that keeps the elevation and speed complementary to each other throughout. It is true that a non-negligible amount of energy will be lost (battery life will be wasted) near the end of the flight due to this method, and the Applicant leaves the reduction or elimination of this waste as a challenge to be picked up by other engineers.

So, still referring to FIG. 8I, there are two embodiments to implement the swirler-based braking system that the last few paragraphs have led up to. The one specifically shown in FIG. 8I is meant to try to retain energy and minimize losses. By opening a bay door or pair of bay doors 97 at the bottom of the vortex chamber 94—specifically, two doors hinged near to each other at the center-line of the bottom surface of the aircraft and which pivot up toward each other such that when they meet, they create a dividing wall (as shown at 97) whereat, since the swirling of the air in the left side vortex chamber 94 is clockwise and the swirling of the air in the right side vortex chamber is counter-clockwise, a large portion of the air should, when it arrives at the dividing wall 97, be led directly downward to create lift at the front of the aircraft. If in this embodiment the impeller system is left to idle, then with a little extra battery power air can be led to the middle portion of the impeller system and this air can be ejected downwardly from a portion of the impeller system (such as from the rear end of the longitudinal duct 8) to create lift. The result of this is that the air that has been slowed down (which requires work to be done by the aircraft but which produces lift, this lift being accomplished by a negative thrust or drag on the aircraft) is ejected downwardly to create the lift and this allows the aircraft to lose speed without losing altitude (this is an oversimplification, of course). So, although the impeller system has used some power (battery life) during this deceleration, the power was used to maintain altitude and thus it has been converted into potential energy. Once the aircraft has slowed down enough, the mechanical elements such as the flaperons, wings, and stabilator, can be used to perform a normal (known in the prior art) descent from whatever altitude the aircraft finds itself after going through the deceleration protocol, and whatever modifications to it are required to be safe and conserve energy.

However, it is possible that all of the preceding paragraph was much ado about nothing, and that the use of the impeller system at this stage and the creation of lift just don't amount to much in the way of energy savings or even if they do, it's probably not worth the trouble. So, the following discussion of a swirler-braking scheme is the preferred embodiment. Although FIG. 8I does not show this, if we were to imagine the bay doors 97 to be instead replaced with an annular openable venting system (i.e. many vents) all around the entire vortex chamber 94 (about both vortex chambers, actually) that just bleeds air laterally straight out from every angle, we can shut down the impeller system completely to conserve energy (it was only being used in FIG. 8I because if the doors 97 open and air exits them straight downwardly, we have the problem of a resultant pitching up of the nose of the aircraft to catastrophic results, and thus power is needed from the 1^{st} impeller module to offset it by ejecting air downwardly closer to the rear of the aircraft, which hopefully won't be needed in this preferred embodiment.

In other words, in this preferred embodiment, the aircraft is traveling from right to left at very high velocity in FIGS. 1A, 8G, and 8I. Air is enveloped by the intake 3 and enters the swirler 90 where the air loses longitudinal velocity (in the relative frame of the aircraft) and gains tangential/lateral velocity, such that the sum of all the vectors of the tangential/lateral flow is zero, due to the counter-rotating action of the diagonal fans. Meaning, the tangential/lateral components of all the swirling and/or laterally ejected air molecules' vectors zero out, such that their only remaining averaged vector component is in a forward direction but at a speed much higher (in the relative frame of the ambient air) than it was before contacting the swirler, which was substantially zero. Thus, work has been performed by the aircraft and if there is no thrust to offset that work, according to the law of conservation of energy the aircraft must slow down such that its kinetic energy is reduced as a function of this work. Therefore, we have found a way to shed velocity by using the swirler to eject air laterally and vertically outward, and since the swirler will have been designed to handle an incoming, supersonic airstream through the intake 3 without aerodynamic problems, there is no reason to believe that, by shutting down the impeller system while simultaneously opening circumferential vents around the vortex chambers 94A and 94B, we would have any unsolvable problems in slowing down the aircraft at/from supersonic airspeeds. The Applicant cannot predict for what duration this strategy should be used, but if it becomes insufficient for our purposes, the impeller system could be made to idle and the thrust reversers 304A and 304B (see FIG. 7A) could positively, actively supplement the braking, when and if required.

It was mentioned that the embodiments shown in FIGS. 1A and 8G-8J omit guide vanes in area 109 (FIG. 2A) of the intermediate passage 108. Now that the embodiment of FIGS. 8G-8J has been invented and subsequently digested by the Applicant (it had not been when the Applicant began writing this application, and there were indeed guide vanes at 109 to direct the 1^{st} and 2^{nd} diagonal fans' exhaust directly back toward the 3^{rd} diagonal fan), it is very likely that it is optimal that the exhaust from the 1^{st} diagonal fan stages be left to swirl unhindered inside the intermediate passage 108. The air is going to get shoved rearwardly by succeeding incoming exhaust from the 1^{st} diagonal fans anyway, so messing with it (i.e. via guide vanes) not only disrupts the airflow, but it reduces the rotational velocity that the 2^{nd} diagonal fan stage will be allowed to spin, thus reducing the power of the impeller system. So much of the current invention is so novel compared to the established art, that it was unavoidable that some vestigial relics were, and are still, hanging around in the Applicant's mind at the time of filing. The guide vanes that were in space 109 are probably vestigial and probably detrimental to the impeller system's functionality/performance, but the Applicant has left them in the discussion (even though he erased them from the drawings) as evidence that they were researched and thought-out, and in the event that they are useful or will be used in some other manner, they need to be disclosed. The reason they were used is because there was a desire to un-swirl the air so that it experiences less skin drag along the interior surfaces of the intermediate passage, and also because when the Applicant started typing the application, the fully awesome capability of the dual series fan concept was not yet appreciated. If the outlet of the 2^{nd} diagonal fans is tangential, and almost all of the movement of the air inside the 1^{st} and 2^{nd} diagonal fans is tangential, well by using the swirler we can jump-start this process and never, ever stop accelerating the air (it will actually accelerate itself inside the intermediate passage and inside the annular volute because of the centrifugal forces created by the diagonal portion of the diagonal fans) until it gets to the elbow duct. If the aircraft is traveling at 3000 mph, and the axial component of the air exiting the trailing edges 92 of the swirler is less than 1000 mph, we are putting a drag on the aircraft that is the equivalent of subtracting over 2000 mph from the 2^{nd} impeller module exhaust (thrust velocity), but the tangential velocity of the air exiting the trailing edges 92 is over 2000 mph which means we can spin the 1^{st} diagonal fan at 2000 mph faster (leading edge tangential velocity, that is). The resulting higher rotational speeds of all of the subsequent fans stack up and as a consequence the thrust air being ejected from the 2^{nd} impeller module through the thrust ducts 14 will be 2000 mph faster (or much more), so there will be an added thrust (forward) force that offsets, or in another way of looking at it, powers the work done by the swirler.

In FIG. 8G we kept the roof 301 from the VTOL system in FIGS. 7 and 9A-9T. FIG. 8H has been provided to show that the roof segments 301A and 301B are separately manipulable along the arrow 93 to (as described earlier) close off the impeller system, ingest air from only the front of the aircraft, and ingest air from only the top of the aircraft. One noteworthy thing about FIG. 8G is that it is probably preferable to have the roof 301 upstream (forward) of the swirler 9, which is the best mode the Applicant chose to depict in the drawings. However, it is possible that it would be better if the swirler 90 was placed ahead of the roof 301. So long as they are made in such a way as to not interfere with each other, the Applicant cannot think of a reason why both ways are not feasible. However, he believes it best to place the pivotable roof 301 up front for a few reasons and for now we'll leave it that way, without dragging into the application the additional figures that would logically result from this paragraph.

FIG. 8J shows a potential embodiment of the application wherein the front of the impeller system intake 3 is the same as that shown in FIGS. 8G-8I, but wherein the roof 301 and floor panel 301C can pivot toward each other to converge their leading edges somewhat, thereby bypassing incoming air around the impeller system and allowing it to work on less air, when needed. The figure will be referred to during other portions of the application such as discussion of braking and of closing off the impeller system 3.

FIGS. 8A-8E illustrate a presently non-preferred embodiment for the impeller system intake 3 in front of the first impeller module 100. In this non-preferred (intake-ramp) embodiment, the impeller system intake comprises sidewalls and how these comport to the overall fuselage shape and continue it forward (leftward on the page) must be determined by the aerospace designers that would make the device, if this non-preferred embodiment turns out to be most advantageous. The two main components of FIGS. 8A-8E are the intake ramps 5 (labeled 51-54) and the roof 301. As described previously in the discussion of FIGS. 7A and 8H, the roof 301 of the impeller system intake can pivot/drop from raised portion, where it is part of the roof of the impeller system intake 3, down to a lowered position, already described, where the trailing edge of it sits on the bottom of the impeller system intake 3. However, in FIG. 8A it only drops so far as the intake ramps 5 (51-54), to cooperate with them to make a smoother air intake passage. The roof 301 and its operation were described with reference to FIG. 7A and will be described again later, so further discussion of it will be omitted here.

FIGS. 8A-8D show the four stages of operation of the intake ramps. The intake ramps comprise a first intake ramp 51, a second intake ramp 52 downstream of the first intake ramp 51, an intermediate panel 53 downstream of the second intake ramp 52, and a transition panel 54 downstream of the second intake ramp 52 and immediately upstream of the 1^{st} impeller module.

As mentioned previously in the application, the Applicant is not an expert or even a novice in aeronautical engineering, and even less expert is he in the areas dedicated to supersonic travel. However, it is possible that intake ramps could be required during supersonic airspeeds. The quantity and types of intake ramps, and how they move in unison to effectuate various flow profiles, must be left up to subsequent engineers. It is possible that a low-supersonic prototype can be made and tested while the rest of the intake-ramp endeavor is carried forth in parallel, such that the intake ramps can be studied on a separate track from the furtherance of the primary embodiments put forth herein.

In FIG. 8A the intake ramps are basically formed into a lateral (side-to-side) hump that does not interact with the flow, and simply forms a nice platform for the roof 301 to drop down onto, in order to eliminate intake airflow from the front 2 of the aircraft. It is obvious that the intake ramps could be repositioned into various configurations to make this easier or to augment it, but FIG. 8A is not really that important, it just was convenient to make a place to show the intake ramps 5 and the roof 301 together, since they are in the same place. FIG. 8A also serves to show that the front of the aircraft is probably not going to be as simple as shown in FIG. 1A.

FIG. 8B depicts the configuration of the intake ramps 5 and roof 301 in a benign form, where they have no interaction with the air and simply lie flat against the inner surfaces/walls of the impeller system intake 3. In this configuration it will be like the intake ramps 51, 52, 53, and 54 do not exist, and this is what non-supersonic flow will look like as the incoming air experiences it.

FIG. 8C depicts a 1^{st} phase of intake ramp activity wherein at a moderate supersonic and/or trans-sonic airspeed, as the intake ramps become more and more necessary, they are repositioned by the controller and whatever at-present unconceived-of (but workable in a robustly theoretical sense) mechanism might conceivably pull all this off to resemble the traditional (albeit upside-down) intake ramp geometry for rectangular intake ducts of other, known, supersonic aircraft. Specifically, the first intake ramp 51 is at a very acute angle, such as 4-5 degrees, and the second intake ramp 52 is at a less acute angle, such as 6-12 degrees. The transition panel 54 is at another acute angle (relative to the horizontal), but reversed such that the impeller system intake 3 gets wider here. The intermediate panel 53 bridges the trailing edge of the second intake ramp 52 to the leading edge of the transition panel 54.

FIG. 8D depicts a 2^{nd} phase of intake ramp activity wherein at a high supersonic airspeed, as the intake ramps become more pronounced in their activity and effect, they are repositioned by the controller and said mechanism. Specifically in this simplified example, the first intake ramp 51 is at an acute angle, such as 7 degrees, and the second intake ramp 52 is at a less acute angle, such as 14 degrees. The transition panel 54 has also been moved to have a greater angle relative to the horizontal. The intermediate panel 53 still bridges the trailing edge of the second intake ramp 52 to the leading edge of the transition panel 54, and it might be necessary to have an intermediate panel that is of variable length such that as the 2^{nd} intake ramp 52 and the transition panel 54 pivot and their edges move farther apart from each other, the intermediate panel can always fill the space and keep air moving smoothly over the intake ramps 5, as is known in the art. There are a variety of combinations of variable intake ramps available to meet any flow requirement that is encountered in practice heading forward.

FIG. 8E depicts something technologically adjacent to the foregoing but difficult to explain, an unconventional effort to portray the aircraft a) after cruise and during initial approach, or also possibly to show it b) during a specific type of cruise.

In FIG. 8E, the roof 301 and the transition panel 54 are shown in such a manner that their front/leading edges (the left-hand side of each in the figure) have moved inwardly, toward each other. This can be achieved using ordinary skill in the art, and although it is a little sophisticated, the reader can use their imagination and realize that there are many ways and one way will be better than the others. The trailing edges of the roof 301 and the transition panel 54 have meanwhile stayed hinged to the impeller system intake's upper and lower walls. It is possible that the intermediate panel 53 moves with the transition panel 54, and this is what is shown in FIG. 8E. The aim of this side-project is to divert some of the incoming air around the aircraft (over the top and under the bottom) to a) reduce the burden on the engine during high-airspeed, low-thrust flight modes, and b) increase lift of the aircraft, and c) to thereby increase lift-induced drag.

Still referring to FIG. 8E, at some point in each flight, it becomes necessary to slow down and begin an approach toward a landing zone. Several alternative modes of doing this were described in the brief summary of the invention, and now another one is proposed. As the roof 301 and the transition panel 54 move toward each other as shown in FIG. 8E, the portions of the incoming airstream, shown as bypasses 60 (lower) and 61 (upper), bypass the impeller system and get passed over and under, respectively, the aircraft. An additional panel, labeled 55, has been added to the bottom of the impeller system intake and it moves with the transition panel 54 and creates a smooth outer contour for the lower bypass airstream 61 to pass around.

Due to the new positions of the roof 301 and the transition panel 54 shown in FIG. 8E, the lift and lift-induced drag of the aircraft are increased, for reasons that will not be gone into herein. Because the upper and lower bypass airstreams 60 and 61 have been diverted away from the impeller system intake, the 1^{st} impeller module temporarily takes in less air. If we are indeed trying to slow down the aircraft during this mode, it will be simultaneously disadvantageous to create rearward thrust and necessary to dispose of the air coming into the impeller system intake. Although it is probably not the best mode, the 1^{st} impeller module could, as discussed in the brief summary, simply shut down and create a bow wave in front of the aircraft, which would cause the aircraft to lose kinetic energy (a positive result, as we are trying to slow down), but which could lead to shock-induced vibration and discomfort for the passengers, and possible catastrophic failure. Nonetheless, that option should not be overlooked, and it could be done without using the configuration shown in FIG. 8E, but this is probably not preferred.

Anyway, in the event that the configuration shown in FIG. 8E is used, the impeller system will constantly fill up with air and this will continuously have to be flushed out by the 1^{st} impeller module (unless we use the bow wave alternative). It is absolutely preferred to shut down the 2^{nd} impeller module at this point (in the deceleration/approach scheme) and bypass it if possible. Bypassing some of the air via 60 and 61 so that it doesn't even enter the 1^{st} impeller module is a good start. This allows us to reduce the power of the 1^{st} impeller module in addition to cutting off power to the 2^{nd} impeller module. But it is probably unavoidable that we are going to have an internal flow entering the 1^{st} impeller module, so it will keep spinning at the lowest power (battery consumption rate) that is possible without choking the 1^{st} impeller module intake.

To reduce back-pressure on the 1^{st} impeller module, the reader is referred to FIG. 8E in combination with FIG. 8F, which latter figure shows an embodiment of the rear of the aircraft that can be used in conjunction with the configuration of FIG. 8E. Firstly, still referring to FIG. 8E, the floor 302 of the elbow duct 7 can be pivoted to a position that allows a front downward exhaust 62, which not only bypasses the 2^{nd} impeller module, but it pitches up the front of the aircraft while the aircraft is descending, allowing the aircraft to exchange its speed for distance until it is at a slow enough airspeed that it can begin a normal (comparable to other aircraft) approach and descent. It is presumed that the stabilator won't be able to accomplish this alone, as the more we pitch up the aircraft during descent, the less battery will be consumed during a flight. Whether or not we use the floor 302 to bypass the longitudinal duct to create a front downward exhaust (and upward pitch), there is still, at some point, a curved flow 63 that is heading toward the 2^{nd} impeller module. If we let it seep through the 2^{nd} impeller module, a back-pressure will be exerted on the 1^{st} impeller module, and this will increase power consumption. So, if desired, we can simply bypass the 2^{nd} impeller module by raising a back panel 58 over the 2^{nd} impeller module intake duct. The back panel 58 is hinged at its leading edge and when its trailing edge is raised, it reveals a 2^{nd} impeller module bypass duct 59 that simply exhausts the 1^{st} impeller module exhaust to the environment, shown as bypass outlet flow 66. The flap or door at the rear of the aircraft and at the rear of the 2^{nd} impeller module bypass duct 59 that facilitates this has not been shown or labeled because it's simple enough to imagine without adding dotted lines or another figure.

So, in our effort to shut down the 2^{nd} impeller module and run the 1^{st} impeller module at minimum power during descent, deceleration, and/or approach of the aircraft following a high-altitude, high-airspeed cruise duration, we have partially bypassed the entire impeller system via upper and lower bypass airstreams 60 and 61 while in doing so creating lift and lift-induced drag, which will be used to stretch out the mileage at the end of a flight, while we have also bypassed the 2^{nd} impeller module via front-down thrust 62, which raises the front of the aircraft, also stretching out the mileage at the end of a flight, and whatever air is left in the impeller system when it gets to the 2^{nd} impeller module simply passes over the 2^{nd} impeller module and out of the impeller system via the bypass duct 59. The bypass at this point is created by lifting a 2^{nd} impeller module intake hatch 58. Since the aircraft will be at a very high altitude and a very high airspeed, it is presumed that this “coast down” method of shedding the altitude and airspeed will take a few minutes and in this time the aircraft will have traveled more than 50 miles, if not 100 miles, and this is time/distance where we do not have to use the battery except for a modicum of power needed to idle the 1^{st} impeller module when it's clearing out the impeller system intake at negligible back-pressure.

The aircraft has so much kinetic energy and potential energy at the end of cruise, and this is energy that was earned by the batteries, so we should do everything we can not to waste it, even if this means adding a few minutes to the flight. However, in a situation where the aircraft can arrive near its destination without completely draining its battery, the thrust reversers, flaperons, and stabilator can all, either in cooperation or individually or a combination of both, be utilized to slow the aircraft down much more quickly, as desired. Of course, when the aircraft has descended below 1000 feet and slowed to about 300-500 mph, the 2^{nd} impeller module will quickly run up to its operative rotational rate, because it will needed for vertical landing.

FIGS. 8G-8J show an interesting and probably preferred embodiment for the front of the aircraft and the impeller system intake 3. The impeller system intake 3 is shown in both figures and its relationship to the 1^{st} impeller module 100 is mostly the same as it has been in other figures. For each 1^{st} impeller submodule (100A, 100B, etc.), there is a 1^{st} impeller module intake 4 with a circular intake area in front of the 1^{st} diagonal fan. This area is mostly devoid of structure such that the intake air is unimpeded and the air that is ingested by the impeller system arrives to the 1^{st} diagonal fan(s) at the same velocity, relative to the 1^{st} impeller module, that it passed into the aircraft front/nose 2, relative to the aircraft. However, unlike the embodiment described in FIGS. 1A-1B and FIGS. 8A-8D, wherein the air arrives to the 1^{st} diagonal fans (s) with a completely axial velocity vector, the embodiment shown in FIGS. 8G-8J comprises a swirler 90. Actually, there are two swirlers 90 and they are mirror images of each other, one in front of each of the 1^{st} impeller submodules 100A and 100B, and like the latter, their swirl directions are opposite to each other. To elucidate, the swirler shown in FIG. 8G is in front of the 1^{st} impeller submodule 100A and since the 1^{st} impeller module is spinning the air clockwise (looking forward toward the front of the aircraft), the swirler 90 shown in FIG. 8G is twisting the air such that it spins in the same rotational direction as the 1^{st} impeller submodule. Of course, on the other side of the aircraft, another swirler (not shown) will be a mirror image of the swirler shown in FIG. 8G, and it will twist the air such that it spins in the counterclockwise direction which is the same as the 2^{nd} impeller module, both about parallel axes.

The function of the swirlers 90 is to deflect the air from a completely axial velocity vector such that its aggregate (the average of all of the velocity vectors of all air molecules) vector is mostly tangential, but with a minor axial component, such that when the leading edges of the 1^{st} diagonal fans encounter this air, the air is already spinning with the 1^{st} diagonal fans but slower, such that the velocities of the leading edges of the 1^{st} diagonal fan vanes relative to velocities of the air molecules can be kept at a moderate differential even though the rotational velocity of the 1^{st} diagonal fans is very high. Like the use of intake ramps as 51-54, we have technically performed work on the air (this will create a negative or rearward longitudinal force on the aircraft like drag), but we will reclaim this work when the air exits the aircraft at a higher speed. Using the swirlers 90 to twist the air into vortices that feed the air to the 1^{st} diagonal fans in the same direction they are spinning, we can spin the 1^{st} diagonal fans much faster than if their intake air flow were entirely axial. It is noted with emphasis that the intermediate passage's guide vanes 109 are omitted from the intermediate passage 108. Not only are the guide vanes 109 not needed, they will be detrimental. We no longer care about the axial movement of air. We're just trying to roll it faster and faster until it is ejected into the elbow duct. Trying to deflect it downwardly actually costs us energy and efficiency. What we'll do is just spin the 2^{nd} diagonal fans such that their leading edges have a speed relative to the tangential velocity of the air swirling in the intermediate passage 108. So, in this embodiment, the 1^{st} diagonal fans can spin faster than in previous embodiments, and the 2^{nd} diagonal fans (without the guide vanes) in turn spin much faster than in previous embodiments.

The swirler comprises sweeping vanes that begin with leading edges 91 that are parallel to the longitudinal axis of the aircraft, such that the intake air passes in an axial direction without being disrupting it at all. The vanes arc with progressively increasing curvature to their trailing edges 92. It is clear from FIG. 8G how this is taking place. The air passing along the vanes is ejected from between adjacent trailing edges at an angle that is preferably 50-80 degrees relative to the axial direction, or 10-40 degrees relative to the tangential direction. 94 is a vortex chamber that can be shorter or longer to allow the various air flows (it won't be as simple as described herein how the air is moving around) to stabilize with each other and form a somewhat unidirectionally vortical flow. From the vortex chamber the 1^{st} diagonal fans cut into the flow and separate it into dozens of sectored passageways to accelerate it even more in a tangential direction.

It is noted that the intake ramp system is probably not preferable if the swirler proves to be at all feasible for supersonic flows. There does not seem to be any reason to doubt that it would. It isn't interfacing with the air, really. Insofar as the supersonic intake impinges on the swirler's leading edges, the latter could be filed down to a razor's edge and the material of the leading edges could be thermically reinforced (metallurgically, etc.). As mentioned before, the aircraft is performing a great deal of work on the air by swirling it. However, this work acts on the air to accelerate it tangentially, and this tangential acceleration will be recaptured when the air enters the longitudinal duct at a much higher speed than it would have in a non-swirler embodiment.

FIG. 8J illustrates a situation where the impeller system intake is typical and conforming to the preferred embodiment but the intake flow could be excessive at certain speeds, meaning it will be too much for the impeller system to work on and more particular, too much for the 1st impeller module to reduce to a cross-sectional flow area that will pass easily through the longitudinal duct without causing back-pressure. This can for instance happen when the aircraft is traveling over 300 mph (or less) while still being at less than 15,000 feet altitude (or more). Eventually the air density through the impeller system must be reduced for this aircraft to succeed in its bespoke way, and there is a problem that will be experienced after the aircraft has achieved airspeeds of over 250 mph (+ or − 50 mph) while still facing air densities that might choke the impeller system. So in FIG. 8J the roof 301 and floor panel 301C pivot toward (and/or away) from each other, as much as is needed for any particular stage of a flight, to bypass a required fraction of flow around and out of the impeller system.

Continuing with FIG. 8J and with sustained reference thereto, when the air intake into the impeller system intake 3 is going to be too much for the impeller system to operate properly, the front ends of the roof 301 and the floor panel 301C pivot towards each other. Even though this will only transpire at relatively modest speeds, speeds which are subsonic, the flow along the roof 301 and the floor panel 301C will not transition well along the designs shown in FIG. 8J. So presuming that this configuration as shown in FIG. 8J is not conducive to laminar flow and will experience energy losses, of course the contours of the roof 301 and the floor panel 301C should be 2-dimensionally continuous, as in steadily contoured with predictable inflection points (or one inflection point), meaning that there is no elbow/angle at the trailing edges of the roof/panel (meaning it will not be a straight-up angle as shown in FIG. 8J—it will be smooth/rounded). Some means (piezoelectric, mechanical) should be provided to flatten some of their portions and also lend extra curvature to other portions. Perhaps the contour will be most pronounced in the front so that there is more concavity (top toward bottom and bottom toward top) there while the trailing edges are straighter, or vice versa (more mutual mirrored concavity more rearward while the leading edges are straight), or a hybrid between these options.

At super-high airspeeds and altitudes the pivotable roof 301 and floor panel 301C are provisional candidates for use in a braking scheme. The impeller system will probably be idle during this time and it would be advantageous to achieve passive braking, as has been described for this stage at other parts of this application. If the roof 301 and floor panel 301C could more sophisticated multi-inflected (S) curves as seen from the vantage of the cross-section of FIG. 8J (but not shown in FIG. 8J), or other exotic curves not yet envisioned, perhaps these two controllable panels could be a significant factor in the post-cruise approach-and-descent phase. The Applicant does not yet know how to do this and defers to the preferred (other) embodiments described in this application (using the swirler). But if these panels were made to be capable of assuming many configurations, perhaps some one or more of such configurations could be useful for passive post-cruise modes of braking. Even if this involved also using the swirler and/or combining as well things that have not yet been thought up, this avenue should be explored.

### Back to VTOL

Getting back to the VTOL and how it will actually be performed, we will use FIGS. 9A-9T to walk us through an entire flight sequence that begins and ends with the aircraft lying on the ground. We will only label the pertinent moving parts in FIG. 9A, and an intelligent reader should be able to understand during the description of them what parts are being discussed in latter figures within FIGS. 9A-9T without us having to label every figure with repetitive labels. Firstly, not shown but which exist are landing gear which can be any simple device or set of devices designed to keep the aircraft several inches off the ground, when it is actually on the ground, so that the VTOL valves 310 can be actuated to their lowered position as shown in FIG. 9B. Conversely, the aircraft could lie completely flat and the VTOL valves could be actuated with enough force to raise the rear of the aircraft when they are actuated. Either way, we will for convenience's sake discuss FIGS. 9A-9T without referring to the landing gear or the potential problem of the surface of the ground interfering with the actions of the VTOL valves 310.

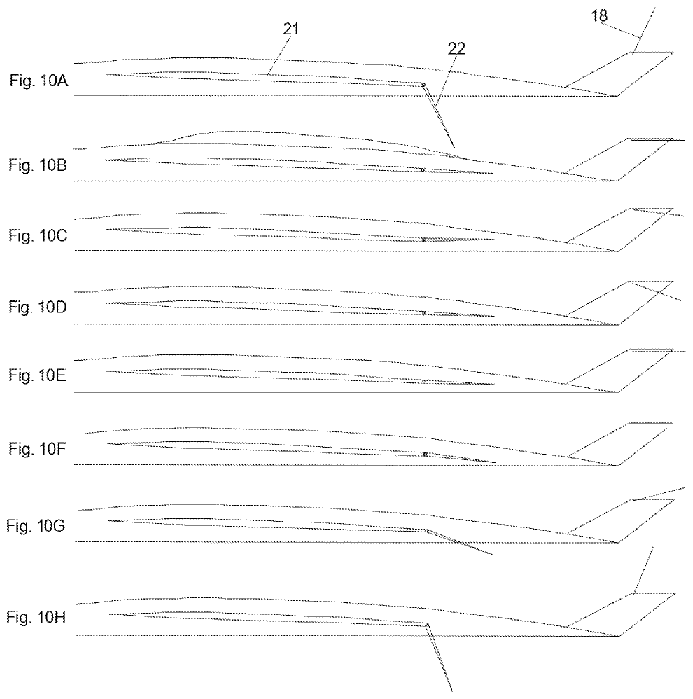

FIGS. 9A-9T do not show the aerodynamic elements such as wings, stabilizers, flaperons, etc. Some of that will be shown in the next group of figures, FIGS. 10A-10H. FIGS. 9A-9T instead show the mechanisms and method for controlling air as it passes longitudinally through the aircraft. Only a few elements of FIGS. 9A-9T have been labeled, and these are the moving parts that will be discussed. Everything else has been labeled and discussed elsewhere within the application. Also, elements will only be labeled in the first figure they appear in. FIGS. 9A-9J on the left-hand side show the sequence of configurations from pre-takeoff to post-landing of these moving parts, and FIGS. 9K-9T show the instantaneous angle of the aircraft, relative to the horizontal, at each time during which the figure (from 9A-9J) is in the configuration shown in the individual figure directly to the left of it. So, FIG. 9K shows the aircraft flat because the aircraft in FIG. 9A is also flat and on the ground when the configuration of elements in FIG. 9A is occurring, while FIG. 9O shows the aircraft pointed nearly straight up because the configuration shown in FIG. 9E is actively driving the aircraft nearly straight up. This relationship between the left-hand side FIGS. 9A-9J and the right-hand side FIGS. 9K-9T is maintained throughout the discussion.

We begin with FIGS. 9A and 9K, which show the aircraft lying on the ground before any takeoff is attempted. The roof 301 is down like that shown in FIG. 7A. However, for FIG. 9A the roof 301 is composed of two sub-panels (lower roof panel 301A and upper roof panel 301B) that are usually parallel to or stacked with each other as shown in FIG. 9E. But in FIG. 9A, one of them is pivoted down, as shown as lower roof panel 301A, and the other one of them is pivoted up as shown as upper roof panel 301B. The two panels block at this moment both the upper and front intakes to the 1^{st} impeller module such that no air can enter the impeller system intake 3. In other words, the upper roof panel 301B prohibits air from entering from the top of the front of the aircraft, and the lower roof panel 301A blocks air from entering from the front of the aircraft. Similarly, the rear flap 303 is pivoted down, which closes the 2^{nd} impeller module intake duct to any outside air, such that the 1^{st} and 2^{nd} impeller modules do not have any air available to take into them. Thus, there will be no flow and the impeller modules perform no work on any air no matter what they do, and the aircraft remains stationary at that position while the fans can accelerate or decelerate to whatever rotational velocity is required of them without resistance from flow air.

While the aircraft is in the configuration shown in FIG. 9A, once the payload is settled (seated) and ready to go, the 1^{st} and 2^{nd} impeller modules begin to spin faster and faster until they are rotating at near-maximum speeds. They will do the run-up to their near-maximum speeds in a vacuum, because with the front and top of the aircraft shut off to incoming air, the impeller modules will quickly evacuate the impeller system of all air. Thus, they can accelerate up to their upper rotational velocities quickly and without performing any work (moving any air or even encountering any air). This greatly reduces the amount of battery power required to perform this initial acceleration, and that is battery power we can use later in the sequence. The floor 302 of the elbow duct and the VTOL valves 310 are shown in their up positions, but this doesn't really matter because they aren't doing anything at this point.

Once the impeller modules have achieved their maximum (or near-maximum) speeds (each will require its own, distinct max speed), we move quickly to FIG. 9B where the roof (specifically, the lower roof panel 301A) has suddenly dropped to a lowered roof position, while the rear flap 303 has been pivoted up to its completely open position. The floor 302 is still pivoted up to close the longitudinal duct such that the 2^{nd} impeller module's intake will be solely through the opened rear flap 303, and the VTOL valves 310 are immediately moved to their actuated position. Now we have achieved the configuration from FIG. 7A wherein the 1^{st} impeller module sucks air (referring back to FIG. 7A) downward at arrow 341 into itself and discharges it straight downward at 343, resulting in a powerful lifting force on the front of the aircraft. Meanwhile, the 2^{nd} impeller module sucks air downward at arrow 342 and discharges it straight downward at rear vector 344, resulting in a powerful lifting force on the rear of the aircraft. As shown in FIG. 9L, the aircraft is still flat, but it is rising with an acceleration that is preferably controlled.

Still referring to FIG. 9B, as described earlier, when the roof 301 and VTOL valves 310 drop to commence vertical takeoff, the impeller modules are at first rotating at maximum speeds, which are much higher than the regular takeoff speeds. This is because the aircraft is not moving into the air yet, and must rely on the air “falling” or “jumping” into the impeller modules once the impeller modules have created a semi-vacuum upstream of them. For the thrust equation (T=v*m-dot) at this moment, the volumetric flow (m-dot) will be greatly reduced compared to the ideal situation of having an incoming air flow, so the velocity of the thrust air/exhaust(s) must be extremely high to offset this. The best way to achieve that now is to spin the impeller modules as fast as possible. As the impeller modules suck the air in and thrust it downward, the aircraft will begin to rise upward from the ground and the incoming air will then start to be available in increasing amounts. The impeller modules will inherently decelerate as the air flows in more because they are not equipped to keep up such a rotational rate once the volumetric flow increases. They can only spin at the max rate in two situations, one at extremely high altitudes where the air density is very low, and the other at initial takeoff when the air density is also very low due to the fans sucking air that at the intake is at 14 psi with no inflow (longitudinally traveling air) to assist its “jump” into the fans.

Steadily after the aircraft begins to rise, the impeller modules begin to decelerate and the amount of air (throughput) entering the impeller modules begins to increase; we must keep the thrust equation at a controlled product (T) that will have been predetermined to be comfortable and non-hazardous to humans, while still being commercially attractive to passengers and companies alike.

As soon as the aircraft has achieved adequate altitude and upward airspeed for it to be flipped up such that the front points vertically upward and the rear points vertically downward, the maneuver to do this must be accomplished quickly. It is not desired to perform the maneuver at a high altitude because of various safety factors, so let us say that after 5 seconds (subsequent to opening the floor 302 and rear flap 303), when the aircraft is going 50 mph upward and has reached about 100 feet, the maneuver is commenced and immediately consummated.

The flip-up maneuver begins with FIGS. 9C and 9M. With the roof 301 still down, each one of the VTOL sub-valves 310A (described with reference to FIG. 7A) retracts into the aircraft simultaneously on both sides of the rear of the aircraft, while the other VTOL sub-valve 310B stays in the actuated position, such that the rear downward exhaust is only partial, maybe around half, and it can no longer compete with the front downward exhaust being ejected downward from the 1^{st} impeller module, such that the front of the aircraft begins to rise faster than the rear and the aircraft begins to pivot such that its front becomes increasingly higher than the rear and not only that, it will without mitigation begin to pivot too fast such that if this configuration were maintained, there would be no way to get back control of this pivoting action, so almost immediately after the VTOL sub-valves 310A are retracted, the floor 302 starts moving toward the closed/lowered position, and an intermediate position for it (between open and closed) is shown in FIG. 9D. Also, while stopping to review FIG. 9D, we will notice that FIG. 9M showed the beginning of the flip-up maneuver having already taken place on its way to the angle shown in FIG. 9N, which happens almost immediately after. Also in FIG. 9D it can be seen that the roof 301 and the rear flap 303 have started to close such that they are taking in a lot of air from in front of them and the 2^{nd} impeller module is receiving air now from the 1^{st} impeller module via the longitudinal duct because the floor 302 is partially closed and continuing to close.

Looking now at FIG. 9E, the controller will move the floor 302 toward its closed position in such a way that the flip-up maneuver will be controllable and once the angular momentum has been established to an exact value, the floor 302 closes completely, the roof 301 goes up completely, the VTOL sub-valves 310B retract (meaning they will all now be closed), the rear flap 303 drops/closes completely, and the aircraft is in its normal, forward-flight configuration while being aimed nearly straight up toward the sky, as shown in FIG. 9O.

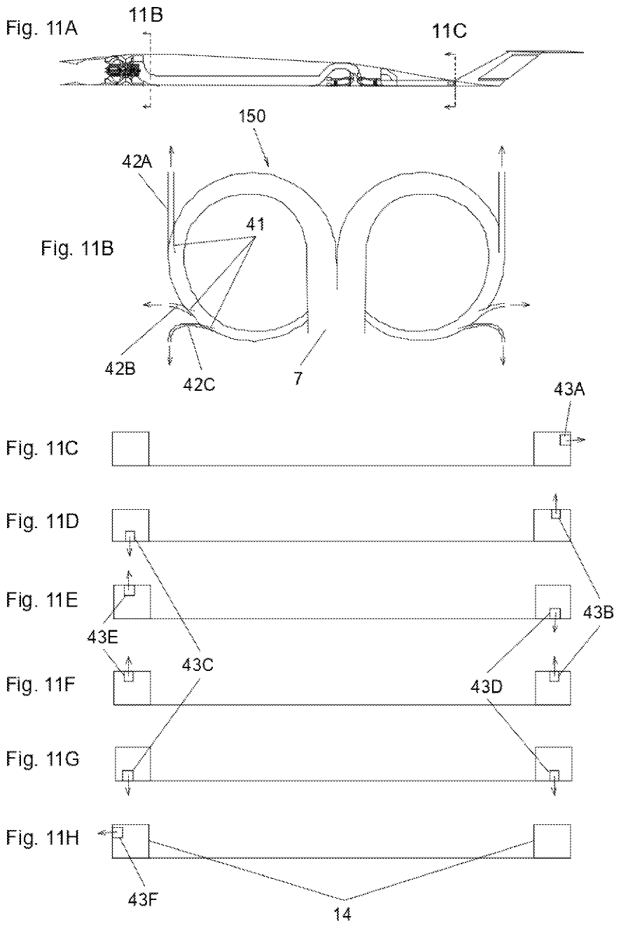

It is noted that at FIGS. 9E and 9O, it is obvious that the aircraft needs to be actively/positively stabilized, and this will be addressed with reference to FIGS. 11A-11H, which discusses a set of stabilizing valves proportionally bleeding air from the 1^{st} impeller module's volutes in various directions. Leaving that discussion aside for now to continue with FIGS. 9A-9T, we begin by observing that FIG. 9O shows, as mentioned previously, the aircraft pitched up nearly vertically. All the exhaust is exiting through the thrust ducts out the rear of the aircraft, such that all thrust is accelerating the aircraft upward. However, as the aircraft accelerates it begins to experience lift, so to offset this, the aircraft gradually shifts somewhat (via the stabilator and/or thrust vectoring, explained later) toward the horizontal. For instance, as shown in FIG. 9P, the aircraft is at about an 80 degree angle with respect to the horizontal. Because the aircraft is designed to achieve regular flight at around 300 mph (at sea level), this creates the situation where, especially after it has accelerated to more than 300 mph, the lift forces are pushing it back (to the left in FIG. 9P). So, the aircraft's velocity vector must be kept at or less than 90 degrees, and to do this we need to continuously, as the airspeed becomes greater and greater, pitch the nose of the aircraft further down, which is what FIG. 9P is meant to depict. Well, FIG. 9P shows one angle, and it should be obvious to the reader that all the continuum of angles between 9O and 9P were gone through to get to FIG. 9P.

It is noted that FIG. 9F is unchanged from FIG. 9E, because the internal configurations of the aircraft will not change from FIG. 9E until the landing cycle is commenced in FIG. 9I. Still, FIGS. 9E-9H have been included, even though there is no variation between them, so that we can talk about FIGS. 9O-9R. Again, FIG. 9O shows the aircraft ascending with a vertical velocity vector and to keep the vertical velocity vector, the aircraft's actual positional angle (pitch) must be transitioned from vertical, as shown in FIG. 9O, to a less-obtuse angle, such as that shown in FIG. 9P. As the aircraft's airspeed becomes much higher, it is possible that the pitch might even become more horizontal than that shown in FIG. 9P, but regardless, once the vertical climb cycle is complete, we need to bend the aircraft's trajectory (pitch as well as velocity vector) toward the horizontal so we can begin to get toward our destination and because we don't want to stall. After FIG. 9P, the stabilator and thrust vectoring elements aggressively torque the rear of the aircraft upward around the aircraft's center of mass, such that the aircraft transitions through the angle shown in FIG. 9Q to arrive at the angle shown in FIG. 9R, in which acceleration is almost completely horizontal. The aircraft will level out after FIG. 9R, but this is not shown except at FIGS. 9S and 9T, since now it is operating as a regular aircraft and it takes no stretch of the imagination to imagine this. However, as the aircraft is flying with a very high airspeed (over 1000 mph) and quickly gaining speed (accelerating at perhaps 30 mph/s), it will keep ascending until the aircraft reaches a cruise altitude and cruise airspeed.

Importantly, if the preferred takeoff mode utilizing a launch tower or other vertical guide (chute, rail, etc.) is being used, FIGS. 9A-9D and 9K-9N are skipped and the takeoff protocol will begin at FIGS. 9E and 9O.

FIG. 9I represents a simplified transition from cruise to landing, wherein the upper roof panel 301A is simply dropped down to close off flow and the impeller system shuts down fully or partially. This is the simplest embodiment for performing a descent/approach to the landing area discussed in the application; it was mentioned elsewhere, among other perhaps more-preferred embodiments, and will not be gone into further here. As shown in FIG. 9S, the aircraft is substantially horizontal now and its trajectory will be horizontal at first and then it will begin to descend as it loses airspeed. Once the aircraft has lost airspeed (i.e. at 300 mph) and altitude (i.e. at 300 feet), the impeller system will come online again, so that when, as shown in FIG. 9J, the lower roof portion 301A drops, the rear flap 303 opens upwardly, the floor 302 is raised, and the VTOL valves 310 are activated, the configuration of FIG. 9B is again implemented for landing and touchdown—the 1^{st} impeller module will take in air from above like it did in FIG. 9B (but still referring to FIG. 9J) and eject it downwardly for a front downward exhaust thrust, and the 2^{nd} impeller will take in air from above it like it did at the beginning of the flight (in FIG. 9B) and eject it downwardly for a rear downward exhaust thrust. Using the braking scheme described elsewhere in this application with reference to FIGS. 10A-10H (stabilator and flaperons) and FIG. 7B (thrust reversers 304A and 304B), the aircraft will slow down until its horizontal velocity is zero and then the impeller system will slow down allowing the aircraft to touch down in the appropriate location. FIGS. 9S and 9T show the aircraft angle during this operation, which is substantially horizontal.

FIGS. 10A-10H illustrate a series of side views of the aircraft with everything omitted except the profile of the aircraft 1, the left-front wing front portion 21, the left flaperon 22, and the stabilator 18, wherein these are depicted in the various positions they will move to during a typical flight from takeoff from a field/pad to landing on a field/pad. It should be obvious to the reader that since there are two wings each with its own flaperon, whatever is shown as happening on the left side of the aircraft in FIGS. 10A-10H is also happening on the right side, with one exception pertaining to FIG. 10E. The three elements are only labeled in FIG. 10A to make the other FIGS. 10B-10H more clear, since anyone of ordinary skill in the art can find them in FIGS. 10B-10H and know what they are doing or what their meaning is using FIG. 10A.

FIG. 10A does not correspond to FIGS. 9A-9B and 9K-9L, because it shows the aircraft after it has popped up off the ground. Initially, corresponding to FIGS. 9A-9B and 9K-9L, it is FIG. 10B that depicts what the flaperon and stabilator will look like when the aircraft is on the ground. However, once the aircraft begins to ascend (corresponding to FIGS. 9A-9C and 9K-9M), we want to reduce wind resistance so, as shown in FIG. 10A, the flaperon 22 can pitch all the way up and the stabilator 18 can pitch all the way down. This simply gets them out of the way so the air can pass by without encountering them as the aircraft travels upwardly. Once the aircraft flips up, corresponding to FIGS. 9D-9E and 9N-9O, the flaperons go to their regular flight positions which are shown in FIG. 10B, in which the stabilator 18 is substantially horizontal relative to the aircraft and the flaperons 22 are substantially parallel to the wing front portion (horizontal relative to the aircraft).

Now comes an unusual proposition, and the Applicant is not sure it will benefit enough to be used. It should have some effect but perhaps it is not worth the trouble. However, as shown in FIG. 10C, it is proposed that the flaperons 22 pitch down a little to reduce the lift created by the wing. As described earlier with reference to FIGS. 9F and 9P, while the aircraft is performing the vertical climb, which is the point we've arrived at in FIG. 10C, once the aircraft's upward airspeed increases a certain amount the natural lift forces across the fuselage and wings will start pushing the aircraft back (increasing its vector's angle to more than 90 degrees from the forward-horizontal) which would be catastrophic. It was proposed to actively pitch the aircraft down to offset this, and discussion of that is going to follow soon. But while we're here, the Applicant proposes that a reduction of the lift could be helpful to help offset this and reduce overall lift drag. So, it can be noticed, although not obvious, in FIG. 10C, that the flaperons 22 are not exactly parallel to the wing front portion 21. At moderate speeds (300-700 mph) it is believed by the Applicant that this will not be detrimental to the functioning or efficiency of the aircraft, and it reduces the amount that the aircraft has to be pitched down to keep its velocity vertical (straight up). Also, as shown in FIG. 10C, whether or not we pitch down the flaperons 22, we will be using the stabilator 18 to modulate the aircraft's vertical vector by pitching the stabilator 18 up progressively as the airspeed increases.

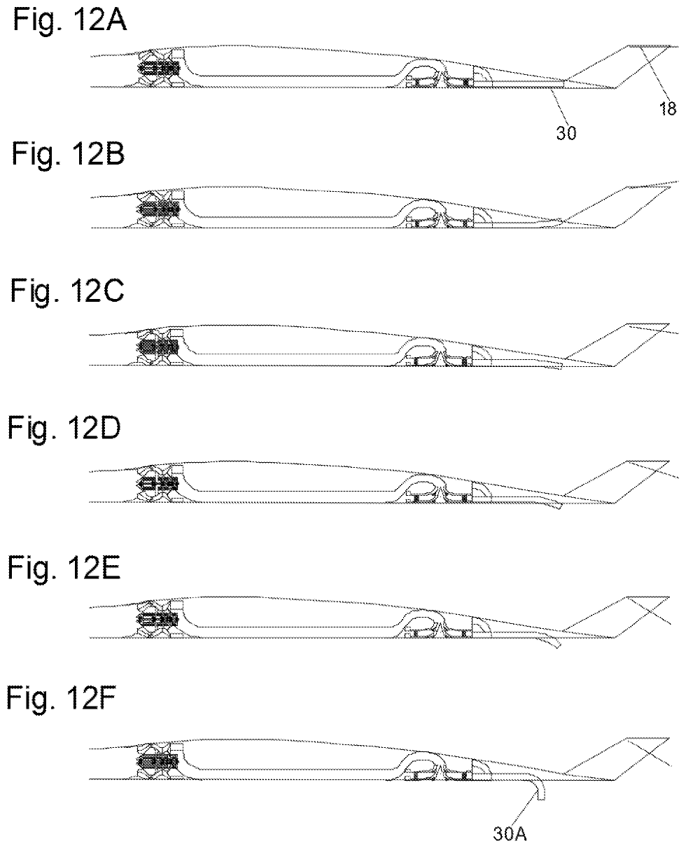

FIG. 10D has the flaperons 22 leveled out once more and parallel to the wing front portions 21 such that the combination yields a normal wing shape. However, the stabilator 18 is pitched up aggressively because, corresponding to 9P and 9Q, the aircraft is trying to flatten out its trajectory to finish its climb and level off to achieve horizontal flight. With help from the thrust vectoring nozzles 30, described with reference to FIGS. 12A-12F, and perhaps some help from the stabilization valves 41 and 43, described later with reference to FIGS. 11A-11H, the front of the aircraft is gradually pivoted down until the aircraft is nearly horizontal (relative to the earth's surface), and this state corresponds to FIGS. 9H and 9R. This state has already been described in the discussion of FIGS. 9H and 9R so it will not be explained in detail here. But referring to FIG. 10D, once this is achieved, the stabilator pitches back down to its regular default position as shown in FIG. 10E.

FIG. 10E is normal flight including cruise flight and other non-transient flight modes. The aircraft has leaped up through its initial climb, it's been pushed over by the stabilator 18 and thrust vectoring nozzles 30 to be more-or-less horizontal, and it is longitudinally accelerating, while climbing via lift. There is no reason now to move the stabilators 18 or the flaperons 22 unless we need to pitch the aircraft up or down or increase lift or lift drag, for normal reasons which are well known in the aeronautical arts (the aircraft is just an airplane now). However, at this point, or a little before it or after it, if the aircraft is not aimed directly at its destination, the flaperons on each side of the aircraft can be oppositely pivoted like shown in FIGS. 10C and 10F to roll the aircraft. For instance, to turn right, the flaperon 22 on the right-hand side pitches down while the flaperon 22 on the left-hand side pitches up. Meanwhile the rudder 17 pivots to yaw the aircraft, and this is all well known in the relevant arts. This is just how most aircrafts turn, but like a military jet, we are using flaperons instead of ailerons. Anyway, the turn to adjust the aircraft's heading will be brief and might have to be repeated a few times elsewhere within this application due to wind gusts or the Jetstream concerns or other contingiencies. But in all events, prevailing environmental data and kinematic factors should be processed by a computer to minimize the number of turns performed during a flight. It is possible that there will be some small turns required during descent and approach to the landing site. However, the point here is to make a huge majority of the flight, especially all the high-airspeed portion of it, happen along a very straight line. This minimizes travel time, energy consumption, and wear on the aircraft's surfaces and moving parts.

At some point the impeller system shuts off (either nearly or completely) and the aircraft begins to lose altitude and airspeed. FIG. 10F shows a strategy for controlling the descent of the aircraft. The aircraft at this moment has an enormous amount of energy (potential and kinetic) and so we can't trade off speed for altitude in the traditional manner. We will now try to use the flaperons as flaps once the airspeed has gotten low enough to allow this. The stabilator can pitch down at this point (FIGS. 10F-10G) to try to plateau the aircraft, keeping it level to significantly reduce airspeed. The Applicant is pretty confident that this solution will be very difficult, and what to do about the descent is murky at this point. A combination of idling the 1^{st} impeller module, pitching up the flaperons, and pitching down the stabilator is pretty much all that can really be said for this at the time of filing. The Applicant is exceedingly hesitant to say that the aircraft could just perform an unpowered descent, either with none of the strategy proposed herein, or even with it, because the aircraft might accelerate uncontrollably while dropping to altitudes where it would experience intense thermal stress and possible catastrophe (the parachute cannot help). There could be detrimental issues with using the flaperons to increase lift at supersonic speed anyway, so this discussion cannot get bogged down in these solutions, because they are not available to the Applicant at the time of filing. It might be possible to just pitch the stabilator down (it might have to be mechanically or thermally reinforced just for this purpose) more and more and keep the aircraft pointed up somewhat so that it could just “plane out” at high altitude, meaning it would keep trying to maintain altitude by turning itself into a reaction surface, and thus use the lift drag on the stabilator (whose lift is now directed downward) to slow the aircraft. Using this strategy might require that stabilators be placed in a cantilever fashion, outward away from the vertical stabilizers 25, instead of between them. It is possible that if we pitch up the flaperons, with or without pitching down the stabilator, the shock wave off of the top of the wings would simply be an energy drain that according to Newton's 3^{rd} law would necessarily result in a loss of kinetic energy by the aircraft. This shock wave would hopefully go up into space and thus be innocuous. Or so it is hoped in this non-preferred embodiment, because the Applicant has come up with better solutions elsewhere within this application, and is only leaving in this paragraph for full disclosure. So we have somehow got ourselves talking about FIG. 10G, which is nice because now things get simpler again.

FIG. 10G is the first step in the normal (non-extreme-scenario) deceleration of the aircraft. Regardless of how we get the aircraft's energy down to the point where it is at a reasonable altitude and subsonic airspeed, we will at some point use the flaperons 22 and the stabilator 18 to become passive air resistors. They are pitched to the positions shown in FIG. 10G and, as is well known in the airline industry, they thereby both create lift in opposite directions while also keeping the front of the aircraft pointed forward, and the lift results in lift-induced drag that will slow the aircraft. The further they pivot toward the vertical extreme (i.e. FIGS. 10A and 10H) the more they create regular ole air drag. How far we can push this depends on material constraints (how much do we want to put into reinforcing these elements and the shafts they pivot on?) and how much the aircraft will shudder when we try it. So, we'll forgo discussion of this because it has its own known and well-defined realm of literature and industrial expertise already in place to solve it. We do, however, want to slow the aircraft down as quickly as possible (the later we wait to slow it down, the more geographical distance it will have covered in a given amount of time). FIG. 10H shows an extreme state of the flaperons 22 and stabilator 18, used at the end of the descent when it is safe to keep the drag high at lower airspeeds. If the aircraft is going 400 mph and coming in on its destination, we probably can't just keep the stabilator and flaperons at the position shown in FIG. 10G without blowing past the destination. The positions shown in FIG. 10H can or might not be maintained during the vertical drop. It doesn't seem to matter much at this point.

FIG. 11A shows a side view of the aircraft to establish a reference for the forward-facing cross-sectional views 11B and 11C, while 11B shows the annular volute 150 from the rear allowing an understanding of the front stabilization valves and ducts, and FIGS. 11C-11H show the thrust ducts (and the floor of the aircraft, not labeled) along their longitude allowing an understanding of the rear stabilization valves 43A-43F.

So FIG. 11B is an alternative image of the annular volute 150 borrowed from FIG. 4. If it can be remembered from so many pages ago, the air exhausts from the 1^{st} impeller module's 2^{nd} diagonal fans are traveling in opposite rotational directions around the two annuli that are conjoined at a point where they branch away from their respective annuli and merge at/upon the elbow duct 7. The air on the left-hand side annulus is traveling clockwise, and the air on the right-hand side annulus is traveling counterclockwise. Shown at 41 are front stabilization valves that, when open, scoop air out of the annuli and allow that air to enter front stabilization ducts 42A, 42B, and 42C. When not open (configuration not shown in the figures), the front stabilization valves 41 have an arcuate-panel shape that is flush with the outer walls of the annular volute 150 and continue the walls' shape so that they do not disturb the flow therein. The front stabilization ducts 42A, 42B, and 42C lead to the top, side, and bottom, respectively, of the aircraft at which points the air in the annuli gets ejected out at high speed and this is portrayed with the arrows of FIG. 11B. As the annular volute 150 is near the front of the aircraft, using the left duct 42B will yaw the front of the aircraft to the right, while using the right duct 42B (not labeled because the system is bilaterally symmetrical, everything on the left is the same on the right) will yaw the front of the aircraft to the left. Using the bottom left duct 42C and the top right duct 42A (not labeled) will roll the front of the aircraft in a clockwise direction while doing the opposite will roll the front of the aircraft in the opposite (counter-clockwise) direction. Using both the left and right bottom ducts 42C simultaneously will pitch the front of the aircraft upward relative to the rear of the aircraft, and using both the left and right top ducts 42A simultaneously will pitch the front of the aircraft downward relative to the rear of the aircraft. Using the side front ducts 42B simultaneously should probably be avoided unless the impeller system needs to bleed off air for some reason.

FIGS. 11C-11H show a cross-sectional view marked as 11C in FIG. 11A, and it looks forwardly along the longitudinal direction of the 2^{nd} impellers' axes and parallel to the exhaust ducts 14 and the floor of the aircraft (not labeled). The reader should imagine the air coming rearwardly, out of the page, in the boxes 14 (FIG. 11H) that depict the 2^{nd} impeller module exhaust and which are also the thrust ducts. There are valves for scooping this air and ejecting it laterally upward, downward, and laterally, and the system is similar to the front stabilization valves 41, except it doesn't need stabilization ducts because the walls of the thrust ducts 14 constitute the actual walls of the aircraft at the point where this is to be done. There are many ways to do this, so, we'll just use the simplest example of a flap that is hinged at its rear edge and can pivot its front edge inwardly to a slight angle, such that any air that hits it at high speed will be deflected laterally outwardly away from the airstream in the thrust duct 14. So, as shown in FIG. 11C, a rear stabilization valve 43A can open to yaw the aircraft to the right. Rear stabilization valves 43B and 43C can open simultaneously to yaw the aircraft clockwise as shown in FIG. 11D. Rear stabilization valves 43D and 43E can open simultaneously to roll the aircraft counterclockwise as shown in FIG. 11E. Rear stabilization valves 43B and 43E can open concurrently to push the rear of the aircraft downwardly relative to the front of the aircraft per FIG. 11F, while rear stabilization valves 43C and 43D can be open concurrently to push the rear of the aircraft upwardly relative to the front of the aircraft as per FIG. 11G. Rear stabilization valve 43F can be open alone to yaw the aircraft to the left. It is noted that rear stabilization valves 43B and 43E will have above them a complimentary ejection passage that accepts their air from them and conducts it up through whatever structure is above them to ejects their exhausts upwardly.

As should be becoming obvious to the reader, a proper coordinated utilization of the front stabilization ducts 42A-42C and rear stabilization valves 43A-43F can be implemented to completely and actively control the aircraft's attitude in all six degrees of freedom, even in the face of adverse wind conditions or unintended pitch/yaw/roll of the aircraft. It either can immobilize the aircraft against unanticipated shoves and wind gusts, as well as against Coriolis (say an impeller module or just a fan is not operating properly or shut down), or it can twist and turn the aircraft during the vertical climb to accomplish feats that otherwise are not aeronautically possible. These ducts and valves could perform various ancillary functions that are too numerous to list here. It is envisioned that the stabilization system just described will be most important during the takeoff from and landing on a horizontal surface within the few seconds that occur between the contact with the ground surface and when the aircraft is going fast enough to be inherently aerodynamically stable. However, the stabilization system needn't be reactive. Perhaps it could be useful for augmenting the normal movements of the aircraft when desired.

### Thrust Vectoring

FIGS. 12A-12F depict a series of side views of the aircraft with everything missing except the profile of the aircraft, the impeller modules, the longitudinal duct (all these items being not labeled because they have been discussed ad nauseum already), a thrust vectoring nozzle 30, and the stabilator 18, wherein the stabilator 18 and the thrust vectoring nozzle 30 are depicted in the various neutral, intermediate, and extreme positions they might move to/through during a typical flight.

FIG. 12A shows the aircraft in a normal flight state wherein the thrust vectoring nozzles 30 (one on each side of the aircraft) are the termini of the thrust ducts 14 or otherwise known as the 2^{nd} impeller module exhaust ducts 14 (see FIGS. 1A, 1B, 1C, 5B, 5C, 5E, 7A, and 11H). In FIG. 12A, the thrust vectoring nozzles 30 are neutral. They both, on each side of the aircraft, aim the thrust of the thrust ducts 14 directly rearwardly along a horizontal plane, for simple forward thrust (thrusting the aircraft in the longitudinally forward direction). The thrust ducts are therefore in this instance straight and there is nothing really going on.

FIG. 12B depicts the thrust vectoring nozzles 30 vectoring the thrust somewhat upward, which will impart a clockwise torque (in the view of FIGS. 12A-12F) about the center of mass of the aircraft, meaning in this instance that the torque (if both thrust vectoring nozzles on both sides are in the same configuration) will tend to pitch up the front of the aircraft.

FIG. 12C depicts the thrust vectoring nozzles 30 vectoring the thrust somewhat downward, which will impart a counterclockwise torque (in the view of FIGS. 12A-12F) about the center of mass of the aircraft, meaning in this instance that the torque (if both thrust vectoring nozzles on both sides are in the same configuration) will tend to pitch down the front of the aircraft.

It is noted that in FIGS. 12B, 12C, 12D, and 12E, the chord line of the stabilator 18 is parallel to the thrust vectoring nozzles' outlet vector throughout (not labeled but obvious), such that the stabilator 18 is performing a similar torque around the center of mass of the aircraft but using the passing air, to complement the torque of the thrust vectoring nozzles 30, or to be complemented by it. Meaning, when the thrust vectoring nozzles 30 are torquing the aircraft in a rotational direction (pitch up, pitch down), the stabilator 18 will be matching the torquing action by being substantially parallel to the thrust vectoring nozzles 30, but this is not necessary or always the case; it might be preferred that the stabilator chord line angle be more pronounced than the thrust vectoring nozzles' outlet vector, or vice versa. However, the preferred relationship for this cannot be determined previous to the time of filing. The combination of the matched actions will be meaningful but is not entirely required in the embodiments proffered in this application.

It is possible that at very high airspeeds and/or altitudes the flaperons will not be available for use as ailerons, for reasons not understood completely by Applicant, but still a potential problem. In this case, we can avail of the thrust vectoring nozzles 30 to roll the aircraft like ailerons would, without worrying (hopefully) about aeronautical concerns. This can be accomplished by twisting the thrust vectoring nozzles, such that one side torques up and the other side torques down. To visualize this, during a left turn the configuration in FIG. 12B is used for the left side, with the thrust vectoring nozzle 30 aimed a little up, so as to dip the left side of the aircraft downward, and the configuration in FIG. 12C (as if we could see through the aircraft) is used for the right side, with the thrust vectoring nozzle aimed a little down, so as to lift the right side of the aircraft upward. Anyone knowledgeable with ailerons will understand the meaning of this. The reciprocal scheme will be used for a right turn. This is possibly important at very high speeds and also at very low speeds. Who knows. Anyway, it is herein proposed that independently manipulable thrust vectoring nozzles (one side up, one side down) can be used to perform roll on the aircraft to change or offset its orientation during certain transient or outlier states. Also, the stabilization nozzles and ducts 42A-42C and 43A-43F (from FIGS. 11A-11H) can be used in conjunction with the foregoing scheme to augment or complete this activity which might be important in conditions where the airspeed is extremely high or extremely low. The activity and effects of the rudder (or stabilator or flaperons) might also be rendered useless or inefficient in extreme circumstances, and in this case we can use the stabilization nozzles and ducts 42A-42C and 43A-43F from FIGS. 11A-11H to directly accomplish the actions/forces that the flaperons, stabilator, and rudders might not be able to do in such extreme cases.

At FIG. 12D, things become a little more paramount apropos the functionality and the desired outcome. This is the configuration of the thrust vectoring nozzles 30 and the stabilator 18 when the aircraft is performing its vertical climb, but (as described previously) even though it is trying to go straight up vertically, the lift across its fuselage and wings is trying to bend the aircraft's trajectory away from the intended vector. Of course, before we got here, the configuration of FIG. 12C (on both sides of the aircraft, meaning both thrust ducts 14) will have been used to offset the lift in a lower-speed precursor situation. That discussion has been omitted because it is the same as what we will describe now, but to lesser effect. The aircraft is moving straight up, as per FIG. 9P, but it is pitched over a little because to keep moving up, it must be pitched somewhat down toward the destination, for reasons of unwanted lift (described before). So, the aircraft is bent over a little, away from the vertical and toward the destination, but the resultant agents upon its overall vector render its vector unequal to its attitude, but it still needs to go up. So, the thrust vectoring nozzles point straight down while the aircraft is canted a little toward the horizontal but its rise is still completely vertical. This is optimal. Or it is also possibly what we are left with and we're making the best of things. Meaning, at FIG. 12D, the stabilator 18 and thrust vectoring nozzles 30 are precipitously aimed downwardly at 10-25 degrees while the aircraft climbs.

At 12E, we are really bending the aircraft over, away from its vertical climb and transitioning it from vertical to substantially horizontal flight. The torques around the aircraft's center of mass created by the thrust vectoring nozzles 30 and the stabilator 18 are very high. The aircraft is forced to flatten out, albeit not very quickly (likely not less than 10 seconds). The stabilator 18 and thrust vectoring nozzles 30 are both at an extreme angle designed to forcefully crank the aircraft toward the horizontal and away from vertical climb.

At FIG. 12F the thrust vectoring nozzles 30 are shown as aimed straight down vertically toward the earth (now described as nozzles 30A). If this is practicable, it could obviate the VTOL valves, or complement them. The thrust vectoring nozzles 30A have simply in this case been modified to be able to create the rear downward exhausts/thrusts by different means, but this might be preferable because they could keep the rearward exhaust always aimed at the ground without splitting it up, and this might be preferable during certain takeoff or landing scenarios, not described herein.

### Supplementary Battery (Booster) Modules

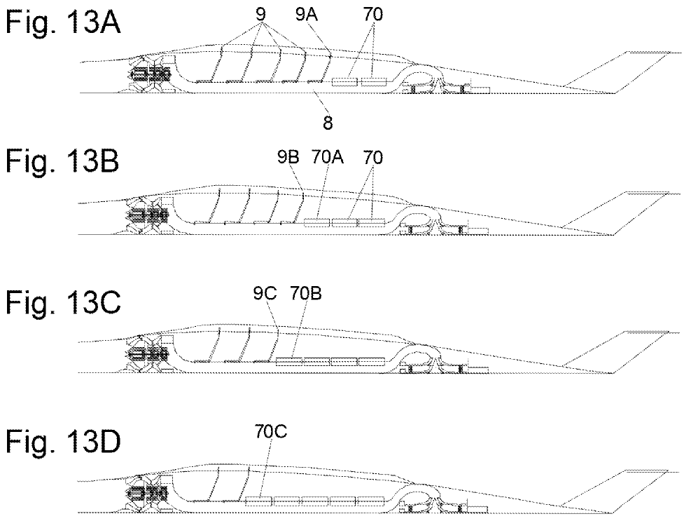

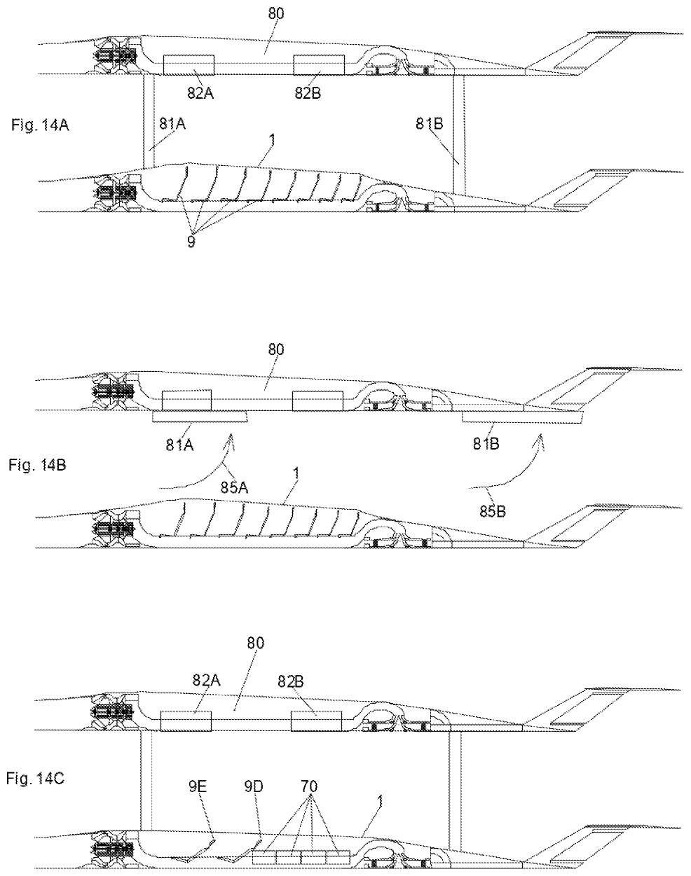

FIGS. 13A-13D illustrate a series of side views of the aircraft 1 with everything missing except the profile of the aircraft, the impeller modules, the longitudinal duct 8, the seats 9, and supplemental battery modules 70, wherein FIG. 13A shows two sets of supplemental battery modules 70, FIG. 13B shows three supplemental battery modules 70, FIG. 13C shows four supplemental battery modules 70, and FIG. 13D shows five supplemental battery modules 70.

FIG. 13A shows the aircraft 1 from the left side wherein four of the rear-most seats (two on each side) have been removed in order to install two supplemental battery modules that each saddle the longitudinal duct 8, with a battery pack on each side of the longitudinal duct 8 and the paired battery packs connected to each other by a yoke (not shown) that spans the top of the longitudinal duct 8, and the modules are selectively locked in place but removable via quick-change means (rapid fasteners, quick-release elements, etc.) and portable enough that they can be dropped in and pulled out by workers or a hoist, either individually or by yoked pairs. In FIGS. 13A-13D, each seat-pair removal is associated with the addition of a supplemental battery module. So, in FIG. 13A, there are ten seats 9 and two supplemental battery modules 70, and the ten seats 9 include two rearmost seats 9A. In FIG. 13B, there are eight seats 9 and three supplemental battery modules 70. The rearmost seats 9A from FIG. 13A have been replaced with a new, third battery module 70A, and now the rearmost seats are 9B. In FIG. 13C there are six seats 9 and four supplemental battery modules 70. The rearmost seats 9B from FIG. 13B have been replaced with a new, fourth battery module 70B, and now the rearmost seats are 9C. Finally, in FIG. 13D there are four seats 9 and five supplemental battery modules 70. Here the rearmost seats 9C from FIG. 13C have been replaced with a new, fifth battery module 70C.

Via the method shown in FIGS. 13A-13D and described in the previous two paragraphs, or some similar strategy or even a radical alternative to it, such various schemes being obvious to anyone possessing a little creativity, the aircraft can achieve longer ranges by exchanging passengers (or cargo weight) for battery modules, either incrementally, or non-incrementally. It doesn't have to be a 1:1 or 1:2 or regular exchange. For each increased geographical range desired, the quantity of passengers can be reduced to allow more supplemental battery modules to be added. All the foregoing is meant to illustrate one of many possible booster systems wherein payload-mass can be decreased to allow for more battery capacity, and thereby more battery minutes, and thereby longer ranges. More ranges for fewer people is probably usually better than stuffing the same 16 people into the same aircraft and using elaborate external booster schemes, or multiple hops, to convey those 16 people to the far-off place. However, the option of using elaborate external booster schemes is also discussed herein, both in the summary of invention and in later portions of the detailed description, so we won't disregard the possibility. In fact, it is likely possible to combine the internal booster system (less-passengers-and-more-supplemental-batteries) with an external booster system (an attached passenger-less clone of the aircraft that is stuffed with batteries, impeller systems, and ducts, but can detach and return to the launch area by itself) to easily get a few people across great distances (East Coast to West Coast, New York to London, etc.) using the teachings of this application, in a single flight. Obviously, as has been shown by multi-staged rockets used for space travel, we could conceivably keep adding external boosters to indefinitely increase the range, since in a preferred embodiment each n^{th} stage would be powering all of the impeller modules of the aircraft and of every booster stage until each said n^{th} stage disconnected and went back to its originating airfield or to another airfield.

FIGS. 14A-14C illustrate the aircraft 1 with an external booster module 80 attached to the aircraft via detachable struts 81A and 81B (detachable from the aircraft 1 but pivotably fixed to the external booster module 80), wherein the external booster module 80 is a payload-less clone of the aircraft 1 and it comprises instead of seats 9 two very large and powerful supplemental battery modules, including a front battery 82A and a rear battery 82B, which are like the supplemental battery modules 70 from FIGS. 13A-13D, but much larger. However, it is conceivable that any number of batteries, shapes of batteries, locations of batteries, etc. could be used without departing from the scope of the invention. Applicant has chosen two instead of one, wherein one 82A is near the front of the aircraft and the other 82B is as far back in the payload/cabin area as it can be put, in order to increase as much as possible the moment of inertia around the lateral and vertical axes, and also such that the front of the external booster module 80 will not be excessively heavier than the rear, or vice versa. It is possible that in the embodiment shown in FIGS. 14A-14C, the front battery 82A could be smaller and/or less massive than the rear battery 82B, and this is primarily because the VTOL valves that create the rear downward exhausts are behind the 2^{nd} impeller module, far behind the rear battery yet the front downward exhaust is close to the front battery, and we need to have a relative torque balance around the center of mass.

The front and rear batteries 82A and 82B can be removable or repositionable or whatever is needed to make the external booster module 80 efficient, adaptable, and stable. By “clone” the Applicant means that the external booster module 80 can be very similar to the aircraft in every way, such as by having the same 1^{st} impeller module, 2^{nd} impeller module, ducts, wings, empennage, VTOL elements, control system, etc. Of course this is not necessary and could actually in certain cases be overly limiting or underleveraging. However, it makes much sense for a starting point, because in a prototype the same method and equipment that were used to make the aircraft 1 can be used to make the external booster module 80. Once the aircraft has proved to be reliable, no additional designing, modeling, or testing are needed to make a booster module. Also, when the proposed aircraft/booster modules are run up for production, the external booster module can be produced by the same machines that make the aircraft without any new design considerations.

To begin with, unlike the smaller booster concepts delineated in the summary of invention, this external booster module is intended to remain coupled to the aircraft through the entire vertical climb, bend-over-to-horizontal, and acceleration to cruise airspeed phases of the flight. Therefore it needs to be capable of sustained supersonic flight, and it needs to be able to turn around and go back to its destination, or another place, once it is done with its mission, and land itself in a convenient place for reutilization (including wing/battery exchange).

While the external booster module 80 is attached, both the external booster module 80 and the aircraft 1 are running all their impeller modules at maximum power, or at the power requisite for optimal flight at every stage of flight that the aircraft finds itself in, but, importantly, the electrical energy is deriving only from the external booster module 80. For instance, not that the power needs to be split or assigned in any prescribed manner, but for discussion and illustration purposes this can be helpful to imagine, the wing batteries of the external booster module 80 can drive the external booster module's impeller system, while the supplemental battery modules (front and rear batteries) 82A and 82B of the external booster module 80 can be powering the impeller system of the aircraft 1. In this way, the aircraft's batteries during the boosted mode are idle and do not begin to be depleted until the external booster module 80 detaches from the aircraft 1 and returns to the launch area (airport/airfield) or to another airport/airfield.

Of course, at least one of the detachable struts 81A and 81B will have robust electrical wiring to transfer electrical power from the external booster module 80 to the aircraft 1 and the aircraft 1 will have decouplable physical mating connections on top of it (or below, if the external booster module 80 is to be located under the aircraft 1) with robust electrical fixtures/adapters for receiving power from the external booster module 80, since the aircraft 1 should be getting most or all of its electrical energy from external booster module 80 when they are joined.

When the struts 81A and 81B are detached from the aircraft 1, there are many options for dealing with them while the external booster module 80 returns to earth, such as tucking them into the external booster module, or just leaving them sticking out/down. Both when attached to the aircraft 1 and when detached from it, the external booster module 80 in this example will operate identically to how the aircraft 1 would operate, meaning it can perform a 180-degree turn, travel back at high altitude toward its origin point, slow down, descend to the origin point, slow down some more, and land there, as if it were the aircraft itself, since it will probably comprise the same elements (except for seats, etc.) as the aircraft and will be autonomous or remotely controlled.

Although there should be no limitation on the various means for detachably coupling the external booster module 80 to the aircraft 1, FIG. 14B shows how the simplest embodiment would uncouple. In FIG. 14A the struts are vertical and mechanically and electrically join the externa booster module 80 to the aircraft 1, and in FIG. 14B the struts have pivoted up (shown via arrows 85A and 85B) to rest against the bottom of the external booster module 80 in a manner wherein they are parallel to the longitudinal axis of the booster module. It is mentioned in passing that the struts should be long enough such that the aerodynamic side-effects the aircraft 1 manifests in the passing airstream do not interfere with the performance of the external booster module 80, and the aerodynamic side-effects that the external booster module 80 manifests in the passing airstream do not interfere with the performance of the aircraft 1. Also, the struts could be diagonally configured such that one of the aircraft 1 and booster module 80 is positioned farther forward than the other, if it is discovered that this augments the aerodynamic performance or the mechanical functionality of the overall system.

FIG. 14C is basically a hybrid of FIGS. 13D and 14B. The aircraft 1 only carries a few (i.e. 4) passengers so that it can be provided with a lot of supplemental batteries 70, and it has an external booster module 80 fully loaded with more supplemental batteries 82A and 82B. Both the aircraft 1 and external booster module 80 have a full complement of wing batteries as well. So, the battery-to-passenger ratio has been maximized and this maxed-out version (technically it is not maxed out because more external booster modules could be stacked on top of or under the ones shown via additional, identical pairs of struts 81A and 81B) should be able to carry the few people a much greater distance than the embodiment shown in FIGS. 1A-1B. In fact, it is probable that it can carry the 4 people as much as 5-12 times as far as the main embodiment of FIGS. 1A-1B. It is noted in passing that the solutions shown in FIGS. 14A-14C have been designed for the launch tower (airport with a takeoff ramp or rails that guide the aircraft more or less vertically during its initial takeoff) mode of takeoff. In the event that someone were to try to use them for a vertical takeoff from a landing pad or a field, the system could be modified accordingly such that the front and rear vertical exhausts of the external booster module could be made to impinge the ground either around, next to, or behind the aircraft 1 somehow. However, this option has not been explored in the present application, because although the Applicant can foresee that it might be useful in some environments, it is just not worth going into here.

FIG. 14C provides us an opportunity to reimagine the current invention as a long-haul or luxury vehicle. It puts a lot of mechanical elements, mass, and energy into conveying just a few people, but the passengers would not have to deal with the extra complexities and preparations that the aircraft (and ground crews and logistics staff) would be burdened with before and after a flight. Just like the regular version, the passengers would just step in, sit down, go, and after some small passage of time get out, but at a greater monetary expense. Yes, the cost per flight would be much higher, but the amenities and advantages would be well worth it. To begin with, the seats 9E and 9D can be reclined to increase comfort and to reduce the height of the aircraft, perhaps allowing a greater airspeed. As a luxury/long-haul vehicle, it would allow wealthier or time-pressed individuals (or simply families or groups) to travel great distances in just a single 20-50 minute trip without suffering any of the delays or discomfitures of conventional air travel or the lesser hassles of having to keep stopping at successive airfields/airports for new wings and/or booster modules. It is foreseen at the time of filing that a mobile airborne battery swapping airship, or a fleet of such, could enable nonstop unlimited travel, or that the booster module 80 once it drops off could be immediately replaced by another, second booster module 80, in-air, that had been itself boosted by a third booster module to be in position to join up and couple itself to the aircraft, and this as could although with difficulty be indefinitely maintained by ground support such that, again, unlimited nonstop commercial air travel could be made a reality.

Thus it is proposed that we are now herein offering to the world the first round-the-world nonstop supersonic passenger air travel service known to man, albeit one that relies on a bevvy of crutches and logistical supports. The Applicant has kicked around several ideas for the futuristic ideas proposed in this paragraph, but he simply does not have the time to keep adding more and more to this application, it being overly voluminous already. Anyway, the simplified summaries put forth herein should be enough for the public record to have been established that methods for nonstop unlimited air travel exist now, and many obvious and non-obvious inventions will hopefully spring from these paragraphs by the efforts of others or, if he lives long enough, by the Applicant himself.

It is starting to become obvious that the more the Applicant discloses, the more options keep appearing that could be explored. Especially when it comes to battery boosters (internal and external), but overall as well, there seems to be no limit on how many ways, and how far, this invention can be extrapolated. At some point soon the Applicant is going to have to stop typing and file this application, but it is evident that the progress along these lines only depends on the mental energy that is invested in them. This application should by no means be considered the definitive account of this new type of device, this new industry, this new way we will travel. Once one of these (a prototype) has been made to fly from one place to another, the rate of change (advancement and investment) should accelerate parabolically, as more investors and engineers turn their attention to it. However, short of saying that the Applicant apologizes for not publishing more at this time, we have reached a point in history where the exigencies of publishing this application immediately, both as pertains to the Applicant himself and to the world in general, are overtaking the need for more disclosure.

### Other Elements and Views

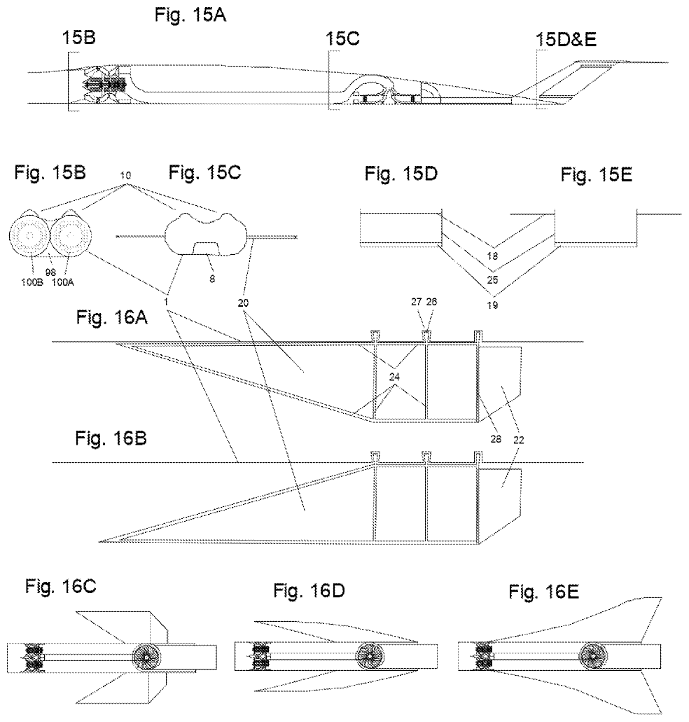

To begin to wrap up the device of the invention per say, FIG. 15A shows a side view of the aircraft, copied from FIG. 1A, to establish a reference for the forward-facing cross-sectional views of FIGS. 15B-15E that show frontal (rear-facing) views of the aircraft at various longitudinal cross-sections.

FIG. 15B is such a view taken from a cut-away of the aircraft 1 longitudinally between the swirler 90 (not shown) and the 1^{st} impeller module 100, and because we are looking backward toward the rear of the aircraft, the left-front impeller sub-module 100A is on the right-hand side and the right-front impeller sub-module 100B is on the left-hand side in this figure. The impeller sub-modules 100A and 100B are shown for the first time in this application as comprising vanes. The 1^{st} impeller module 100 has been discussed ad nauseum in this application, so all that will be said here is that this could be what it looks like when viewed from the front (from the vortex chamber, 94, really). FIG. 15B has been primarily provided to show what the outline or profile of the aircraft 1 will be like at this longitudinal point of the aircraft, and although the head humps 10 do not protrude up from the profile at this longitudinal point, they are shown to be peeking up from the aircraft at a point behind the profile. This has been done for the reason that other than FIG. 1A, there really has been no other opportunity previously in the application to depict them in a way that, with reference to FIG. 1A and FIG. 15B, a reader can now, with FIG. 15B extant, imagine exactly how they are intended by Applicant to be manifested in the present application.

As also described previously in the application, the roof of the aircraft between the head humps 10 and/or between the left- and right-front impeller sub-modules 100A and 100B dips down (is concave-upward) to allow air to pass longitudinally and uninhibitedly along the center of the top of the aircraft, in order to reduce air displacement around the aircraft, which reduces form drag, and also to create an inherent lift force by means of the passing air, a portion of which (that portion passing between the head humps) will be vertically and passively displaced several (i.e. 10-20) inches downward between its ingress point at the space between the tops of the front impeller sub-modules and its egress point at the space between the vertical stabilizers 18 (FIG. 15D). It is noted that the lower area (near reference numeral 98), between the bottoms of the front impeller sub-modules 100A and 100B, is not recessed in such a way, for various reasons well-known and obvious to practitioners in the art. The bottom of the aircraft will be flat here and as the vortex chambers should probably be barrel-shaped, this dead space 98 should be walled off. This walled-off dead space 98 by no means should be unutilized. By proper geometrical and material selection of its walls and frame, this space could be used as a radome and would likely and advantageously be the housing for various radar, Lidar, RF antennas, optical devices, sensors, wire harnesses, pitot intakes, the list goes on and on. The Applicant concedes here that this could put material constraints on the swirler 90 and/or the front 2 of the aircraft that might not be inconvenient (their front edges might need to be made from metal), but these contingencies are better left for further research. Their discussion does not belong here.

Moving on to FIG. 15C, which illustrates a cross section taken from the cutaway 15C shown in FIG. 15A taken from between the cargo/cabin and the 2^{nd} impeller module 200, or more specifically from the longitudinal point at where the torsos of the rear-most passengers would be, although these and also the seats 9 have not been shown. Although not obvious, the vertical height of the fuselage is reduced from that in FIG. 15B. Also unlike FIG. 15B, which is taken from an area longitudinally forward of the fronts of the wings 20, the cutaway used for FIG. 15C is right at the point where the wings 20 are their longest, such that they have been shown at 20, one on each side extending oppositely in cantilever fashion from the aircraft 1. The head humps 10 are still extant at this longitudinal point but like the aircraft 1 itself, their height is being reduced by being tapered as shown in FIG. 1A (not in FIG. 15A, where the head humps 10 have been omitted).

Although FIG. 15C does not show the seats 9, it is obvious where they should be; one in each of the two wide-open spaces evident in the figure, and most importantly, the longitudinal duct 8 is for the first time in the application shown in longitudinal cross-section, residing neatly on the floor of the aircraft and protruding upward therefrom, such that it is hollow and air passes, from the point of view of the reader, into the page and toward the 2^{nd} impeller module 200 (not shown). The Applicant has taken this opportunity to show a non-rectangular geometry for the hollow body of the longitudinal duct 8, as a hint that there is no required form for it. It could be rectangular, or like the figure but even more pronouncedly trapezoidal (narrower at top and wider at bottom), or just simply wider at its base, to handle a wider 2D expanse of air. The most important point here is that it should not encroach on the ergonomics of the seating areas focused around the seats 9. In other words, since the view shown provides ample space for the passengers' heads in the head humps 10, and the shoulders, torso, hips, and thighs, the longitudinal duct should be designed to avoid forcing occupants to sit with their legs twisted or their feet or hips incommoded in any way, and it could have elbow and/or forearm supports atop it. There are only three spaces shown in FIG. 15C, the air outside of the aircraft 1, the air inside the aircraft 1 but not within the longitudinal duct 8, and the air inside the longitudinal duct 8. It is conceived of at the time of filing that the air within the longitudinal duct 8 could be further subdivided for various reasons into longitudinal sub-ducts, and that the passenger space inside the aircraft 1 but outside the longitudinal duct 8 could also be divided up, i.e. for personal privacy or to stop the spread of communicable diseases.

Moving much further back along the longitudinal direction of the aircraft 1 in FIG. 15A we encounter cross-sectional views 15D and 15E at the tail/rear of the aircraft 1 wherein by looking rearwardly along the bracket labeled 15D&E in FIG. 15A we refer to FIGS. 15D and 15E. FIG. 15D depicts the embodiment discussed throughout much of this application, in which the stabilator 18 (temporarily referring also to FIG. 1A) is suspended between two vertical stabilizers 25, each of which protrudes upward from the aircraft rear/tail 19. As can be seen in FIG. 15D, the rear 19 of the aircraft at this point is very short and is smoothly tapering the shape of the aircraft to quickly come to a rear edge, not labeled, in such a way that even at very high supersonic airspeeds, the passing airstream is not allowed to separate from the aircraft's top, and in this way laminar flow is maintained. FIG. 15E shows an alternative, and at the time of filing non-preferred, embodiment wherein two stabilators 18 are provided, each being outboard of its respective side's vertical stabilizer and cantilevered therefrom. It is noted that the embodiments of FIGS. 15D and 15E could be used together, with or without the stabilators being somehow ganged or connected for concurrent movement or even separably actuatable for differential movement. It is also noted that the stabilators of 15E could cantilever from a central unitary vertical stabilizer 25, that the stabilators of 15E could cantilever from another part of the vertical stabilizers 25 or another part of the rear 19 of the aircraft such as the lateral sides/walls. It is also noted that none of these elements need to be at right angles to each other and that a swallow-tail arrangement could also be preferred in order to augment aerial performance but which would complicate braking strategies. In other words, all of the solutions for an empennage known in the prior art are available as a pool of options and none should be discarded, FIGS. 15D and 15E being simply the best modes imagined by the Applicant at the time of filing and by no means should this be seen as limiting the scope of the present application.

FIG. 16A illustrates a single wing 20 cantilevered outward (downward in the drawing) from the body 1 of the aircraft. In this particular illustration, the functional elements of the wings can be addressed and displayed via a few more leader-lines 22, 24, 26, 27, and 28. To begin, each wing 20 will probably require a frame or endoskeleton 24. The Applicant has chosen the maximally robust frame possible, and this is an endoskeleton comprising at least two longitudinal ribs (proximal and distal) and at least two lateral spars, with or without stringers, that support a skin. The front of the wing could include a spar-borne nose rib (which would include very-acutely-angled taper struts) but it is more likely that the best mode would be to fasten/adhere the top skin to the bottom skin at or near the front edge to construct a sharp wedge and locate the front-most spar well behind this to create the acutely-angled taper, allowing this 3D triangular formation to support itself, even though this is not what is shown in FIG. 16A. Although the wings of the current application have been shown and described as represented by the straight mid wing type, they could also be alternatively dihedral, inverted dihedral, gull, or inverted gull wings. These options have not been shown in the drawings because their names alone invoke their exact forms in the minds of practitioners in the field.

FIG. 16A shows how the wings 20 might be removably coupled to the aircraft 1. As mentioned earlier in the application, the best mode proposed by the Applicant at the time of filing is a dovetail connection, or multiple parallel dovetail connections, wherein the wings have male dovetail portions 26 that can be slid into female dovetail portions 27. Although it has been also (earlier in this document) purported that the sliding motion could be longitudinal such that the wing 20 slides along the length of the aircraft 1 with a very long male portion received in a very long female portion, this unpreferred embodiment not only complicates the wing-swap by requiring a large swath of vacant space around the aircraft to achieve, but it is not as strong/robust as the embodiment shown in FIG. 16A. Advantageously, the preferred embodiment illustrated in FIG. 16A comprises two or more male dovetail portions 26 (not individually labeled but obvious), with a front one positioned forward in a longitudinal direction of the labeled one and a rear one positioned rearward in a longitudinal direction of the labeled one. And each (both labeled and unlabeled) male dovetail portion 26 seats in a corresponding female dovetail portion 27 (respectively, both labeled and unlabeled).

In the best mode, the Applicant has shown three dovetail portions, but this is not required. The wing is removed by dropping simultaneously and in parallel the male dovetail portions 26 vertically downwardly into the female dovetail portions 27 such that the former 26 seat in the latter 27, the female dovetail portions 27 having a converging taper or capped-off bottom. Once this is accomplished, a releasable latch, not shown, is actuated either mechanically or electro-mechanically or magnetically such that the wings cannot be removed until an operator or computer releases the latch (not shown). Since the wings in a preferred embodiment cumulatively contain hundreds of pounds of batteries, stuffed in the spaces between and among the ribs and spars, a driven lift-truck or, more preferably, a specialized end effector, would remove, from a succession of passing aircrafts 1, a wing 20 by commanding/effectuating the latch release, lifting the wing several inches while retracting forks or another carrier pivot the entire wing about a vertical elevator shaft while also raising them/it or dropping them/it to the level of a designated storage/charging rack, and then extending the forks or carrier into the storage/charging rack and setting the wing down, at which point the aircraft's electrical connections (likely part of at least one of the male dovetail portions 26) mate with a battery charger/docking station.

FIG. 16B illustrates yet another alternative embodiment of the wing 20 wherein each wing 20 is a forward-swept wing. Although there are many reasons to use forward-swept wings, and also many reasons to avoid using them, the Applicant has proposed them herein basically to avoid not disclosing them as for all their problems they can greatly reduce the size of the wings, which has many benefits. Therefore, it is not unforeseen that they might be one day preferred, however at the time of filing they are not considered the best mode. FIG. 16C shows a top view of the aircraft according to the present invention with forward-swept wings as per FIG. 16B, while FIGS. 16D and 16E illustrate top views of other possible shapes for the wings, and in passing it is proposed that a delta wing is not out of consideration. There are many wing shapes being currently in the relevant arts researched for high-supersonic aircraft and although the most extreme of them do not need to be considered because the present aircraft does not need to take off or land on a runway or even experience supersonic flight at low altitude, many of the attributes of some of the wing geometries available for perusal on the internet could be borrowed to create a perfected aircraft, at which point we simply have not arrived to yet.

### Guided Vertical Takeoff

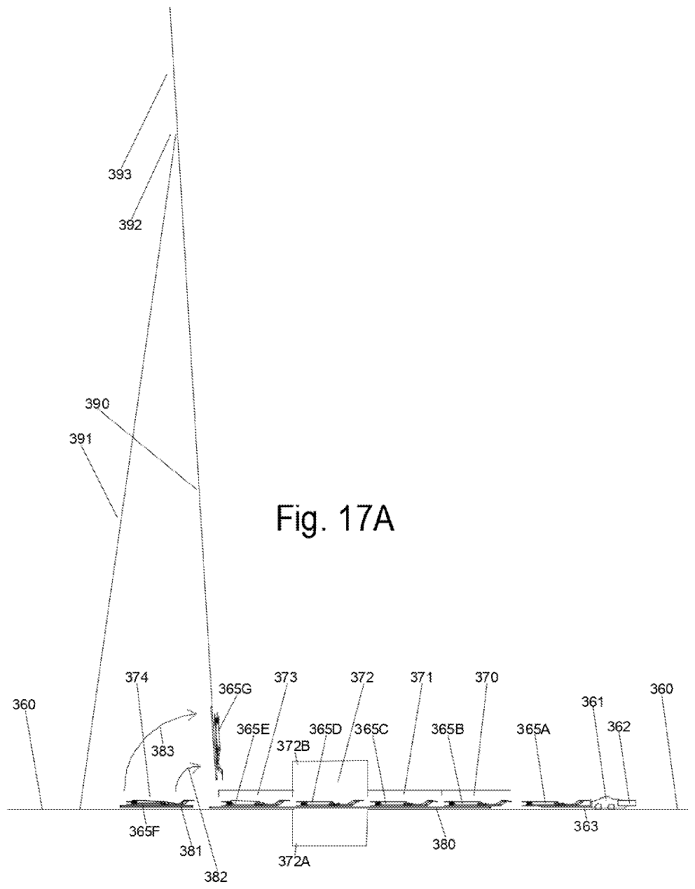

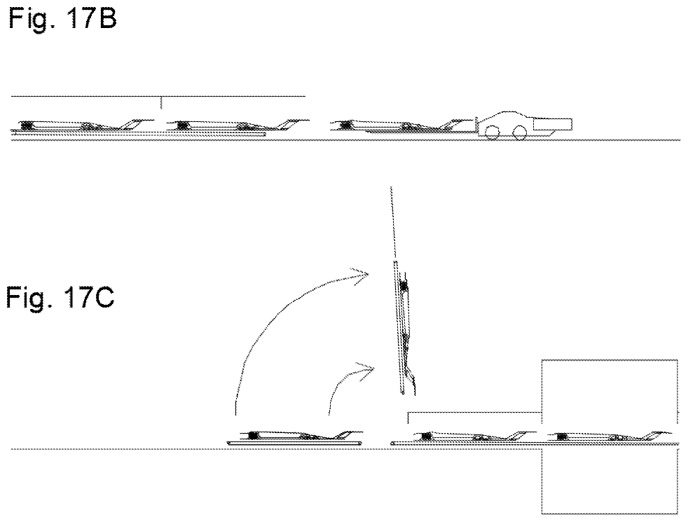

FIG. 17 is an airfield/airport and it has an area (wing-swap room) 372 for battery swapping, and this is where the battery-swap mechanism/process being discussed now should be seen to be taking place. Of course, while one wing is being manipulated in such wise, the opposite-side wing will be put through the same movement regimen by an opposing set of forks or a carrier (or end-effector). On each side the so-called “rack” would be part of a movable vertical array of many racks that simultaneously charge/dock many wings, and a computer would not only automate much of the process in a preferred embodiment, it would keep track of the charging statuses of the batteries in each rack space and would manage the inventory in the most effective way such that a spent aircraft should always have waiting for it pair of fully charged batteries. It is noted that wing-swap room 372 in FIG. 17 has a subterraneous portion 372A where, as mentioned in earlier theoretical discussions, the rack could extend downwardly such that 372 need not be a tall tower with high racks that require the forks/carrier to travel great distances between the level of the aircraft and the highest racks.

However, we can't move to FIG. 17 until we finish with FIGS. 16A-16E. FIG. 16A includes along the rear edge of the wing front portion 21 (FIG. 1A) a flaperon 22, and as shown in FIG. 16A the flaperon 22 is hinged to the wing front portion via a flaperon pivot shaft 28, which could be unitary or housed within or supported by a rear-most wing frame (spar) 24. The motion of the flaperons 22 has already been discussed so we won't go further into it here, except to state that this shaft 28 inherently facilitates all previously and latterly discussed movements of the flaperons 22.

FIG. 17A shows an embodiment of a novel airport or processing station for taking in an endless succession of aircrafts by accepting them at the right-hand side at unloading bay 370 and conveying them through the airport or processing station, respectively from right to left, and successively through debarkation room 371, a wing-swap room 372 (already discussed in part during the discussion of FIG. 16A), and an embarkation room 373, and delivering them to a launch tower 390 whence they (the successive aircrafts) exit the airport (processing station, meaning all of FIGS. 17A-17C).

Before beginning a complete discussion of FIGS. 17A-17C or their component parts, it is important to step back and have a general discussion of takeoff and landing. As already described in this application, the aircraft 1 can land vertically after slowing down to a stop at a point above the desired landing zone. This lends itself to a wide opening-up of the constellation of possible aircraft handling/processing protocols. To begin with, no matter what happens to the aircraft or where it goes, it has the (safety) ability to land almost anywhere (in an emergency or at a scheduled destination) such as in a field (lawn or clearing, parking lot, disused road, etc.) near or within a city, town, industrial park or resort, or even more advantageously on the roof of a leisure, mass-transit, or commercial installation or a gas station. These foregoing scenarios as numerous as they are we will take for granted as adaptations for future use. Said foregoing scenarios do not prescribe in the positive mode or proscribe in the negative mode any realm of continued uses of the aircraft, as this application has merely provided a best mode for taking off from a standstill without any type of crutch. However, such a wanton takeoff, although appealing, suffers the drawbacks of requiring stand-alone logistical support (workers with skid-steers or forklifts to move batteries around, etc.) and of using extra battery power to take off. Still, it is useful and will surely be used in humanity's future in some specialized environments.

However, it is in the interest of the field of endeavor to design a clearinghouse facility for collocating every auxiliary of the aircraft's environment, everything that the aircraft uses, conveys, acquires, disgorges or hooks up to or that supports the aircraft that is not the aircraft itself. There are myriad possibilities in this vein and the Applicant cannot nor does he wish to provide a definitive list of them. This pursuit will be fun to explore and to observe not only for its designers but for the passengers and the public at large, and could incorporate any conceivable avenues of architecture and aerospace, mechanical, and civil engineering that could satisfy the various desires, both technological and aesthetic. Still, there are a handful of necessary conditions to be met and although they are a far cry from actual airports, they will be listed as follows:

1. Means for delivering the needed replaceable parts and the humans to and away from the aircraft—of the two options, firstly (a) conveying everyone and everything needed for a flight up to and away from the aircraft while it stands still on an airfield or staging ground; or secondly (b) conveying the aircraft along a (i.e. belt) path that passes everything needed for a flight change-out in succession. The 20^{th} century has taught us that there is no debating the two options (a) and (b) for high-usage areas because due to the demands of the customers/passengers, the latter option must be chosen and following the same thinking an assembly-line model will be the optimal solution. Having landed firmly on the assembly-line model for high-usage areas (cities, suburbs, etc.), we can now enumerate the rest of the necessary conditions in a spatial manner. However, in villages, rural areas, islands, hospitals, and other anomalous spaces the aircraft could land in a nice spot and everything could be brought up to it, the people could come and go, and then everything could be carried away from it once the fresh wings have been attached and the passengers are settled in their seats.

2. A debarkation point. The passengers could alight from the aircraft directly it lands. They could also alight at a platform in some other location where the aircraft is conveyed to after landing. It is probably not possible to reliably land an infinite succession of incoming aircrafts exactly at a debarkation point in a convenient way (i.e. near a platform), but whether the former or the latter, after debarkation the passengers will want a sheltered hallway, gallery, or under- or over-pass to get them to a ride-share or taxi (aerial or terrestrial) terminal or a parking garage or mass transit.

3. An embarkation point. As the passengers will need to board the aircraft in an orderly manner, an embarkation point should probably entail most of the aspects of the debarkation point, namely, the sheltered ingress/egress amenities as well as a waiting area. It is possible that the debarkation point could be the same as the embarkation point, however this will, like a roller-coaster queue, lead to delays. The processing protocol of the aircrafts in succession should at all costs be made a continuous one and not a batch one. Therefore, the embarkation point should be spatially and operationally disjunct from the debarkation point, although they could share amenities in the same manner that a subway station does (two-way halls, two-way stairwells, etc., as well as a cross-over or shunt passage for people who are traveling through to a subsequent leg of their journey).

4. A wing swap facility. As described during the description of FIGS. 16A and 17A, there should be a set of charging racks and a machine for pulling the wings off of successive aircrafts in succession, docking the wings in the charging racks, and pulling fresh batteries off of other charging racks and put them on the recently wing-divested aircraft to power it through its next flight.

5. A launch assistance device. There are a hundred things we could do here, but the most important is to flip up the nose of the aircraft 1 toward the sky before takeoff so that, during takeoff, the 1^{st} impeller module can directly feed the 2^{nd} impeller module with air for future thrust from the very beginning of a flight, and we do not need to go through the entire vertical takeoff strategy (from a field/lot) with both impeller modules separately ingesting and exhausting parallel streams of air, which is inefficient. By flipping up the nose (or dropping the rear) of the aircraft before takeoff, we also eliminate the aerial flip-up of the nose that is going to be complicated and, although it will eventually be safe and effective although slightly wasteful, it would be nice to avoid it during prototype testing, early industrial applications, and probably in the long run, simply as a universal preference for all these reasons. The launch assistance does not have to constrain the flight of the aircraft in a forward-only manner (such as guiding it or tunneling it or rolling it) during the initial takeoff, but this would be further advantageous because it would allow sustained operation during adverse weather conditions.

6. A landing area and transport means. As mentioned, the practice of landing an infinite succession of aircrafts directly at/on the debarkation point reliably and with pinpoint accuracy during all wind conditions is not something we can even slightly rely on. Better would be an open area/field on which to land a plurality of aircrafts and a lift vehicle for bringing them to the means for conveying the aircraft. Also foreseen is a hopper-type facility where aircrafts automatically slide or otherwise drift, after landing, onto the means for conveying the aircraft, as well as a crane or gantry system for latching onto them to perform the same. Nobody will ever read this so why is the Applicant proof-reading it and why did he ever type it to begin with? The answer is mysterious.

From among all of the above, and from each of their potential divergences that could be more or less eventually efficacious, the Applicant has selected as the best mode a linear assembly-line configuration that he believes is the fastest, most robust, and most potentially reliable embodiment going forward in the figures (a decision reluctantly rendered since we are here without actual modeling or data, which should be pursued). Although the foregoing should not be seen as limiting in any respect, as it is simply the first thing put forth by the Applicant, the application simply does not have more room for tangential discussion of the obvious variants for both the selection of elements and their order. What is put forth herein then is the simplest workable yet effective facility that the Applicant has determined could be preferred for the prototype.

Referring again to FIG. 17A, reference numeral 360 refers to the ground, which should be flat or flattened and is shown as a simple horizon with most of the elements of the prototype being above the horizon and supported by the ground 360, even if this is not explicit in the drawing. As mentioned earlier, it is preferred that the successive aircrafts 1 land on the ground 360 in an area reasonably near an intake bay 370 where the aircraft 1 will begin its journey from pot-landing to takeoff. The ground 360 should consume at least one acre, but preferably 3-20 acres, of cleared and graded (by earth-moving machinery) solid earth, or an artificial turf grounds or other synthetic grounds, such that when the successive aircrafts land with their noses pointed in various directions, they can be retrieved by a lift truck 361. The lift truck 361 could have any useful design, but in the present embodiment it comprises four wheels (not labeled), twin forks 363 for sliding under the aircraft fuselage's convex sidewalls and lifting the aircraft vertically up off the ground 360, and control means or a driver for coming up behind each successive aircrafts 1, gathering them up on its forks, conducting them to the intake bay 370 and depositing them on a long conveyor 380 which is parallel to the ground 360 and being perhaps flush with it but probably not, raised a few or several feet above it, or sunk a few feet below it, wherein the conveyor can be a single belt or set of belts or carts, or a chain with pads or grippers, etc., that in one way or another traverse in an embodiment preferred at the time of filing the whole facility from the inlet bay 370 to at least the embarkation room 373, if not further to include exiting the other (left-hand side in FIG. 17A) end of the facility. It is noted that, in the event that conveyor 380 is a belt, it 380 could be one long belt or pair of belts that undergird the fuselage and support it for transport continuously from one end of the facility to the other, or it could have a separate set of belts (each with its own four or six or more driven pulleys or an array of rollers), one in each “room” of the facility. It is noted in passing that the lift truck 361 is provided with a counterweight 362, known in the arts, that keeps the vehicle upright and fully maneuverable regardless of the weight of the aircraft 365A (as shown in FIG. 17A) that it is carrying.

Moving on, the lift truck 361 picks up the aircraft 365A and carries it to the intake bay 370. The conveyor 380 extends part-way into the intake bay at least 60% of the length of an aircraft 365B, and the intake bay 370 is open to the environment on the intake end such that the lift truck 361 can simply align itself with the conveyor while it is approaching the intake bay 370 and when the aircraft is in position above the end of the conveyor, the lift truck 361 lays the aircraft 365B on the conveyor. Shortly after this (depending on other operations within the facility's other rooms 371-373), the aircraft is indexed forward the length of one room (all rooms 371-373 should be approximately the same length), and in so doing it passes through a window or doorway (only partially shown by having the inter-room divider extend down ⅓ of the way from the roof, not labeled) which can be opened to allow an aircraft through it and then closed to shelter the rooms 371-373 from the outside air, such that the rooms can be climate controlled for the comfort of passengers and workers. Various stages of the aircraft are shown at 365A (on the lift truck 361), 365B (in the intake bay 370), 365C (in the debarkation room 371), 365D (in the wing-swap room 372), 365E (inside the embarkation room 373), 365F (outside, at the aircraft pivoting-up area 374), and 365G (outside, on the launch tower 390), and all of these stages will be subsequently described in sequential, chronological order in conjunction with their respective IP spaces or technological areas.

Once the conveyor 380 has accepted an aircraft 365B from the lift truck 361 and indexed it forward one room-length, the aircraft has thereby become aircraft 365C (the next aircraft deposited by the lift truck in the intake bay 370 will now become aircraft 365B) residing, and stopped by the conveyor in, debarkation room 371. Here the top hatch of the aircraft 365B opens and platforms are set up to already be, or move into position to be, very near the aircraft such that the passengers when they emerge can walk away from the aircraft without stepping on it. It is probable that handles, railings, or other means will be provided to assist them, up to and including hoist devices for elderly and/or handicapped persons. It is possible that the handles/railings/etc. could be mechanically movable in nature and could shift/swing into a utilizable position once the hatch opens. The debarkation room 371 and adjoining regions near it could include various platforms, catwalks, overpasses, elevators, etc. to allow various activities/movements desired by the exiting passengers. The closeable doorway described as closing off the debarkation room 371 from the intake bay 370 in the space over the conveyor need not be repeated between every room, but it is likely that we will want one (a pierceable doorway) between every successive room, because what is going on in the next room, the wing-swap room 372, could very well be extremely loud and potentially emissive of odorous or even toxic gases.

So, after the debarkation room 371, the vacated aircraft, with the next indexing forward of the conveyor 380, gets transported directly, in the preferred embodiment, into the wing-swap room 372. The conveyor has temporarily stopped again and the machines described earlier remove the spent batteries from the sides of the aircraft 365D, place them on recharging racks, and from different recharging racks extract freshly recharged batteries to install them on the aircraft 365D. It is very desirable that this can be accomplished, as can the debarkation, in less time than is required to fully load the aircraft with passengers in the embarkation room (373, imminently described). As was described, the racks will preferably be arranged in the wing-swap room 372 in a vertical array in a tower (not shown), and the tower could extend downward below the level of the ground 360 in a wing-swap lower tower housing 372A and upward above the level of the conveyor 380 in a wing-swap upper tower housing 372B in order to reduce the maximum distance that needs to be traveled by the resupply wings, while the end effector carrying the wings between each aircraft and each given rack. Indexable (like a rolodex) racks are envisioned, as are devices described in the automatic parking garage arts. The array of racks could be a deep matrix or a carousel or anything that allows easy and on-demand access to the wing that the controller or a smart designer determines should be the next one extracted for use.

Now, still referring to FIG. 17A, the next time the conveyor 380 gets indexed forward (as soon as the hatch closes on the new passengers in the embarkation room 373) the aircraft 365D in the wing-swap room 372 will now move forward into the embarkation room 373 and become aircraft 365E, having been replaced in the wing-swap room by a new aircraft 365D. Once in the embarkation room, the top hatch opens and the new passengers (all elements/aspects that were described in the debarkation room 371 can be used herein and will not be rehashed) occupy their seats. Various safety checks, both on- and off-board the aircraft and including manual and automated means, having been quickly performed, the hatch is closed and, once it is redundantly verified that the hatch is closed and latched (such as mechanical means as well as a pneumatic pressure fluctuation check to make sure from the inside that the aircraft is hermetically sealed), the conveyor 380 is indexed forward again a single room-length and the aircraft 365F now finds itself on a supplemental conveyor 381, downstream of and forming an extension of the main conveyor 380. The supplemental conveyor 381 can be identical in form and function to conveyor 380, except it is shorter and it is part of an aircraft pivoting-up means represented by pivoting-up arrows 382 and 383. Accordingly, as soon as the launch tower is verified to have no aircraft 365G on it, the supplemental conveyor 381 is pivoted according to arrows 382 and 383 by the aircraft pivoting-up means (not shown or described) to be parallel to the launch tower, at which point the launch tower captures the aircraft, which is now aircraft 365G, allowing the supplemental conveyor 381 to drop down to the horizontal position to receive a new aircraft 365F. The aircraft, which has already been running up its impeller system to max rotational rates with the intake 3 closed off (via roof upper and lower panels 301A and 301B being in divergent positions), opens up the front end of its impeller system intake (the roof 301 becomes horizontal), the air gets thrown back through the longitudinal duct by the 1^{st} impeller module to be further accelerated by the 2^{nd} impeller module, and the rearward (parallel to the launch tower 390) exhaust of the aircraft 365G quickly causes the aircraft to accelerate along the launch tower and thence upward, freed from the launch tower, into the sky.

The Applicant has chosen an angle for the launch tower to be well over 80 degrees from the horizontal but less than 90. Although this angle could turn out to be very important in the end, the Applicant cannot dabble with numbers he does not have at his disposal to settle upon the proper angle. The angle shown is sufficiently vertical to show that it should be substantially straight-up, to conserve energy and material, while still providing for the possibility that the lift of the aircraft once it reaches the top of the launch tower might tend to pitch up the nose and twist the aircraft backward over itself if we do not give it a buffer angle to find its own preferred pitch. Of course, modeling can solve the problem, as can testing, of what the proper angle should be. As shown, the launch tower 390 can be supported by a beam or preferably pair of beams/posts 391 that together with the launch tower form a tripod, the most stable configuration available without the use of tension wires, which, come to think of it, could also be used, perhaps in a radio-tower manner. All available means should be undertaken to eliminate sway and undulations caused by wind, and if what is shown is not adequate for a launch tower of, preferably, more than 300 feet, if not much more than that, then more means should be added. The launch tower simply solves so many problems at once, we should take extra care to optimize it. Also, many different ways of keeping the aircraft adhered to the launch tower throughout the latter's extent, and also along the extension shown at 393 in FIG. 17A. The launch tower could be two parallel rails with a (wheeled or maglev) shuttle suspended between or on them, and the aircraft could ride on the shuttle and then detach from it at the top, at which point the shuttle could drop down to between the supplemental conveyor 381 to catch and pull up the next aircraft 365G. Alternatively, the launch tower could be two parallel rails and the aircraft could have passive retractable hooks (like little landing gear without wheels) that simply envelope the rails on each side, like a loose linear bearing. Other alternative means include idler wheels on the aircraft that grip the rails, like a roller coaster. How the aircraft keeps itself on the launch tower is not important for the current discussion, other than the Applicant stresses that the means should not require the aircraft to have exposed drag-inducing parts during regular flight.

Still referring to FIG. 17A, whether the launch tower should be positively or passively powered has been thought about by the Applicant to a considerable extent. The launch tower could catapult the aircraft along its length but this does not seem to provide much real advantage unless the launch tower is extremely tall (1000 feet or more). The same goes for having an exposed conductor from which the aircraft could (i.e. via a set of brushes or brush rollers) pick up electrical power to use instead of the batteries. For now, let us content ourselves by providing the launch tower simply as a means for allowing the aircraft to travel in a straight line while it acquires a significant (i.e. >70 mph) speed such that it cannot get shoved around by the wind. This will serve quite nicely for the prototype and probably for most small airport or processing station facilities, and when the industry is ready to be leveled up by having tall powered launch towers, plural-track launch towers (to increase capacity, in which case there would be multiple parallel conveyors leading to multiple parallel launch towers), etc., we can cross that bridge when we get to it.

The airport or processing station facility shown in FIG. 17A is meant to be an exemplary guide to what is possible for the present invention. The Applicant does not want to depend on the self-takeoff or unaided takeoff of FIGS. 9A-9D. In passing the Applicant will note that it is possible that the roof of the facility shown in FIG. 17A could be used as an airfield for small personal flying pods such as non-wheeled flying cars that the passengers could use their smartphones to hail in order to depart from and arrive at the facility, such that walkways, taxi-stands, parking garages, etc. could be eliminated from the flying experience and from the architecture of the airport complex. This could allow a “just in time” flight scheduling software to allow people to leave their own front doors and be literally at their destinations within ten, twenty, or thirty minutes, even if their trip involves three aircrafts and traverses 500 geographical miles. Although this seems like science fiction, the flying pod is probably coming sooner than we think. It is not impossible to imagine the surrounding air humming and swooshing with little pods coming and going, and this facility devouring and disgorging a constant stream of aircrafts at a rate of one every two minutes, and if there are several conveyors/launch towers lined up parallel to each other, the processing capacity of the embodiment shown in FIG. 17A could be incrementally increased as much as needed to meet demand.

FIG. 17B is a blown-up view of the right-hand side of FIG. 17A, and the labels have been omitted in order to keep the image uncluttered. FIG. 17C is a blown-up view of the left-hand side of FIG. 17A, and the labels have been omitted here too. As FIGS. 17B and 17C are just snapshots of the respective portions of FIG. 17A, it seems to Applicant that leaving out labels (reference numerals) is unobjectionable. Also, the drawings will not be further described herein. They have been included only for the reader to be able to see the shapes, and the spaces between the shapes, more clearly.

### Methodological Chronology of a Typical Flight

Methodological chronology refers to the time-wise succession from the initial/start-up states of the aircraft, through the sequences of repositioning the non-static parts during a whole, substantially repetitively realized algorithm from takeoff to landing, as well as to its other functional modalities (i.e. impeller module rotational rates) that manifest with or without respect to the repositioning steps, and also to the aircraft's perceived and constantly incoming environment apropos the relativistic frame of the aircraft.

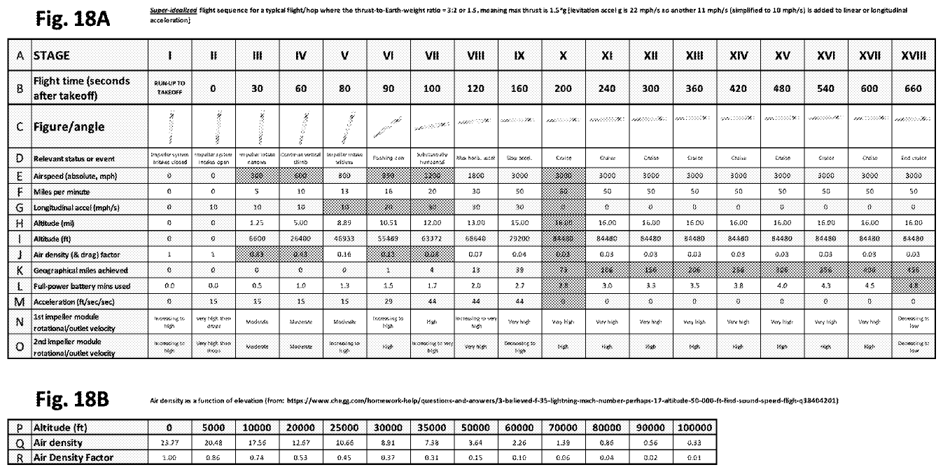

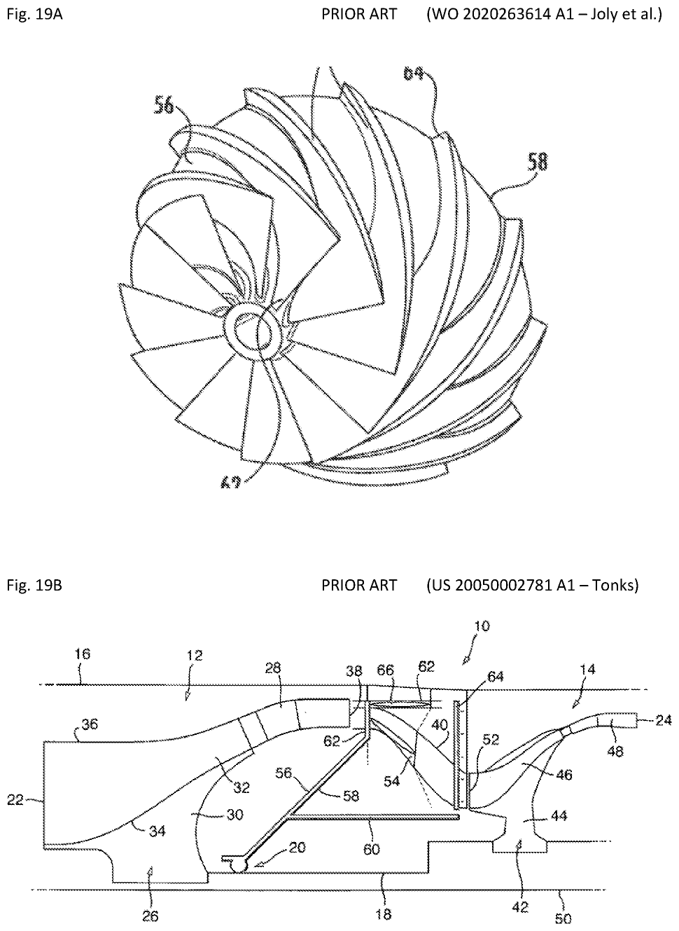

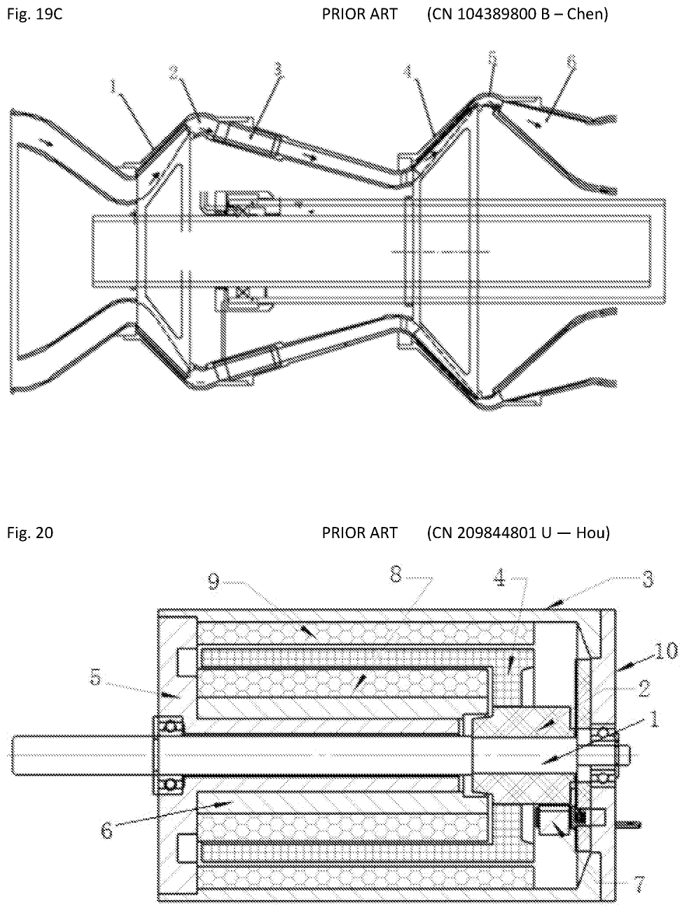

Throughout this discussion of the chronology, incessant referral will be made to FIG. 18A, which is a table of the prevailing statuses and events during the aircraft's voyage in conjunction with most of the scalar quantities representative of its events and relevant time periods. FIG. 18A is an Excel spreadsheet wherein the acceleration of the aircraft is held constant during successive non-transient periods while also in the same table expositing the main transient stage, specifically the portion of time wherein it changes from vertical climb to horizontal cruise.

FIG. 18A and the methodological chronology are broken up into chronology/event stages defined by Roman numerals I-XVIII, shown as column headers, and the quantities scattered amongst the table are mostly the result of mathematical equations embedded in the spreadsheet (and not further discussed, but the Applicant requests good-faith presumption of accuracy because he has every reason to maintain reputability, even though he might have messed them up), said equations mostly being mathematically downstream and amid-stream of the acceleration numbers, which were inputted manually. As is clear from the label, FIG. 18A is an overly idealized flight wherein most of the more complicated conditions of such a flight are problems left to be answered later by other engineers, presuming the prototype will not achieve them, even though it might for some. What is important in FIG. 18A is that it is realizable, absent major snags, and place-holds our progress in the overall development of the invention. What is also important is that the same table could be made with smaller airspeed scalars and the point would be the same; to show that this aircraft accomplishes the stated purpose of the prototype, which is to show that it all works.

FIG. 18A will be the main reference point in the upcoming discussion, but FIG. 18B will also be a basis for referral. FIG. 18B is simply a handy reference card for the prevailing air densities (and thus the drag factor) at each altitude, and it is also an input for FIG. 18A, for when some quantities (i.e. altitude, airspeed) have been determined, via FIG. 18A, namely that the aircraft is at a certain altitude, it greatly avails us to know what the air density is there, and more importantly, what that air density there is as a function of air density at sea level. When we know the air density at a given altitude, we can divide from it the air density at sea level to render a ratio that basically tells us how much drag and lift we will get from the air at the altitude the aircraft is operating in. The basis for FIG. 18B is not apocryphal—it has been borrowed from a (believed-to-be) ingenuous and reputable website, explicitly shown (pasted from URL) above the table in FIG. 18A. Although this website might disappear from the public domain of the internet at some future date, its data should still be considered believable and if not, it doesn't matter because other websites show the same generic data.

To begin we must select from among what are the various conceived-of flight-types, and ideally, what such so-called typical flight-types should be based around. Without restricting the scope of the present application, a typical flight is one that begins on a device/platform/ramp/rail system that has already positioned the aircraft with its front/nose aimed skyward. A typical flight is also one that travels between 200 and 800 geographical miles; the typical flight, called typical for a reason, is one that maximizes the potential of the batteries because this is the range the aircraft is primarily (at the time of filing) optimized to traverse. Non-typical flights can be: a) shorter than 200 miles, wherein these shorter flights do not require the aircraft to climb so high and/or to accelerate to the extreme airspeeds of the typical flight, and b) longer than a distance of, for instance, 800 miles, wherein the aircraft has fastened thereto a booster module at takeoff and during the first few minutes of flight. These preceding ideas were discussed in more detail earlier in the application.

Stages I-III will be discussed with reference to FIGS. 18A, 7A, and 9E-9J. It is noted that the flight sequence that will be described in detail herein is one that begins with the aircraft already aimed up toward the sky, such as has been discussed with reference to FIG. 17A. With reference to FIGS. 9A-9J, since the vertical takeoff stages shown in FIGS. 9A-9D are a method for taking off from a horizontal surface (field or pad), we will skip them here. They have already been discussed during the discussion of a horizontal-surface takeoff. We can utilize the launch tower type of takeoff to describe the flight sequence in a simpler way, since there is no reason to discuss the speed and altitude of the aircraft during the horizontal-surface takeoff. If the aircraft takes off from a horizontal surface as per FIGS. 9A-9E, once it has pivoted up and is in the state shown in FIG. 9E, it can then be tracked in FIG. 18A as starting at stage II.

Thus, stage I of FIG. 18A occurs with the aircraft's internal elements positioned similarly to a state shown in FIG. 9E, but with the aircraft aimed vertically upward (see row C of stage I) and wherein the roof panels 301A and 301B are in the positions shown in FIG. 9A. With the roof panels 301A and 301B in those respective positions to close the impeller system intake 3, and with the rear flap 303 closed, the impeller modules 100 and 200, when energized and made to spin, inherently evacuate the entire impeller system by ejecting all the air in it out of the thrust ducts 14. The impeller modules are driven to rotate in this vacuum and they quickly attain high rotational velocities. As shown for stage I, the flight time in row B is described as “run-up to takeoff” but this could just as well be a range from a negative number of seconds up to 0. This run-up stage I is before second 0, which will mark the beginning of stage II. As shown in row D, the impeller system intakes (via roof panels) are closed, as described previously. The airspeed (rows E and F) the longitudinal acceleration (rows G and M), the altitude (rows H and I), geographical miles achieved (row K), and full-power battery minutes used (row L) are also zero.

Row J is an air density factor concocted for a particular use within this application, and is generally defined as the prevailing air density at the altitude shown in rows H and I, divided by the air density at sea level. As we presume that a typical flight sequence begins at or near sea level, the air density factor at run-up to take off (stage I, row J) is 1. The air densities of row J will be used to provide a raw estimate of how much drag and lift the aircraft is experiencing at a given moment in a flight, and it will also give us an understanding of how much air is entering the impeller system intake 3, which in turn allows us to guesstimate the optimal states of the 1^{st} impeller system rotational velocity (row N) and the 2^{nd} impeller system rotational velocity (row O). The air density scalars used for obtaining the air density factor are available from FIG. 18B, which any practitioner of ordinary skill in the art will understand at a glance. The units for row Q (air density), although not labeled, are pounds per cubic feet. Row R shows the drag factors at various arbitrary altitudes that will allow us to look up relevant drag factors for use in FIG. 18A, or when not available to interpolate between two of those available in FIG. 18B, to plug them into FIG. 18A, row J. For instance at stage IV, row I, the altitude is 26,400 feet, so we simply choose a number in row R of the column under 25,000 feet. The Applicant does not feel this needs to be the time for a tutorial about how these things work, so we'll move forward, as whatever is not comprehensible to the reader at the moment will become so as we work our way through FIG. 18A.

From the discussion in the preceding paragraph, still discussing stage I, we come to rows N and O, which are both “increasing to high”. While using negligible battery power, the impeller modules accelerate to a high rotational velocity because they are spinning in a virtual vacuum since the impeller intake is closed. In fact, they will be run up such that at second 0, they should be spinning at a very high rate. Although the air density factor is at its maximum (1), this will not choke up the impeller modules because there's no air coming into them yet.

So, to reiterate, during stage I the upper and lower roof panels 301A and 301B are pivoted to positions that cooperate to hermetically seal the impeller system such that once the 1^{st} impeller module and the 2^{nd} impeller module begin to spin in earnest, the impeller system evacuates itself. Indeed, the 1^{st} impeller module and the 2^{nd} impeller module are accelerated within the near-vacuum that results, and they can achieve their takeoff rotational rates, the respective rotational rate of each impeller module being optimal for takeoff and not necessarily proportional to the other, without there being drag or wasted partial thrust. The energy savings of doing this are not enormous in the long run (over an entire flight), but they are not insignificant and since they can be accomplished by simply moving two panels we already have for other reasons, we'll do the little bit we have to do to preserve a few seconds of battery power. It is also advantageous to be able to have the impeller modules spinning at takeoff rotational rates, in a vacuum so consuming negligible battery power, while postponing the actual takeoff, just in case some contingency comes up. Meaning, the impeller modules can be spinning while something is going on that prohibits takeoff, and as soon as that something ends, the impeller system intake opens and takeoff commences immediately.

The impeller modules accelerate to their takeoff velocities while the aircraft itself does nothing but sit on the launch tower (or other substantially vertical guide), and then, when the lower roof panel 301A pivots up (FIGS. 9A and 9E) out of the way, the impeller system instantaneously begins to ingest air for propulsion.

A minor objection here included as an aside must entail the question: if the 1^{st} impeller module and the 2^{nd} impeller module are supported by magnetic thrust bearings or maglev, how do they not slosh down against other surfaces when they the aircraft is upended as shown in stage I, row C. This is a very interesting subject and the Applicant proposes that there are many solutions available from the prior art; potentially hundreds, involving among many fields magnetic levitation, linear bearings (i.e. Nylon), magnetic oscillation, rotary bearings, air bearings, air-effect bearings, lubricious bearings, etc. Something is needed for this and this application can't bear any more gear so we have to move on, after first saying that an electromagnetic thrust bearing arrangement is preferred, and has been discussed elsewhere within the application.

So, in a vacuum, the fans of the impeller system have run up to their optimal takeoff velocities and the roof panels have opened up to create a full-throated ingestion of ambient air and we have now arrived at 0 seconds, specifically, stage II. Consequently, a virtual vacuum is created at the longitudinal front (top, since its pointed straight up) of the aircraft and a buoyant force on the aircraft manifests itself as a function of 14 psi, the static pressure of air at sea level (1 atm=14 psi pressure on the closed bottom end of the aircraft competing with an evacuated cross-sectional area of the 1^{st} impeller module's intake at the open top end of the aircraft), meaning the upward force will be (quantities are provisional and non-binding) about 10-14 psi*1200 square inches=14,400 pounds, plus or minus 2,000 pounds, on average. This number can be represented as a thrust until the aircraft is ascending too quickly for this to keep happening. At some point (airspeed between approximately 150 and 300 mph) the buoyant force will diminish to near nil as the predictable fallout from high airspeed results in a significant reduction in the amount of pressure existing behind/under the aircraft that is available to push or “spit” the aircraft upward. So, the buoyant force will atrophy quickly from 14,400 pounds (extra thrust) to a negligible amount as the aircraft achieves a moderate airspeed. But this 14,400 pounds is helpful, since at the very beginning of stage 1 the impeller system intake is probably only taking in air at about 100-200 mph, which would normally lead to an impeller system thrust that is small relative to its potential. Once the buoyant thrust becomes negligible, the aircraft's airspeed will already be high enough that its intake air velocity (i.e. 200 mph) allows the impeller system to have enough incoming air and air stream velocity to provide real thrust.

The buoyant force is only pushing up the aircraft for a handful of seconds during the beginning of takeoff (but for much of stage II). What about the thrust of the aircraft, which needs to be powerful through the 10-15 seconds while the aircraft is ascending relatively slowly but needs extra acceleration? At this point the impeller system intake is ingesting air at about 60-100 mph. This means a minimal amount of intake air is entering the system. At the inception of the takeoff mode (stage II), the intake air is being sucked in at, again, about 60-100 mph via suction caused by the rotation of the 1^{st} diagonal fan. These numbers seem at first glance to be insufficient for forward acceleration when beginning from a straight upward aircraft configuration. The trick is that the 3^{rd} diagonal fans (2^{nd} stages of the 1^{st} impeller sub-modules) and the 2^{nd} impeller module do not have their rotational velocities constrained by the 1^{st} diagonal fan intake velocity or the 1^{st} diagonal fan exhaust velocity. The 2^{nd} impeller module, importantly, can spin at a speed that achieves an exhaust velocity of perhaps 8,000 mph or more, especially in the case where the intake air stream does not have a lot of air molecules in it. In other words, when the incoming air is not providing a lot of volumetric throughput (because the aircraft is just taking off or when the aircraft is at a high altitude where air density is inherently greatly reduced, such as during stages II and X), the 2^{nd} impeller module will spin at absurdly high speeds, because it can. There's hardly any air coming into it, that air is arriving at already high speed, and we have all that centrifugal force and the flingers to just pile on to the speed. There isn't a single law of physics standing in the way. The inner intake portions of the centrifugal fans' vanes are only a few inches away from the axis of rotation, so they can pretty much do what they want without affecting or being affected by the flow and/or mechanical considerations. And if they affect them, then modification will ensue via later improvements by other engineers.

In other words, when the impeller system intake is not receiving a lot of air, either because the aircraft has a low airspeed or because the aircraft is high above the troposphere, the 2^{nd} impeller module spins at an extremely high rotational velocity to eject the thrust at 5,000-10,000 mph or higher. Because the volumetric air flow through the impeller system is low at these stages, its contribution to the thrust equation (T=m-dot*v) is very low, so the 2^{nd} impeller module's super-high-velocity exhaust (v) offsets the low air flow (m-dot). Thus, the thrust can be maintained at a high level even when there is very little air going through the impeller system.

So, this presents us with a boundary-value problem that we now have the boundary-points for. At stage II(row B=0 seconds, zero airspeed means very low through-flow) and at very high elevations (low through-flow due to diminished air density), the 2^{nd} impeller module can be run up to higher rotational velocities, independently of the 1^{st} impeller module's rotational velocities, to augment thrust and make up for a low through-flow. The 1^{st} impeller module's rotational velocities will be determined by airspeed and air density. While the rotational velocities of the 1^{st} and 2^{nd} diagonal fans will be a function of the aircraft's airspeed and the air density at whatever altitude the aircraft is flying at, the rotational velocity of the 3^{rd} diagonal fan will be independently determined by those factors too, but more as a function of the conditions of the exhaust from the 1^{st} and 2^{nd} diagonal fans. With the 1^{st} impeller module more attuned to efficiently working on the air and the 2^{nd} impeller module more attuned to modulating the thrust, the 1^{st} impeller module becomes simultaneously a 1) buffer between the incoming air and the 2^{nd} impeller module and 2) a supercharger for the 2^{nd} impeller module. It then becomes possible to modulate the rotational velocities of all the fan stages to create a balanced flow and to maximize the thrust without consuming excessive battery power. This will become important during a takeoff-sequence segment where the aircraft's airspeed is moderate while the aircraft's altitude is low. There may in this instance be an opportunity to borrow power from the 2^{nd} impeller module for the 1^{st} impeller module, or to otherwise deal with the extremely high through-put (m-dot) while maintaining an optimal thrust.

Returning to FIG. 18A, although we got a bit off track, we are still beginning stage II, which begins at 0 seconds and goes all the way to flight time 30 seconds at which point stage III will start. At 0 seconds, as shown in rows C and D, the impeller system intake opens while the aircraft is pointed substantially vertically up. As described in rows N and O for stage II, the impeller systems' rotational velocities, having begun at a maximum, drop as a consequence of filling with air and beginning to perform work. Rows E, F, H, I, K, and L are still 0 because the aircraft hasn't done anything yet, but importantly, a longitudinal acceleration (row G) has now become 10 mph/s whereas it was previously 0. This number was arrived at earlier in the application. Basically, FIG. 18A is all set up with the intention of keeping the acceleration of row G at a nice even number and, this cannot be overemphasized, a constant number (except during the push-over stages V and VI), even though in real practices the acceleration will not be constant. 10 is about as nice and even as you can get. Quickly, this is the amount of acceleration that results from providing enough magnets on the impeller modules to obtain a thrust-to-weight ratio (for the aircraft fully laden) of 3:2, which means that when it is aimed up the number 3 in that ratio represents all the power of the impeller system, the number 2 represents the proportion of thrust required to levitate the aircraft (9.8 m/s/s or 22 mph/s), and this leaves another one-half of the latter number for accelerating the aircraft upward (11 mph/s, which we have rounded down to 10 be conservative). Meaning, during stages II, III, and IV, for every second of flight time accumulated, the aircraft is traveling with an airspeed of 10 mph faster. So after 3 seconds it's traveling 30 mph upward, after 10 seconds it's traveling 100 mph upward, etc. However, as the stages of FIG. 18A show only what is happening at the beginning of a stage, we don't see any change specifically in that column for stage II. Most of the rows in stage II are zero still but some begin to change after second 0, and the air density factor is still 1.

As described earlier and shown in rows N and O for column/stage II, the impeller modules, as they suck in air, are decelerated as they take in more and more air. At the beginning of stage II this will not be much air, because although the impeller system is creating a near-vacuum in the impeller system intake, the impeller system still needs the air, subjected as it is to what is actually a moderately high pressure of 1 atm or 14 psi, to expand downward and into the impeller system. However, as stage II progresses, the airspeed will increase such that the intake air will self-pressurize the impeller system intake and the 1^{st} diagonal fan can begin to modulate its thrust to optimize the now abundantly-available air.

During stage II the acceleration of row G will have had an effect on most of the other rows such that they will be ramping up, some quickly and some more slowly, such that after 30 seconds we will enter stage III. At the beginning of stage III, as shown in row C, the aircraft is in a vertical climb, meaning its only goal is to obtain higher and higher elevations. After 30 seconds, the airspeed is 300 mph (row E), which translates into 5 miles per minute, as shown in row F. The acceleration is unchanged of course and is a sustained 10 mph/s, and the aircraft has by now attained an altitude of 1.25 miles or roughly 6,600 feet (rows H and I), whereat the air density factor (row J) is 0.83. 30 seconds is half of a minute so the total full-power battery consumption so far is 0.5 minutes (row L). As per rows N and O, the 1^{st} and 2^{nd} impeller modules are spinning with moderate rotational velocity. Still we have accomplished zero geographical miles (row K). It is noted out of hand that the acceleration (est. 10 mph/s) is also being tabulated throughout this sequence in row M as 14.7 feet per second per second, for reasons unknown to anyone. As noted in stage III row D, the impeller intake can taper or be narrowed a bit at the front end to bypass incoming air around the aircraft, so as not to choke the impeller system with too much air. This was discussed earlier in the application.

All of the preceding brings us to stage IV, beginning at 60 seconds (row B) of lapsed flight time and still looking in row C like stage II in that the aircraft is still continuing its vertical climb with no thought or effort towards traversing geographical distance. It's “pushed over” a little because its attitude needs to offset its lift, and because it is traveling so fast (airspeed=600 mph per row E) it must be pushed over toward the horizontal a little bit because the aircraft's induced lift will be trying to push it back the other way (nose constantly nudged in the left-hand direction in FIG. 18A). Row D still portrays “vertical climb” because very little has changed from the beginning of stage III except there is more lift to counteract and because the airspeed has increased substantially. So, after 60 seconds the airspeed is (due to 10 mph/s) now up to 600 mph (row E) or 10 miles per minute (row F). It needn't be mentioned that the longitudinal acceleration of the aircraft is still 10 mph/s (row G), but the altitude has made a significant jump, up to 5 miles or 26,400 feet (rows H and I). The air density factor at 26,400 feet (row J) is 0.43, which means we can eventually widen the impeller system intake at some point, but probably not yet.

As we mention that at the beginning of stage IV the altitude is roughly 26,400 feet and the airspeed is 600 mph, at which point the air density factor is 0.43 (stage IV, row J), we must also mention that at the beginning of stage III the airspeed was 300 mph and the altitude was 6,600 feet, while the air density factor there was 0.83 (stage III, row J). Because the airspeed is twice at stage IV what it was at stage III while the air density factor at stage IV is half of what it was at stage III, we can simply presume for convenience's sake that the load on the impeller system is the same for both stages even though they spin a little faster, because the same amount of air will be entering the impeller system and being worked on therein. Instead of choking on air because the airspeed has accelerated to a moderate speed, the effects on the impeller system, and particularly on the 1^{st} impeller module, have not changed much. This is why cells III-E through IV-E and cells III-J through IV-J have been shaded in, so that they can be paired for exemplary purposes. As shown in rows N and O for stage IV, the impeller modules' rotational velocities have remained moderate, as they were in stage III. Their volumetric throughputs have not significantly changed from stage III to stage IV, thus their rotational velocities will not have varied significantly.

At the beginning of stage IV, we still have not traversed any geographical miles (row K) but we have attained an airspeed of 600 mph (10 miles per minute) straight upward, while still experiencing (throughout stage IV) 10 mph/s of acceleration, and this acceleration does not relent. By the way, without covering a single mile of geographical distance (row K), we have used 1 minute of full-power battery minutes (row L of col. IV). It is noted, in case it is not obvious, that unlike most of the other cells which detail an instantaneous amount or state, row L is cumulative from stage I onward, meaning that each number will increase as we move in the right-hand direction across FIG. 18A in row L (throughout the flight as the batteries are drained). After row L of stage IV, there again is that row M acceleration of 14.7 ft/s/s that no one cares about.

Stage V is where things begin to change a lot and where, once we have attained a certain altitude and do not need oxygen, we can basically do whatever we want. As of 80 seconds into the flight, the airspeed is 800 mph which transposes to 13 miles per minute (row F) and the altitude is now 46,933 feet (row I). Applicant has shown in FIGS. 12A-12F how the thrust ducts 30 can be bent to effectuate a vectored exhaust. Many means, including pitching up of the stabilator 18 and bending the thrust vectoring nozzle 30 down, can be used to push over the aircraft from its vertical climb pitch to its horizontal pitch. This is what is meant in this application by the terms “pushing over” or “push over” or “pushed over” or “push-over”. The aircraft was, during stages I-IV, headed straight up vertically, such that even if it wasn't pointed up vertically (in profile), its aggregate velocity (vector) was vertical (once lift was included into the equation). However, at stage V the aircraft will begin, as shown in column V, rows C and D, to attempt the push over from vertical to horizontal. As stage V begins, the aircraft has attained an airspeed of 800 mph and an altitude of 46,933 feet (8.89 miles) and is still in the final act or moment of the vertical climb. Also as stage V begins, the previously prevailing acceleration of 10 mph/s still holds dominant, while the aircraft is still fighting the full force of gravity, but it won't stay that way. The air density factor (row J) is now 0.16 which means that drag is declining precipitously, but so is lift, while the impeller system must be heartily run up to higher spin rates to offset the lowering air density. Geographical distance covered (row K) is still around zero because the aircraft has been wholly preoccupied with gaining altitude. And since stage V starts at 80 seconds, at this point the aircraft has consumed 1.3 full-power battery minutes (row L).

It is noted for stage V that the 1^{st} impeller module rotational velocity (row N) is still probably moderate while the 2^{nd} impeller module rotational velocity (row O) is probably at this point ramping up to a high speed. The Applicant is unsure of when and how the rotational velocities will accelerate to higher rotational velocities, but that will certainly be a part of this process, as the impeller system will necessarily run much faster to increase the velocity of the air as the air density factor drops. So, it should be said here that rows N and O are simply guesses and should be used solely for educational purposes, in order for the reader to develop an idea of what is going on inside the aircraft throughout the flight. That said, the Applicant has a hunch that the 2^{nd} impeller module will begin to rotate faster before the 1^{st} impeller module does, and will likely stay ahead of it in the transient stages, as the 1^{st} impeller module struggles to digest the incoming air, which at some point will be coming in fast and still dense enough to bog it down.

It should be kept in mind that from the end of stage V to the beginning of stage VII, namely the 20 seconds that transpire while pushing over, the aircraft's vertical ascent will begin to be an increasingly lesser component of the airspeed, while the airspeed's horizontal component will gradually become more and more matched with the airspeed itself. Still, because the aircraft is traveling so fast from stage V to VII, it will have continued to climb a few miles further up during these stages, such that, as shown in rows H and I, during stage VI the altitude is roughly 10.5 miles or 55,000 feet and during stage VII the altitude is roughly 12 miles or 63,000 feet.

To focus only on stage VI for the moment, as shown at the beginning of stage VI, 90 seconds into the flight, the pitch of the aircraft is less than 45 degrees and its velocity vector is roughly 45 degrees, halfway straight up and halfway horizontal, such that the force of gravity is only affecting the aircraft's acceleration half as much as it was, so it can be seen in row G that the longitudinal acceleration of the aircraft has (gradually over the 10 seconds since the beginning of stage V) increased to 20 mph/s. This doubling of the longitudinal acceleration (remember that the aircraft has been designed to have a thrust-to-weight ratio of 3:2 in order to accelerate at 10 mph/s while fighting the force of gravity full on, which was pulling it down at approximately 20 mph/s) is the result of the fact that its acceleration is now at an angle to the vertical, and specifically at this snapshot we have chosen for stage VI, the force of gravity is having only half as much effect on the longitudinal acceleration effort of the impeller system as it was during vertical climb. So, the longitudinal acceleration has doubled simply by nature of the trigonometric relationship between the airspeed's vector and the vertical plane, and not by anything remotely mysterious.

Since the acceleration began to increase during stage V, although not shown in stage V, the airspeed (row E) has grown by the beginning of stage VI to 950 mph, or 16 miles per minute, instead of the 900 mph or 15 miles per minute it would have been if the 10 mph/s acceleration would have stayed the same. The altitude is now about 10.5 miles or 55,000 feet, and since 90 seconds have transpired while the aircraft has been consuming maximum battery power, the full-power battery minutes used (row L) is now 1.5. The acceleration of row M is 29 ft/s/s, and the 2^{nd} impeller system rotational velocity is still in the “high” range while the 1^{st} impeller system can avail of the very low air density factor from row J (0.13) to be increasing to the “high” range (rows N and O). As the aircraft is pushing over, its groundspeed begins to increase from 0, and this is why row K shows that the aircraft has traveled 1 geographical mile.

Between the beginning of stage VI and the beginning of stage VII, the aircraft has substantially flattened out such that its longitudinal acceleration is wholly unencumbered by the pull of gravity (except for lift-induced drag) and this longitudinal acceleration has, for stage VII, as shown in row G, maxed out at 30 mph/s. As shown in row E, the airspeed for the beginning of stage VII has gained significantly over the beginning of stage VI, which was only ten seconds earlier, to 1,200 mph, or 20 miles per minute (row F), and the cells of row E from stage VI to stage VII have been shaded to show this uptick that is a divergence from previous cells in the row. This is facilitated not only by the fact that the 2^{nd} impeller module's rotational velocity is increasing to or has increased to very high (row O) while the air density factor has shrunk (row J) to 0.08 (shaded again to emphasize it), which means that the drag on the aircraft, the only thing holding it back, is less than 1/10 what it was at would be at sea level. This is not unremarkable because it is well known that aircraft designed to travel at such airspeeds (Mach 1.5 to Mach 2.5) typically inhabit the altitude we now find ourselves in, shown in row I to be about 63,000 feet or equivalently in row H as 12 miles. To continue one last time our little motif, since no one is paying attention to row M we'll just admit now that we have it in the spreadsheet because it is being used by various formulas embedded in the other cells of the spreadsheet for resultant data, and the Applicant forgot to drag it down out of the print area before he finalized the figure. Although it has yet to matter, the aircraft has in these ten seconds gained or traversed 3 more geographical miles as shown in row K and it has consumed 1.7 full-power battery minutes (row L). Applicant is not sure how fast the 1^{st} impeller module should be spinning at this stage so he just put in “high” for row N although it could be “very high” since the air density factor is so low.

As mentioned, the cells of VI-E and VII-E are shaded to show how much the airspeed has begun to be increased during this crucial phase of longitudinal acceleration wherein, as is also depicted by parallel shading for cells VI-J to VII-J, the air density factor has been thoroughly reduced to an abject number well less than 0.1 such that the accelerations of airspeeds to desirably and continuously exotic speeds are offset by equally exotically low ambient air densities and therefore exotically low drag. The fact that the aircraft can continue to accelerate is owed to the fact that there is nil reliance by the impeller system on any factor other than how many magnets and coils are used to spin its integral units, and without consideration for the amount, or even existence, of oxygen available for combustion. The impeller modules, and particularly the 2^{nd} impeller module since it has the 1^{st} impeller module feeding it its air (volumetric throughput) and buffering for it, can simply spin at any rate needed/desired to effect whatever thrust is needed during this transitional state, or at least as much as it has magnets/coils to facilitate.

Stage VIII is no less important than stage VII, even though the aircraft has not completely flattened out to completely horizontal. It has up to this point (the beginning of stage VII) retained a slightly positive pitch (upward) to continue to climb to the cruise altitude while still maximizing longitudinal airspeed, while acceleration has been kept constant, as described previously in the application many times. We will allow it to have a slightly upward pitch (i.e. 1-5 degrees) such that every foot it traverses accomplishes a fraction of an inch of altitude gain, because our sweet-spot for cruise travel has not yet been attained.

So let us tick off the status of the aircraft as we find it at the beginning of stage VIII, for all intents and purposes during this idealized flight sequence as we encounter it at 120 seconds (row B showing that 2 minutes have transpired) into such a flight. As shown in row C, the aircraft has, as previously described, assumed a nearly but not completely horizontal pitch (it's still pointed a little skyward but by only a few degrees, or 1 degree, or even less). As shown in row D, the aircraft has attained its maximum longitudinal acceleration of 30 mph/s and is currently traveling at an instantaneous airspeed of 1,800 mph or 30 miles per minute (rows E and F). The longitudinal acceleration of 30 mph/s persists throughout this short phase (row G) for reasons of keeping the “ideal” scenario proportioned for the spreadsheet to keep it simple. The current altitude is around 13 miles or 69,000 feet (rows H and I) and the air density factor has decreased even further to 0.07 (row J) for the beginning of stage VIII. The geographical miles achieved (row K) is now 13 miles, while the consumption of battery power has now incremented up to 2 full-power battery minutes used/consumed. In other words and this is counter-intuitive, the aircraft's batteries have been drained of up to ¼ of their total energy storage (assuming a total of 8 minutes' full charge) and we haven't even gone 20 miles. This will change starkly from this moment on. As per rows N and O, the 1^{st} impeller module's rotational velocity is probably transitioning from high to very high and the 2^{nd} impeller module's rotational velocity has already reached a very high level.

Although stages V-VIII consumed a short timeframe (40 seconds), the timeframe from the beginning of stage VIII to the beginning of stage IX is also 40 seconds which can create a discontinuity that might be baffling to the reader unless s/he is paying attention to this paragraph. There wasn't much else to describe because stage VIII was technically not a transitional stage. However, between the beginning of stage VIII and the beginning of stage IX (no shading is shown to exist in or cross this column for that reason), the prevailing circumstances play a huge role in establishing the relevance of stage IX as an outstanding candidate for proof that this invention matters imminently on a global scale. While maintaining the previously described constant acceleration of 30 mph/s after stage VII, the aircraft by the beginning of stage IX (160 seconds) has accelerated to 3,000 mph (row E) and now we must, as shown in in row D, simply stop accelerating the aircraft. The reasons for this are arbitrary, but we must stop accelerating the aircraft, even in this super-idealized flight sequence, just so we can stop talking about it and get out of the discussion and on to the claims.

So, as seen as we move down through column/stage IX, the airspeed is 3,000 mph (row E) or 50 miles/min (row F), and the acceleration has stopped completely, as shown in stage X, row G, while the altitude is 15 miles (row H) or 79,000 feet (row I). The air density factor (row J) has decreased even further to 0.04, meaning drag is less than 1/20 of what it would be at sea level. The geographical distance traversed at this point (row K) is now around 40 miles while full-power battery minutes used (row L) is about 2.7 minutes, but attention should be drawn now to what happens to the geographical distances achieved from this moment on, as per row K. They simply abound. Meanwhile the 1^{st} impeller module's rotational velocity and the 2^{nd} impeller module's rotational velocity are “very high” (rows N and O) but the 2^{nd} impeller module rotational velocity starts decreasing to “high” as the massive thrust required during the acceleration stages II-IX is no longer required after the beginning of stage IX, since the (arbitrarily chosen, by the way) max airspeed has been attained. Applicant is unsure of whether to reduce the rotational velocity of the 1^{st} impeller module in cell N-VIII, so it has been left as “very high”, but it could possibly also reduce to “high” without much changing the performance, in which case the latter would be preferred in order to reduce power consumption.

Turning to stage X, which begins at flight time 200 seconds, the aircraft is now in a steady cruise mode, since it already reached its maximum velocity of 3,000 mph and has now obtained its (arbitrarily chosen) maximum altitude of about 85,000 feet or 16 miles. The air density here is so low (row J shows 0.03) that drag has become less than negligible and by flying the aircraft with its nose pitched up just a little, described previously, or not, if the aircraft is designed to provide some lift in this scenario, there can be no doubt that the lift deficiency can be made up for by the super-high airspeed. The impeller modules will have been relaxed to whatever power level is optimal for keeping the aircraft in this state, and it has been guesstimated by the Applicant that the power consumption from the batteries should be about one-fourth of full-power battery consumption, and this is why the numbers in row L taper off and, as shown in a given cruise stage of 1 minute (meaning within stages XII-XVII), the average increase of one column over the previous column is 0.25 (although it is not showing up exactly that way as the spreadsheet is rounding the numbers to a single decimal place). To take one time period as an example, from stage XII to stage XVI, four minutes have elapsed and 200 geographical miles (row K) were traversed, yet only one full-power battery minute has been used (4.3-3.3 as per row L). In other words, when the aircraft is designed according to this specification, once the vertical climb and push-over have been accomplished, the aircraft is going 50 miles per minute while using 1 minute's worth of full-power battery power every 4 minutes, and this sums up the cruise portion of the flight and, as everything but rows K and L stays the same after stage IX until the descent is initiated (that is why most of stage X has been shaded, to bookmark the point at which the cells have leveled off), this wraps up our discussion of FIG. 18A.

The Applicant has arbitrarily chosen to truncate the spreadsheet, electing to omit the rest of the seconds after 660 seconds which is the beginning of stage XVIII, at which point 456 miles (cells K and L of column XVIII are shaded for emphasis) have been traveled and 5 minutes of full-power battery power have been drained from the batteries. How much further we would be able to travel depends only on how much battery power/life is installed in the aircraft, and (because we don't know this yet) how quickly the impeller system drains that battery power/life (and, of course, how much technological advancement will be required to make an aircraft that can actually perform according to this super-idealized sequence). For stage XVIII, row D says “end cruise” and rows N and O say “decreasing to low” but, as mentioned elsewhere in this application, the Applicant doesn't completely understand yet how the aircraft will be decelerated and brought back down to earth without burning it up or getting its wings ripped off. So the descent is not part of FIG. 18A, nor is the landing.

Omissions and Unforeseen Deviations from the Proposed Embodiments

It is inherent in the present endeavor that the applicant has made several omissions in disclosure, errors in explanation as well as in design and method, and perhaps complete miscalculations about industry demands or industry standards or even, perhaps, the nature of the engineering concepts and formulas used or invoked herein. This is in part due to the applicant's lack of expertise in the myriad industries, aerospace and mechanical engineering foremost among them, but also material science and electrical engineering. No one person can be an expert in more than two disparate fields, while also being capable of typing in authentic patent-speak a 300-page patent application. So it is humbly requested of history that the errors and inconsistencies of this document do not reflect poorly upon the Applicant. Applicant's hope is that the mess-ups are either moderately numerous and small, or very few if they are large, wherein the mistake(s) is/are corrigible within a short timeframe. Meaning, the smaller mistakes can be corrected easily, so we don't have to worry about them. And the one big mistake, assuming there's at least one, can be solved by a bright engineer once s/he notices it or is presented with it, or by the industry at large over time, or by the Applicant.

I claim:

1. An aircraft comprising an impeller system, said aircraft further comprising a longitudinal forward flight direction and a longitudinal rearward direction parallel to said longitudinal forward flight direction and opposite to said longitudinal forward flight direction, said aircraft further comprising a downward direction that is orthogonal to said longitudinal forward flight direction and toward the earth; said aircraft being propelled by at least one longitudinal thrust; wherein
said aircraft comprises at least one of a fuselage, a wing, and a nacelle; wherein
said impeller system comprises at least one electrically powered first impeller module situated in a forward zone within said at least one of said fuselage, wing, and nacelle; wherein
said impeller system further comprises at least one electrically powered second impeller module situated in an aftward zone within said at least one of said fuselage, wing, and nacelle; and wherein
said aftward zone is rearward, in said longitudinal rearward direction, of said forward zone.

2. The aircraft of claim 1, wherein said aircraft comprises at least two replaceable wings, wherein said at least two replaceable wings each comprise batteries, and wherein said at least two replaceable wings both comprise means for rapid attachment to said fuselage.

3. The aircraft of claim 1 wherein said at least one first impeller module feeds air through at least one hollow duct to said at least one second impeller module and said at least one longitudinal thrust is generated by air being ejected directly from the aircraft by said at least one second impeller and not by said first impeller module; wherein
said at least one hollow duct extends more than two feet in said longitudinal rearward direction away from the at least one first impeller module.

4. The aircraft of claim 1, wherein said at least one first impeller module comprises at least one electrically powered diagonal fan having an axis of rotation and at least one inlet diameter defined by a diameter of a fan inlet area outer annular surface, and at least one outlet diameter defined by a diameter of a fan outlet area outer annular surface; wherein
said at least one outlet diameter is more than 15% greater than said at least one inlet diameter.

5. The aircraft of claim 1, wherein said at least one of said first impeller module and said second impeller module comprises a spinning fan body that is directly fused in a shaftless manner with an electrical-coil-containing rotor that is driven via electromotive force.

6. The aircraft of claim 1, wherein said at least one first impeller module ejects air selectively and sequentially a) downwardly in said downward direction and then b) rearwardly in said longitudinal rearward or, oppositely a) rearwardly in said longitudinal rearward direction and then b) downwardly in said downward direction, wherein said selectively and sequentially are effectuated via a movable duct, a pivotable wall or flap, a valve, or a nozzle.

7. The aircraft of claim 1, wherein said aircraft comprises thrust reverser means for actively braking said aircraft and said at least one second impeller module comprises a volute with an outer wall, said thrust reverser means for actively braking said aircraft further comprising at least one thrust reverser closure that moves to partially open said outer wall of said volute.

8. The aircraft of claim 1, wherein said at least one second impeller module comprises at least two centrifugal fans, wherein said at least two centrifugal fans exhaust outlet air in said longitudinal rearward direction to create at least two parts of said at least one longitudinal thrust.

9. The aircraft of claim 1, wherein the second impeller module comprises two second impeller module sub-units, including a 1^{st} second impeller sub-unit spinning in a first rotational direction and a 2^{nd} second impeller sub-unit spinning in a second rotational direction opposite to said first rotational direction; wherein
said 2^{nd} second impeller sub-unit is situated on top of said 1^{st} second impeller sub-unit.

10. The aircraft of claim 1, wherein the first impeller module comprises dual first impeller module sub-units including a 1^{st} first impeller sub-module spinning in a first rotational direction and a 2^{nd} first impeller sub-module spinning in a second rotational direction opposite said first rotational direction, such that an exhaust from said 1^{st} first impeller sub-module and an exhaust from said 2^{nd} impeller sub-module merge in a confluence duct.

11. The aircraft of claim 1, wherein at least one fan of said at least one of said at least one first impeller module and said at least one second impeller module is driven by magnets annularly arrayed via at least one matched pair of concentric annular oppositely-flux-focused Halbach arrays.

12. The aircraft of claim 1, wherein said first impeller module includes at least one first diagonal fan and at least one second diagonal fan, said at least one first diagonal fan and said at least one second diagonal fan being arranged in series such that the at least one first diagonal fan feeds air to said at least one second diagonal fan, wherein said at least one first diagonal fan rotates at a first fan rotational velocity A and said at least one second diagonal fan rotates at a second fan rotational velocity B, and wherein B/A>1.4.

13. The aircraft of claim 1, wherein said impeller system is a vertical-takeoff-and-landing impeller system, and wherein said impeller system expels a VTOL thrust downwardly along said downward direction simultaneously from at least two distinct areas via a 1^{st} VTOL airflow flowing downwardly away from said 1^{st} impeller module and a 2^{nd} VTOL airflow flowing downwardly away from said 2^{nd} impeller module; wherein
the 1^{st} impeller module also can feed air to the 2^{nd} impeller module.

14. The aircraft of claim 1, wherein said aircraft comprises a nose and said at least one first impeller module takes in air from said nose of the aircraft through an impeller system intake that is concentric with said nose of said aircraft or three-dimensionally subsumes a majority of the interior of said nose of said aircraft.

15. The aircraft of claim 1, further comprising at least one pre-swirler upstream of said 1^{st} impeller module, wherein said at least one pre-swirler converts a primarily axial intake air flow into a flow that is more than 30% tangential and less than 80% tangential.

16. The aircraft of claim 1, wherein said second impeller module comprises at least one electrically powered centrifugal impeller module; wherein
said centrifugal impeller module comprises at least two centrifugal impeller module sub-units, wherein said at least two centrifugal impeller module sub-units share the same axis, wherein said at least two centrifugal impeller module sub-units comprise a 1^{st} centrifugal impeller sub-unit spinning in a first rotational direction about said axis and a 2^{nd} centrifugal impeller sub-unit spinning in a second rotational direction opposite to said first rotational direction around said axis.

17. The aircraft of claim 16, wherein
said aircraft comprises at least two replaceable wings, wherein said at least two replaceable wings each comprise batteries, and wherein said at least two replaceable wings both comprise means for rapid attachment to said fuselage; wherein
said at least one first impeller module feeds air through at least one hollow duct to said at least one second impeller module and said at least one longitudinal thrust is generated by air being ejected directly from the aircraft by said at least one second impeller and not by said first impeller module; wherein
said at least one hollow duct extends more than two feet in said longitudinal rearward direction away from the at least one first impeller module; wherein
said at least one first impeller module comprises at least one electrically powered diagonal fan having an axis of rotation and at least one inlet diameter defined by a diameter of a fan inlet area outer annular surface, and at least one outlet diameter defined by a diameter of a fan outlet area outer annular surface; wherein
said at least one outlet diameter is more than 15% greater than said at least one inlet diameter; wherein
said at least one of said first impeller module and said second impeller module comprises a spinning fan body that is directly fused in a shaftless manner with an electrical-coil-containing rotor that is driven via electromotive force; wherein
said at least one first impeller module ejects air selectively and sequentially a) downwardly in said downward direction and then b) rearwardly in said longitudinal rearward or, oppositely a) rearwardly in said longitudinal rearward direction and then b) downwardly in said downward direction, wherein said selectively and sequentially are effectuated via a movable duct, a pivotable wall or flap, a valve, or a nozzle; wherein
said aircraft comprises thrust reverser means for actively braking said aircraft and said at least one second impeller module comprises a volute with an outer wall, said thrust reverser means for actively braking said aircraft further comprising at least one thrust reverser closure that moves to partially open said outer wall of said volute; wherein
said at least one second impeller module comprises at least two centrifugal fans, wherein said at least two centrifugal fans exhaust outlet air in said longitudinal rearward direction to create at least two parts of said at least one longitudinal thrust; wherein
the second impeller module comprises two second impeller module sub-units, including a 1^{st} second impeller sub-unit spinning in a first rotational direction and a 2^{nd} second impeller sub-unit spinning in a second rotational direction opposite to said first rotational direction; wherein
said 2^{nd} second impeller sub-unit is situated on top of said 1^{st} second impeller sub-unit; wherein
the first impeller module comprises dual first impeller module sub-units including a 1^{st} first impeller sub-module spinning in a first rotational direction and a 2^{nd} first impeller sub-module spinning in a second rotational direction opposite said first rotational direction, such that an exhaust from said 1^{st} first impeller sub-module and an exhaust from said 2^{nd} impeller sub-module merge in a confluence duct; wherein
at least one fan of said at least one of said at least one first impeller module and said at least one second impeller module is driven by magnets annularly arrayed via at least one matched pair of concentric annular oppositely-flux-focused Halbach arrays; wherein
said first impeller module includes at least one first diagonal fan and at least one second diagonal fan, said at least one first diagonal fan and said at least one second diagonal fan being arranged in series such that the at least one first diagonal fan feeds air to said at least one second diagonal fan, wherein said at least one first diagonal fan rotates at a first fan rotational velocity A and said at least one second diagonal fan rotates at a second fan rotational velocity B, and wherein B/A>1.4; wherein
said impeller system is a vertical-takeoff-and-landing impeller system, and wherein said impeller system expels a VTOL thrust downwardly along said downward direction simultaneously from at least two distinct areas via a 1^{st} VTOL airflow flowing downwardly away from said 1^{st} impeller module and a 2^{nd} VTOL airflow flowing downwardly away from said 2^{nd} impeller module; wherein
the 1^{st} impeller module also can feed air to the 2^{nd} impeller module; wherein
said aircraft comprises a nose and said at least one first impeller module takes in air from said nose of the aircraft through an impeller system intake that is concentric with said nose of said aircraft or three-dimensionally subsumes a majority of the interior of said nose of said aircraft; wherein
the aircraft further comprises at least one pre-swirler upstream of said 1^{st} impeller module, wherein said at least one pre-swirler converts a primarily axial intake air flow into a flow that is more than 30% tangential and less than 80% tangential; wherein
said electrically powered diagonal impeller module is situated in a forward zone within said at least one of said fuselage, wing, and nacelle; wherein
said impeller system further comprises at least one electrically powered centrifugal impeller module situated in an aftward zone within said at least one of said fuselage, wing, and nacelle; and wherein
said aftward zone is rearward, in said longitudinal rearward direction, of said forward zone; wherein
said impeller system comprises at least one electrically powered diagonal impeller module situated in a forward zone within said at least one of said fuselage, wing, and nacelle; wherein
said centrifugal impeller module is situated in an aftward zone within said at least one of said fuselage, wing, and nacelle.

18. An aircraft comprising an impeller system, said aircraft further comprising a longitudinal forward flight direction and a longitudinal rearward direction parallel to said longitudinal forward flight direction and opposite to said longitudinal forward flight direction, said aircraft further comprising a downward direction that is orthogonal to said longitudinal forward flight direction and toward the earth; said aircraft being propelled by at least one longitudinal thrust; wherein
said aircraft comprises at least one of a fuselage, a wing, and a nacelle; wherein
said impeller system comprises at least one electrically powered diagonal impeller module within said at least one of a fuselage, a wing, and a nacelle, wherein said electrically powered diagonal impeller module includes at least one first diagonal fan and at least one second diagonal fan, said first diagonal fan and said at least one second diagonal fan being arranged in series such that the at least one first diagonal fan feeds air to said at least one second diagonal fan, wherein said at least one first diagonal fan rotates at a first fan rotational velocity A and said at least one second diagonal fan rotates at a second fan rotational velocity B, and wherein B/A>1.4.

19. The aircraft of claim 18, wherein said electrically powered diagonal impeller module is situated in a forward zone within said at least one of said fuselage, wing, and nacelle; wherein
said impeller system further comprises at least one electrically powered centrifugal impeller module situated in an aftward zone within said at least one of said fuselage, wing, and nacelle; and wherein
said aftward zone is rearward, in said longitudinal rearward direction, of said forward zone.

20. The aircraft of claim 18, wherein the impeller system comprises an impeller system intake wherein said impeller system intake comprises at least one pre-swirler in said impeller system intake, forward in said longitudinal forward direction of said at least one first diagonal fan, that tangentially swirls intake air before said intake air arrives at said at least one first diagonal fan.

21. An aircraft comprising an impeller system, said aircraft further comprising a longitudinal forward flight direction and a longitudinal rearward direction parallel to said longitudinal forward flight direction and opposite to said longitudinal forward flight direction, said aircraft further comprising a downward direction that is orthogonal to said longitudinal forward flight direction and toward the earth; said aircraft being propelled by at least one longitudinal thrust; wherein
said aircraft comprises at least one of a fuselage, a wing, and a nacelle; wherein
said impeller system comprises at least one electrically powered centrifugal impeller module within said at least one of a fuselage, a wing, and a nacelle; wherein
said centrifugal impeller module comprises at least two centrifugal impeller module sub-units, wherein said centrifugal impeller module sub-units share a same axis, wherein said at least two centrifugal impeller module sub-units comprise a 1^{st} centrifugal impeller sub-unit spinning in a first rotational direction about said axis and a 2^{nd} centrifugal impeller sub-unit spinning in a second rotational direction opposite to said first rotational direction around said axis.

22. The aircraft of claim 21, wherein said impeller system comprises at least one electrically powered diagonal impeller module situated in a forward zone within said at least one of said fuselage, wing, and nacelle; wherein
said centrifugal impeller module is situated in an aftward zone within said at least one of said fuselage, wing, and nacelle; and wherein
said aftward zone is rearward, in said longitudinal rearward direction, of said forward zone.

23. The aircraft of claim 21, wherein said impeller system comprises at least one electrically powered diagonal impeller module within said at least one of a fuselage, a wing, and a nacelle, wherein said electrically powered diagonal impeller module includes at least one first diagonal fan and at least one second diagonal fan, said first diagonal fan and said at least one second diagonal fan being arranged in series such that the at least one first diagonal fan feeds air to said at least one second diagonal fan, wherein said at least one first diagonal fan rotates at a first fan rotational velocity A and said at least one second diagonal fan rotates at a second fan rotational velocity B, and wherein B/A>1.4.
